(19) United States
(12) Patent Application Publication
(10) Pub. No.: US 2026/0236135 A1
(43) Pub. Date: Aug. 13, 2026

(54) Devices, Methods, and Graphical User Interfaces for Providing Information on a Wake Screen

(71) Applicant: Apple Inc., Cupertino, CA (US)

(72) Inventors: William M. Tyler, San Francisco, CA (US); Lyam J. Bewry, San Francisco, CA (US); Adam Grabowski, Cupertino, CA (US); Andrew P. Clymer, San Jose, CA (US); Vincenzo Vuono, Cupertino, CA (US); Marie Otsuka, San Francisco, CA (US); William A. Sorrentino, III, Kentfield, CA (US); James J. Owen, San Francisco, CA (US); Alan C. Dye, San Francisco, CA (US); Christopher P. Foss, San Francisco, CA (US); Bobby Martin, JR., Oakland, CA (US); Shubham Kedia, Santa Clara, CA (US); Chanaka G. Karunamuni, San Jose, CA (US); Bruno Canales, San Francisco, CA (US); Miquel Estany Rodriguez, San Francisco, CA (US); Stephen O. Lemay, Palo Alto, CA (US)

(21) Appl. No.: 19/450,627

(22) Filed: Jan. 15, 2026

Related U.S. Application Data
(60) Provisional application No. 63/749,470, filed on Jan. 24, 2025.
(60) Provisional application No. 63/808,561, filed on May 19, 2025.
(60) Provisional application No. 63/819,893, filed on Jun. 8, 2025.

(51) Int. Cl. G06F 3/0481; G06F 3/0485

(52) U.S. Cl. CPC G06F 3/0481; G06F 3/0485

(57) ABSTRACT

A computer system displays a first user interface. Displaying the first user interface includes concurrently displaying: first content; and an indication of a current time of day that is updated as the current time of day changes. While displaying the first user interface, the computer system detects a first event. In response to detecting the first event, the computer system: displays, via the one or more display generation components, a change in a spatial arrangement of the first content in the first user interface; and, displays, via the one or more display generation components, a change to the indication of the current time of day, including changing an aspect ratio of the indication of the current time of day while maintaining display of the indication of the current time of day in the first user interface, based on the change in the spatial arrangement of the first content.

### RELATED APPLICATIONS

This application claims priority to U.S. Provisional Patent Application No. 63/819,893, filed Jun. 8, 2025, U.S. Provisional Patent Application No. 63/808,561, filed May 19, 2025, and U.S. Provisional Patent Application No. 63/749,470, filed Jan. 24, 2025, each of which is hereby incorporated by reference in its entirety.

### TECHNICAL FIELD

This relates generally to electronic devices with touch-sensitive surfaces, including but not limited to electronic devices with touch-sensitive surfaces that provide information on wake screens.

### BACKGROUND

The use of touch-sensitive surfaces as input devices for computers and other electronic computing devices has increased significantly in recent years. Example touch-sensitive surfaces include touchpads and touch-screen displays. Such surfaces are widely used to manipulate user interfaces, such as wake screens, and objects therein on a display.

### SUMMARY

Accordingly, there is a need for electronic devices with faster, more efficient methods and interfaces for providing information on wake screens. Such methods and interfaces optionally complement or replace conventional methods for providing information on wake screens. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system that is in communication with one or more input devices and one or more display generation components. The method includes displaying, via the one or more display generation components, a first user interface. Displaying the first user interface includes concurrently displaying: first content; and an indication of a current time of day that is updated as the current time of day changes. The method includes, while displaying the first user interface, detecting a first event. The method includes, in response to detecting the first event: displaying, via the one or more display generation components, a change in a spatial arrangement of the first content in the first user interface; and, displaying, via the one or more display generation components, a change to the indication of the current time of day, including changing an aspect ratio of the indication of the current time of day while maintaining display of the indication of the current time of day in the first user interface, based on the change in the spatial arrangement of the first content.

In accordance with some embodiments, a method is performed at a computer system that is in communication with one or more input devices and one or more display generation components. The method includes displaying, via the one or more display generation components, a first user interface. The first user interface includes a first object placement region that includes a first set of two or more object placement locations arranged in a first spatial arrangement, and a second object placement region that includes a second set of two or more object placement locations arranged in a second spatial arrangement. The first and second object placement regions include multiple object placement locations for placing a respective type of user interface object in the first user interface, and the respective type of user interface object is restricted from being placed outside of an object placement region for placing the respective type of user interface object. The method includes, while displaying the first user interface, detecting, via the one or more input devices, a user input that corresponds to a request to move a first user interface object of the respective type of user interface object to an object placement location in the second object placement region. The method includes, in response to detecting the user input that corresponds to the request to move the first user interface object to an object placement location in the second object placement region: in accordance with a determination that the second set of two or more object placement locations in the second object placement region meets first criteria, moving the first user interface object into an object placement location in the second set of two or more object placement locations in the second object placement region; and, in accordance with a determination that the second set of two or more object placement locations does not meet the first criteria: moving the first object placement region to a location adjacent the second object placement region; and moving the first user interface object to a placement location within a user interface object placement location in a combined object placement region including the first set of two or more object placement locations and the second set of two or more object placement locations.

In accordance with some embodiments, a method is performed at a computer system that is in communication with one or more input devices and one or more display generation components. The method includes displaying, via the one or more display generation components, a first user interface that corresponds to a restricted state of the computer system. Displaying the first user interface includes concurrently displaying: a background; a media player user interface object, overlaying the background; and an indication of a current time of day that is updated as the current time changes, wherein the indication of the current time is displayed at a first size, overlaying the background. The method includes, while displaying the first user interface, detecting, via the one or more input devices, a first user input directed to the media player user interface object. The method includes, in response to detecting the first user input directed to the media player user interface object: in accordance with a determination that the first user input directed to the media player user interface object meets first criteria, wherein the first criteria require that the first user input is directed to a first portion of the media player user interface object in order for the first criteria to be met, while remaining in the restricted state of the computer system, concurrently displaying, via the one or more display generation components: visual media associated with audio content that is being controlled using the media player user interface object, wherein the visual media associated with the audio content replaces display of a respective portion of the background of the first user interface; and an indication of the current time of day at a second size that is different from the first size. The method includes, in response to detecting the first user input directed to the media player user interface object: in accordance with a determination that the first user input directed to the media player user interface object does not meet the first criteria, while remaining in the restricted state of the computer system, forgoing replacing display of the respective portion of the background of the first user interface with the visual media associated with the audio content and forgoing changing the size of the indication of the current time of day to the second size.

In accordance with some embodiments, a method is performed at a computer system that is in communication with one or more display generation components. The method includes displaying, via the one or more display generation components, a system user interface. Displaying the system user interface includes concurrently displaying: first content; and a first status element that includes first status information about a first active session of a first application, wherein the first status information in the first status element is updated over time while the first active session is ongoing. The method includes detecting occurrence of an event corresponding to the first active session. The method includes, in response to detecting the occurrence of the event corresponding to the first active session: in accordance with a determination that respective criteria are met, wherein the respective criteria include a requirement that a second active session of a second application is executing on the computer system, wherein the second application is different from the first application, and that the second active session is related to the first active session in order for the respective criteria to be met, concurrently displaying in the system user interface, via the one or more display generation components: the first status element; and a second status element that includes second status information about the second active session, wherein the second status information in the second status element is updated over time while the second active session is ongoing. The method includes, in response to detecting the occurrence of the event corresponding to the first active session: in accordance with a determination that the respective criteria are not met, displaying in the system user interface, via the one or more display generation components, an expanded user interface corresponding to the first active session without displaying the second status element.

In accordance with some embodiments, a method is performed at a computer system that is in communication with one or more input devices and one or more display generation components. The method includes displaying, via the one or more display generation components, a first user interface. The method includes, while displaying the first user interface, detecting, via the one or more input devices, a first user input that corresponds to a request to move a user interface overlay relative to a reference location. The method includes, in response to detecting the first user input that corresponds to the request to move the user interface overlay relative to the reference location: moving the user interface overlay, including moving an edge portion of the user interface overlay across a first region of a display area, previously occupied by a portion of the first user interface, that includes respective content, including: displaying, via the one or more display generation components, the edge portion of the user interface overlay with an appearance based on a first degree of simulated optical distortion of a portion of the respective content at a location that corresponds to the edge portion of the user interface overlay; and displaying, via the one or more display generation components, an interior portion of the user interface overlay with an appearance based on the respective content with less than the first degree of simulated optical distortion of the respective content under the interior portion of the user interface overlay.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for providing information on wake screens, thereby increasing the effectiveness, efficiency, and user satisfaction with such devices. Such methods and interfaces may complement or replace conventional methods for providing information on wake screens.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

Figure (“FIG.”) 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5AP illustrate example user interfaces for displaying a wake screen in accordance with some embodiments.

FIGS. 6A-6AC illustrate example user interfaces for displaying live activity status information, including in a wake screen, in accordance with some embodiments.

FIG. 7 is a flow diagram of a process for changing the appearance of information on a wake screen in accordance with some embodiments.

FIG. 8 is a flow diagram of a process for modifying object placement regions in a wake screen in accordance with some embodiments.

FIG. 9 is a flow diagram of a process for interacting with a wake screen that includes a media player and a current time in accordance with some embodiments.

FIG. 10 is a flow diagram of a process for displaying live activity status information in a wake screen in accordance with some embodiments.

FIGS. 11A-110 illustrate example user interfaces for transitioning from a wake screen and modifying a home screen in accordance with some embodiments.

FIG. 12 is a flow diagram of a process for transitioning from a wake screen user interface in accordance with some embodiments.

### DESCRIPTION OF EMBODIMENTS

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

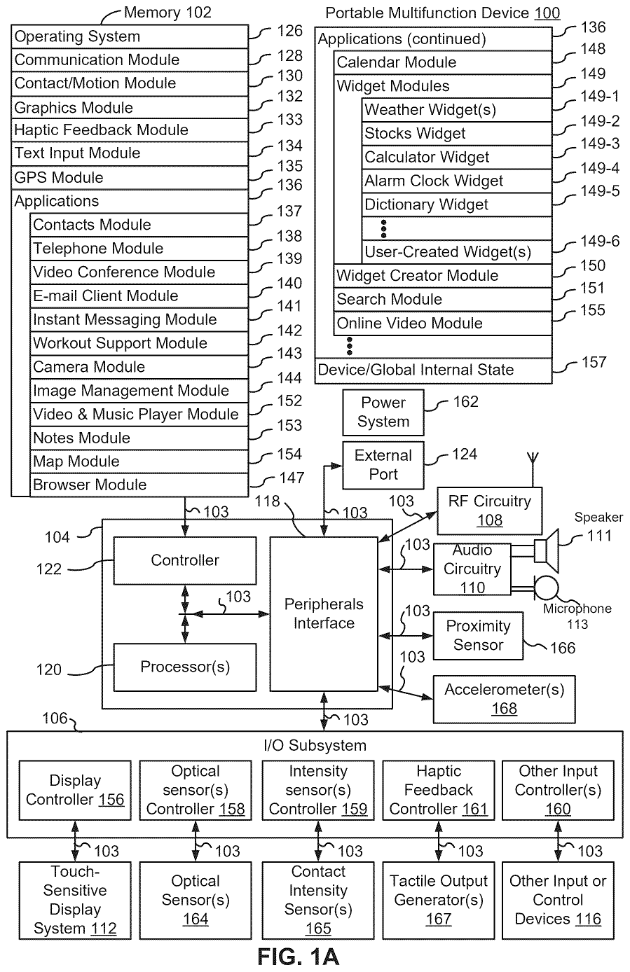

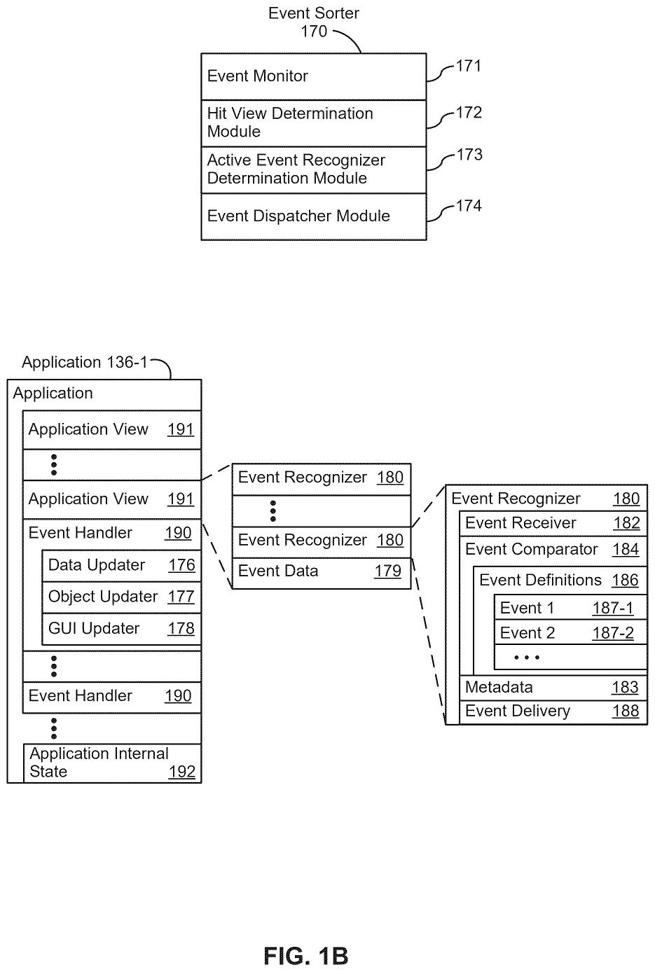

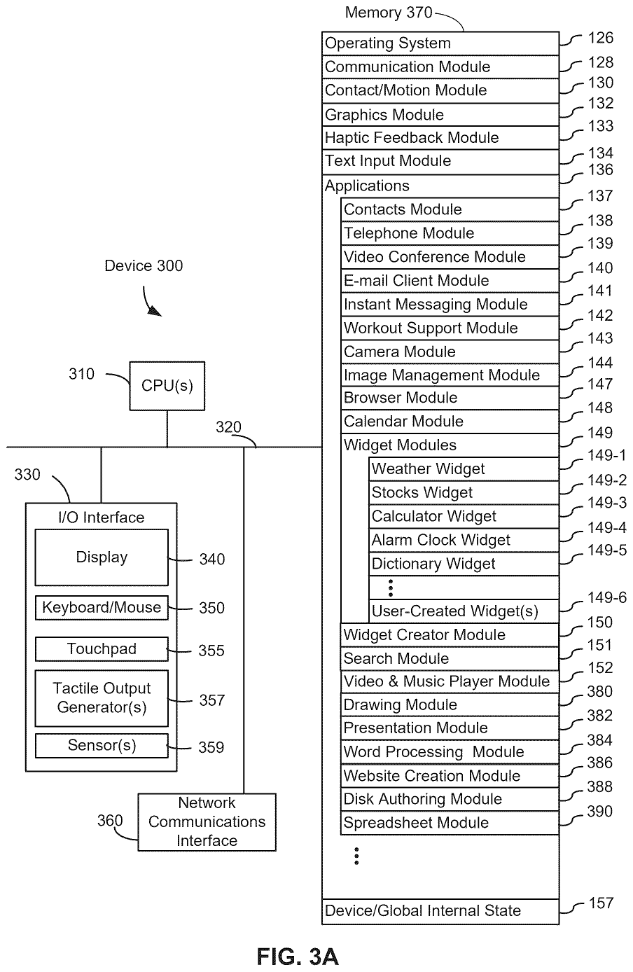

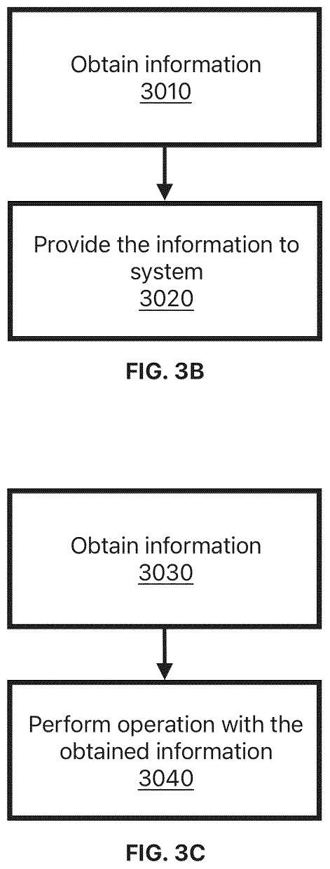

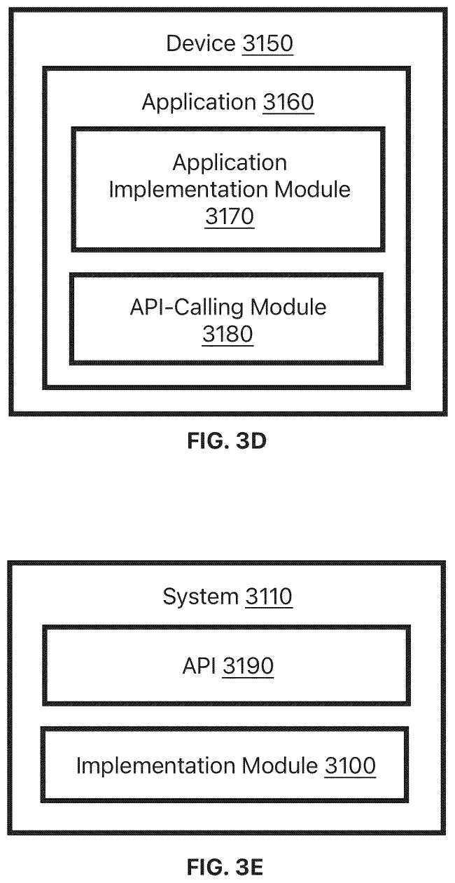

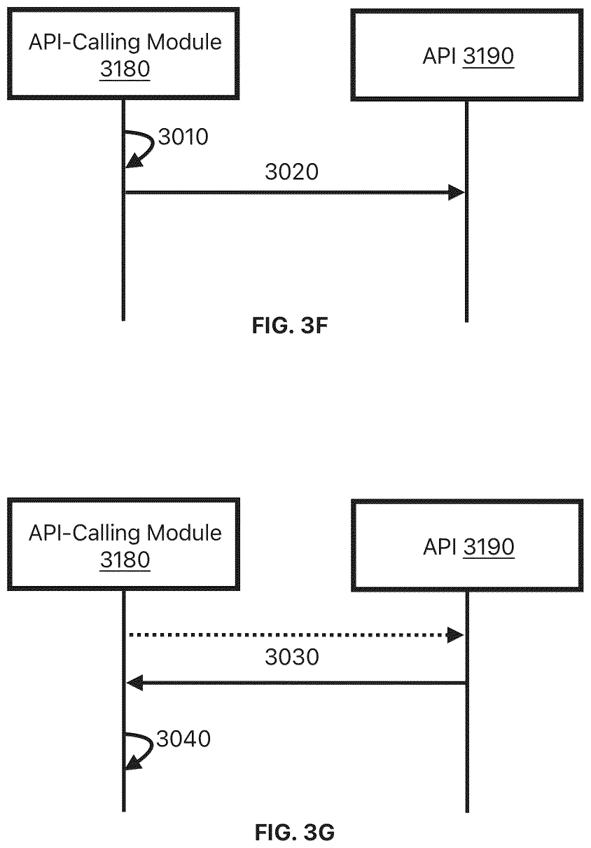

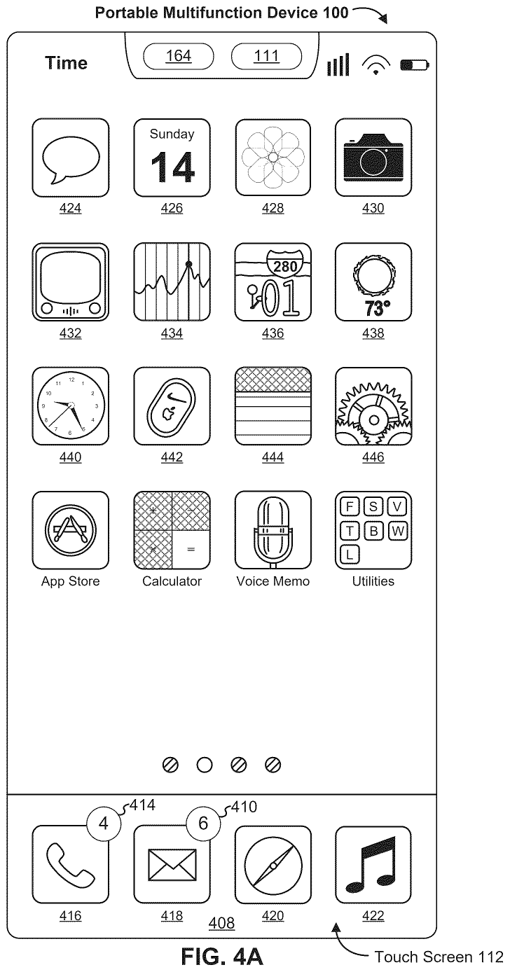

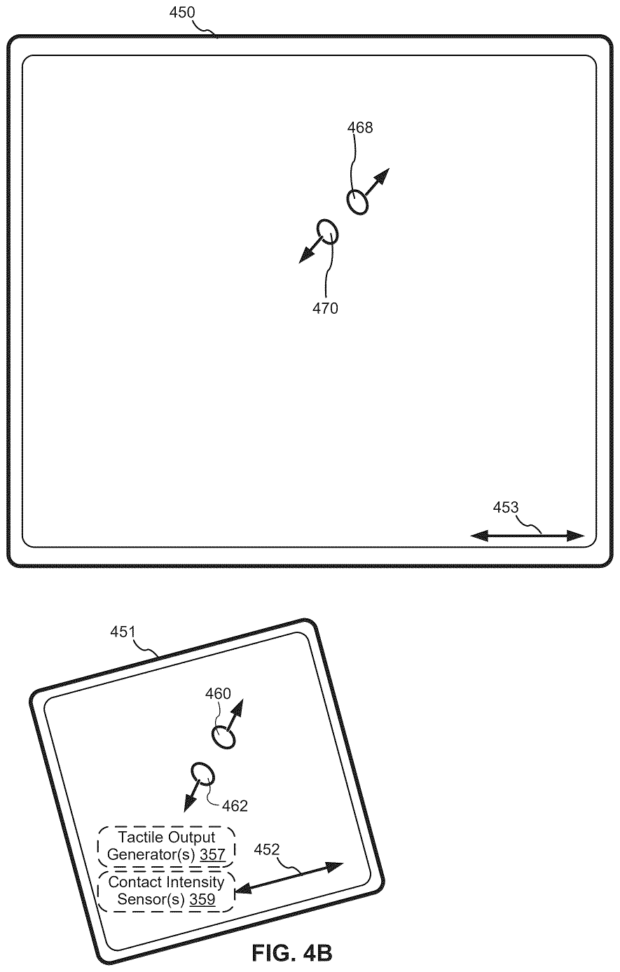

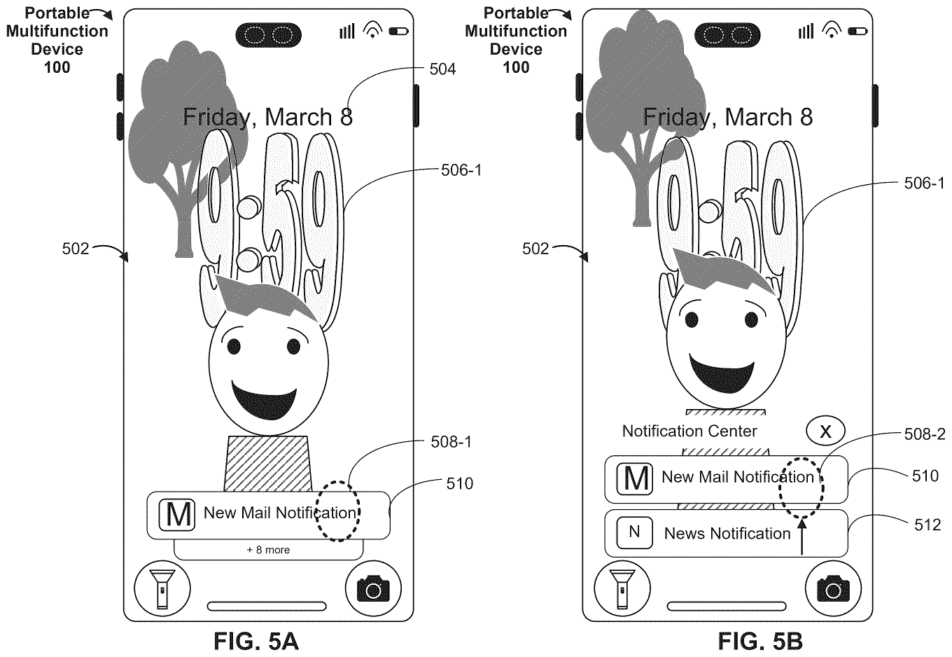

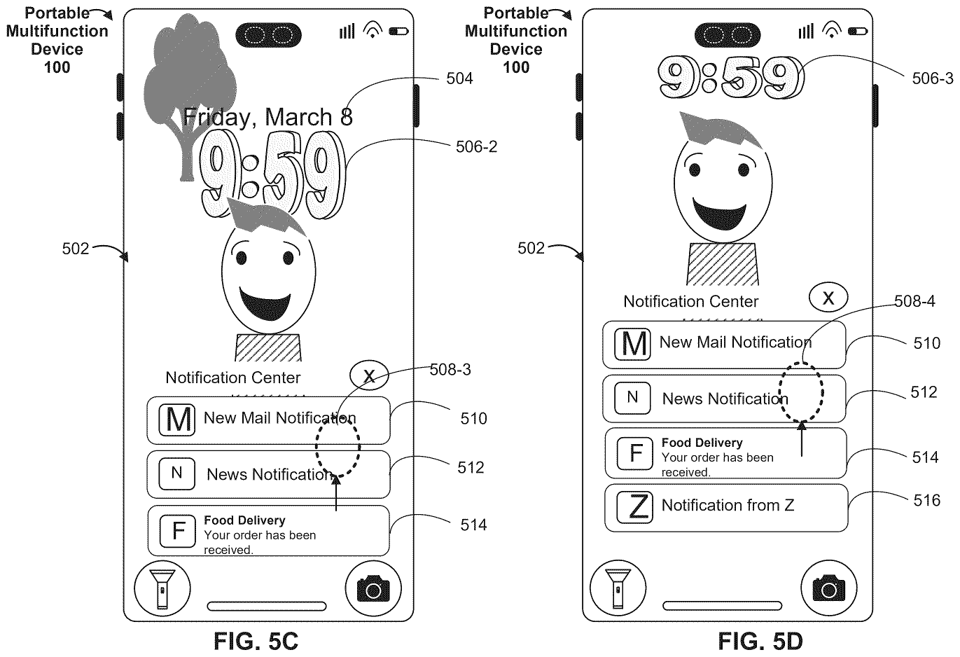

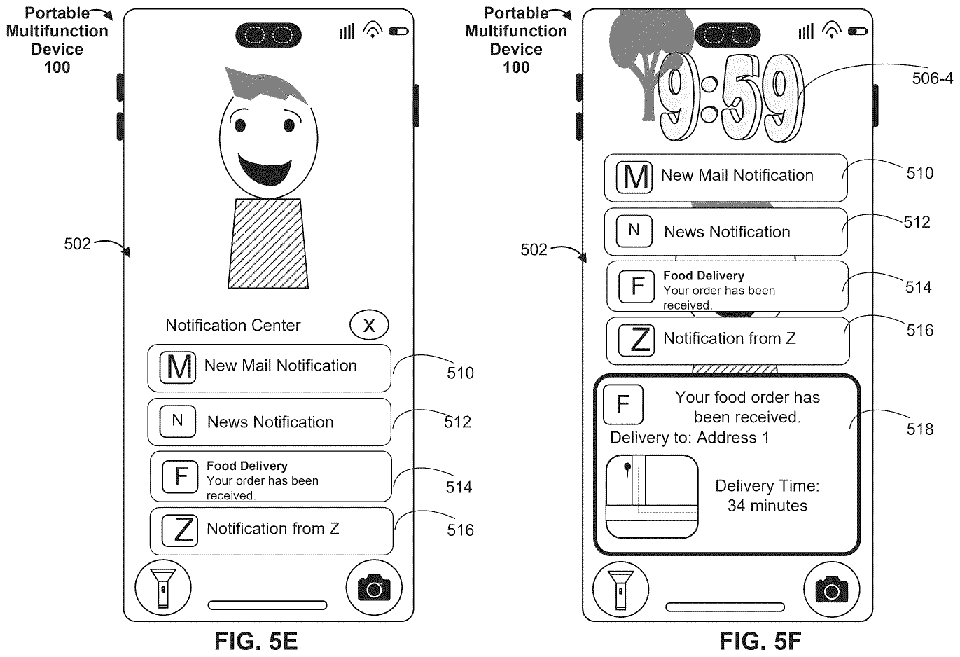

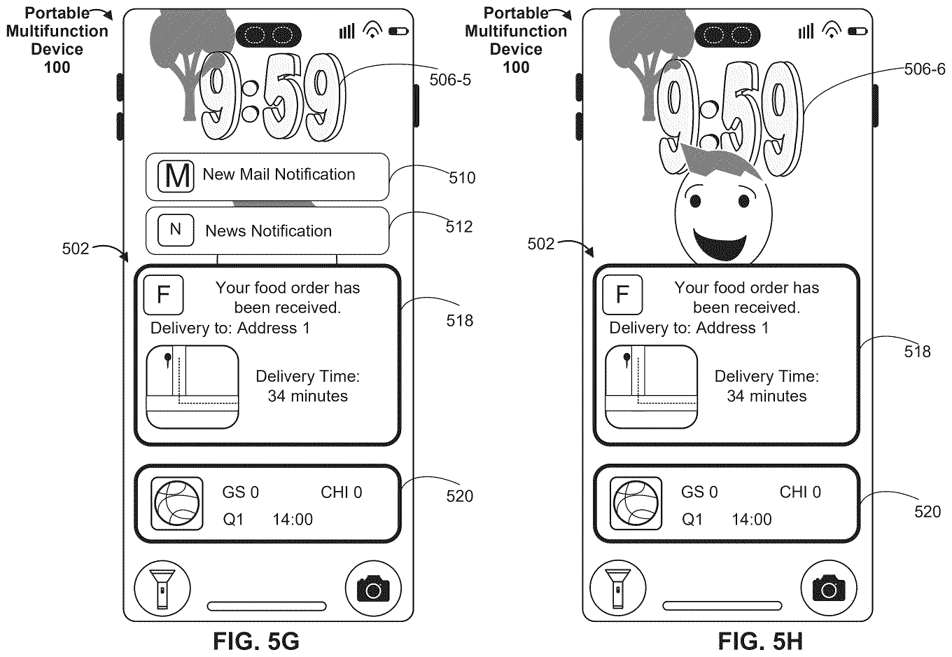

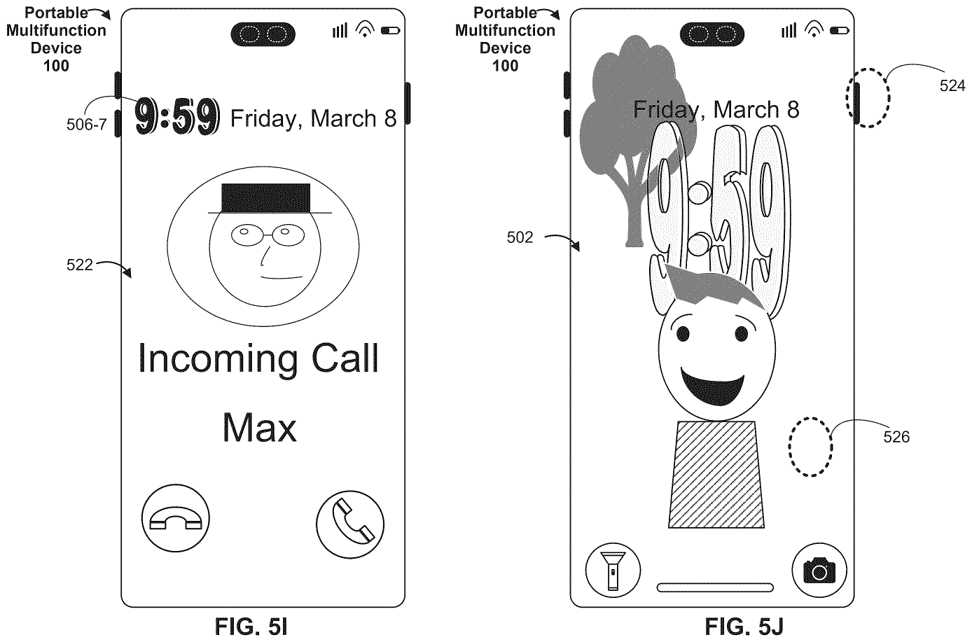

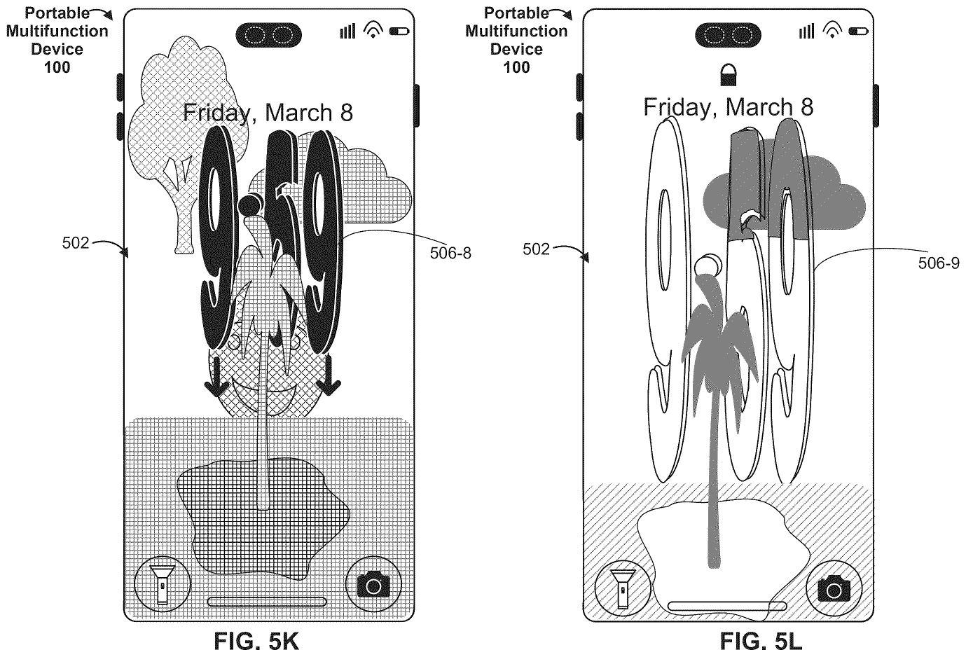

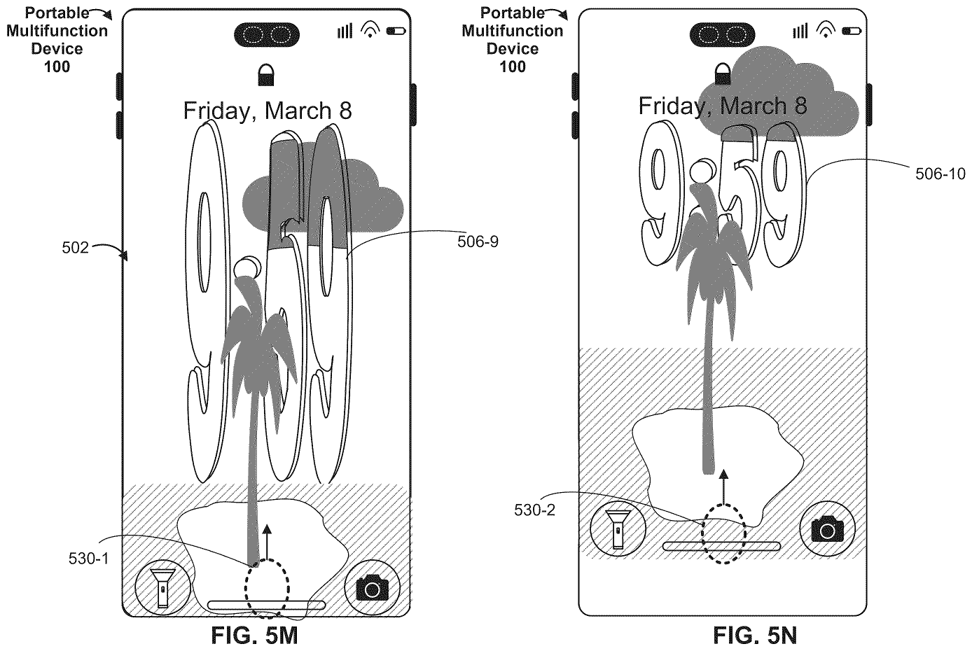

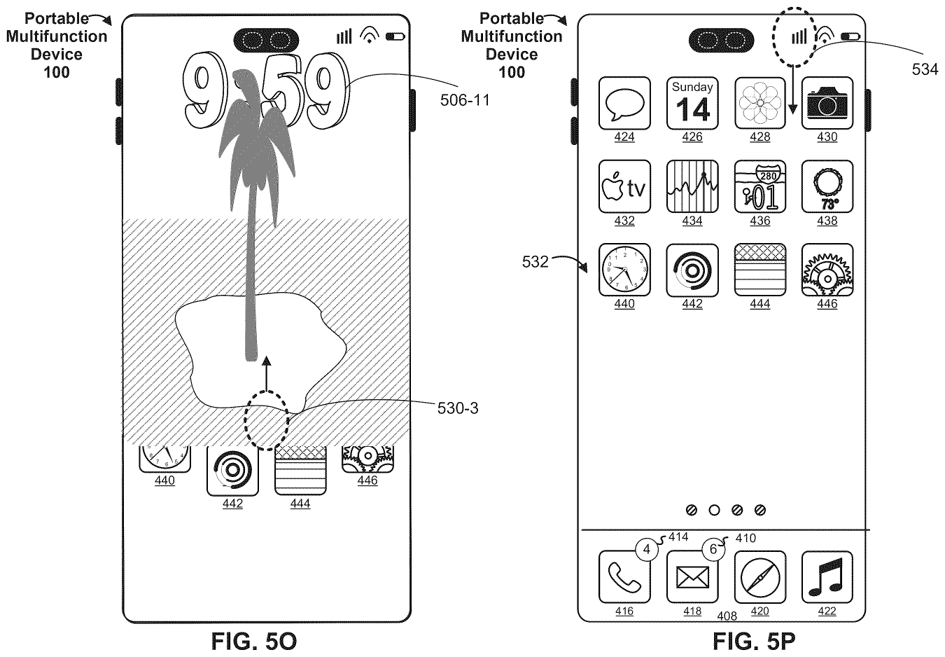

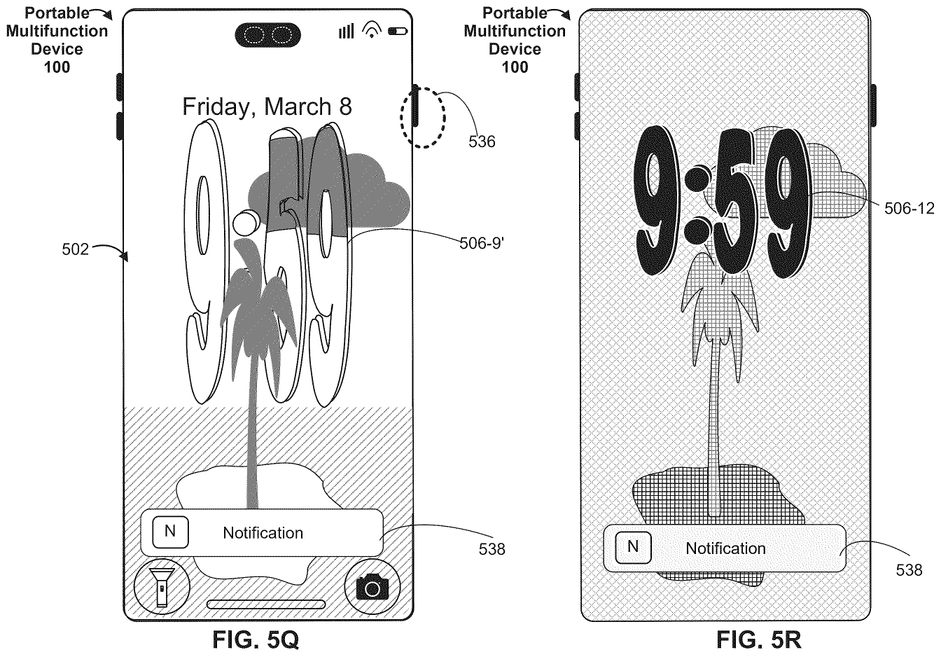

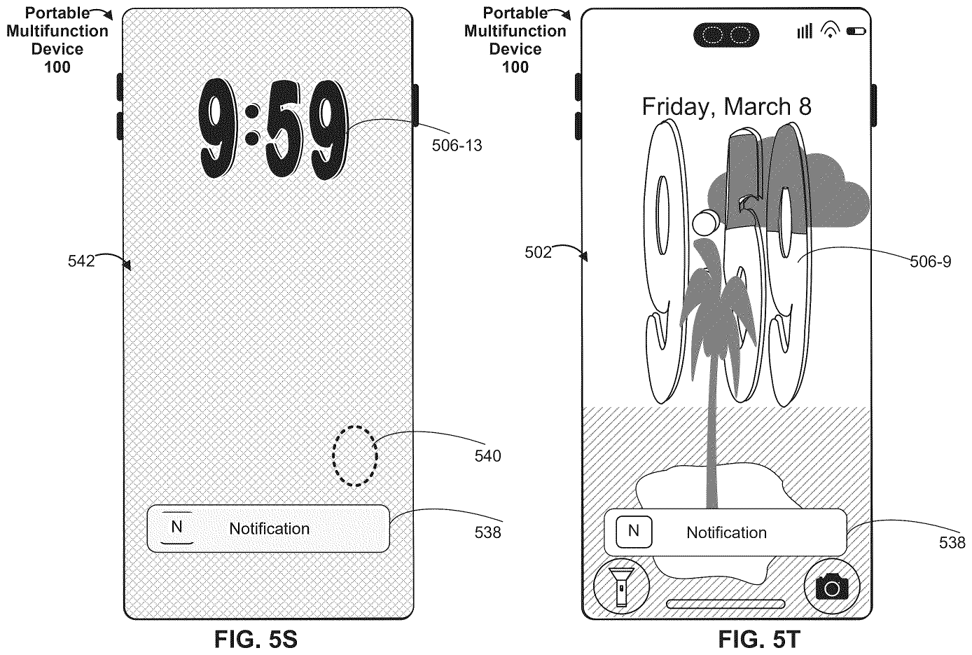

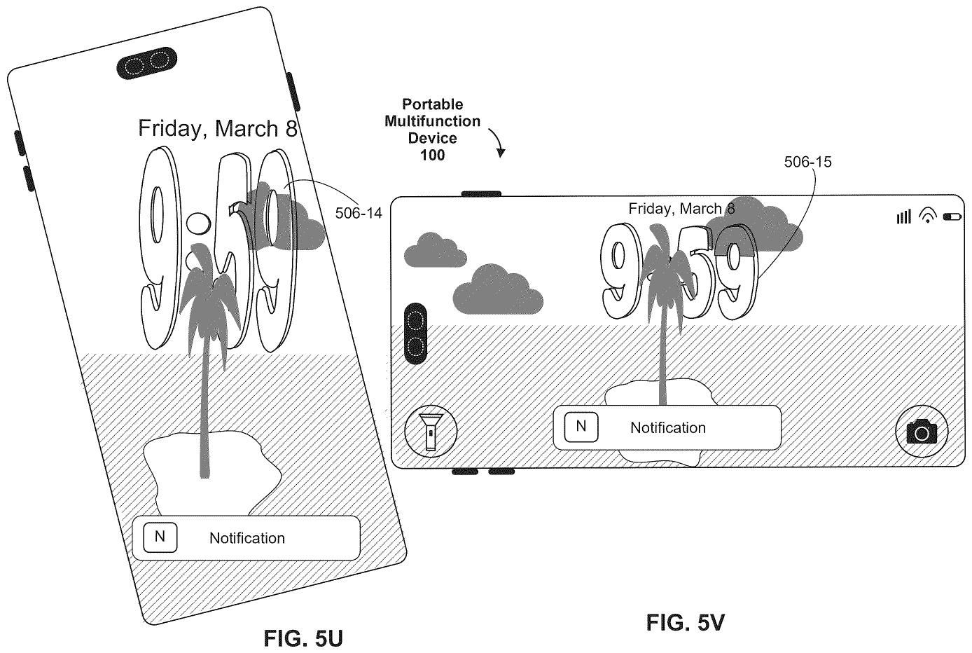

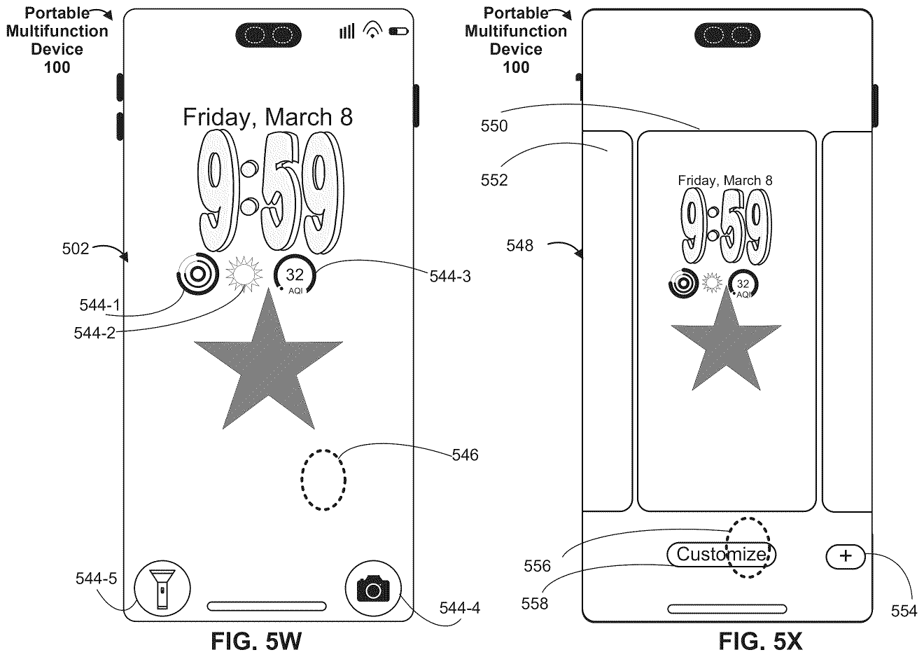

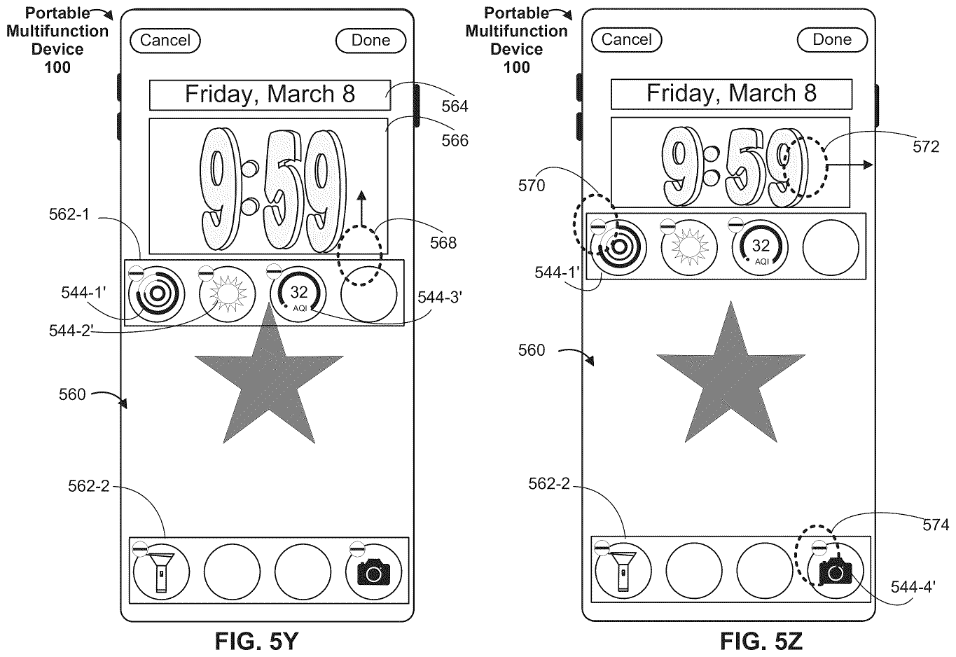

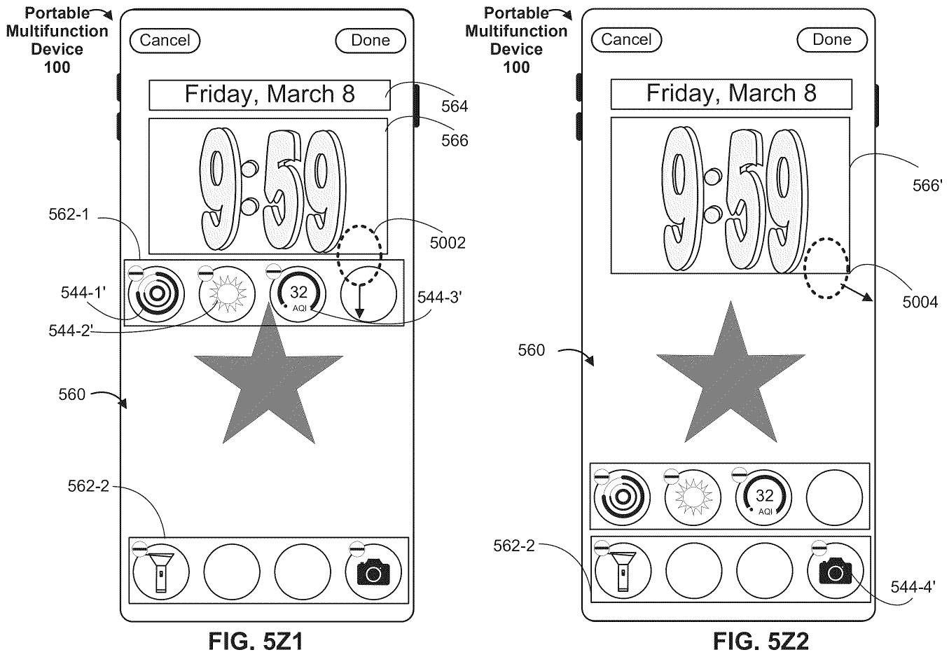

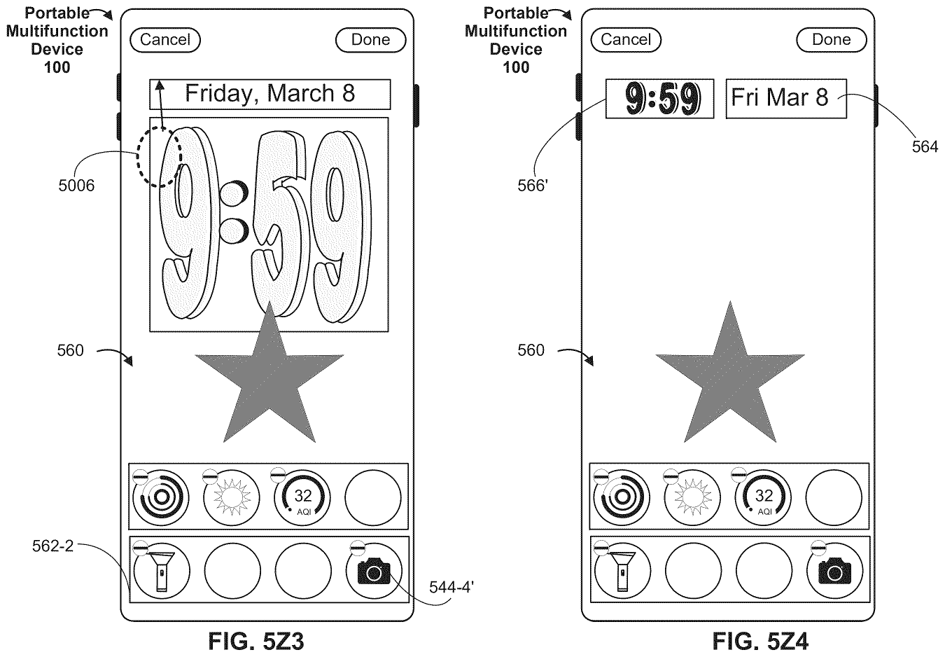

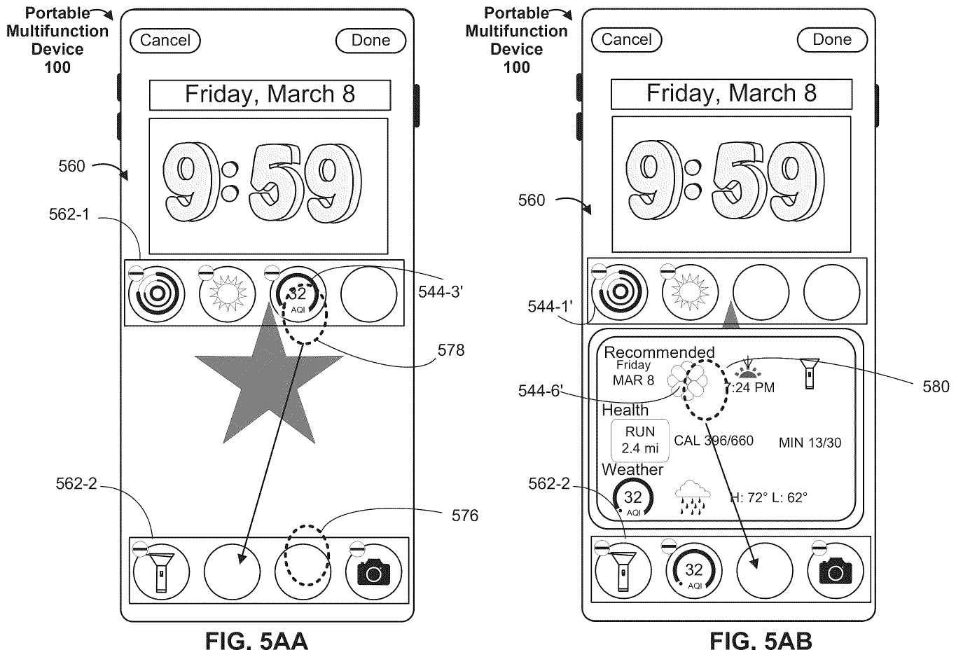

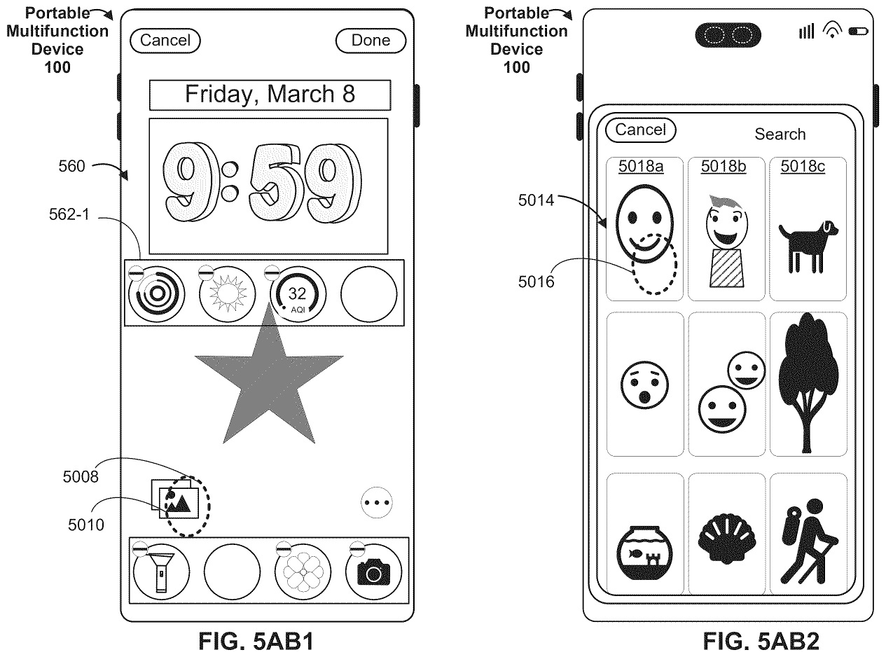

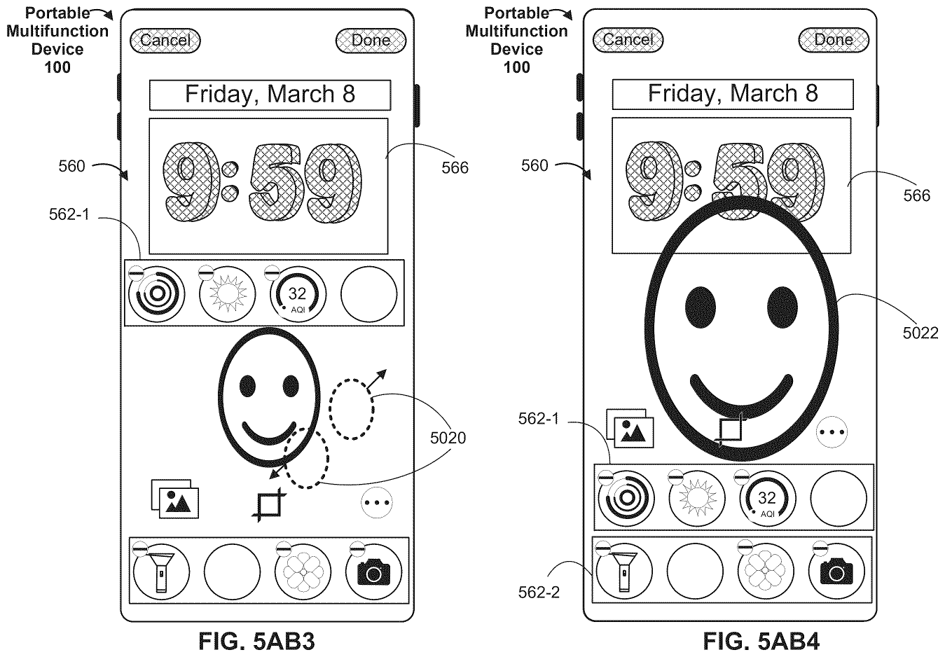

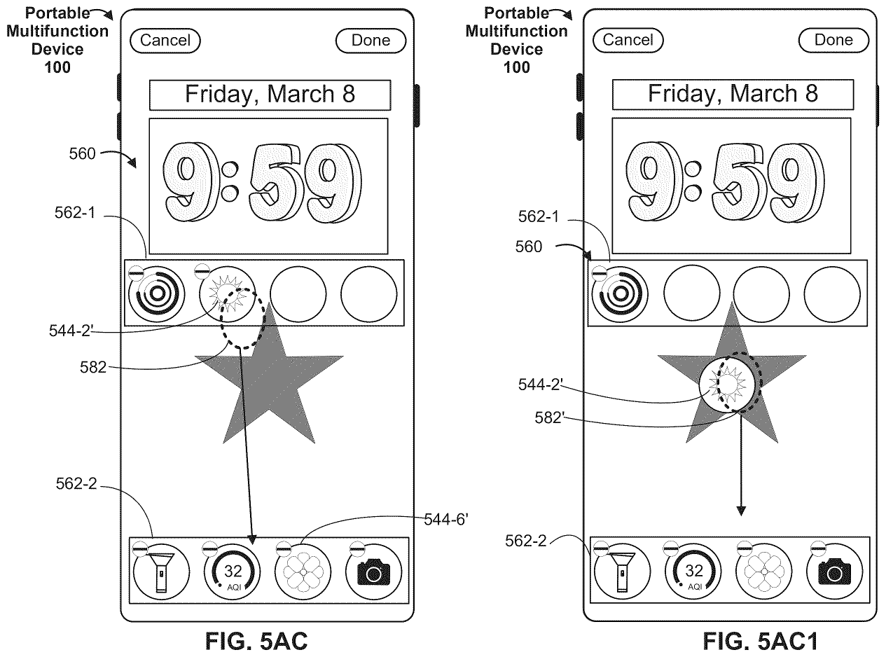

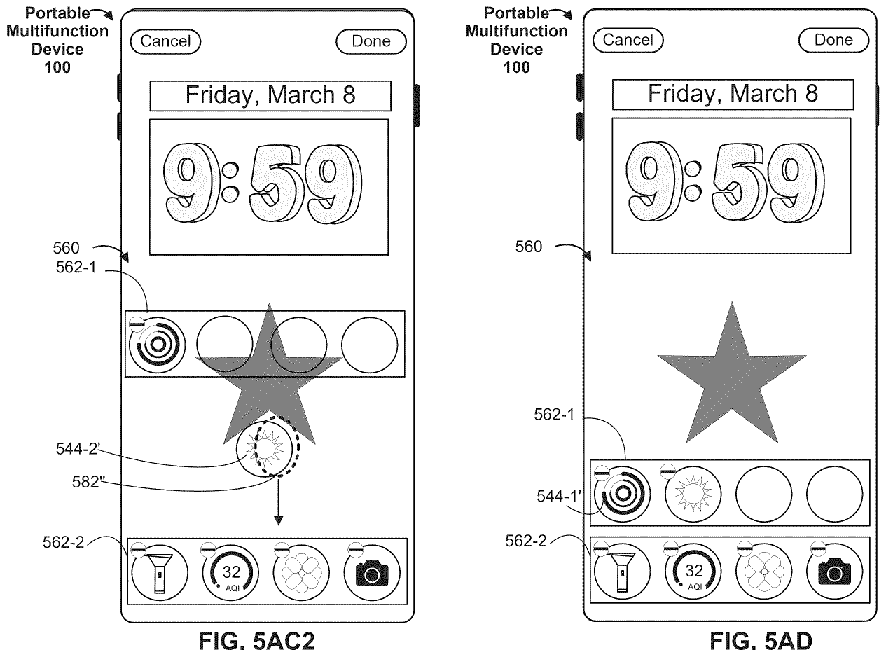

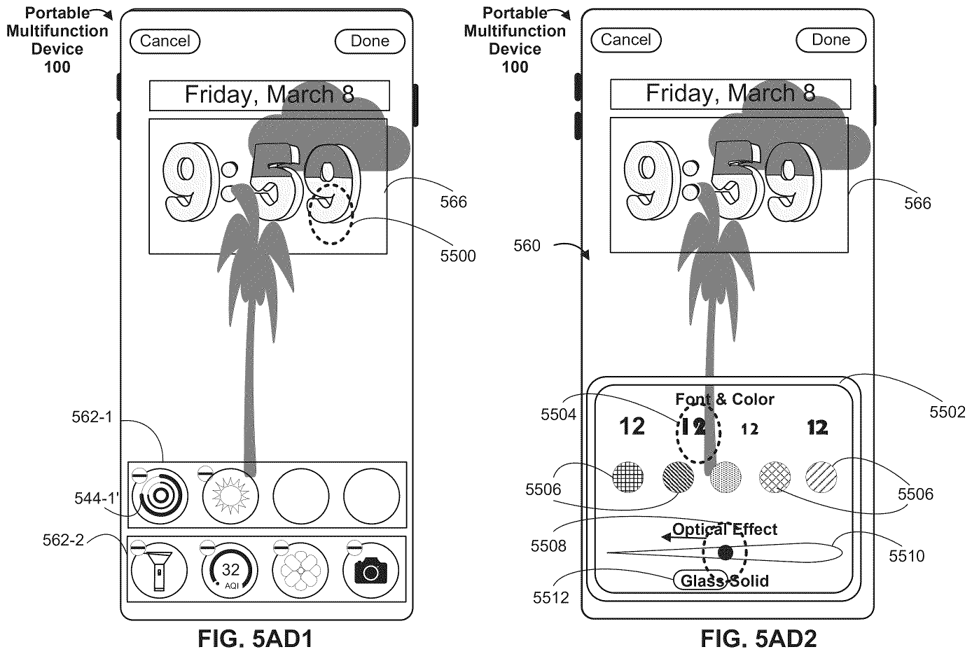

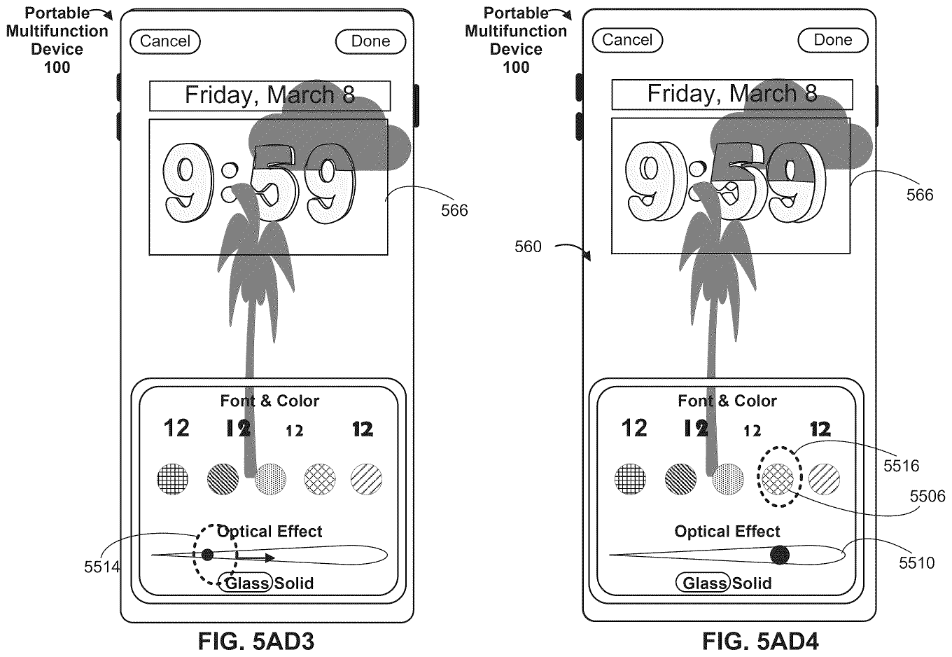

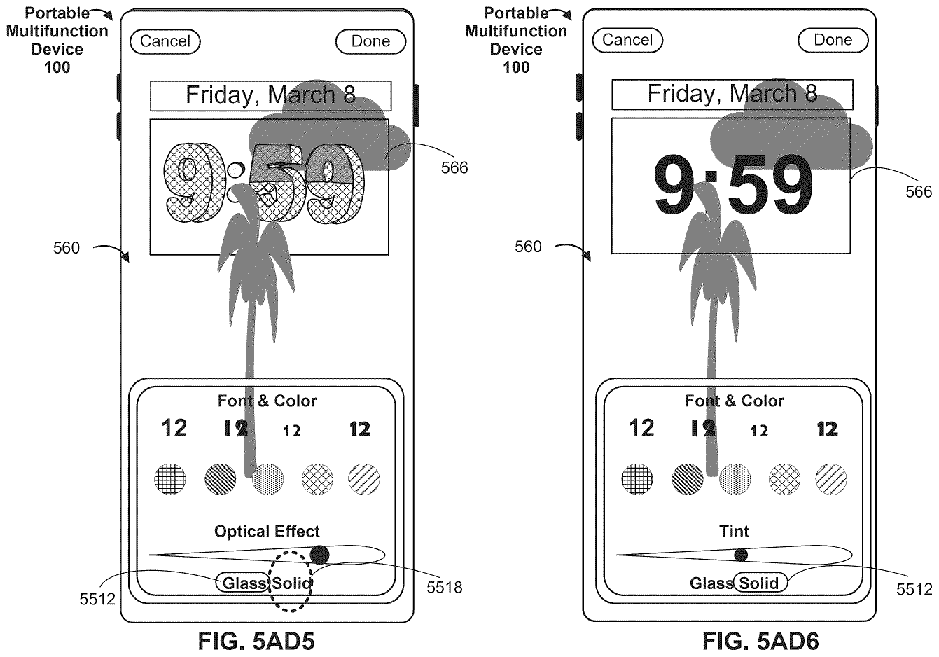

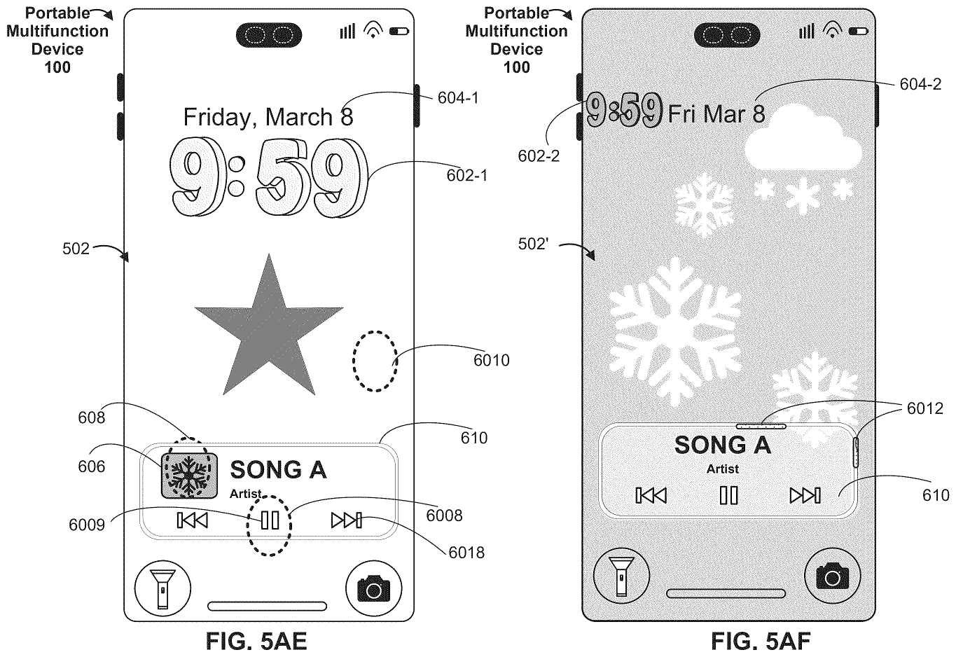

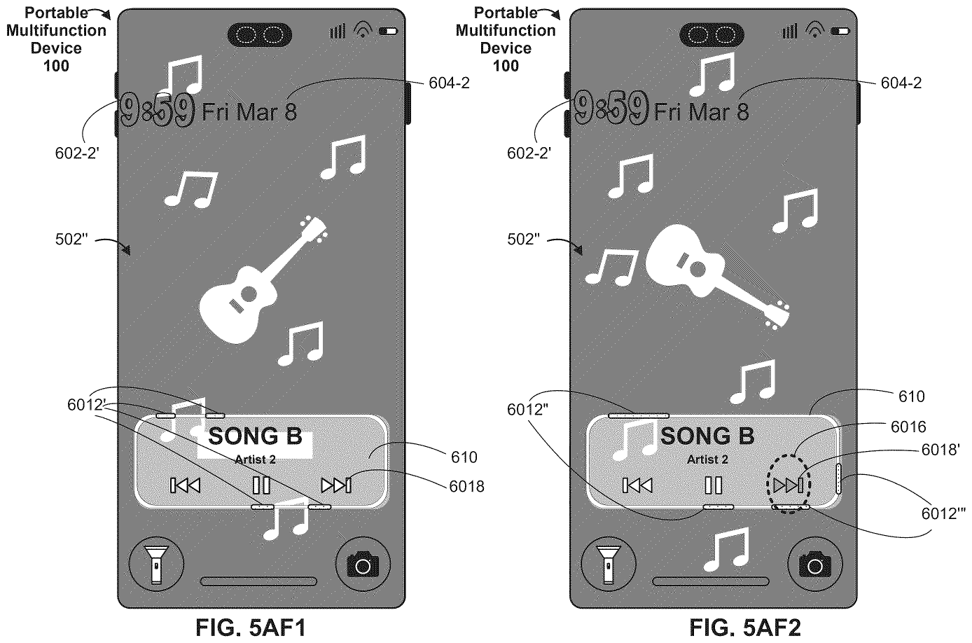

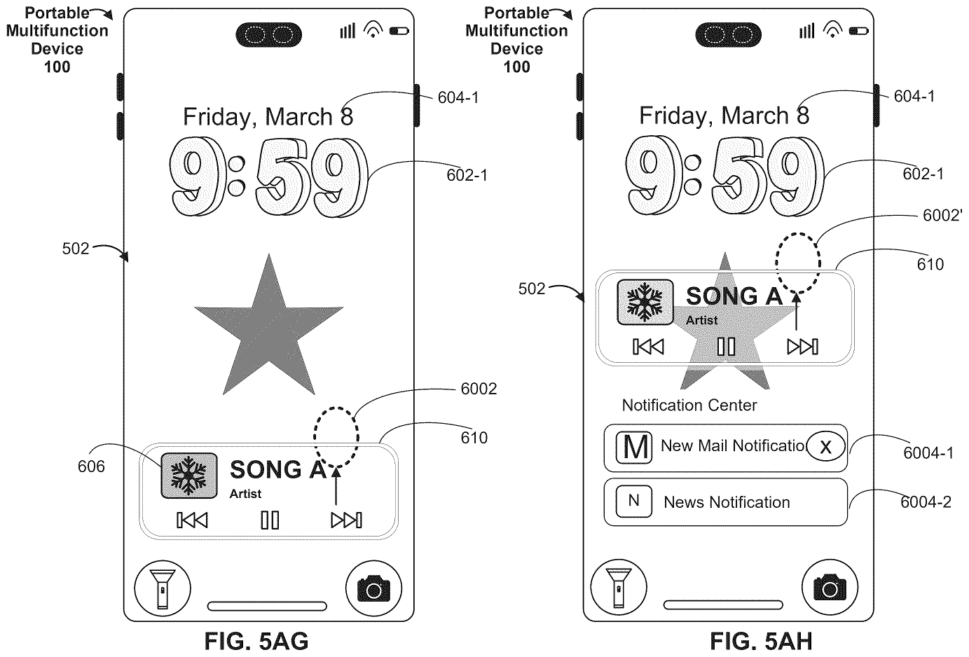

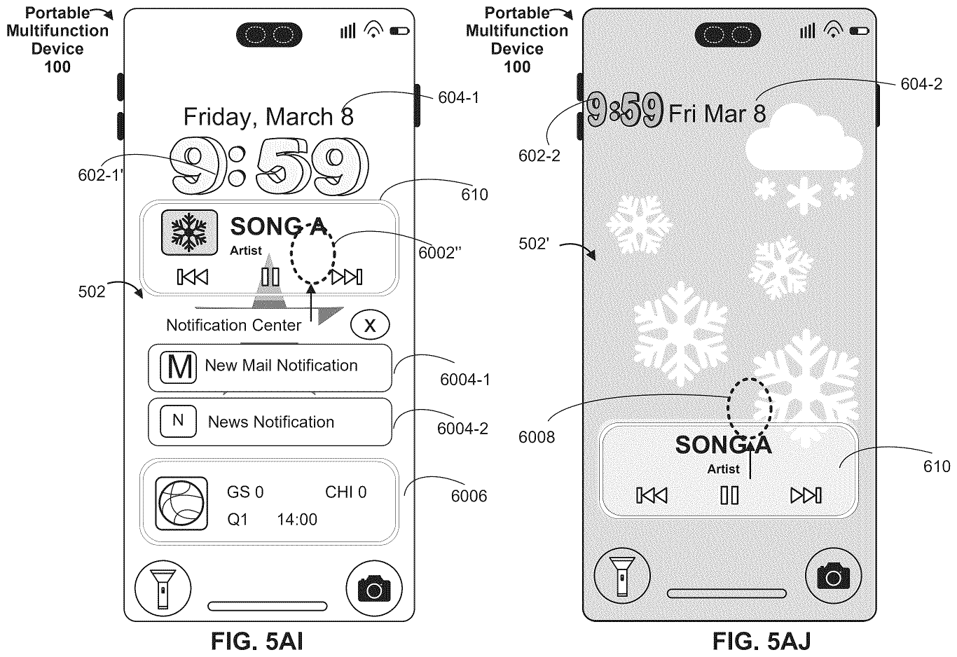

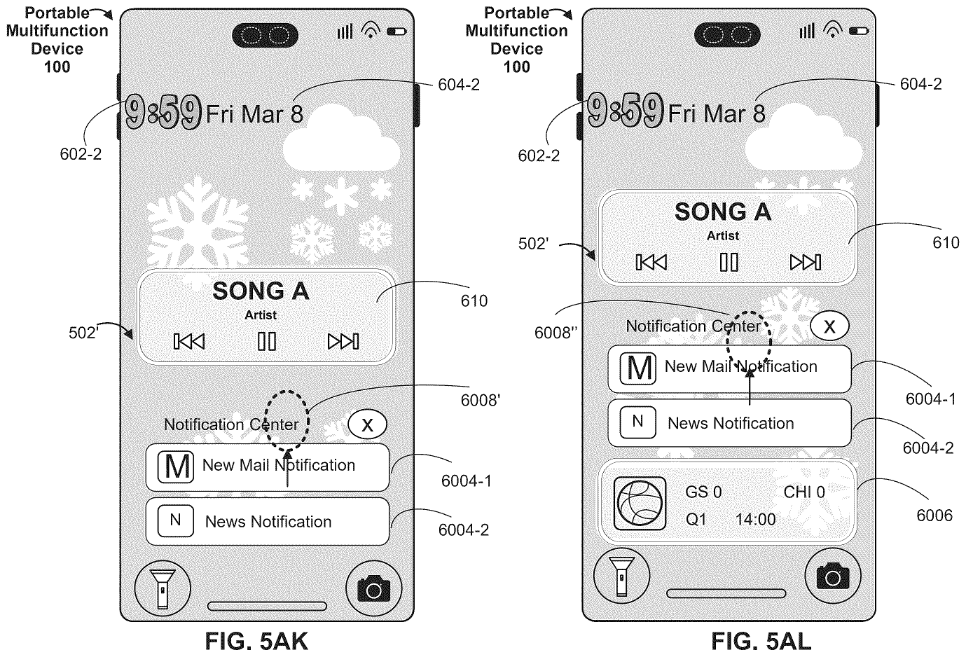

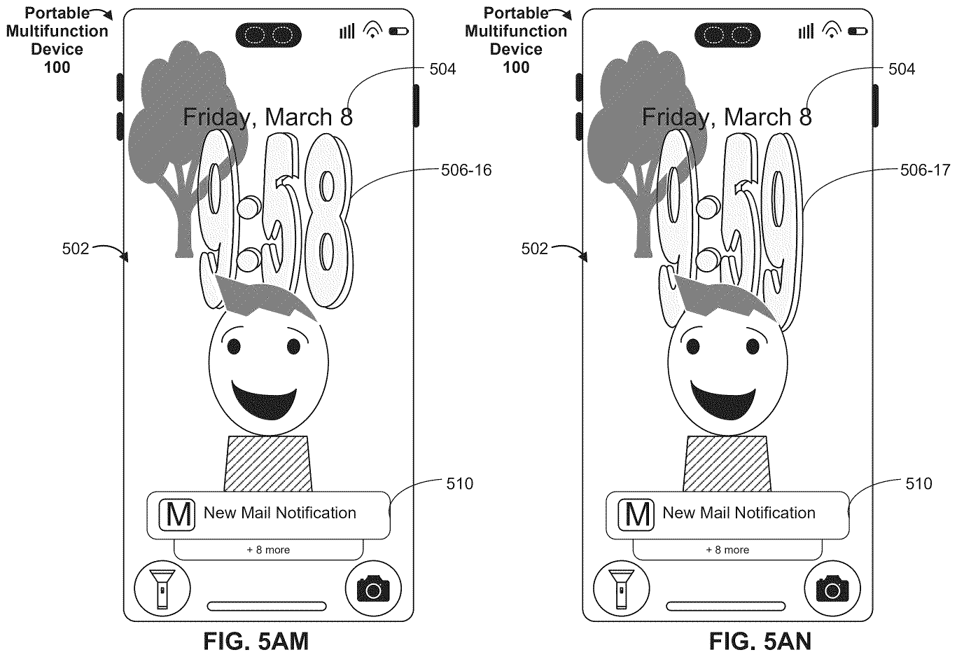

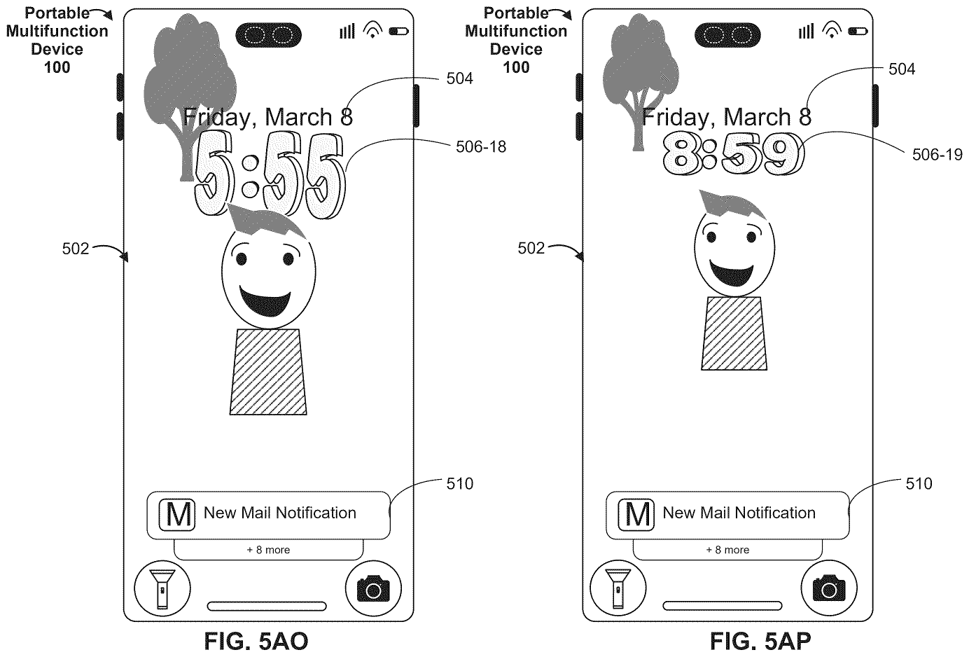

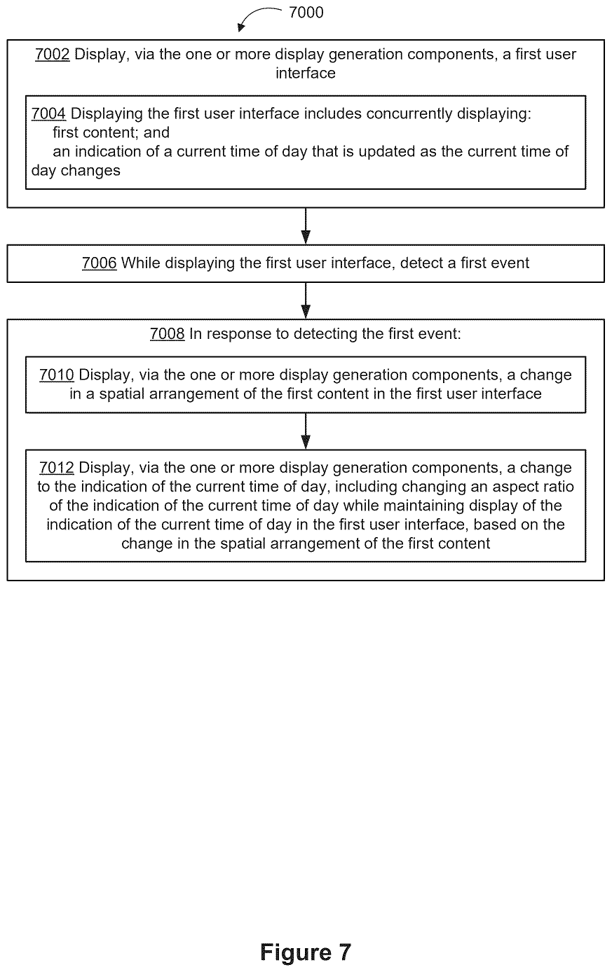

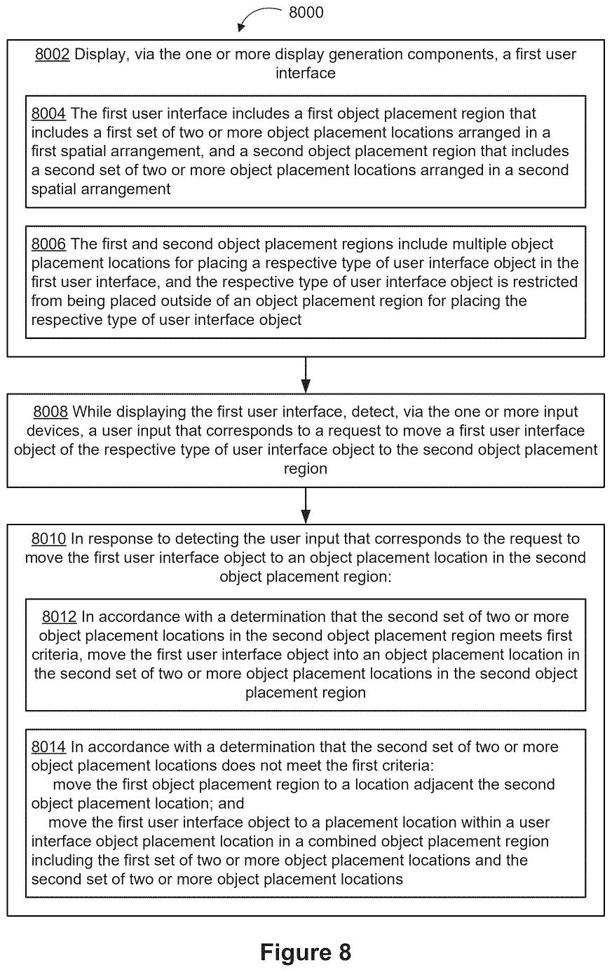

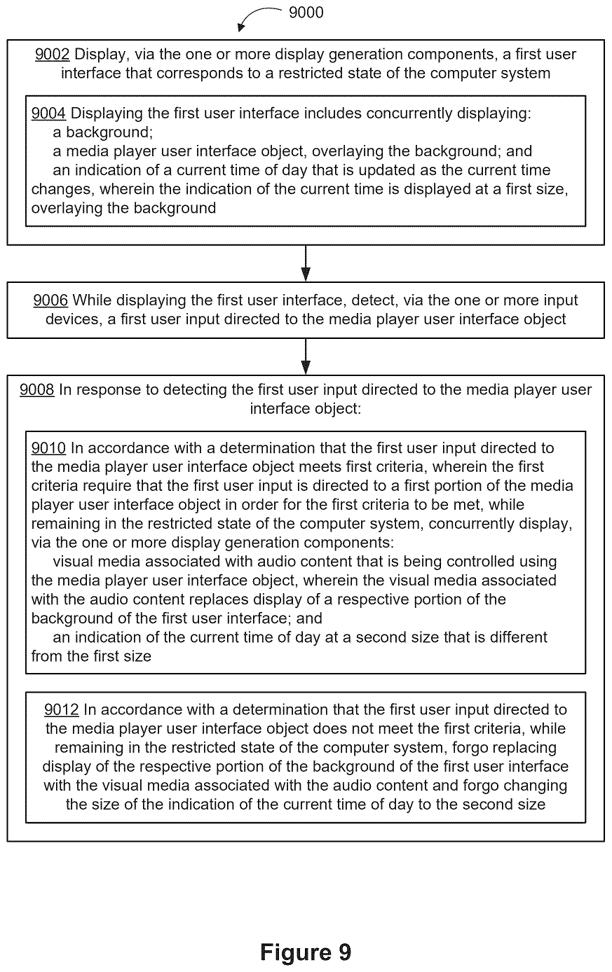

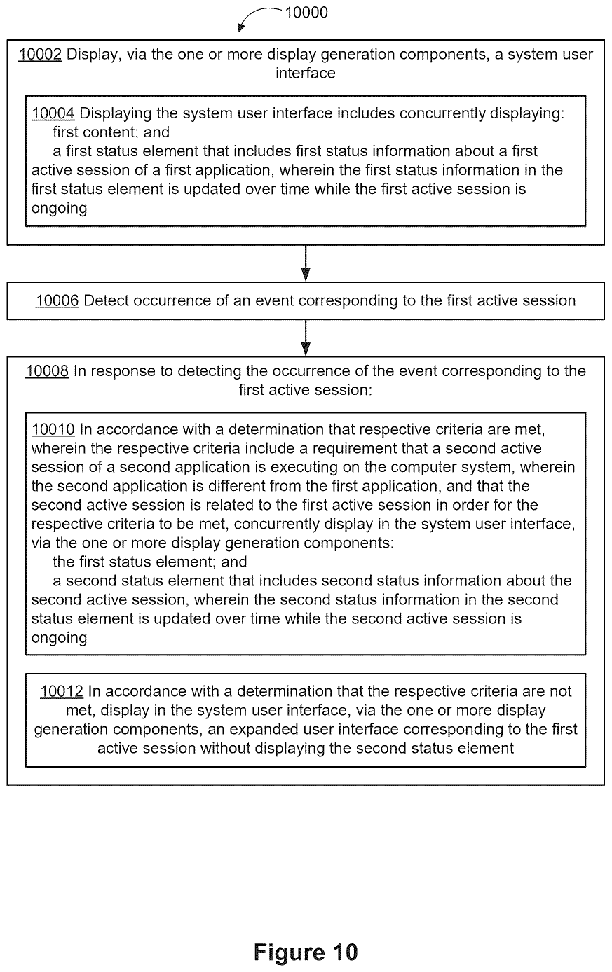

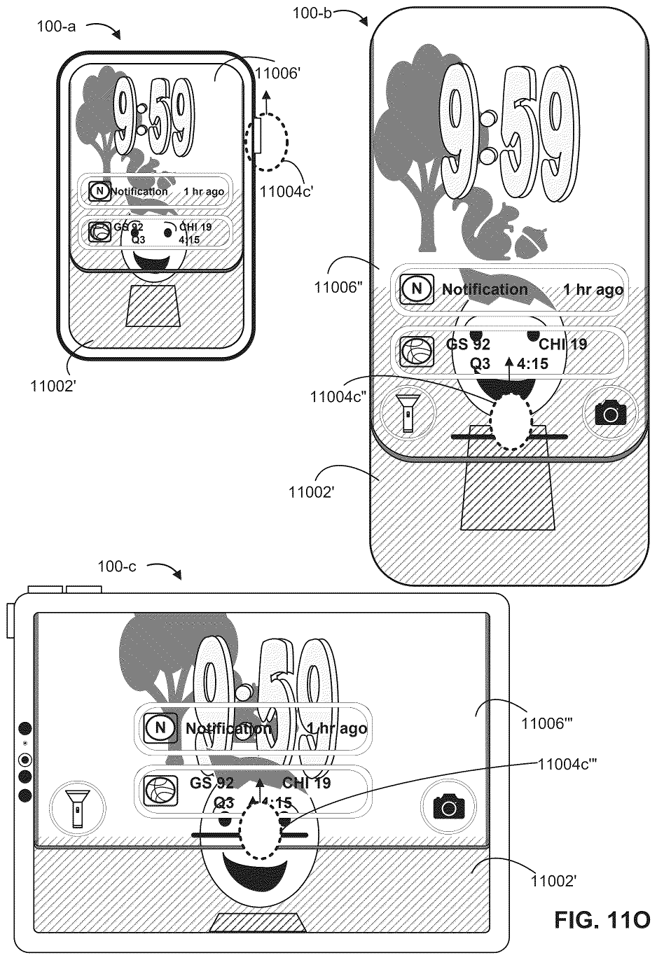

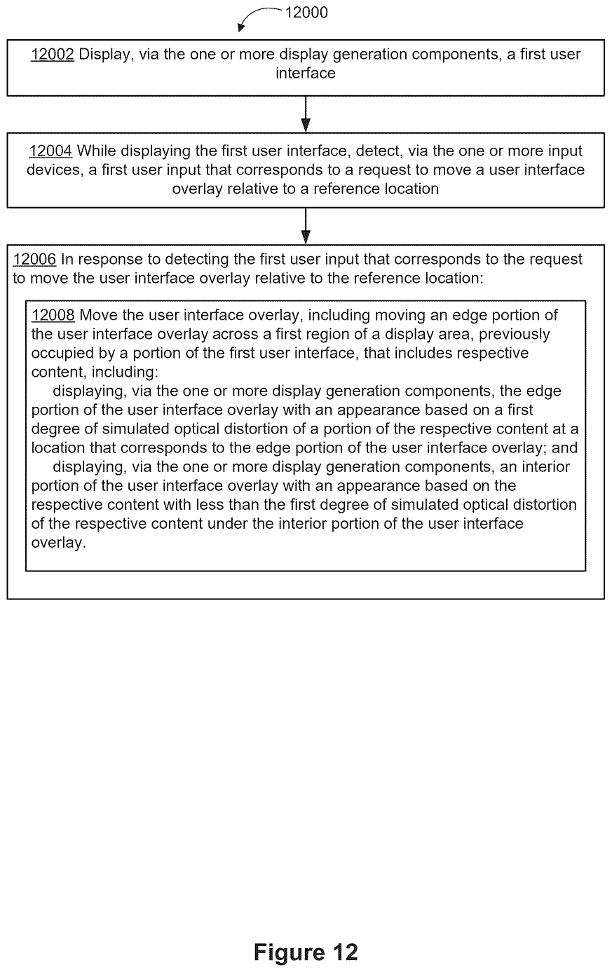

Below, FIGS. 1A-1B, 2, and 3A provide a description of example devices. FIGS. 3B-3G describe the use of Application Programming Interfaces (APIs) to perform operations. FIGS. 4A-4B, 5A-5AP, 6A-6AC, and 11A-110 illustrate example user interfaces for displaying a wake screen, for displaying a home screen, and for displaying live activity status information, including in a wake screen or a home screen. FIG. 7 illustrates a flow diagram of a method of changing the appearance of information on a wake screen. FIG. 8 illustrates a flow diagram of a method of modifying object placement regions in a wake screen. FIG. 9 illustrates a flow diagram of a method of interacting with a wake screen that includes a media player and a current time. FIG. 10 illustrates a flow diagram of a method of displaying live activity status information in a wake screen. FIG. 12 illustrates a flow diagram of a method of transitioning from a wake screen user interface. The user interfaces in FIGS. 5A-5AP, 6A-6AC, and 11A-110 are used to illustrate the processes in FIGS. 7, 8, 9, 10, and 12.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

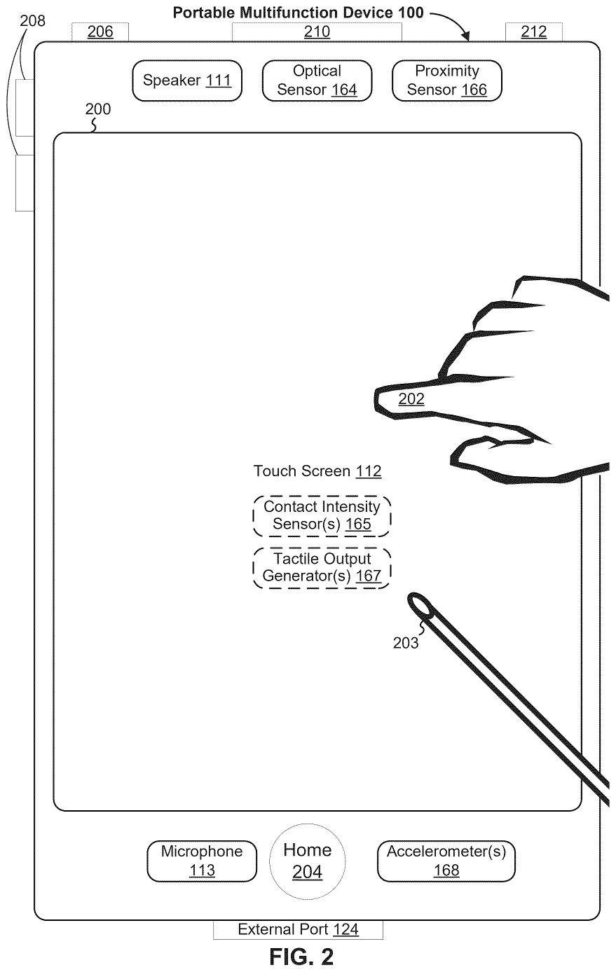

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in an address book of contacts module 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-executable storage medium (or multiple tangible computer-readable storage media of one or more types) encoding one or more computer-executable instructions. It should be recognized that computer-executable instructions can be organized in any format, including applications, widgets, processes, software (e.g., one or more computer programs), and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a communications network, and/or read from a storage device).

Referring to FIG. 3B, FIG. 3D, and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) to which information is provided is an operating system hosted on device 3150. In some embodiments, the system (e.g., 3110 shown in FIG. 3E) is an external device (e.g., a server, a peripheral device, an accessory, and/or a personal computing device) that includes an operating system that includes one or more system processes.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190 of FIG. 3E) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. The device 3150 may be an instance of any of the devices described herein. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-executable instructions) that provides an interface that allows a different module (e.g., API-calling module 3180) to communicate with a system process to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and accessed using API 3190 or uses data types or objects defined in the SDK library and provided by (or accessed using) API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component of device 3150.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-executable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure of API 3190.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide the first set of functions, or a subset of the first set of functions, and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a communications network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected, the direct sensor data (e.g., data representing or corresponding to detection of the input) is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls made between steps of interacting with the computer system (e.g., API calls between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 7000 (e.g., as discussed herein with respect to FIG. 7), method 8000 (e.g., as discussed herein with respect to FIG. 8), method 9000 (e.g., as discussed herein with respect to FIG. 9), and/or method 10000 (e.g., as discussed herein with respect to FIG. 10) by calling an application programming interface (API) provided by the system process using one or more parameters.

In some embodiments, example APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-executable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device (or computer system more generally), such as portable multifunction device 100 or device 300, that includes or is in communication with one or more display generation components and (optionally) one or more input devices, (optionally) a touch-sensitive surface, (optionally) one or more tactile output generators for generating tactile outputs, and (optionally) one or more sensors to detect intensities of contacts with the touch-sensitive surface.

FIGS. 5A-5AP and 6A-6AC illustrate example user interfaces for displaying a wake screen and for displaying live activity status information, including in a wake screen, in accordance with some embodiments. The user interfaces in these figures are used to illustrate the processes described below, including the processes in FIGS. 7, 8, 9, and 10. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector, and/or in response to detecting other types of inputs performed using an input device (e.g., a hardware button, a controller, a mouse, a trackpad, or another control device) while a location or object is targeted, such as via a focus selector (e.g., a pointer, or a cursor, or a gaze) being on the location or object, and/or an air gesture performed using an input element such as hand(s) or finger(s) (e.g., a hand waving, a hand flipping, two hands moving toward each other, two fingers pinching, and/or one finger tapping) posed, changing pose, and/or moving in physical space while a location or object is targeted, such as when the location of the hand(s) and/or finger(s) are on or near the object or the location or while a focus selector is on the location or object.

FIG. 5A illustrates a wake screen user interface 502 displayed by device 100 in accordance with some embodiments. In some embodiments, the wake screen user interface 502 includes a date indication 504, a time indication 506-1 and optionally one or more notifications, including notification 510. In some embodiments, the wake screen user interface includes a wallpaper, such as a photo, image, pattern, or other media content. In some embodiments, a wallpaper of the wake screen user interface 502 includes a foreground portion and a background portion of the wallpaper, where the time indication 506-1 is displayed in a layer that appears to be in front of the background portion of the wallpaper (e.g., the time indication 506-1 at least partially occludes the tree in the background portion of the wallpaper in FIG. 5A) and that appears to be behind the foreground portion of the wallpaper (e.g., the time indication 506-1 is at least partially occluded by the face in the foreground portion of the wallpaper).

In some embodiments, the time indication 506-1 is displayed as being made of a simulated glass material (e.g., with a first level of translucency and/or transparency), whereby the simulated glass material is displayed as having a non-zero thickness (e.g., indicated by edges that are at least partially visible and that interact with (e.g., refract and/or reflect) other content that is displayed behind and/or near the time indication 506-1. In some embodiments, content that appears underneath the simulated glass material is at least partially visible in a distorted manner (e.g., content in the background layer appears to be blurred, refracted, reflected, magnified, or otherwise visually altered as though viewing the content through a glass material).

In some embodiments, the time indication 506-1 is displayed with a first size that is optionally selected by the user (e.g., via an editing user interface, described with reference to FIG. 5Y) and/or that is selected automatically by the device 100 without requiring user input. For example, the device 100 automatically selects the first size of the time indication 506-1 based at least in part on the selected wallpaper (e.g., the size of the time indication 506-1 is selected based on the content in the selected wallpaper so as to complement and/or prevent occlusion of respective portions of the wallpaper). For example, a size of the time indication 506-1 is selected such that the face (e.g., or other detected content) included in the foreground of the wallpaper partially occludes less than a threshold amount of the time indication 506-1.

In some embodiments, the device 100 detects a user input 508-1 such as a tap user input, a swipe user input, or another selection input, directed to the notification 510. In some embodiments, in response to detecting movement of the user input 508-1 (e.g., continued as user input 508-2, FIG. 5B) corresponding to a swipe gesture, the device 100 displays a stack of notifications, such as by displaying additional notification 512 while moving a position of the notification 510 upwards in the wake screen user interface 502. In some embodiments, in response to detecting the user input 508-2, or in response to detecting another event, such as arrival of a notification, arrival of a system alert, activation of a live activity, or another event, the device 100 moves the foreground of the wallpaper (e.g., the face) upward so as to prevent occlusion of the foreground of the wallpaper as the stack of notifications takes up additional space, optionally without changing a size and/or position of the time indication 506-1. For example, the user is enabled to scroll through the stack of notifications (e.g., and scroll to display additional notifications) by continuing to swipe upward on the stack of notifications. For example, as illustrated in FIG. 5C, in response to detecting user input 508-3 (e.g., a scroll input that is distinct from the user input 508-2 or that is a continuation of the user input 508-2), the device displays an additional notification 514.

In some embodiments, as additional notifications are displayed in the stack of notifications, the device 100 automatically changes a size of the time indication 506-1 to the time indication 506-2. In some embodiments, changing the size of the time indication 506-1 includes changing an aspect ratio of the time indication 506-1 (e.g., shrinking a height of the time indication 506-1 to the height illustrated by time indication 506-2 without changing a width or font weight of the time indication 506-1). In some embodiments, the position of the time indication 506-2 is also shifted upwards in the wake screen user interface 502 as the stack of notifications increases in size.

In some embodiments, as illustrated in FIG. 5D, in response to detecting the user input 508-4 (e.g., a continuation of the user input 508-3 or a separate user input), the device 100 continues to shrink the time indication 506-2 to the time indication 506-3 while also shifting the time indication 506-3 upward in the wake screen user interface (e.g., until the time indication is shifted off of the wake screen user interface completely, as illustrated in FIG. 5E). In some embodiments, the time indication 506-3 changes in width without changing in height relative to the time indication 506-2. In some embodiments, the time indication changes in height without changing in width and/or font weight relative to the time indication 506-2. For example, in FIG. 5D, the stack of notifications increases in size to display additional notification 516 in response to detecting a scroll user input 508-4.

In some embodiments, in response to detecting an end of the scroll user input 508-4, the device 100 displays a rubberbanding visual effect that causes the wake screen user interface to shift downwards from its position at the time the scroll user input ends (e.g., upon liftoff of the scroll user input, the wake screen user interface appears to snap back down by a small amount while continuing to display the expanded stack of notifications).

FIG. 5F illustrates an example of the wake screen user interface 502 that is displayed in accordance with a determination that a live activity 518 is ongoing. For example, a live activity 518 corresponds to an active session associated with an application (e.g., a food delivery application in FIG. 5F) executing on the device 100. In some embodiments, while the active session is ongoing, a live activity 518 user interface element is automatically, without requiring user input, displayed on the wake screen user interface 502 that is updated with status updates via the associated application. In some embodiments, the time indication 506-4 is automatically resized (e.g., from its standard size illustrated by time indication 506-1) in the wake screen user interface 502 such that the time indication 506-4 is at least partially visible while also displaying notifications and/or live activities. For example, while displaying the wake screen user interface 502 illustrated in FIG. 5A, in response to detecting that a live activity has started, the live activity 518 user interface element is displayed, optionally while displaying one or more notifications 510, 512, 514 and/or 516, in the wake screen user interface 502, including optionally updating a size and/or position of the time indication 506-4 in order to make space for displaying the live activity 518.

FIG. 5G illustrates another example of the wake screen user interface 502 that includes the live activity 518 and the live activity 520 (e.g., corresponding to an active sports session associated with a sports application) while concurrently displaying notification 510 and notification 512. In some embodiments, the live activity 518 and/or the live activity 520 are displayed in the wake screen user interface automatically, without requiring user input, while the active session associated with the respective live activity is ongoing, and the device 100 automatically ceases to display the respective live activity in accordance with a determination that the session is no longer active (e.g., the food delivery is complete and/or the sports game has ended).

FIG. 5H illustrates an example of the wake screen user interface 502 that displays the live activity 518 and the live activity 520 without displaying one or more notifications. In some embodiments, the time indication 506-6 is automatically resized (e.g., from the time indication 506-1 in FIG. 5A) in accordance with one or more live activities that are displayed in the wake screen user interface. For example, the wake screen user interface in FIG. 5A is automatically updated to the wake screen user interface in FIG. 5H while the sessions for the live activity 518 and the live activity 520 are ongoing.

FIG. 5I illustrates an example of updating the wake screen user interface 502 to an incoming call user interface 522 in response to detecting an incoming communication at the device 100. In some embodiments, the time indication 506-7 is optionally displayed with a smaller width and height (e.g., relative to the time indication 506-1) so as to create space in the user interface 522 to display other information, such as a contact photo, avatar and/or name, about the incoming call and/or one or more controls (e.g., for accepting or rejecting the call).

FIG. 5J illustrates detecting a user input 526 (e.g., a tap user input or other selection input) corresponding to a request to change the wallpaper of the wake screen user interface 502. In some embodiments, the wallpaper of the wake screen user interface is selected as a slideshow of images (e.g., the wallpaper image changes over time to display different images included in the slideshow). In some embodiments, in response to detecting the user input 526, the device 100 replaces the wallpaper image that includes and the face with a wallpaper image that includes a palm tree island in the ocean (e.g., as illustrated in FIG. 5L).

In some embodiments, the device 100 detects a user input 524 corresponding to a request to lock and/or dim the screen (e.g., to put the device 100 in a standby mode). In some embodiments, after the device 100 has been put in the standby mode, in response to an event that causes the device 100 to wake from the standby mode, the wallpaper of the wake screen user interface 502 is updated to another wallpaper image (e.g., the palm tree island in the ocean).

In some embodiments, in response to detecting the user input 526 (e.g., and/or in response to detecting user input 524 followed by a wake event of the device 100 and/or in response to detecting a time threshold has elapsed that causes the wallpaper to update), the device 100 displays an animated transition, as illustrated in FIG. 5K, that includes crossfading the images of the wallpaper (e.g., to replace the image of the face with the image of the palm tree island in the ocean). In some embodiments, the animated transition further includes stretching (e.g., as indicated by the downward arrows) the time indication 506-8 gradually over time to change the size of the time indication 506-8 (e.g., to increase the size of the time indication) to the size illustrated by the time indication 506-9 (FIG. 5L). For example, the time indication 506-9 has a different standard size (e.g., assigned for the palm tree island wallpaper) than the standard size of time indication 506-1 (e.g., assigned for the face wallpaper). In some embodiments, the standard size of the time indication 506-9 is selected based on a position of a horizon line in the content of the wallpaper (e.g., the time indication 506-9 has a size that extends to the horizon line of the ocean in FIG. 5M).

FIG. 5M illustrates detecting a user input 530-1, such as a swipe input or other user input requesting to dismiss the wake screen user interface 502, and in response to detecting the user input 530-1, the device 100 slides the wallpaper upwards (e.g., in the direction of the swipe input) while decreasing a size (e.g., an aspect ratio that includes changing a height without changing a width) of the time indication 506-9, illustrated with a smaller size as time indication 506-10, as illustrated in FIG. 5N. In some embodiments, in response to detecting a continuation of the user input 530-1 (e.g., as user input 530-2 and user input 530-3), the device 100 continues to slide the wallpaper upwards (e.g., by a greater amount, optionally in accordance with a distance, velocity and/or acceleration of the detected user input 530-2) while further decreasing the size of the time indication 506-10 (e.g., time indication 506-11 is smaller in height than time indication 506-10), as illustrated in FIG. 5O. In some embodiments, one or more application icons (e.g., application icon 440, application icon 442, application icon 444 and application icon 446) that are included in a home screen user interface 532 are displayed as animating onto the display as the wake screen user interface 502 is dismissed.

In some embodiments, the time indication 506-9 is displayed with a set of simulated optical properties, including simulated refraction, simulated reflection, simulated thickness, and/or simulated blurring, to appear as a simulated glass material (e.g., as described above with reference to time indication 506-1 in FIG. 5A). In some embodiments, the simulated optical properties include distorting portions of the background image that are visible through the simulated glassy material of the time indication 506-9. For example, in FIG. 5M, the cloud that appears behind a portion of the time indication 506-9 is distorted according to the set of simulated optical properties within the numerals of the time indication.

FIG. 5P illustrates displaying home screen user interface 532 in response to dismissing the wake screen user interface 502. In some embodiments, while displaying the home screen user interface 532 (e.g., and/or an application user interface for an application executing on device 100), the device 100 detects a user input 534, such as a swipe user input, corresponding to a request to view a coversheet user interface (e.g., the coversheet user interface having the same properties of the wake screen user interface, including displaying the time indication 506-9). For example, FIG. 5Q illustrates redisplaying the wake screen user interface 502 (e.g., also referred to herein as a coversheet user interface) in response to the user input 534.

FIG. 5Q further illustrates the device 100 detecting that a notification 538 has occurred and/or has been received. In some embodiments, in response to detecting that an event corresponding to a new notification 538 has occurred, the device 100 displays notification 538 in the wake screen user interface 502. In some embodiments, in conjunction with displaying notification 538, the device 100 updates the wake screen user interface 502 to change a size of one or more portions of the background image, such as by moving and/or resizing the image of the palm tree and/or ocean displayed in FIG. 5Q. For example, the background image is modified so as to not obstruct the palm tree with the display of the notification 538. In some embodiments, the device 100 changes the size of the time indication 506-9 (e.g., in FIG. 5M) to the size of time indication 506-9′ based on the change to the background image (e.g., the time indication 506-9′ is decreased in height, thereby changing an aspect ratio of the time indication 506-9′ relative to time indication 506-9), for example, to maintain the position of the bottom of the time indication 506-9′ relative to the horizon line of the ocean.

In some embodiments, the device 100 detects a user input 536 directed to a button for putting the device 100 into the standby mode. In some embodiments, the device 100 automatically, without user input, enters the standby mode in accordance with a determination that a threshold amount of time has passed without activity of the device 100 (e.g., without detecting user interaction, providing notifications, or performing other activities). In some embodiments, in response to detecting the user input 536, the device 100 displays a gradual animation to dim, fade, or otherwise visually obscure the wallpaper of the wake screen user interface 502, including the notification 538, as illustrated in FIG. 5R. In some embodiments, the animation of the wallpaper of the wake screen user interface includes displaying a simulated camera transition that changes a perceived depth of the content (e.g., in the image) of the wallpaper (e.g., to appear as if moving farther away from the viewpoint of the user). In some embodiments, the animation includes gradually decreasing a size of the time indication 506-9 (e.g., to the time indication 506-12). In some embodiments, a simulated thickness of the simulated glass material of the time indication 506-9 gradually decreases as the size of the time indication decreases (e.g., optionally shrinking in height without changing a width of the time indication).

FIG. 5S illustrates that, while in the standby mode, the device 100 displays (e.g., via an always-on display) a time indication 506-13 and optionally displays one or more notifications, such as notification 538, in a dimmed state. In some embodiments, while in the standby mode, the device 100 optionally ceases to display the wallpaper of the device 100. In some embodiments, the device 100 detects a user input 540 corresponding to a request to wake the device 100 (e.g., to cause the device 100 to exit the standby mode). In some embodiments, in response to detecting the user input 540, the device 100 exits the standby mode and displays the wake screen user interface 502, as illustrated in FIG. 5T.

FIGS. 5T-5V illustrate the device 100 transitioning from a portrait orientation to a landscape orientation. For example, in response to detecting (e.g., using one or more accelerometers 168 and/or gyroscopes) a change in a physical position (e.g., a change in orientation relative to gravity) of the device 100 that changes the orientation of the device 100, the device 100 displays an animated transition for rotating the wake screen user interface 902. In some embodiments, the animated transition includes maintaining the time indication 506-14 at a position that aligns to the horizon of the content displayed in the wallpaper of the wake screen user interface 902.

FIG. 5V illustrates that the time indication 506-15 is displayed with a different size than the time indication 506-9 (e.g., smaller in height and optionally in width) while the device 100 is in the landscape orientation. In some embodiments, the position of the time indication 506-15 is maintained relative to the horizon of the content (e.g., and/or relative to a subject, a portion of a landscape, or another portion of the content) displayed in the wallpaper. For example, the bottom of time indication 506-15 is displayed above the horizon line in FIG. 5V, and the bottom of time indication 506-9 is displayed at a same relative position to the horizon line in FIG. 5T.

FIG. 5W illustrates a wake screen user interface 502 displayed with a star wallpaper. In some embodiments, the wake screen user interface 502 includes one or more widgets 544 (e.g., including health rings widget 544-1, weather widget 544-2 and air quality index (AQI) widget 544-3). In some embodiments, a camera widget 544-4 and/or a flashlight widget 544-5 are displayed as quick access controls in the wake screen user interface 502. In some embodiments, in response to detecting a user input 546 (e.g., a long press input that is maintained for at least a threshold amount of time), the device 100 displays a face switching user interface 548 for selecting a different face (e.g., a selectable portion of a representation of face 552 is displayed) for the wake screen user interface 502 (e.g., where each face includes one or more of a different wallpaper, a different time indication, a different date indication, and/or different widgets). In some embodiments, the face switching user interface 548 includes an option 554 to create a new face (e.g., by selecting a wallpaper, a time indication, a date indication, and/or widgets to include in the new face), and an option 558 to customize the currently selected representation 550 of the current face displayed by the wake screen user interface 502. In some embodiments, the device 100 detects a user input 556, such as a tap user input or other selection user input.

In response to detecting the user input 556, the device 100 displays editing user interface 560, as illustrated in FIG. 5Y. In some embodiments, editing user interface 560 includes one or more selectable regions for modifying various portions of the wake screen user interface. For example, the editing user interface 560 includes reticle 564 around the date and reticle 566 around the time to indicate the date and time are editable (e.g., in text font and/or the type of information displayed). In some embodiments, reticle 562-1 and reticle 562-2 indicates widget regions that are customizable (e.g., the computer system detects and responds to a user input directed to reticle 562-1 and/or reticle 562-2 that corresponds to a request to initiate a process to add, remove, and edit the widgets displayed on wake screen user interface 502). In some embodiments, reticle 562-1 is displayed at a position below the time indication and reticle 562-2 is displayed along a bottom edge of the editing user interface 530. In some embodiments, the position of the reticle 562-1 is optionally changed (e.g., as described below with reference to FIG. 5AD). For example, reticle 562-1 includes four placeholders to which widgets may be added, where widget 544-1′, widget 544-2′, and widget 544-3′ occupy three of the four placeholders in reticle 562-1 in FIG. 5Y; reticle 562-2 includes four placeholders to which widgets may be added, where a flashlight widget and a camera widget are illustrated as occupying two of the four placeholders in reticle 562-2 in FIG. 5Y.

In some embodiments, in response to detecting a user input 568 directed to the time indication (e.g., directed to or within reticle 566), in accordance with a determination that the user input is a swipe user input in a first direction, the device 100 updates a size of the time indication in accordance with the detected movement of the swipe user input. For example, in response to the user input 568 directed to a bottom portion of the time indication followed by an upward movement, the device 100 decreases a height of the time indication. In some embodiments, changing a size of the time indication in the editing user interface 560 causes content of the wallpaper to be displayed differently relative to the time indication. For example, while the time indication is being resized via a drag user input, the time indication is displayed behind a foreground portion of the wallpaper image. In some embodiments, as illustrated in FIG. 5Z, in response to detecting a user input 572 directed to a right portion of the time indication followed by a rightward movement, the device 100 increases a width of the time indication (e.g., as illustrated in FIG. 5AA). As such, the amount and/or direction of movement of a respective user input directed to the time indication causes the device 100 to resize the time indication in accordance with the amount and/or direction of movement of the respective user input. It will be understood that movement in other directions, such as diagonal movement (e.g., user input 5004, FIG. 5Z2) relative to the time indication, causes the device 100 to update the size of the time indication in both height and width (e.g., optionally in proportion to the x-component (e.g., corresponding to width) and y-component (e.g., corresponding to height) of the diagonal movement of the input). In some embodiments, a size of the date indication is independently controlled such that resizing the time indication does not cause the device 100 to resize the date indication.

FIG. 5Z further illustrates the device 100 detecting a user input 570, such as a tap input or other selection input, directed to the “remove” control displayed for widget 544-1′. In some embodiments, each widget in the reticles 562-1 and 562-2 is displayed with a respective remove control that, when selected, removes the widget from the widget region (e.g., the widget ceases to be displayed in a placeholder of the reticle 562-1 or reticle 562-2). For example, in response to detecting the user input 570, the widget 544-1′ ceases to be displayed and would no longer be included in the wake screen user interface 502. Similarly, in response to detecting the user input 574 directed to the “remove” control displayed for widget 544-4′, the device 100 would cease to display widget 544-4 in the wake screen user interface 502.

FIG. 5Z1 illustrates the device 100 detecting a user input 5002, such as a swipe input, a drag input, or another selection input directed to the reticle 566 for the time indication. In some embodiments, in response to detecting the user input 5002, the time indication increases in size in accordance with the magnitude and/or direction of the user input 5002. For example, in response to detecting a downward swipe, the size of the time indication increases in height, optionally without increasing a width, by an amount proportional to the amount of movement of the downward swipe. In some embodiments, in accordance with a determination that a size of the time indication has increased such that the time indication overlaps the reticle 562-1, the reticle 562-1 is automatically moved to a position proximate to the reticle 562-2, as illustrated in FIG. 5Z2 (e.g., as described below with reference to FIG. 5AD). As such, in some embodiments, in response to increasing a size of the time indication to a threshold size, the widget area illustrated in reticle 562-1 is updated to a different position in the user interface 560 (e.g., such that the time indication does not overlap with the reticle 562-1).

FIG. 5Z2 illustrates the device 100 detecting user input 5004, such as a swipe or drag input in a diagonal direction, directed to a corner of the reticle for the time indication. In some embodiments, in response to detecting the user input 5004, the time indication increases in size, including increasing in height and width, in accordance with the diagonal swipe input. In some embodiments, the amount of increase in height and/or width (e.g., font weight) is proportional to the amount of movement (e.g., distance between an initiation of the user input 5004 until an end of the user input, such as liftoff or ceasing to move the user input) of the user input 5004, as illustrated in FIG. 5Z3. For example, a magnitude of the y-component of the diagonal direction of user input 5004 causes the height of the time indication to change by a proportional amount and a magnitude of the x-component of the diagonal direction of user input 5004 causes a width and/or font weight of the time indication to change by a proportional amount. In some embodiments, one or more portions of the background are displayed in front of the time indication. For example, as the time indication is resized such that it overlaps with the star in the wallpaper, at least a portion of the star partially occludes a portion of the time indication. In some embodiments, one or more other portions of the wallpaper are displayed behind the time indication (e.g., in FIG. 5T, a cloud is displayed behind the time indication 506-9 while the palm tree is displayed in front of the time indication 506-9).

FIG. 5Z3 illustrates detecting a user input 5006 corresponding to a request to move the reticle that includes the time indication to a position next to the reticle that includes the date indication. For example, in response to detecting the user input 5006, the time indication reticle 566′ is displayed inline with the reticle 564 that includes the date indication, as illustrated in FIG. 5Z4. In some embodiments, to make space for the time indication, the date indication displayed in reticle 564 is updated, for example by abbreviating the date indication, to reduce a size of the date indication. In some embodiments, a selectable option is displayed in the user interface 560 for displaying the time indication with a fixed size (e.g., the fixed size illustrated in FIG. 5Z4). For example, in response to detecting a user input directed to the selectable option, the time indication is automatically updated in size and/or position to the fixed size illustrated in FIG. 5Z4.

In some embodiments, alternative to the user inputs illustrated in FIGS. 5Z1-5Z3, the user interface illustrated in FIG. 5AA follows from FIG. 5Z (e.g., where the reticle 562-1 is still displayed immediately below the time indication). FIG. 5AA illustrates detecting a user input 578 corresponding to a request to move AQI (air quality index) widget 544-3′ from a position in a placeholder of reticle 562-1 to a placeholder of reticle 562-2. In some embodiments, in response to detecting the user input 578, the device 100 moves the AQI widget 544-3′ into the reticle 562-2, as illustrated in FIG. 5AB. In some embodiments, the device 100 detects a user input 576 corresponding to a request to add a widget to the widget area corresponding to reticle 562-2, and in response to detecting the user input 576, the device 100 displays a platter that includes a plurality of selectable widgets, as illustrated in FIG. 5AB. In some embodiments, the user selects, via a user input 580 (e.g., a tap user input, a drag user input that drags the widget to the desired position, or another selection user input) a respective widget 544-6′ from the platter, and in response to detecting the user input 580, the device 100 adds the widget 544-6′ to the reticle 562-2 corresponding to the widget region. In some embodiments, the platter that includes the plurality of selectable widgets includes one or more quick access controls, such as a quick access flashlight control and/or a quick access camera control. In some embodiments, the quick access flashlight control, when selected, toggles a flashlight of the device 100 on and/or off; and the quick access camera control, when selected, initiates a camera operation. In some embodiments, the quick access controls enable a user to access one or more functions of the device 100 without requiring authentication by the user (e.g., while the device 100 is in a locked state).

FIG. 5AB1 illustrates detecting a user input 5010 directed to a photos option 5008 for changing a background photo of the wallpaper. In some embodiments, in response to detecting the user input 5010, the device 100 displays a platter 5014 that includes a plurality of selectable photos, such as photo 5018a, photo 5018b, and photo 5018c, to be used as a wallpaper for the wake screen user interface, as illustrated in FIG. 5AB2.

In some embodiments, in response to detecting the user input 5016, such as a tap input or other selection user input, directed to the photo 5018a, the device updates the wallpaper for the wake screen user interface to the photo 5018a, as illustrated in FIG. 5AB3. In some embodiments, in response to updating the wallpaper for the wake screen user interface, one or more visual properties of the time indication and/or one or more other controls (e.g., the cancel button, the done button and/or other controls) are automatically updated without additional user input, as indicated by the pattern of the time indication illustrated in FIG. 5AB3. For example, a color of the time indication, cancel button, and/or done button is automatically selected based on one or more colors of the wallpaper for the wake screen user interface (e.g., the color of the time indication is updated to a color sampled from the photo 5018a or to a color that contrasts with the photo 5018a). In some embodiments, the reticle 562-1 remains at its position below the time indication in reticle 566 in accordance with a determination that the subject of photo 5018a is not overlapping with the reticle 562-1. For example, as the photo 5018a is resized, so long as the subject of the photo 5018a does not overlap with the reticle 562-1, the reticle 562-1 remains at its position. In some embodiments, as described with reference to FIG. 5AB4 below, if the photo 5018a is cropped and/or resized such that the subject of the photo 5018a overlaps with reticle 562-1 and/or the time indication in reticle 566, the reticle 562-1 is automatically moved in position so as to avoid occluding the subject of the photo 5018a.

In some embodiments, as illustrated FIG. 5AB3, a user input 5020, such as a pinch input, a drag input, or other type of user input, corresponding to a request to change a size and/or crop the photo 5018a used as the wallpaper is detected. In some embodiments, a pinch input that includes two or more contacts that move away for each other causes the device 100 to increase a size of the photo 5018a and a pinch input that includes two or more contacts that move closer together causes the device 100 to decrease a size of the photo 5018a in accordance with a magnitude of the change between the two or more contacts.

FIG. 5AB4 illustrates that, in response to detecting that the photo 5018a has increased in size such that a subject of the photo 5018a (e.g., face 5022) overlaps with the time indication in reticle 566, the reticle 562-1 is automatically moved from a position below the time indication (e.g., FIG. 5AB3) to a position immediately above the reticle 562-2 (e.g., FIG. 5AB4).

In some embodiments, alternative to the user inputs illustrated in FIGS. 5AB1-5AB4, the user interface illustrated in FIG. 5AC follows from the user interface illustrated in FIG. 5AB. FIG. 5AC illustrates detecting a user input 582 (e.g., a drag user input or other movement of a selection user input) corresponding to a request to move the widget 544-2′ from the reticle 562-1 to the reticle 562-2. In some embodiments, the reticle 562-2 does not have any placeholder positions available for the widget 544-2′ to be moved into the reticle 562-2 (e.g., all four placeholders in reticle 562-2 are filled with other widgets). In some embodiments, in response to detecting the user input 582, and in accordance with a determination that the reticle 562-2 does not have available space for the widget 544-2′, the device repositions the reticle 562-1, including the widget 544-1′ and widget 544-2′, in the editing user interface 560 to be positioned above the reticle 562-2 (e.g., to generate a combined placement region that includes reticle 562-1 and reticle 562-2), as illustrated in FIG. 5AD. As such, the widget area is moved from its position immediately below the time indication to a position immediately above the reticle 562-2. In some embodiments, in response to a user input, such as a drag user input, directed to reticle 562-1, the reticle 562-1 moves in accordance with the drag user input (e.g., a drag user input in the upward direction causes the device 100 to reposition the reticle 562-1 upward, back to its position immediately below the time indication). As such, the user is enabled to reposition the reticle 562-1 (e.g., and/or reticle 562-2). In some embodiments, the respective widgets are displayed in the wake screen user interface 502 at corresponding positions to the widgets displayed in the editing user interface (e.g., after the reticle 562-1 is moved in the editing user interface 560, the widget 544-1 and the widget 544-2 are displayed in a region immediately above the region that includes the widgets 544-5, 544-3, and 544-4 in the wake screen user interface 502.

In some embodiments, repositioning the reticle 562-1 includes, while detecting the user input 582, moving the widget 544-2′ without moving the reticle 562-1, as illustrated in FIG. 5AC1. In some embodiments, in accordance with a determination that the widget 544-2′ has been moved (e.g., via user input 582″) at least a threshold distance away from the initial position of the reticle 562-1 (or has otherwise moved beyond a first position of the user interface 560), the device 100 begins to display the reticle 562-1 as moving in a direction that follows the user input 582″, as illustrated in FIG. 5AC2. In some embodiments, the rate of movement of the reticle 562-1 is different than the rate of movement of the widget 544-2′, for example, the reticle 562-1 is moved faster in order to appear to catch up with the widget 544-2′ as the widget 544-2′ is moved downward in the user interface 560. In some embodiments, in accordance with a determination that the widget 544-2′ and/or the reticle 562-1 has moved within a threshold distance of the reticle 562-2, the reticle 562-1 is snapped into a predefined position (e.g., that corresponds to the region immediately above the region that includes the widgets 544-5, 544-3, and 544-4), as illustrated in FIG. 5AD. In some embodiments, reticle 562-1 is snapped into the predefined position before the user input 582′ reaches the predefined position.

FIGS. 5AD1-5AD6 illustrate a sequence of user interfaces of device 100 for modifying one or more visual properties of the time indication illustrated in reticle 566. In some embodiments, the time indication in reticle 566 is displayed with a simulated glass material with a first set of visual properties, such as a first level of opacity and/or frostiness, a first level of simulated refraction, a first level of simulated reflection, a first level of blur, a first set of one or more rules for remapping a range of luminance values of background content to a different range of luminance values, and/or other distortion that is applied to underlying content that overlaps with the time indication (e.g., a portion of the cloud that overlaps with the time indication is distorted by a first amount in accordance with the first set of visual properties of the time indication in FIG. 5AD1). In some embodiments, in response to detecting a user input 5500, such as a tap input or other selection input, directed within reticle 566, an editing platter 5502 is displayed for modifying the time indication displayed in the reticle 566, as illustrated in FIG. 5AD2. In some embodiments, the editing platter 5502 includes a plurality of font options (e.g., the number “12” presented in different fonts) and/or a plurality of color options 5506. In some embodiments, in response to detecting a user input 5504, such as a tap input or other selection input, directed to a respective font option, the font of the time indication in reticle 566 is updated to be displayed with the selected respective font option. In some embodiments, the editing platter 5502 includes a slider 5510 for modifying a level of the optical effect (e.g., a level of visual properties of the simulated glass material). In some embodiments, the editing platter 5502 includes a toggle option 5512 for displaying the time indication with the simulated glass material (e.g., “Glass”) or without the simulated glass material (e.g., “Solid”). In some embodiments, changing the font of the time indication changes the effect of the simulated glass material parameters (e.g., changing a location and/or intensity of reflection, refraction, blur, and/or specular highlights).

In some embodiments, in response to detecting a user input 5508, such as a swipe user input, a drag user input, a tap user input, or another user input, directed to the slider 5510, the device 100 updates the level of optical effect (e.g., by changing values of one or more visual properties of the simulated glass material) of the time indication in the reticle 566. For example, as illustrated in FIG. 5AD3, in response to detecting the user input 5508 that includes movement to the left (e.g., corresponding to a request to decrease a degree to which the simulated glass material obscures the underlying content), the time indication is displayed with a smaller level of blur, a smaller level of frostiness, remapping a range of luminance values of background content from a first range of luminance values to a second range of luminance values that is smaller than the first range of luminance values, and/or a higher level of the degree of simulated refraction. In some embodiments, the simulated thickness of the simulated glass material is optionally updated based on the selected level of optical effect (e.g., an increased simulated thickness for an increased level of optical effect and vice-versa).

In some embodiments, in response to detecting a user input 5514 directed to the slider 5510, such as a swipe input, a drag input, a tap input, or another input, corresponding to a request to increase the degree to which the simulated glass material obscures the underlying content with which the time indication is displayed, the device 100 updates display of the time indication to be displayed with the level of optical effect specified by the currently selected value of the slider 5510. For example, as illustrated in FIG. 5AD4, in response to detecting the user input 5514, the time indication displays a greater amount of distortion (e.g., of the underlying content), for example by decreasing a level of simulated refraction, increasing a level of blur, remapping a range of luminance values of background content to a third range of luminance values that is larger than the second range of luminance values and smaller than the first range of luminance values, and/or increasing a level of frostiness of the simulated glass material of the time indication.

In some embodiments, in response to detecting a user input 5516, such as a tap input or other selection input, directed to a respective color option of the plurality of color options 5506, the device 100 displays the time indication with a tint that is based on the selected respective color option, as illustrated in FIG. 5AD5. In some embodiments, in response to detecting a user input 5518, such as a tap input, a swipe input, a drag input or other selection input directed to the toggle 5512, corresponding to a request to switch from “Glass” to “Solid,” the device 100 ceases to display the time indication with the simulated glass material and displays the time indication as two-dimensional text (e.g., without the simulated glass material that is simulated to have a non-zero thickness), as illustrated in FIG. 5AD6.

FIGS. 5AE-5AL illustrate a sequence of user interfaces of device 100 displaying a media player user interface element 610 that includes one or more controls (e.g., skip to previous, pause/play (e.g., pause control 6009), skip to next (e.g., skip control 6018), and/or one or more other controls) for controlling playback of a currently playing media item (e.g., “Song A”) in the wake screen user interface 502. In some embodiments, the one or more controls and/or the media player user interface element 610 are displayed with a user interface material that appears glassy (e.g., a glassy material as described with reference to time indication 506-1 in FIG. 5A). For example, the one or more controls appear with a simulated glass material that is layered on top of the simulated glass material of the media player user interface element 610. In some embodiments, in response to detecting a user input 6008 directed to a respective control, such as the pause control, the device 100 performs an operation associated with the respective control. For example, in response to detecting the user input 6008, the device 100 pauses playback of Song A. In some embodiments, the media player user interface element 610 includes a representation 606 of cover art related to the currently playing media item, as illustrated in FIG. 5AE. In some embodiments, the wake screen user interface 502 includes date indication 604-1 and time indication 602-1 (e.g., as described with reference to FIG. 5A, where the wake screen user interface includes date indication 504 and time indication 506-1). In some embodiments, the wallpaper of the wake screen user interface 502 includes a star. In some embodiments, in response to detecting a user input 6010, such as a press and hold input, a tap input, or another type of input, the device 100 displays a wake screen selection and/or customization user interface that enables the user to add a new wake screen user interface (e.g., with a different wallpaper, different widgets and/or different focus mode) and/or to enter an editing mode for the wake screen user interface.

In some embodiments, as illustrated in FIG. 5AE, the device 100 detects a user input 608 (e.g., a tap input, a long press, or other selection user input) directed to the representation 606 of the cover art (e.g., also referred to herein as album art) (e.g., and/or detects a user input directed to another portion of the media player user interface element 610). In some embodiments, in response to detecting the user input 608, the device 100 displays an updated wake screen user interface 502′ to replace the wallpaper with display of a representation of the currently playing media item (e.g., animated snowflakes falling over a grey background), as illustrated in FIG. 5AF (e.g., following FIG. 5AE in sequence). In some embodiments, the representation of the currently playing media item is an animated image and/or video. In some embodiments, the representation of the currently playing media item is displayed as extending to the edges of the display of device 100. For example, the animated image of snowflakes falling over a grey background extends to the edges of the display area of device 100. For example, the grey background of wake screen user interface 502′ is expanded (e.g., from the representation 606 of the cover art) to replace the entirety of the background of wake screen user interface 502. In some embodiments, the representation of the currently playing media item (e.g., an expanded version of the cover art) is displayed with a color scheme that matches a color scheme of the representation 606 of the cover art. For example, in FIG. 5AE, the representation 606 of the cover art includes a snowflake on a grey background, and in FIG. 5AF, the wallpaper is replaced with an animated image of snowflakes falling over a grey background. In some embodiments, expanding the representation of the currently playing media item (e.g., an expanded version of the cover art) includes automatically generating content with colors, text, images and/or other content based on the representation 606 of the cover art, and optionally reflecting, blurring or otherwise visually modifying the representation 606 of the cover art to generate the representation of the currently playing media item displayed in the wake screen user interface 502′. For example, if the representation 606 of the cover art included a colorful (e.g., variegated or otherwise non-uniform) background rather than a grey or solid background, the wallpaper background would include an expanded version of at least a portion of the colorful background of the representation of the cover art. In such circumstances, media player user interface element 610 would appear as if the colorful wallpaper background were viewed through the simulated glass material of media player user interface element 610, with colors of the colorful wallpaper background being refracted by and/or reflected via the simulated glass material of the media player user interface element 610 and/or the one or more controls appearing with the simulated glass material layered on top of the simulated glass material of the media player user interface element 610. In some embodiments, in response to the user input 608, the device 100 automatically resizes the time indication 602-1 by decreasing a height, width, and optionally a thickness (e.g., a thickness of a simulated glass material) of the time indication, as illustrated by time indication 602-2 in FIG. 5AF. In some embodiments, in response to the user input 608, the device 100 updates the date indication 602-1 to an abbreviated version of the date indication 604-2 and optionally displays the date indication 604-2 with a smaller font size than the date indication 604-1. As such, the device 100 resizes the date indication 604-1 and/or the time indication 602-1 while displaying the updated wake screen user interface 502′ so as to minimally occlude the representation of the currently playing media item that replaces display of the wallpaper.

In some embodiments, the time indication 602-2 is displayed with a set of optical properties that is different than the set of optical properties of time indication 602-1. For example, in some embodiments, the time indication 602-1 is displayed with a first level of simulated refraction, a first level of simulated reflection, a first level of simulated thickness and/or a first level of simulated blurring (e.g., with a first simulated glass material, as described with reference to time indication 506-1 (e.g., in FIG. 5A) and/or time indication 506-9 (e.g., in FIG. 5M), and the time indication 602-2 is displayed with a second level of simulated refraction, a second level of simulated reflection, a second level of simulated thickness and/or a second level of simulated blurring, where, for at least one of the visual properties, the first level of the visual property is different than the second level of the visual property (e.g., a first level of simulated refraction is different than the second level of simulated refraction, a first level of simulated reflection is different from the second level of simulated reflection, the first level of simulated thickness is different from the second level of simulated thickness and/or the second level of simulated blurring is different from the first level of simulated blurring). As such, the simulated glass material for the time indication 602-1 is different from the simulated glass material for the time indication 602-2. For example, in FIG. 5AF, the time indication 602-2 appears flatter (e.g., with a decreased simulated thickness) relative to the time indication 602-1 (e.g., in FIG. 5AE).

In some embodiments, the media player user interface element 610 is displayed with a simulated lighting effect (e.g., specular highlights 6012, 6012′ and 6012″). In some embodiments, edges of the simulated media player user interface element 610 (e.g., and/or other user interface objects that are displayed with a simulated glass material) are displayed with a visual effect of specular highlight(s) simulating light from other content displayed in the user interface reflecting from the edges. In some embodiments, the specular highlight(s) are based on one or more simulated light sources and/or one or more physical light sources in a physical environment surrounding the device 100. In some embodiments, the device 100 changes the simulated lighting effect by changing position, orientation, size, brightness, and/or other visual property of the simulated lighting effect. In some embodiments, the specular highlights 6012 are updated based on a change in content of the background, for example, the animated snowflakes correspond to simulated light sources such that a change in position of the animated snowflakes (e.g., where each snowflake corresponds to a simulated light source) causes the simulated lighting effect to change (e.g., to move in position as the position of the snowflake(s) change relative to the media player user interface element 610). For example, in FIG. 5AF1, following FIG. 5AE, specular highlights 6012′ are updated to be based on the falling musical notes (e.g., instead of the snowflakes that affect specular highlights 6012). In some embodiments, as illustrated in FIG. 5AF2, following in sequence from FIG. 5AF1, the musical notes traveling downward in the user interface cause the specular highlights 6012′ to change size, position, orientation, and/or brightness, as illustrated by specular highlights 6012″. As such, the simulated lighting effect is updated based on a change in the content surrounding and/or behind the media player user interface element 610.

FIGS. 5AF1-5AF2 illustrate an updated wake screen user interface 502″ that is displayed in accordance with a determination that the song has changed, for example, from playback of Song A to playback of Song B, following in sequence from FIG. 5AE. In some embodiments, the song is changed in response to detecting a user input, such as a user input selecting a skip forward and/or a skip backward control in the media player user interface element 610, or in response to detecting a voice command requesting Song B. In some embodiments, the song is changed automatically in accordance with a determination that Song A has ended. In some embodiments, in accordance with a determination that the song has changed, the device 100 ceases display of the representation corresponding to Song A (e.g., the animated snowflakes over a grey background) and displays a representation corresponding to Song B, optionally based on cover art associated with Song B. For example, as illustrated in FIGS. 5AF1-5AF2, the representation corresponding to Song B includes a rotating guitar (e.g., where the guitar optionally corresponds to a simulated light source) and musical notes (e.g., where one or more of the musical notes corresponds to a simulated light source) that appear to travel downward in the wake screen user interface 502″.

As illustrated in FIG. 5AF1, in some embodiments, the time indication 602-2′ that is displayed with a simulated glass material appears different than the time indication 602-2 illustrated in FIG. 5AF based on the background content (e.g., where the time indication 602-2 overlays the background content), including a color of the background content that appears to pass through the simulated glass material of the time indications 602-2 and 602-2′.

FIG. 5AF2 further illustrates the device 100 detecting a user input 6016, such as a tap input, a tap and hold input, or other selection input, directed to the skip control 6018. In some embodiments, in response to detecting the user input 6016, the device 100 performs the operation associated with the skip control 6018 by causing playback of a next song. In some embodiments, in response to detecting the user input 6016, the simulated glass material of the skip control 6018 is updated, for example, to a decrease a thickness of the simulated glass material (e.g., to make the skip control 6018′ appear flatter) or otherwise change one or more optical properties of the skip control 6018′, optionally to indicate a selection state of the control (e.g., that the skip control 6018 has been selected). In some embodiments, selection of any of the one or more controls displayed in the media player user interface element 610 causes the device 100 to update one or more optical properties of the respective control (e.g., such that the selected control appears flatter or otherwise visually modified). In some embodiments, in response to detecting selection of the skip control 6018, one or more specular highlights 6012′″ are updated and/or added. In some embodiments, one or more controls in the media player user interface element 610 corresponds to one or more simulated light sources for generating the simulated lighting effect (e.g., specular highlights 6012, 6012′, 6012″, and/or 6012′″), and a change in state of the one or more controls (e.g., in response to a selection user input directed to a respective control) causes the simulated lighting effect that is based on the respective control to change. In some embodiments, the selection state of the respective control is maintained with the changed state while the user input 6016 continues to be detected, and automatically reverts to its initial state (e.g., skip control 6018′ is redisplayed as skip control 6018) in response to detecting that the user input 6016 has ended (e.g., upon liftoff of a contact of user input 6016) and/or in accordance with a determination that a threshold amount of time has passed (e.g., 10 milliseconds, 1 second, 5 seconds, or another amount of time).

FIGS. 5AG-5AI illustrate a sequence of user interfaces for moving the media player user interface element 610, for example, via a scrolling user input. In some embodiments, while displaying the wake screen user interface 502, the device 100 detects a user input 6002, such as a swipe input (e.g., an upward swipe), a drag input, a tap input, or another user input, as illustrated in FIG. 5AG (e.g., following in sequence from FIG. 5AE). In some embodiments, the user input 6002 is an input corresponding to a request to move the media player user interface object 610 and/or corresponds to a request to display one or more notifications (e.g., below the media player user interface object 610). For example, in response to detecting an upward swipe that is initiated at a position within the user interface 502 (e.g., that optionally does not start at an edge of the user interface 502), the device 100 displays one or more notifications 6004 (e.g., including notification 6004-1 and notification 6004-2). In some embodiments, the user input 6002 is continued as user input 6002′ (FIG. 5AH), such as a continuation of the swipe input, and in response to the user input 6002′, the device 100 displays additional notifications (e.g., by scrolling upward through the notifications).

In some embodiments, one or more live activity sessions, such as live activity 6006, are displayed at a bottom of the user interface 502. In some embodiments, a respective live activity session includes information that is updated by a respective application executing at device 100. For example, a respective live activity session displays real-time updates while the live activity is ongoing. Examples of live activity sessions include sports games, delivery updates, rideshare information, workout progress, and other activities that provide details about an ongoing activity. In some embodiments, the one or more live activity sessions are displayed at a position near the bottom of the wake screen 502 (e.g., below the media player user interface element 610 and/or below notifications 6004). For example, FIG. 5AI illustrates live activity 6006 corresponding to an ongoing sports game that includes score and timing information that is updated while the sports game is ongoing.

In some embodiments, as illustrated in FIG. 5AH, following FIG. 5AG, as the notification 6004-1 and notification 6004-2 are displayed as being scrolled upward, the notifications are displayed below the media player user interface element 610 such that a position of the media player user interface element 610 is updated within the user interface 502 (e.g., the media player user interface element 610 appears to move upward towards the top of the user interface 502 in accordance with a direction of the user input 6002). In some embodiments, the size and position of the time indication 602-1 is not updated while the media player user interface element 610 moves upward until the media player user interface element 610 is at a position that would overlap with the time indication 602-1. In some embodiments, in accordance with a determination that the media player user interface element 610 is at a position that would overlap with the time indication 602-1, the size of the time indication 602-1 is updated, for example, by decreasing a height of the time indication 602-1′, as illustrated in FIG. 5AI.

In some embodiments, the size of the time indication 602-1 decreases until the size of the time indication 602-1 satisfies a minimum size threshold and once displayed with the minimum size, the size of the time indication 602-1 does not continue to decrease (e.g., even as the user input 6002″ continues to move upward and additional notifications and/or live activity sessions are displayed). In some embodiment, the user input 6002″ continues to move upward such that the date indication 604-1, the time indication 602-1′ (e.g., displayed at its minimum size), and the media player user interface element 610 appear to scroll off the top edge of the device 100, for example, to make room in the display area for additional notifications to be displayed (e.g., as described with reference to FIGS. 5D-5E).

FIGS. 5AJ-5AL illustrate a sequence of user interfaces where the size of the time indication 602-2 is not updated while the media player user interface element 610 is moved within the wake screen user interface 502′. In some embodiments, FIG. 5AJ follows, in sequence, FIG. 5AF. For example, while displaying the wake screen user interface 502′ (e.g., displayed in response to a user input 608 described with reference to FIGS. 5AE-5AF), the time indication 602-2 is displayed at a fixed size adjacent to the date indication 604-2.

In some embodiments, in response to detecting a user input 6008 (e.g., a same type of input as input 6002 (FIG. 5AG)) corresponding to a request to move the media player user interface element 610 and/or corresponding to a request to display one or more notifications, the device 100 displays the one or more notifications 6004 as traveling upward in accordance with the continuation of the user input 6008′. For example, the user input 6008 continues to move as a swipe or drag input as illustrated by user input 6008′ (FIG. 5AK) and user input 6008″ (FIG. 5AL). In some embodiments, as the user input 6008″ continues to move upward, additional notifications and/or live activity sessions are displayed in the wake screen user interface 502′. In some embodiments, the media player user interface element 610 also appears to move upward (e.g., toward a top edge of the device 100) in order to make space for the notifications 6004 and/or live activity session 6006. In some embodiments, while the media player user interface element 610 moves within the wake screen user interface 502′, the size of the time indication 602-2 does not change (e.g., time indication 602-2 continues to be displayed with the fixed size). For example, without changing a size of the time indication 602-2 or the date indication 604-2, the media player user interface element 610 snaps or locks to a position immediately below the time indication 602-2. In some embodiments, the media player user interface element 610 continues to travel upward until it is displayed immediately below the time indication 602-2 and the date indication 604-2. In some embodiments, in response to detecting that the user input 6008″ continues to move in the upward direction, additional notifications are displayed, and the time indication 602-2, the date indication 604-2, and the media player user interface element 610 appear to be scrolled off the display area of device 100 (e.g., disappear across the top edge of the device 100, as described with reference to FIGS. 5D-5E).

FIGS. 5AM-5AP illustrate dynamic changes to the time indication 506-1 of the wake screen user interface 502 over time. FIG. 5AM illustrates that at a first time (e.g., 9:58 AM), time indication 506-16 is displayed at a first height. FIG. 5AN illustrates that at a different, second time (e.g., a later time, 9:59 AM), time indication 506-17 is displayed at a second height that is greater than the first height of time indication 506-16 in FIG. 5AM.

FIG. 5AO illustrates that at a different, third time (e.g., a later time, 5:55 PM), time indication 506-18 is displayed at a third height that is less than the first height of time indication 506-16 in FIG. 5AM and less than the second height of time indication 506-17 in FIG. 5AN. In addition, in FIG. 5AO, a wallpaper of the wake screen user interface 502 is changed (e.g., moved higher on the display area of device 100, and the tree and face resized smaller).

FIG. 5AP illustrates that at a different, fourth time (e.g., 8:59 PM), time indication 506-19 is displayed at a fourth height that is less than the first height of time indication 506-16 in FIG. 5AM, less than the second height of time indication 506-17 in FIG. 5AN, and less than the third height of time indication 506-18 in FIG. 5AO. In addition, in FIG. 5AP, the wallpaper of the wake screen user interface 502 is further changed (e.g., moved higher on the display area of device 100, and the tree and face resized smaller). Similarly, the time could increase in height as time continues to progress (e.g., 8:59 PM in FIG. 5AP back to 9:59 AM as shown in FIG. 5AM).

More generally, time indication 506-1 is displayed at different sizes, positions, heights, and/or aspect ratios at different times of day. For example, FIG. 5AN illustrates an automatic change (here, an increase) in the height of time indication 506-1 after a minute has elapsed since the time in FIG. 5AM, and is optionally followed by a subsequent change (e.g., a decrease, or at least a partial reversal of the prior change) in the height of time indication 506-1 to the height of time indication 506-1 shown in FIG. 5AM after another minute has elapsed (e.g., at 9:00 AM). In some embodiments, the transition from FIG. 5AM to FIG. 5AN is gradual, in that the height of time indication 506-1 increases through a plurality of intermediate heights between the heights shown in FIGS. 5AM and 5AN (e.g., and optionally decreases through a plurality of intermediate heights to one or more lower heights such as the heights shown in FIGS. 5AO and 5AP). In another example, FIG. 5AO illustrates an automatic change (here, a decrease) in the height of time indication 506-1 at a particular time of day (e.g., sunset), in contrast to the heights of time indication 506-1 during the daytime (e.g., optionally triggered by sunrise) in FIGS. 5AM and 5AN. In yet another example, FIG. 5AP illustrates an automatic change (here, a decrease) in the height of time indication 506-1 at a user-defined time of day (e.g., bedtime) in contrast to the heights of time indication 506-1 during other user-defined times of day (e.g., awake time).

In some embodiments, device 100 changes the height of time indication 506-1 automatically (e.g., without regard to whether device 100 detects a user input, arrival of a notification, arrival of a system alert, a change in state of a live activity, and/or occurrence of another event). For example, FIGS. 5AM-5AP illustrate that no new notifications have been received, as indicated by notification 510 (e.g., displayed as a topmost notification of a stack of notifications) being the same in FIGS. 5AM-5AP. In addition, the transitions of FIGS. 5AM-5AP are performed without device 100 detecting a user input to scroll through the stack of notifications (e.g., and scroll to display additional notifications), as discussed herein with respect to FIGS. 5A-5D. In some embodiments, the transitions of FIGS. 5AM-5AP are performed in accordance with a determination that device 100 is configured with a dynamic time setting that enables the indication of time (also herein called an indication of a current time of day) to change automatically as time elapses and/or the dynamic time setting is enabled (e.g., optionally a setting that is available to be enabled or disabled for a set of one or more backgrounds or wallpapers that are able to automatically adjust over time as the height of the indication of time changes), and not performed in accordance with a determination that that device 100 is not configured with the dynamic time setting and/or the dynamic time setting is not enabled.

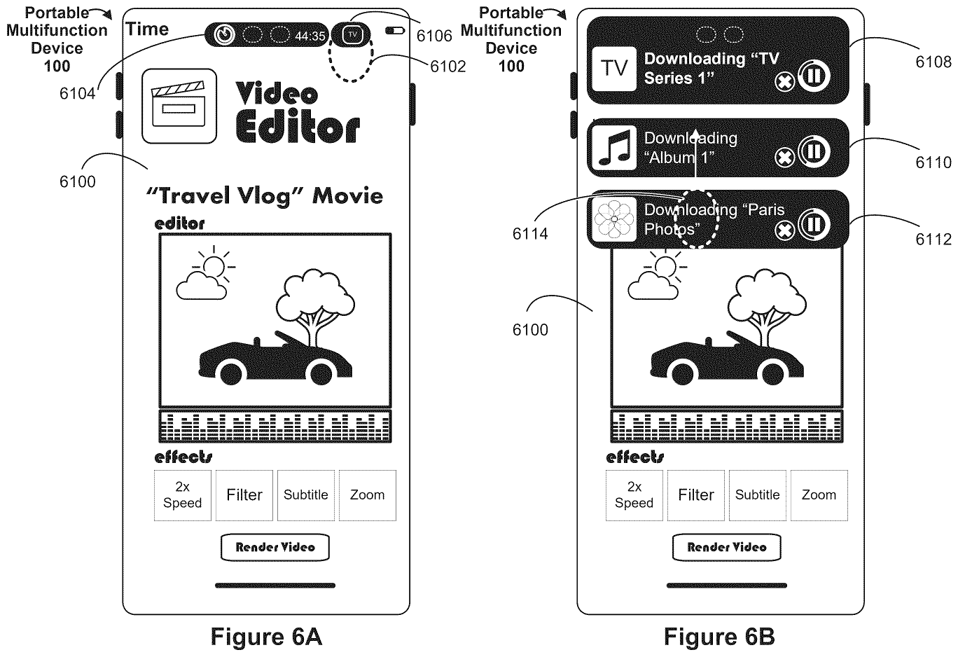

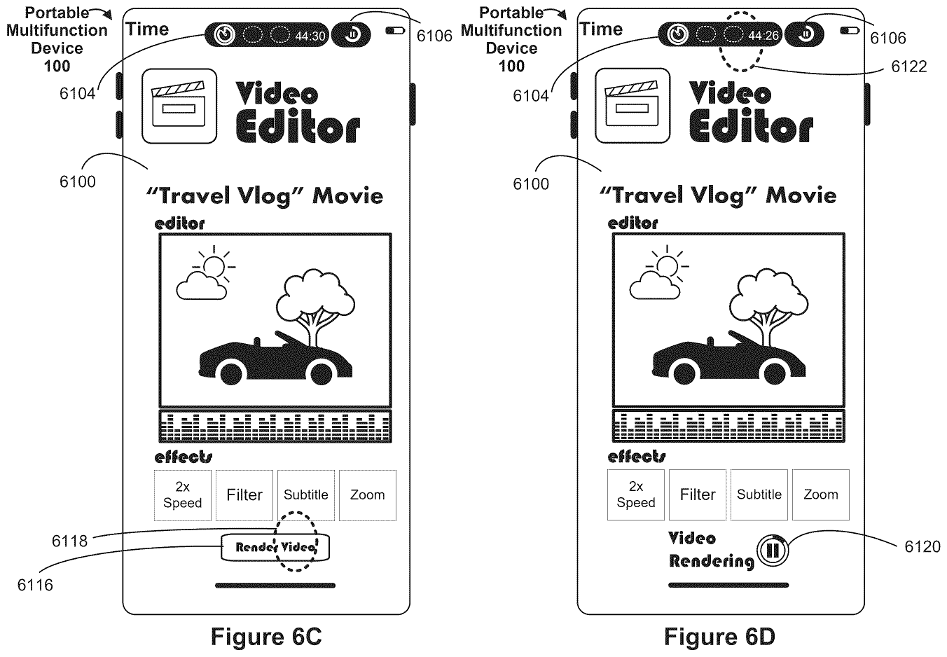

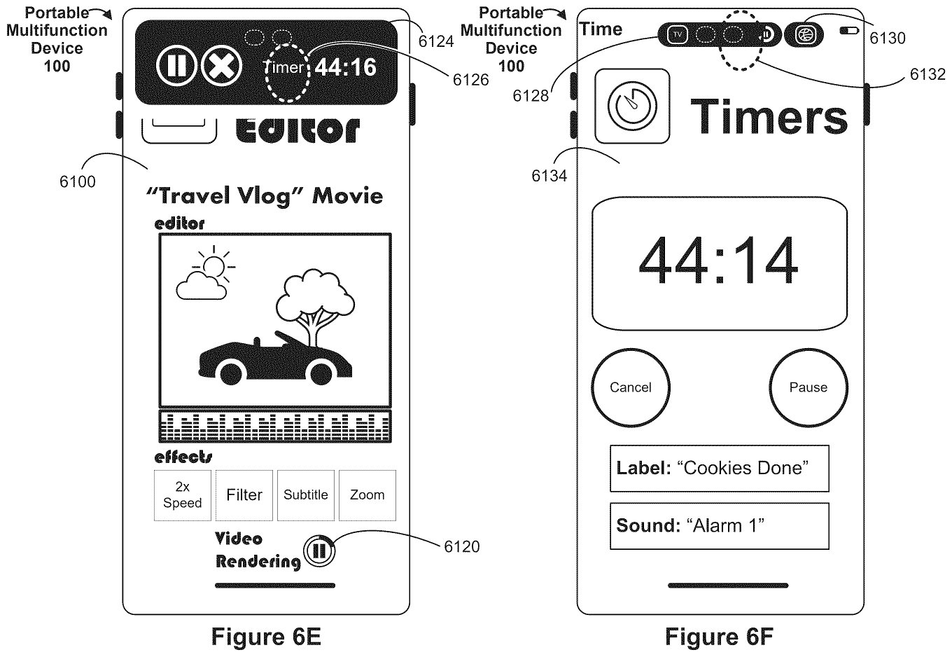

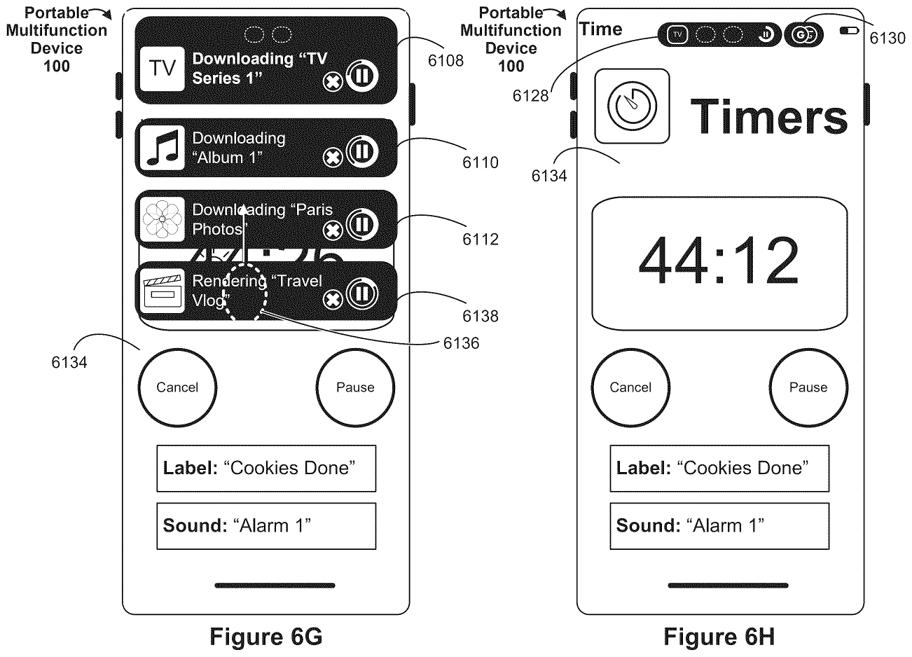

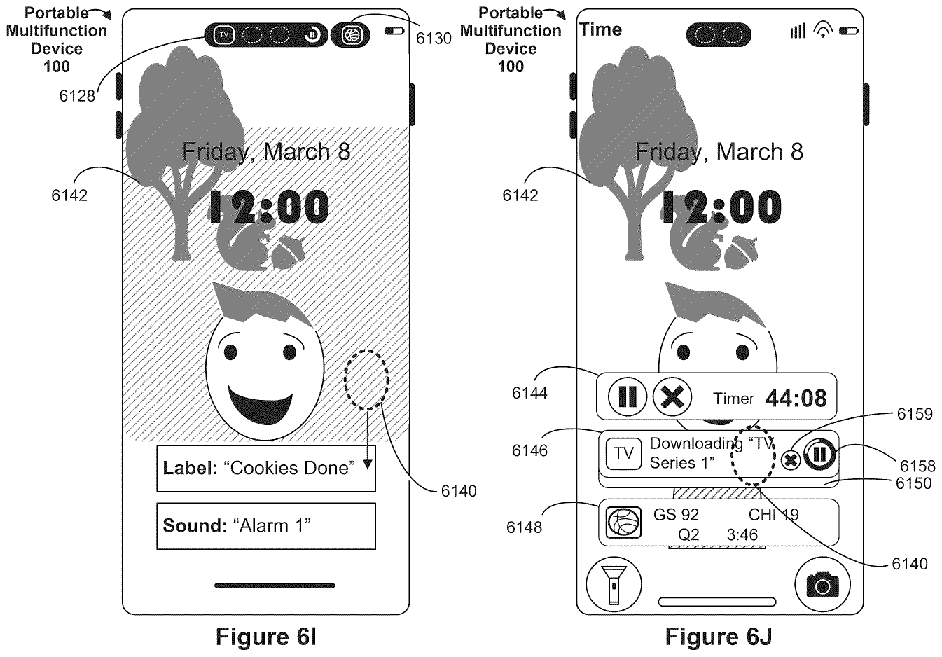

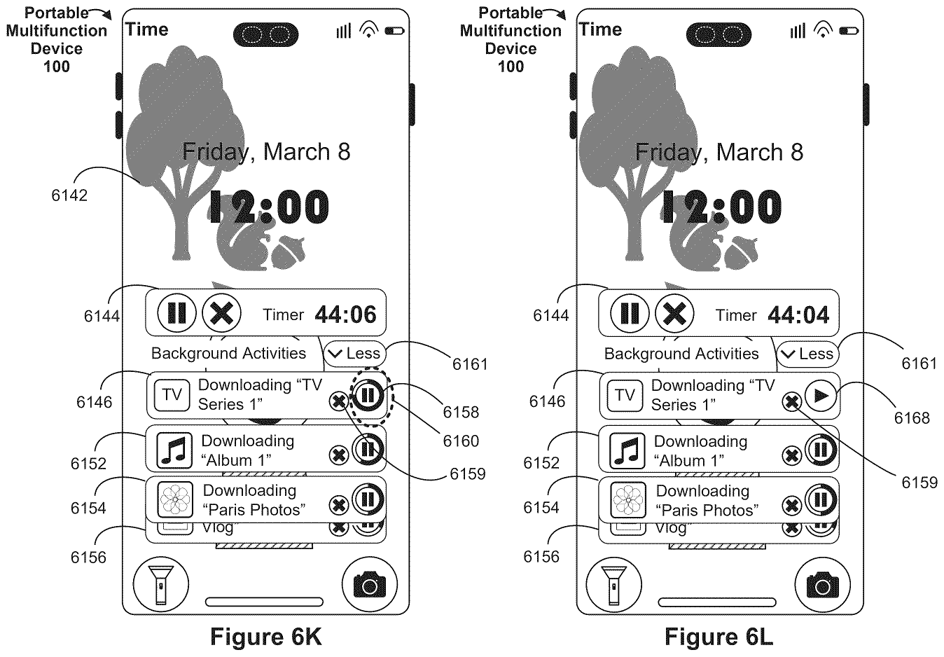

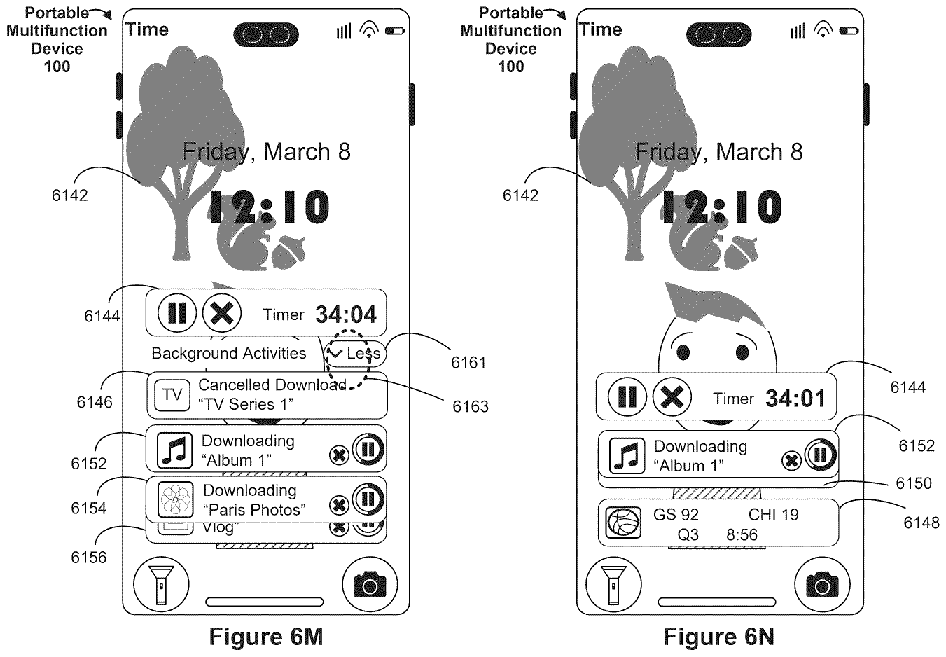

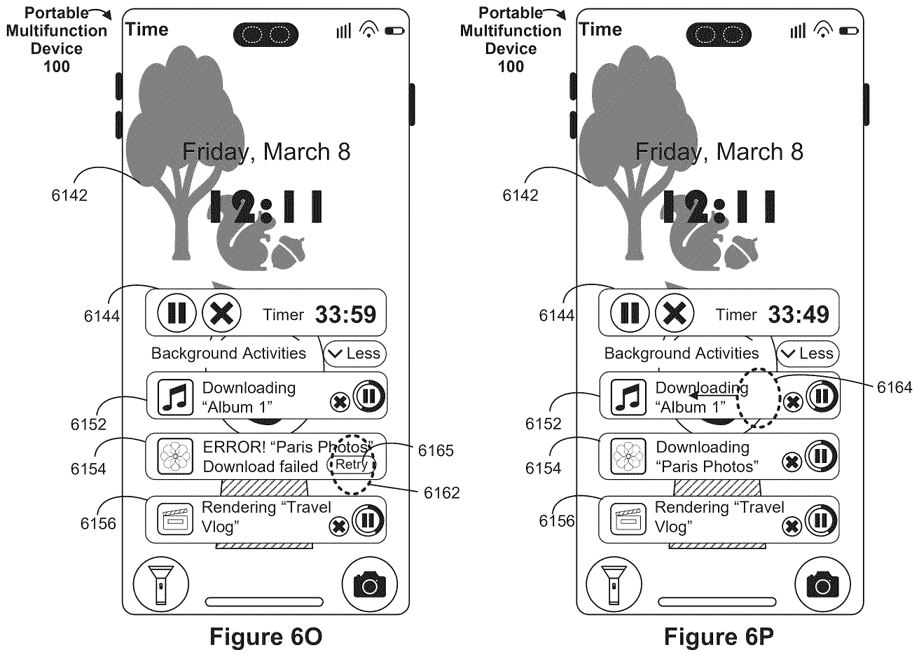

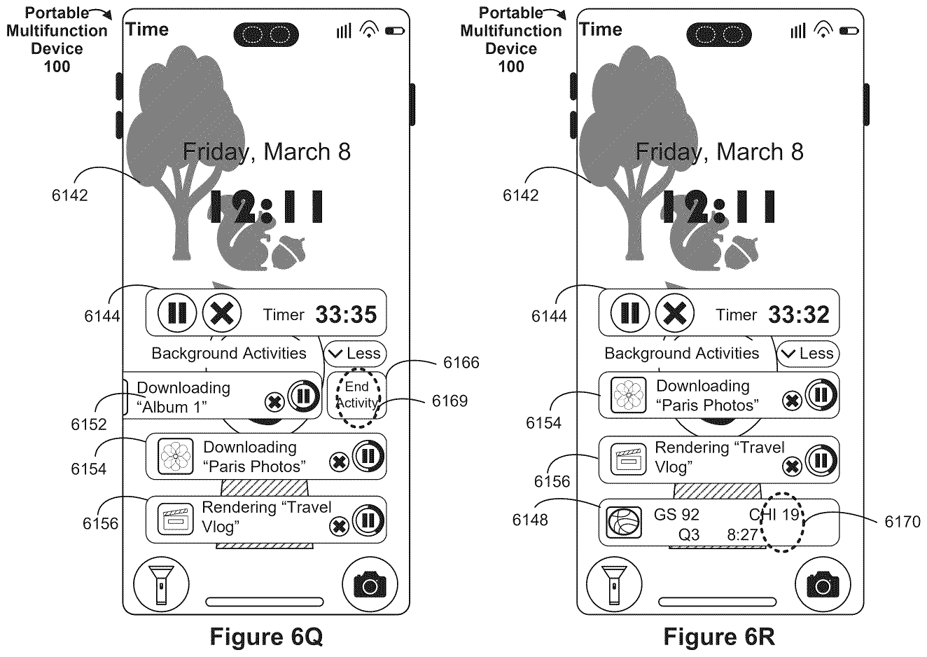

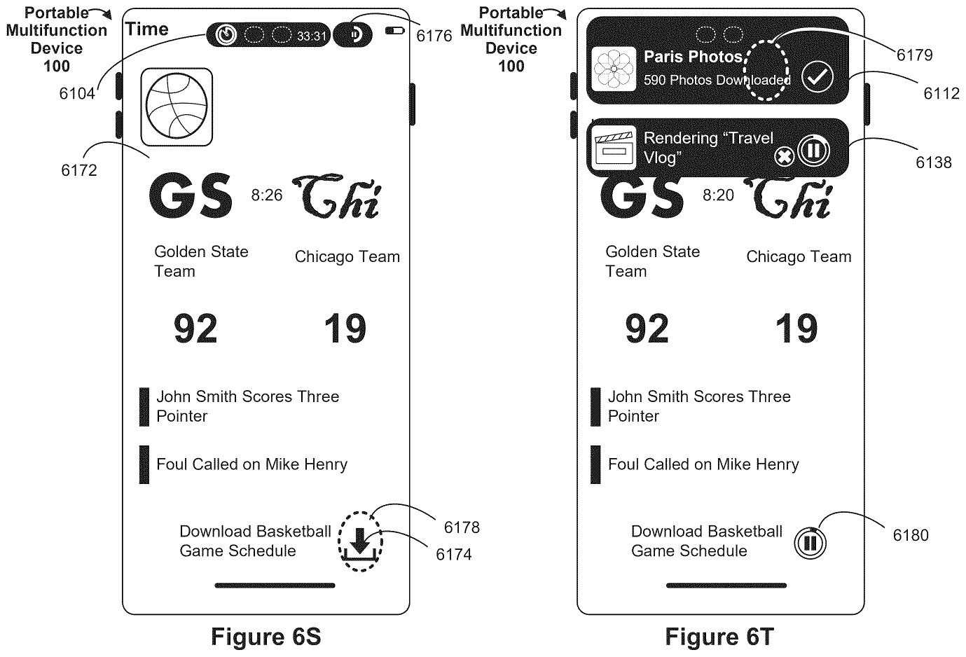

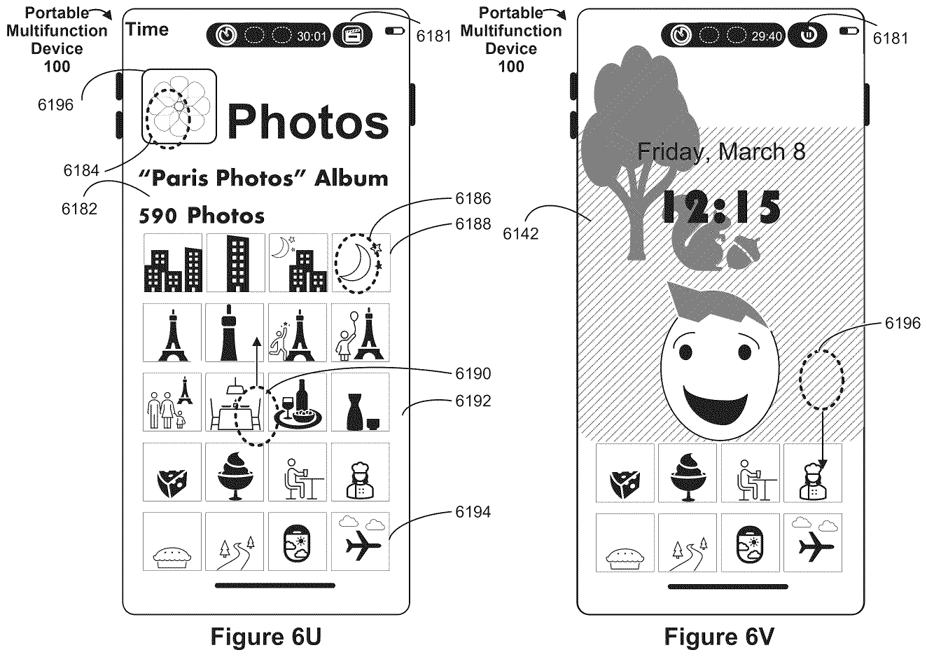

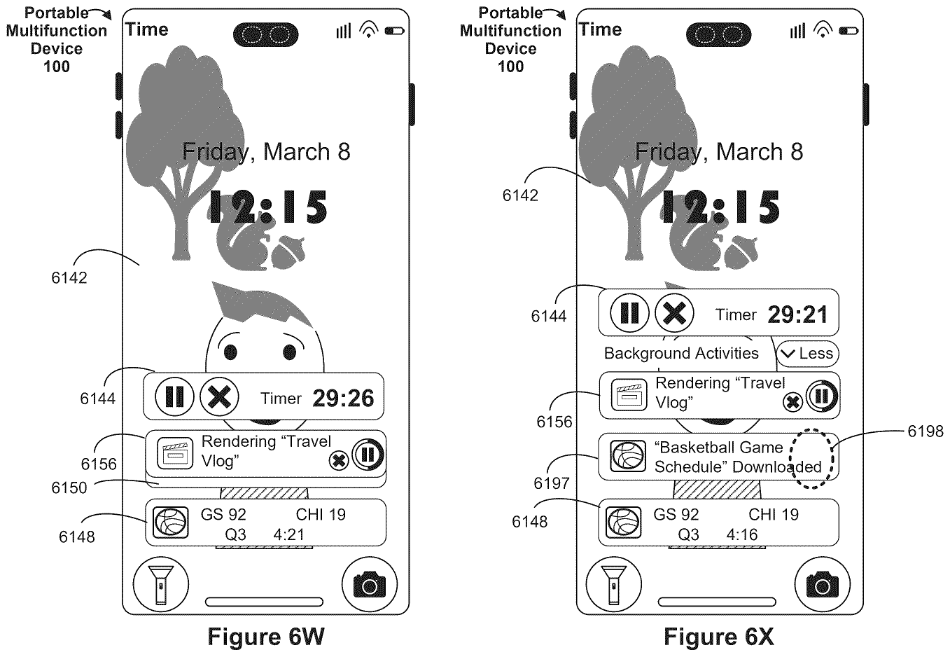

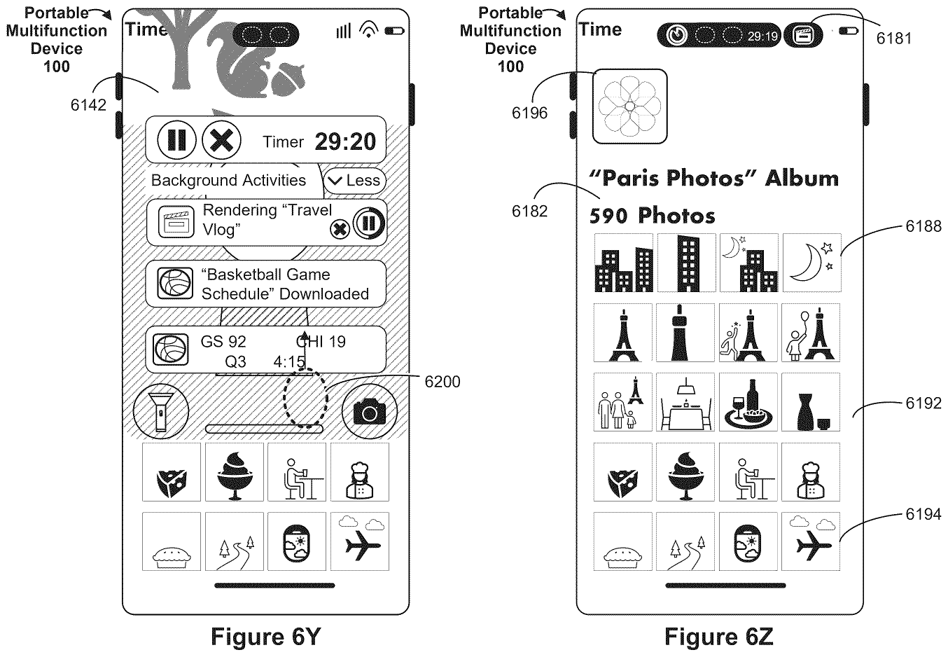

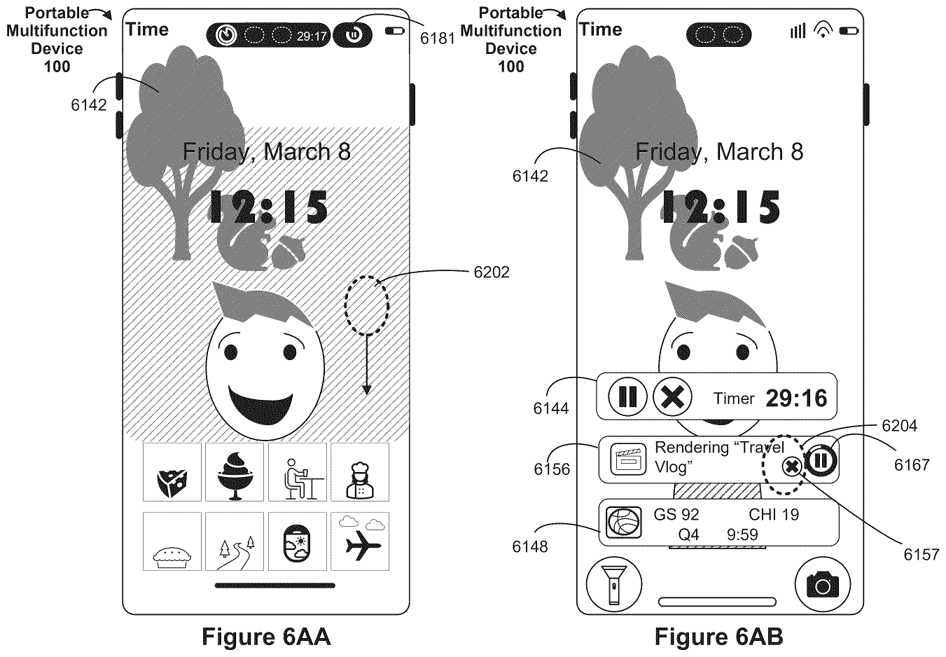

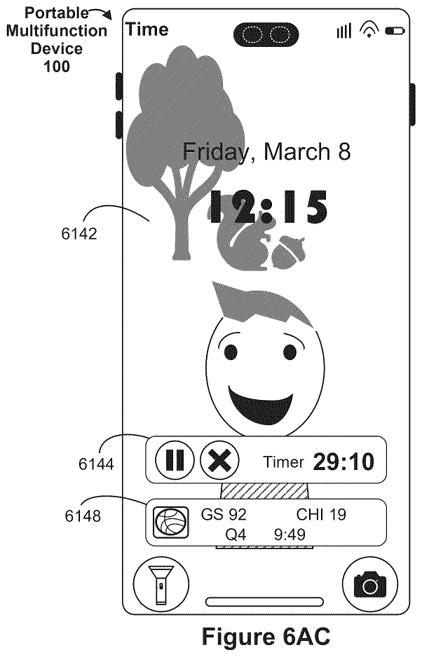

FIG. 6A illustrates a user interface 6100 of a video editing application displayed by device 100. Video editing application user interface 6100 is displayed in an application region of the display of device 100 while live activities (e.g., of applications other than the video editing application) are ongoing and have status information represented in a status region of the display. For example, live activity user interface element 6106 corresponds to an active session associated with an application (e.g., a running download of a television series) executing on device 100 and live activity user interface element 6104 corresponds to an active session associated with a different application (e.g., a running timer) executing on device 100. In some embodiments, live activity user interface element 6104 displays a thumbnail graphic that represents the application that corresponds to the live activity (e.g., the timer application) and a status associated with the live activity (e.g., the time remaining on the running timer). In some embodiments, live activity user element 6106 displays only the thumbnail graphic of the associated live activity (e.g., a television application) and cycles display between the thumbnail graphic and the status of the live activity.

FIG. 6A also illustrates detecting a user input 6102 (e.g., a tap user input or other selection input) directed toward live activity user interface element 6106.

FIG. 6B illustrates that, in some embodiments, in response to detecting user input 6102, device 100 expands live activity user interface element 6106 to display more of the related live activities, such that live activity user interface elements 6108, 6110, and 6112 are displayed. In the example in FIG. 6B, in conjunction with displaying related live activities user interface elements 6108, 6110, and 6112, live activity user interface element 6104 for the timer application (e.g., which is not one of the related live activities) ceases to be displayed (e.g., is hidden while the list of related live activities is expanded). In some embodiments, each live activity user element 6108, 6110, and 6112 displays a thumbnail graphic of the associated live activity, the status of the live activity, and control affordances (e.g., a pause affordance and a cancel affordance) that control the live activity. For example, live activity user element 6108 corresponds to a running download of a television series, representing the same live activity as live activity user element 6106 in FIG. 6A, live activity user element 6110 corresponds to a running download of a music album, and live activity user element 6112 corresponds to a running download of a photo album (e.g., or set of photos).

FIG. 6B also illustrates detecting user input 6114 (e.g., a swipe upward gesture) directed towards live activity user interface element 6108, 6110, or 6112.

FIG. 6C illustrates that, in some embodiments, in response to detecting user input 6114, device 100 minimizes related live activity user elements 6108, 6110, and 6112 and returns to user interface 6100 as displayed by device 100 before expanding the related live activities as in FIG. 6B (e.g., FIG. 6C is analogous to FIG. 6A). FIG. 6C also illustrates detecting user input 6118 (e.g., a tap user input or other selection input) directed toward background processing task initiation affordance 6116 to start a new background processing live activity (e.g., rendering a movie within the video editor application).

FIG. 6D illustrates that, in some embodiments, in response to detecting user input 6118, device 100 begins the background processing live activity of rendering the movie in the video editor application. Status indicator 6120 shows the status of the background processing task that was started in FIG. 6C. FIG. 6D also illustrates detecting user input 6122 (e.g., a tap user input, long press user input, or other selection input) directed toward live activity user interface element 6104 corresponding to a request to expand the live activity that corresponds to live activity user interface element 6104.

FIG. 6E illustrates that, in some embodiments, in response to detecting user input 6122, device 100 expands live activity user interface element 6104 to display more control affordances for the corresponding live activity (e.g., because there are no live activities executing on device 100 that are related to the running timer activity). For example, live activity user interface element 6124 displays a thumbnail graphic of the associated live activity, the status of the live activity, and control affordances (e.g., a pause affordance and a cancel affordance). In some embodiments, if one or more live activities related to the running timer were executing on device 100, device 100 would, in response to detecting user input 6122, display an expanded set of live activity user interface elements corresponding to the running timer and its one or more related live activities, instead of displaying expanded live activity user interface element 6124. While the expanded live activity user interface element 6124 is displayed, live activity user interface element 6106 ceases to be displayed. FIG. 6E also illustrates detecting user input 6126 directed toward live activity user interface element 6124.

FIG. 6F illustrates that, in some embodiments, in response to detecting user input 6126 directed toward the live activity user interface element 6124, device 100 opens the user interface of the relevant status page of the application associated with the live activity user interface element 6124 (e.g., the timer application), and accordingly displays user interface 6134. In some embodiments, the live activity user interface elements that are displayed in the status region changes, since an application user interface 6134 of the timer application is now displayed in the application region. For example, live activity user interface element 6128 corresponds a background processing live activity (e.g., a running download of a television series) that is different from the live activity that corresponded to the live activity user interface element 6104 previously displayed in the corresponding portion of the status region in FIG. 6D, since the application that corresponds to live activity user interface element 6104 is now open on device 100. Live activity user interface element 6130 corresponds to a live activity (e.g., with updates about an ongoing sports game) that is different from the live activity that corresponds to the live activity user interface element 6106 previously displayed in the corresponding portion of the status region in FIG. 6D. FIG. 6F also illustrates detecting user input 6132 (e.g., a tap user input or other selection input) directed toward live activity user interface element 6128 corresponding to the running download of a television series and having one or more related live activities (e.g. background processing tasks).

FIG. 6G illustrates that, in some embodiments, in response to detecting user input 6132, device 100 expands live activity user interface element 6128 to display more of the related live activities, such that live activity user elements 6108, 6110, 6112, and 6138 are displayed. Live activity user element 6138 corresponds to the background live activity that was started in FIG. 6C (e.g., a rendering of a movie). Accordingly, the expanded list of live activities in FIG. 6G is similar to the expanded list of live activities in FIG. 6B, except with live activity user element 6138 further included in FIG. 6G. FIG. 6G also illustrates detecting user input 6136 (e.g., a swipe upward gesture directed toward live activity user interface elements 6108, 6110, 6112, and 6134) to minimize the user interface elements of related live activities.

FIG. 6H illustrates that, in some embodiments, in response to detecting user input 6136, device 100 minimizes related live activity user elements 6108, 6110, 6112, and 6138, and returns to user interface 6134 that was displayed by device 100 before expanding the related live activities (e.g., as illustrated in FIG. 6F). Live activity user interface element 6130 (e.g., with updates about an ongoing sports game) in FIG. 6H displays a graphic representing the competing sports teams in the ongoing sports game, instead of the thumbnail graphic of the associated application (e.g., sports application).

FIG. 6I illustrates detecting user input 6140 (e.g., a swipe downward gesture, optionally from a top edge of the display of device 100) corresponding to a request to display wake screen user interface 6142.

FIG. 6J illustrates that, in some embodiments, in response to detecting user input 6140, device 100 displays wake screen user interface 6142. Wake screen user interface 6142 includes live activity user interface elements 6144, 6146, and 6148 because the live activities associated with these user interface elements are ongoing. For example, the representation of live activity 6144 corresponds to an active session associated with the running timer that is still executing on the device 100 (e.g., the same live activity that is represented in live activity user interface element 6104 in FIGS. 6A, 6C, and 6D, live activity user interface element 6124 in FIG. 6E, and timer application user interface 6134 in FIG. 6H); live activity 6146 corresponds to the ongoing television series download; and live activity 6148 corresponds to the ongoing sports game updates. In some embodiments, while the active sessions are ongoing, the corresponding live activity user interface elements (e.g., live activity user interface elements 6144, 6146, and 6148) are displayed on the wake screen user interface and are updated with status updates via the respective associated applications.

In some embodiments, related live activities are displayed in a stack 6150 appearance on the wake screen user interface 6142. The device 100 displays at the top of the stack 6150 the status of a respective live activity of the related live activities in the stack. For example, the live activity user interface element 6146 corresponds to the television series downloading operation executing in the background (e.g., the same live activity represented in live activity user interface element 6106 in FIGS. 6A, 6C, and 6D, live activity user interface element 6108 in FIGS. 6B and 6G, and live activity user interface element 6128 in FIGS. 6F and 6H), which relates to the stack 6150 of background processing live activities. The other live activity user interface elements 6144 and 6148 are not displayed in a stacked formation because they are not related to the live activities in the stack 6150, for example because live activity user interface elements 6144 and 6148 (e.g., a running timer and sports game updates) are not in the same category of live activities (e.g., are not background processes). In some embodiments, a live activity user interface element displays one or more affordances (e.g., for controlling the live activity). For example, the live activity user interface element 6146 for the television series downloading operation includes a cancel affordance 6159 (e.g., for cancelling the download) and a pause affordance 6158 (e.g., for pausing the download).

FIG. 6J also illustrates detecting a user input 6140 (e.g., a tap user input or other selection input) directed toward the stack 6150 of related live activities. FIG. 6K illustrates that, in some embodiments, in response to detecting the user input 6140 (e.g., and because the user input 6140 corresponds to a request to expand the stack 6150 of related live activities), the device 100 expands the stack 6150 of live activities to display more of the related live activities, such that live activity user interface elements 6152, 6154, and 6156 are displayed. In some embodiments, the representations of one or more other non-related live activities cease to be displayed on the wake screen user interface 6142 due to the stack of related live activities being expanded and occupying the display area. For example, live activity user interface element 6148 (e.g., sports game updates) is no longer displayed on the wake screen user interface 6142 in FIG. 6K (e.g., having been displaced by the expansion of the stack of the related live activities). In some embodiments, the representations of one or more non-related live activities continue to be displayed on the wake screen user interface 6144 even after expansion of the stack of related live activities. For example, the live activity user interface element 6144 is still displayed even after the stack 6150 of background processing related live activities has been expanded to reveal live activity elements 6152, 6154, and 6156 in addition to the already displayed live activity element 6146. In some embodiments, one or more of the related live activities continue to be displayed in a stacked appearance depending on the number of related live activities and the display space available on the wake screen user interface 6142. For example, live activity user interface element 6156 is only partially visible behind live activity user interface element 6154. In the example of FIG. 6K, live activity user interface element 6152 corresponds to the music album downloading operation (e.g., of the live activity user interface element 6110 in FIG. 6B, and/or of a music application), live activity user interface element 6154 corresponds to a photo downloading operation (e.g., of the live activity user interface element 6112 in FIG. 6B, and/or of a photos application), and live activity user interface element 6156 corresponds to the movie rendering operation of the video editor application (e.g., initiated in FIG. 6C and also represented as live activity user interface element 6138 in FIG. 6G). In some embodiments, an affordance 6161 (e.g., labeled “Less”) is displayed with the expanded live activity user interface elements (e.g., above the expanded stack in FIG. 6K) and is activatable to collapse the expanded related live activity user interface elements (e.g., back into the stack 6150).

FIG. 6K also illustrates detecting a user input 6160 (e.g., a tap user input or other selection input) on the pause affordance 6158 of live activity user interface element 6146. In FIG. 6L, in response to detecting the user input 6160 on the pause affordance 6158, device 100 pauses the live activity associated with the live activity user interface element 6146 (e.g., pauses download of the television series) and displays a resume affordance 6168 that controls the corresponding live activity (e.g., a paused download of a television series).

FIG. 6M illustrates that, in some embodiments, after (e.g., in response to detecting that) a live activity has been paused for a threshold of time, the device 100 automatically cancels the live activity. For example, in FIG. 6M, the live activity associated with live activity user interface element 6146 has now been cancelled, and the live activity user interface element 6146 now displays the corresponding cancelled message to the user, due to a threshold amount of time (e.g., ten minutes) having passed since the television series downloading operation was paused in FIGS. 6K-6L (e.g., as indicated by the time remaining on the running timer of live activity user interface element 6144). FIG. 6M also illustrates detecting user input 6163 (e.g., a tap user input or other selection input) directed towards the “Less” affordance 6161 (e.g., corresponding to a request to collapse the expanded group of related live activity user interface elements, including live activity user interface elements 6146, 6152, 6154, and 6156).

FIG. 6N illustrates that, in some embodiments, in response to detecting the user input 6163 directed towards the affordance 6161, the device 100 collapses the live activity user interface elements 6146, 6152, 6154, and 6156 and returns to displaying the stack 6150 of related live activity user interface elements in user interface 6142. However, in contrast to FIG. 6J, which shows the live activity user interface element 6146 for the television series downloading operation as the topmost element of the stack 6150 of the related live activity user interface elements, the topmost element of the stack 6150 in FIG. 6N is live activity user interface element 6152 for a music album downloading operation (e.g., of a music application), because the television series downloading operation has been canceled and thus is not ongoing.

FIG. 6O illustrates that, in some embodiments, in response to a change in state of a related live activity that corresponds to a live activity user interface element, device 100 automatically expands the stack of related live activities (e.g., background processing tasks) and displays the change in state of the live activity within its corresponding live activity user interface element. For example, in response to the live activity associated with live activity user interface element 6154 experiencing a change in state of the live activity (e.g., a download error), device 100 automatically expands the stack 6150 of related live activities (e.g., background processing tasks) and displays the change in state (e.g., an error message indicating a failed download) in the live activity user interface element 6154, along with a retry affordance 6165 that controls the live activity. FIG. 6O also illustrates detecting user input 6162 (e.g., a tap user input or other selection input) directed towards retry affordance 6165 and corresponding to a request to reattempt the photo downloading operation corresponding to live activity user interface element 6154 (e.g., which had been automatically stopped due to download error).

FIG. 6P illustrates that, in some embodiments, in response to detecting the user input 6162 directed towards retry affordance 6165, device 100 resumes, or otherwise restarts or retries, the photo downloading operation corresponding to live activity user interface element 6154. FIG. 6P also illustrates detecting user input 6164 (e.g., a left swipe gesture or other input) directed towards live activity user interface element 6152 (e.g., corresponding to a request to dismiss the live activity user interface element 6152 and/or end the corresponding live activity).

FIG. 6Q illustrates that, in some embodiments, in response to detecting user input 6164 directed towards live activity user interface element 6152, device 100 displays live activity user interface element 6152 moved to the left (e.g., repositioned based on the magnitude and direction of movement of the user input 6164) to reveal the end affordance 6166. FIG. 6Q also illustrates detecting user input 6169 (e.g., a tap user input or other selection input) directed towards end affordance 6168 (e.g., corresponding to a request to end the live activity associated with live activity user interface element 6152).

FIG. 6R illustrates that, in some embodiments, in response to detecting user input 6169 directed towards end affordance 6166, device 100 ends the live activity associated with live activity user interface element 6152 (e.g., the music album downloading operation) and remove live activity user interface element 6152 from wake screen user interface 6142. FIG. 6R also illustrates detecting user input 6170 (e.g., a tap user input or other selection input) directed towards live activity user interface element 6148 (e.g., corresponding to a request to open an application corresponding to live activity user element 6148).

FIG. 6S illustrates that, in some embodiments, in response to detecting user input 6170 directed towards live activity user interface element 6148 corresponding to the ongoing sports game updates, device 100 opens the sports application associated with live activity user interface element 6148, and in some embodiments automatically navigates to and displays the user interface 6172 of the particular portion of the application that is involved in the live activity user interface element 6148 towards which the user input 6170 was directed (e.g., where user interface 6172 is a page of the sports application for the same sports game whose status is displayed in live activity user interface element 6148). Device 100 also ceases to display wake screen user interface 6142 and instead displays live activity status information in the status region, including for example live activity user interface element 6104 for the running timer and/or live activity user interface element 6176 (e.g., in accordance with the television series downloading operation corresponding to the previously displayed live activity user interface element 6106 of FIG. 6A having ended and in accordance with the sports application corresponding to the previously displayed live activity user interface element 6130 for ongoing sports game updates of FIG. 6F being now open in the application region outside of the status region). In some embodiments, as illustrated in FIG. 6S, live activity user interface element 6176 corresponds to the ongoing photo downloading operation (e.g., the live activity corresponding to the topmost live activity user interface element 6154 of the related live activities in FIG. 6R). In some embodiments, a different live activity user interface element is displayed in the status region in FIG. 6S (e.g., in place of live activity user interface element 6176), such as live activity user interface element 6181 of FIG. 6U, optionally because the ongoing movie rendering operation is the most recently initiated live activity. In the example of FIG. 6S, user interface 6172 includes a download affordance 6174 for downloading a basketball game schedule. FIG. 6S also illustrates detecting user input 6178 (e.g., a tap user input or other selection input) directed towards download affordance 6174 and corresponding to a request to download a basketball game schedule.

FIG. 6T illustrates that, in some embodiments, in response to detecting the user input 6178 directed towards download affordance 6174, device 100 starts downloading the basketball game schedule, as shown by the status 6180 of the download. FIG. 6T also illustrates that, in some embodiments, in response to a change in state of a related live activity, which in FIGS. 6S-6T are represented in the status region instead of displayed in a wake screen user interface, device 100 automatically expands the related live activity user interface elements (e.g., background processing tasks) and displays the change in state of the live activity within its corresponding live activity user interface element (e.g., even if a live activity user interface element for the particular live activity that experienced the change in state was not previously displayed). For example, in response to the live activity associated with live activity user interface element 6112 (e.g., the photo downloading operation) experiencing a change in state of the live activity (e.g., download finished), device 100 automatically expands the live activity user interface elements of related live activities (e.g., including live activity user interface element for the completed photo download and live activity user interface element 6138 for the rendering of a movie, which were represented in FIG. 6S by live activity user interface element 6176 for the photo downloading operation, and not including live activity elements such as live activity user interface elements 6108 and 6110 of FIG. 6G for processes that have ended) and displays the change in state (e.g., the completion message associated with a finished download) in the live activity user interface element 6112. FIG. 6T also illustrates detecting user input 6179 (e.g., a tap user input or other selection input) directed towards live activity user interface element 6112 (e.g., corresponding to a request to open a user interface of an application associated with the live activity corresponding to the live activity user interface element 6112).

FIG. 6U illustrates that, in some embodiments, in response to detecting user input 6179 directed towards live activity user interface element 6112, device 100 opens a user interface 6182 (e.g., relevant to the live activity) of an application associated with the live activity user interface element 6112. For example, the live activity corresponding to live activity user interface element 6112 is the download of a photo album. In response to detecting user input 6179, device 100 opens the user interface 6182 of the downloaded album within a photos application. In the example of FIG. 6U, the user interface 6182 includes a display area 6192 that displays thumbnail images such as thumbnail images 6188 and 6194 in an arrangement, such as a grid pattern, of the downloaded album for easy selection by the user. The user interface 6182 also optionally includes a thumbnail graphic 6196 of the application (e.g., the photos application). In some embodiments, the user interface 6182 is responsive to one or more different inputs directed toward respective locations in the user interface 6182. For example, in response to detecting an input 6184 (e.g., a tap user input or other selection input), device 100 optionally displays a different page of the application (e.g., the home page of the photos application). In response to detecting an input 6186, device 100 optionally displays the image represented by thumbnail image 6188 (e.g., enlarges the image displayed in the thumbnail image 6188). In response to a user input 6190 (e.g., an upward swipe gesture), device 100 optionally scrolls the user interface 6182 to display more thumbnail images from the same photo album (e.g., the images within the “Paris Photos” album).

FIG. 6U also illustrates that live activity user interface element 6181 corresponding to the ongoing movie rendering operation is displayed in the status region instead of live activity user interface element 6176 corresponding to the photo downloading operation, because the photo downloading operation has ended and/or because a user interface 6182 of the photos application is displayed outside of the status region. More generally, in FIG. 6U, live activity user interface element 6181 is displayed after other related live activities (e.g., corresponding to live activity user interface elements 6146, 6152, and 6154 shown in FIG. 6K) have ended. In some embodiments, the appearance of live activity user interface element 6181 changes (e.g., alternates or cycles) between a plurality of different graphics, such as from a thumbnail graphic of the associated application (e.g., the video editing application) in FIG. 6U to a graphic representing the progress of the ongoing operation (e.g., movie rendering) in FIG. 6V, and similarly in FIGS. 6Z-6AA.

FIG. 6V illustrates detecting user input 6196 (e.g., a downward swipe gesture) corresponding to a request to display the wake screen user interface 6142. FIG. 6W illustrates that, in some embodiments, in response to detecting user input 6196, device 100 displays the wake screen user interface 6142 and live activity user interface elements 6144, 6156, and 6148 in accordance with a determination that the live activities associated with live activity user interface elements 6144, 6156, and 6148 are ongoing. The live activity user interface elements previously displayed at the top of the stack 6150 of related live activities, such as live activity user interface element 6146 in FIG. 6J and live activity user interface element 6152 in FIG. 6N, are no longer displayed at the top of the stack 6150 of related live activities because those activities have already terminated. Instead, live activity user interface element 6156 is displayed at the top of stack 6150. Stack 6150 of related activities is displayed because there is still one other related live activity that is ongoing.

FIG. 6X illustrates, in some embodiments, in response to a change in state of a related live activity, device 100 automatically expands the stack of related activities and displays the change in state of the live activity within its corresponding live activity user interface element (e.g., even if a live activity user interface element for the particular live activity that experienced the change in state was not previously displayed as the topmost element of stack 6150). For example, due to the live activity associated with live activity user interface element 6197 (e.g., the downloading of a basketball game schedule, which was initiated in FIG. 6S and which continued as a background process after the sports application user interface 6172 ceased to be displayed) experiencing a change in state (e.g., the download being completed), device 100 automatically expands the stack of related live activities (e.g., background processing tasks) and displays the change in state (e.g., the completed state of the basketball game schedule download) in live activity user interface element 6197. In some embodiments, device 100 is configured, in response to detecting a user input 6198 (e.g., a tap user input or other selection input) directed towards live activity user interface element 6197, to display a user interface corresponding to the live activity of the live activity user interface element (e.g., the user interface of the downloaded basketball game schedule within the sports application of FIG. 6S).

FIG. 6Y illustrates detecting user input 6200 (e.g., an upward swipe gesture) corresponding to a request to dismiss wake screen user interface 6142. FIG. 6Z illustrates that, in some embodiments, in response to detecting user input 6200, device 100 displays (e.g., redisplays) the user interface that was most recently displayed before the just dismissed wake screen user interface 6142 was displayed. For example, since device 100 detected the user input 6196 corresponding to the request to display wake screen user interface 6142 while displaying the photos application user interface 6182 as seen in FIG. 6U, in response to detecting user input 6200 corresponding to the request to subsequently dismiss wake screen user interface 6142, device 100 redisplays user interface 6182 corresponding to the photos application.

FIG. 6AA illustrates detecting user input 6202 (e.g., a downward swipe gesture) corresponding to a request to display wake screen user interface 6142. FIG. 6AB illustrates that, in some embodiments, in response to detecting user input 6202, device 100 redisplays wake screen user interface 6142, except without displaying live activity user interface element 6197 in wake screen user interface 6142, because the live activity (e.g., the basketball game schedule download) corresponding to the live activity user interface element 6197 is no longer ongoing (e.g., dismissing the wake screen in FIGS. 6Y-6Z in response to user input 6200 resulted in live activity user interface element 6197, which indicated the completion of the corresponding live activity, being removed from the wake screen).

FIG. 6AB also illustrates detecting user input 6204 (e.g., a tap user input or other selection input) directed towards cancel affordance 6157 and corresponding to a request to cancel the live activity corresponding to live activity user interface element 6156.

FIG. 6AC illustrates that, in some embodiments, in response to detecting user input 6204 directed to cancel affordance 6157 in live activity user interface element 6156, device 100 cancels the live activity corresponding to live activity user interface element 6156. For example, FIG. 6AC shows that the rendering of the movie has been cancelled and live activity user interface element 6156 is no longer displayed on wake screen user interface 6142. FIG. 6AC optionally illustrates the appearance of wake screen user interface 6142 after being dismissed and redisplayed after the cancellation of the movie rendering live activity corresponding to live activity user interface element 6156 (e.g., analogously to live activity user interface element 6197 being removed from wake screen user interface 6142 in FIGS. 6Y-6AB). FIG. 6AC also optionally illustrates embodiments in which a cancelled live activity is immediately removed from wake screen user interface 6142 (e.g., in contrast to FIG. 6M in which the live activity user interface element 6146 for a live activity that was cancelled remains on wake screen 6142 with a cancelled message).

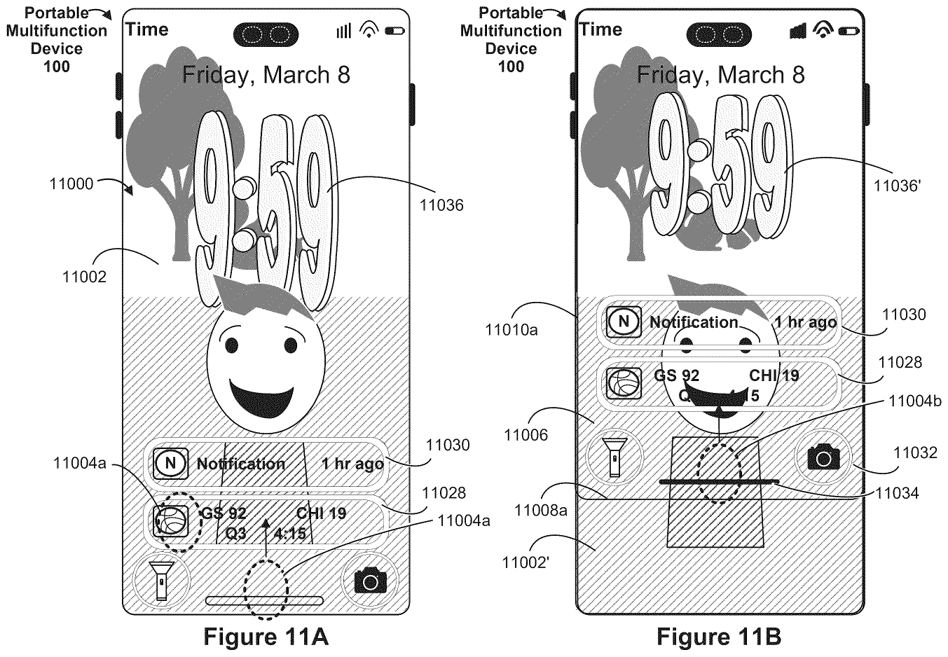

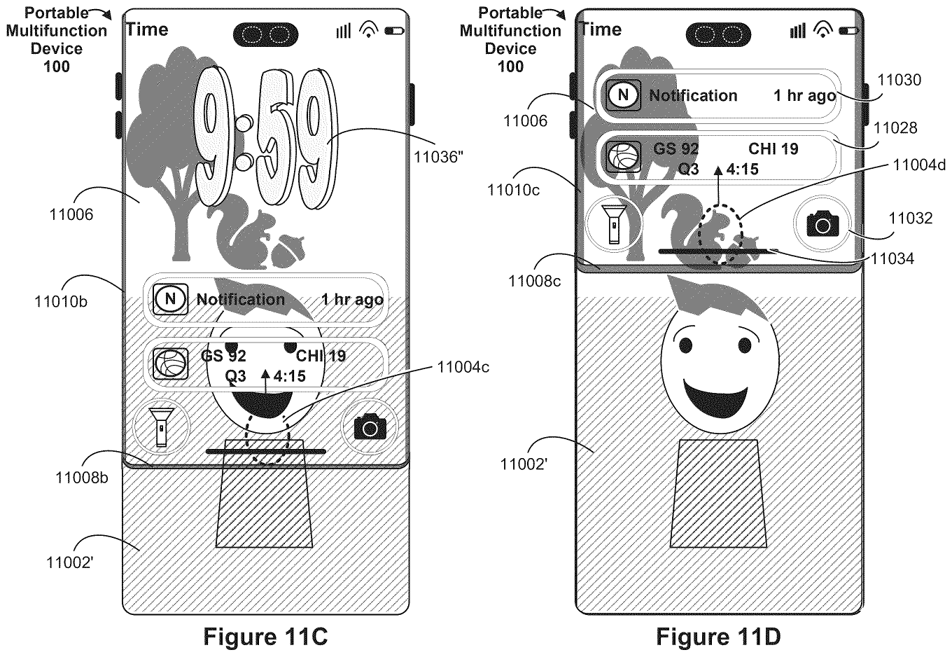

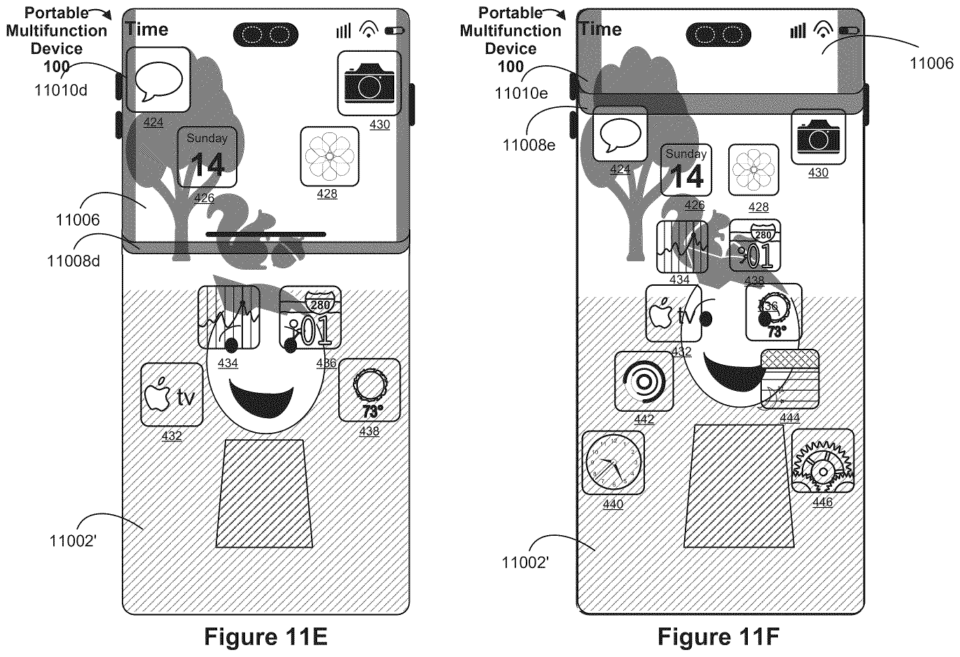

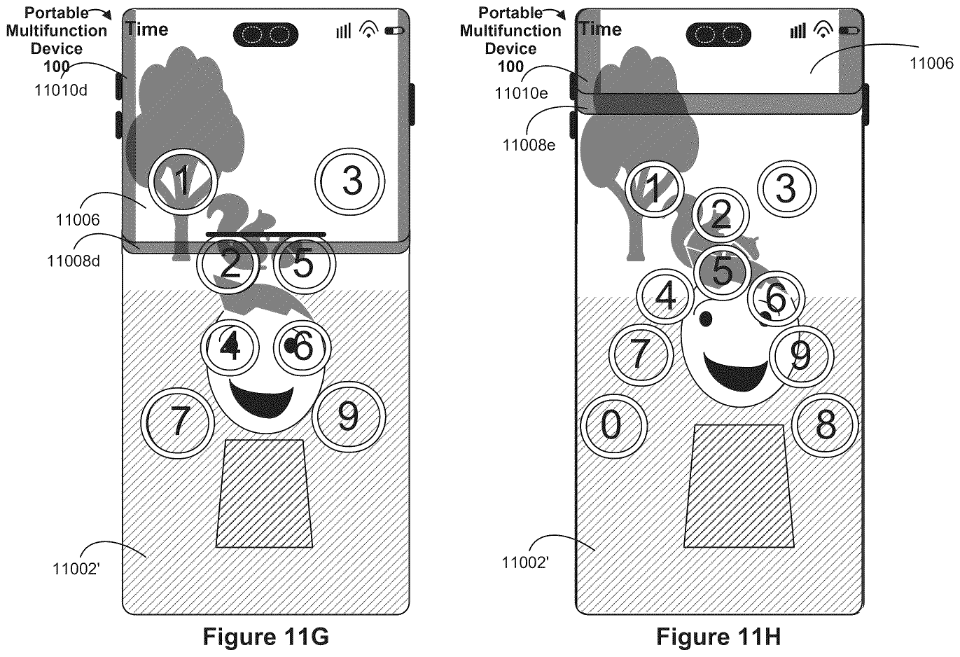

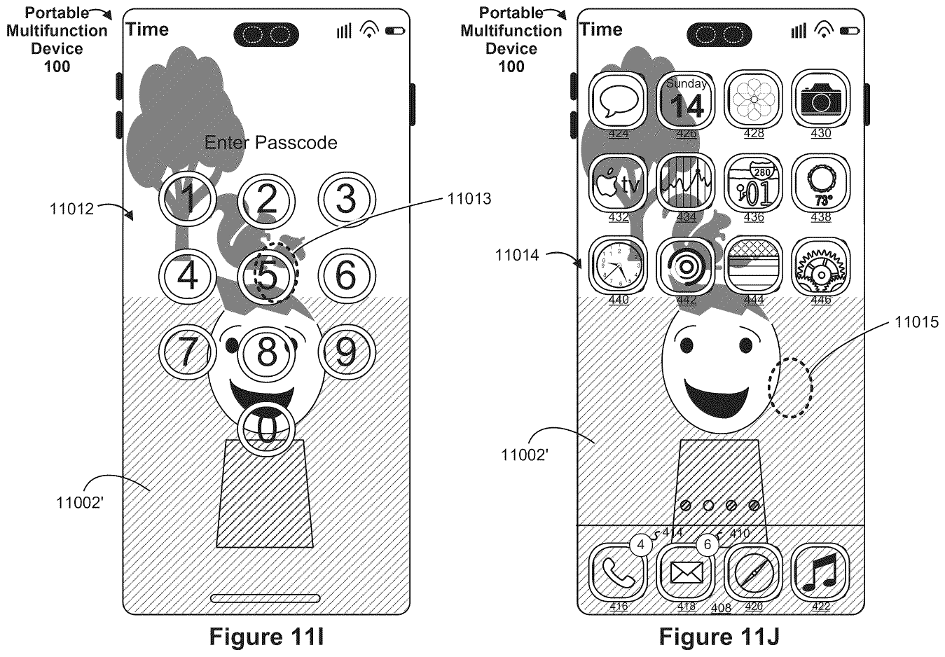

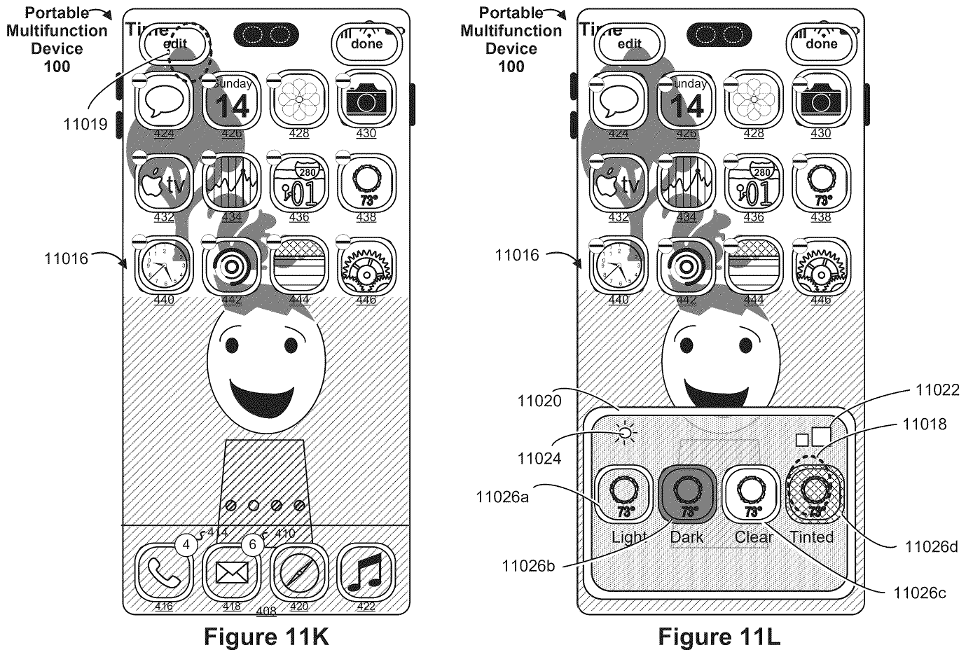

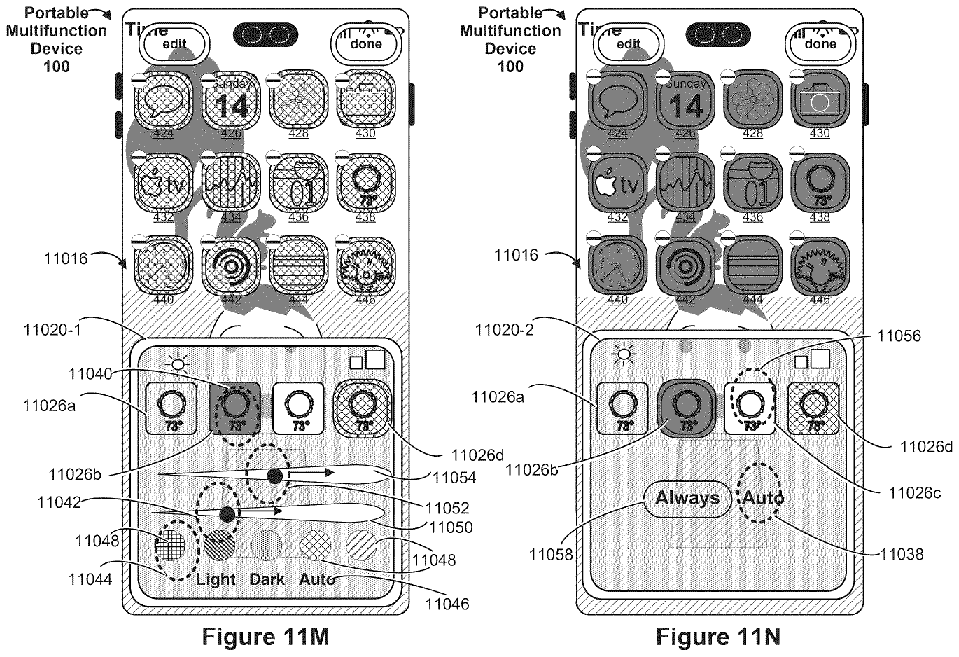

FIGS. 11A-110 illustrate examples user interfaces for transitioning from a wake screen (e.g., FIGS. 11A-11J) and modifying a home screen (e.g., FIGS. 11J-11N) in accordance with some embodiments. For example, FIG. 11A illustrates a system user interface, such as a wake screen user interface 11000. In some embodiments, the wake screen user interface includes a background 11002, also referred to herein as a wallpaper of the wake screen. For example, background 11002 is an image, a live photo, a video, or other content that is displayed in the wake screen user interface 11000. In some embodiments, the wake screen user interface 11000 includes content such as a time indication 11036 and a date indication (e.g., Friday, March 8), one or more quick action options (e.g., a flashlight option, a camera option 11032, and/or other quick action options). In some embodiments, the content of the wake screen user interface 11000 optionally includes one or more widgets, one or more notifications (e.g., notification 11030 and/or other notifications), one or more live activities (e.g., live activity 11028), and/or home affordance 11034. In some embodiments, the content of the wake screen user interface 11000 overlaps and/or partially occludes the background 11002 to appear on top of the background 11002. In some embodiments, at least some of the content of wake screen user interface 11000 is displayed with simulated glass user interface material, as described above with reference to at least FIG. 5A. In some embodiments, while displaying the wake screen user interface 11000, the device 100 detects a user input 11004a, such as a swipe input detected at or near an edge (e.g., a bottom edge or another edge) of the display area of the device 100, a drag input, a tap input, a scroll input, or another type of input, that corresponds to a request to dismiss the wake screen user interface 11000. In some embodiments, the user input 11004a is directed to an affordance 11034, which corresponds to an affordance for dismissing the wake screen user interface 11000 to display a home screen user interface 11014, another system user interface, and/or an application user interface. In some embodiments, the user interface that is displayed by device 100 upon dismissing the wake screen user interface 11000 corresponds to the user interface that was displayed immediately prior to the device 100 entering a low power state and/or displaying the wake screen user interface 11000.

FIGS. 11B-11F and 11J illustrate a sequence of user interfaces for an animated transition for transitioning between display of the wake screen user interface 11000 and the home screen user interface 11014. In some embodiments, the user input 11004a continues as user input 11004b (e.g., in FIG. 11B), and in response to detecting movement of the user input 11004a in a first direction, such as an upward swipe, the device 100 displays a simulated glass material overlay 11006 that includes a bottom edge 11008a and side edge(s) 11010a (e.g., along the right and/or left side edges of the display area of the device 100). In some embodiments, the bottom edge 11008a is displayed at a position that is based on the detected movement and/or current detected position of the user input 11004b. In some embodiments, the simulated glass material overlay 11006 is simulated to have different simulated visual properties than the simulated glass material of the notification 1130, time indication 11036, and/or live activity 11028. For example, the simulated glass material overlay 11006 is simulated as clear glass that has a reduced degree of distortion (e.g., does not refract, blur, or otherwise distort content or refracts, blurs, or otherwise distorts content by a first degree) in a middle portion of the simulated glass material overlay 11006, and an increased degree of distortion (e.g., refracts, blurs and/or otherwise distorts content by a second degree that is higher than the first degree of distortion) along the one or more edges of the simulated glass material overlay 11006 relative to the middle portion of the simulated glass material overlay 11006. In some embodiments, the simulated glass material overlay 11006 simulates a gradual increase in thickness of the edge(s) of the simulated glass material overlay 11006 over time as the animated transition between display of the wake screen user interface 11000 and the home screen user interface 11014 continues. For example, the bottom edge 11008b is thicker than the bottom edge 11008a and the side edge 11010b is thicker than the side edge 11010a. In some embodiments, as the animated transition continues (e.g., the simulated glass material overlay 11006 continues to move upward in the display area), the thickness of the bottom edge 11008a-11008e and the thickness of the side edges 11010a-11010e continue to increase in size, as illustrated by the sequence of user interfaces in FIGS. 11B-11F. In some embodiments, the increase in thickness of the edges that cause distortion of the underlying background 11002′ is used to simulate an increase in thickness of the simulated glass material overlay 11006. In some embodiments, simulating the increase in thickness of the simulated glass material overlay 11006 as the animation continues includes applying a greater amount of distortion (e.g., blur, refraction, reflection and/or other distortion) to the portions of the underlying background 11002′ that overlap with the edges of the simulated glass material overlay 11006.

In some embodiments, the simulated glass material overlay 11006 is displayed as gradually moving and/or sliding upward (e.g., and/or in a direction of movement of the user input 11004c that continues as user input 11004d), as illustrated in FIGS. 11C-11D. In some embodiments, as the simulated glass material overlay 11006 shifts upward, the background 11002′ does not appear to move with the simulated glass material overlay 11006 while content of the wake screen user interface, including the date indication, the time indication 11036″, the notification 11030, the live activity 11028, and/or the camera option 11032 are displayed as moving and/or sliding upward along with the simulated glass material overlay 11006. In some embodiments, the time indication 11036 optionally decreases in size, including changing in aspect ratio, as illustrated by time indication 11036′ and time indication 11036″ as the glass material overlay 11006 moves upward (e.g., and/or the notification 11030 moves upward to cause the time indication 1036′ to shrink, as described above with reference to FIGS. 5A-5D). In some embodiments, the content of the wake screen user interface (e.g., other than the background 11002′) is displayed as sliding off a top edge of the display area as the transition continues, as illustrated in FIG. 11D (e.g., where time indication 11036″ is no longer displayed). In some embodiments, a curvature of the corners along the bottom edge 11008 of the simulated glass material overlay 11006′ is displayed to match the curvature of the corners of the bottom edge of the display area of the device 100, as described with more detail below with respect to FIG. 11O.

In some embodiments, portions of the background 11002′ that are overlaid by the bottom edge 11008 (e.g., including bottom edges 11008a-11008e) and/or side edge(s) 11010 (e.g., including side edge(s) 11010a-11010e) of the simulated glass material overlay 11006′ are distorted. For example, as illustrated in FIG. 11D, a portion of the tree that is displayed in the background 11002′ that overlaps with the side edge 11010c is displayed with distortion; and the portion of the squirrel foot that overlaps with the bottom edge 11008c is displayed with distortion.

In some embodiments, while the user input 11004d (e.g., corresponding to a continuation of the user input 11004a through 11004c) continues to be detected, the content of the wake screen user interface continues to be displayed as moving with the simulated glass material overlay 11006, as illustrated in FIG. 11D. In some embodiments, in response to detecting an end of the user input 11004d, for example, detecting liftoff of the user input 11004d and/or detecting that movement of the user input 11004d has ceased, the device 100 displays an animation for displaying one or more application icons that are included in the home screen user interface 11014 (e.g., in FIG. 11J) and the content of the wake screen user interface, including the notification 11030, the live activity 11028 and/or the camera option 11032, ceases to be displayed. In some embodiments, the animation of the application icons includes gradually displaying application icons as flying onto the display from one or more sides of the display area, for example, flying in from the left and/or right edges of the display area, as illustrated in FIG. 11E-11F. In some embodiments, the animation of the application icons includes gradually decreasing a size of the application icons as they move away from the edge(s) of the display area to simulate the application icons flying in from in front of the display area of the device 100. In some embodiments, additional application icons continue to be displayed as flying onto the display area (e.g., icon 440, icon 442, icon 444 and icon 446 are displayed in FIG. 11F as the animation progresses from FIG. 11E). In some embodiments, portions of the application icons that overlap with the edges of the simulated glass material overlay 11006 are distorted in a same manner as the distortion of the background 11002′. For example, the portion of the application icon 424 that overlaps with the side edge 11010d in FIG. 11E is displayed to simulate distortion of the portion of the application icon 424 that is overlaid by the side edge 11010d of the simulated glass material overlay 11006. In some embodiments, the one or more application icons are optionally displayed as a simulated glass material (e.g., different from the simulated glass material overlay 11006), for example, the one or more application icons are displayed with visual properties that are applied to the simulated glass material of the notification 11030 and/or camera option 11032. For example, the simulated glass material overlay 11006 is displayed as simulated as clear glass, whereas the simulated glass material of the notification 11030, camera option 11032, and/or application icons are displayed as simulated refractive glass that distorts underlying content in which the simulated glass material overlays. In some embodiments, the animation of the application icons ends with display of the home screen user interface 11014 (e.g., where FIG. 11J follows in sequence from FIGS. 11E-11F). In some embodiments, in response to detecting an end of the user input 11004d, the animation for displaying the one or more application icons is performed in accordance with a determination that authentication criteria are met, for example, that the device 100 is in an unlocked state and/or that facial, fingerprint, or other biometric authentication are met based on detection of an enrolled biometric feature (e.g., based on a face detected by one or more visual sensors, based on an eye or portion of an eye detected based on one or more visual sensors, and/or based on a finger detected by one or more fingerprint sensors that are optionally part of a display, button or other hardware component of the computer system).

In some embodiments, in accordance with a determination that the authentication criteria are not met (e.g., the device 100 is in a locked state and/or facial, fingerprint, or other biometric authentication are not met), the device 100 displays an authentication user interface 11012 (e.g., in FIG. 11I) without displaying the home screen user interface 11014 (e.g., or displaying the animated transition illustrated in FIGS. 11E-11F) until the authentication criteria are met. In some embodiments, in response to detecting an end of the user input 11004d and in accordance with a determination that authentication criteria are not met, the device 100 displays an animated transition, as illustrated in FIGS. 11G-11H, that includes displaying number options for entering a passcode as flying onto the display area (e.g., following the animation described with reference to application icons in FIGS. 11E-11F). In some embodiments, each number option is optionally displayed with a simulated glass material. In some embodiments, during the animation, the number options are not displayed with a simulated glass material and, at the end of the animation, while displaying the authentication user interface 11012, the number options are displayed with the simulated glass material. As such, FIGS. 11G-11I illustrate a sequence of user interfaces that follow the sequence illustrated in FIGS. 11A-11D (e.g., if authentication criteria are not met because no biometric feature matching an enrolled biometric feature is detected) as an alternative to FIGS. 11E-11F following the sequence illustrated in FIGS. 11A-11D (e.g., if authentication criteria are met). In some embodiments, the device 100 detects one or more user inputs, such as user input 11013 (e.g., a sequence of one or more tap inputs or other selection user inputs), corresponding to entering a passcode in the authentication user interface 11012. In some embodiments, in accordance with a determination that the passcode entered by the user satisfies authentication criteria, the device 100 displays the home screen user interface 11014, as illustrated in FIG. 11J.

In some embodiments, the home screen user interface 11014 includes application icons that are displayed as overlaying the same background 11002′ that was displayed in the wake screen user interface 11000. In some embodiments, the home screen user interface 11014 is displayed with a different background than the background 11002′ of the wake screen user interface 11014 and the animated transition for displaying the home screen user interface 11014 includes cross-fading the background 11002′ of the wake screen user interface with the background of the home screen user interface.

FIG. 11J illustrates detecting a user input 11015, such as a long press user input or other user input, directed to the home screen user interface 11014 that corresponds to a request to enter an editing mode of the home screen user interface 11014. In some embodiments, in response to detecting the user input 11015, the device 100 displays an editing user interface 11016, as illustrated in FIG. 11K. In some embodiments, the editing user interface 11016 includes displays options to add, remove, rearrange, resize and/or otherwise modify the application icons (e.g., and/or widgets) displayed in the home screen user interface 11014. In some embodiments, in response to detecting a user input 11019, such as a tap input or other selection input, directed to an edit button in the editing user interface 11016, the device 100 displays an editing platter 11020 for modifying one or more visual properties of the application icons (e.g., and/or widgets), as illustrated in FIG. 11L. For example, the editing platter 11020 includes a user-selectable option for changing a brightness 11024 of the application icons (e.g., and/or widgets) and a user-selectable option 11022 for resizing the application icons (e.g., and/or widgets). In some embodiments, the editing platter 11020 further includes selectable options 11026, including light option 11026a, dark option 11026b, clear option 11026c, and tinted option 11026d, for modifying visual properties of the application icons (e.g., and/or widgets) in the home screen user interface 11014.

In some embodiments, as illustrated in FIG. 11M, in response to detecting a user input 11018, such as a tap input or other selection input, directed to the tinted option 11026d, the device 100 displays the application icons (e.g., icon 424, icon 426, icon 428 and/or other application icons) and/or widgets in the home screen user interface 11014 with a colored tint and updates editing platter 11020 to editing platter 11020-1 to include user-adjustable controls to update the colored tint that is applied to the application icons (e.g., and/or widgets). In some embodiments, the tinted option 11026d is emphasized relative to the other options 11026a, 11026b and 11026c, for example, by being displayed with a simulated glass material and/or with a greater simulated thickness relative to the other options 11026a, 11026b and 11026c. For example, the editing platter 11020-1 for the tinted option 11026d includes a slider 11054 for controlling a value within a color range of the tint that is applied to the application icons (e.g., and/or widgets) and a slider 11050 for controlling a level of darkness applied to the color of the tint. In some embodiments, in response to detecting a user input 11052, such as a swipe user input, a tap user input, or other user input directed to the slider 11054 or selection of a respective color option of the color options 11048, the device 100 updates the value of the color used to tint the application icons (e.g., and/or widgets) in accordance with the user input (e.g., based on a magnitude, direction, location and/or other properties of the detected user input 11052). In some embodiments, in response to detecting a user input 11042, such as a swipe user input, a tap user input, or other user input directed to the slider 11050, the device 100 updates a level of darkness (e.g., an amount of tint) that is applied to the application icons (e.g., and/or widgets) in accordance with the user input 11042. In some embodiments, the editing platter 11020-1 includes one or more suggested color options 11048. In some embodiments, at least one of the one or more suggested color options 11048 are sampled and/or automatically selected without user input based at least in part on one or more colors of the background of the home screen user interface 11014. In some embodiments, at least one of the one or more suggested color options 11048 are sampled and/or automatically selected without user input based at least in part on one or more colors of a housing of the computer system. In some embodiments, at least one of the one or more suggested color options 11048 are sampled and/or automatically selected without user input based at least in part on one or more colors of a case of the computer system. In some embodiments, in response to detecting a user input 11044 directed to a respective color option of the color options 11048, the color of the tint applied to the application icons (e.g., and/or widgets) is updated to the selected respective color option (e.g., and updates slider 11054 and/or slider 11050 to reflect the color value and/or level of darkness, respectively, of the color of the tint corresponding to the selected respective color option). In some embodiments, the editing platter 11020-1 includes a set of options 11046 for adjusting a light and/or dark mode to be applied to the application icons (e.g., and/or widgets). In some embodiments, the set of options 11046 includes an option for automatically switching (e.g., “Auto”) between a light and/or dark mode, without requiring additional user input, for example, switching between light and/or dark mode during certain times of the day and/or based on ambient lighting conditions detected by the device 100.

In some embodiments, in response to detecting a user input 11040 directed to the dark option 11026b, the device 100 updates the editing platter 11020-1 to editing platter 1120-2 that includes different user-adjustable controls for applying the dark option 11026b to the application icons (e.g., and/or widgets), as illustrated in FIG. 11N. In some embodiments, the adjustable controls include an option 11058 for when the dark option 11026b is to be applied to the application icons (e.g., and/or widgets), for example, whether the dark option 11026b is always applied or is applied automatically (e.g., to switch between the dark option 11026b and/or a light option 11026a) based on a time of day and/or ambient lighting conditions. For example, in response to detecting the user input 11038, such as a tap user input or a swipe user input that moves the selector to “Auto”, the device 100 determines when to apply the dark option 11026b to the application icons (e.g., and/or widgets) based on one or more conditions (e.g., time of day, ambient lighting and/or other conditions). In some embodiments, an editing platter displayed while the light option 11026a is selected includes the same options as the editing platter 11020-2 (e.g., for applying the light option to the application icons (e.g., and/or widgets) instead of the dark option). In some embodiments, in response to detecting a user input 11056 directed to the clear option 11026c, an editing platter for controlling one or more properties of the clear option 11026c to be applied to the application icons (e.g., and/or widgets) is displayed. In some embodiments, the editing platter for controlling the one or more properties of the clear option 11026c includes a user-selectable option for displaying the application icons (e.g., and/or widgets) as clear (e.g., clear simulated glass material), such as the type of simulated glass material to be displayed, including “Light” glass, “Dark” glass, and/or to automatically switch between Light and/or Dark based on one or more criteria (e.g., based on the white and/or black levels of the background, based on ambient lighting conditions, based on a time of day, and/or other criteria).

FIG. 11O illustrates a plurality of example devices that each has a different corner radius of curvature. For example, the device 100-a (e.g., a wearable device, a tablet, or other portable multifunction device) has a different corner radius of curvature than device 100-b, 100-c and device 100 illustrated, for example, in FIG. 11C. In some embodiments, a user input 11004c′ is a user input that is directed to a crown, a button, and/or the display area of device 100-a, and corresponds to a request to dismiss the wake screen user interface. In some embodiments, in response to detecting the user input 11004c′, the device 100-a performs the animation described with reference to FIGS. 11A-11F. FIG. 11O illustrates a state of the device 100-a that corresponds to the state of the device 100 illustrated in FIG. 11C. In some embodiments, the curvature of the bottom corners of the simulated glass overlay 11006′ are determined to match the curvature of the bottom corners of the device 100-a. As such, the simulated glass material overlay 11006′ has a different corner radius of curvature than the simulated glass material overlay 11006 illustrated in FIG. 11C. Similarly, FIG. 11O illustrates device 100-b in a state that corresponds to the state of the device 100 illustrated in FIG. 11C with a corner radius of curvature of the simulated glass material overlay 11006″ that is different from the corner radius of curvature of simulated glass material overlay 11006 and simulated glass material overlay 11006′. FIG. 11O further illustrates device 100-c in a state that corresponds to the state of the device 100 illustrated in FIG. 11C, where the corner radius of curvature of the simulated glass material overlay 11006′″ matches the corner radius of curvature of the bottom corners of the device 100-c, and is thus different than the corner radius of curvature of simulated glass material overlay 11006, simulated glass material overlay 11006′, and simulated glass material overlay 11006″.

FIG. 7 is a flow diagram illustrating method 7000 of changing the appearance of information on a wake screen in accordance with some embodiments. Method 7000 is performed at a computer system (e.g., device 300 of FIG. 3A or portable multifunction device 100 of FIG. 1A) that is in communication with one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, mice, joysticks, user-held and/or user-worn controllers, and/or other sensors and input devices) (e.g., touch-sensitive display system 112 of FIG. 1A, optical sensor(s) 164 of FIG. 1A, other input or control devices 116 of FIG. 1A, touchpad 355 of FIG. 3A, keyboard/mouse 350 of FIG. 3A, or sensor(s) 359 of FIG. 3A) and one or more display generation components (e.g., touch screen 112 of FIG. 1A or display 340 of FIG. 3). In some embodiments, the one or more display generation components include a display that is a touch-screen display and the one or more input devices include a touch-sensitive surface on or integrated with the display. In some embodiments, the display is separate from the touch-sensitive surface. Some operations in the described method are, optionally, combined and/or the order of some operations is, optionally, changed.

In some embodiments, the one or more input devices include one or more touch-sensitive surfaces such as touch-sensitive buttons, touch pads, touch screens, and/or other touch-sensitive input regions located on the computer system and/or are coupled to the computer system via one or more wired or wireless connections that detect user inputs based on contacts. In some embodiments, the one or more input devices includes one or more cameras that capture movement and/or gestures inputs of the user. In some embodiments, the one or more input devices include one or more microphones that detect voice inputs from the user. In some embodiments, the one or more input devices include sensors for detecting changes in position, lighting, noise, temperature, proximity of objects, activation of hardware controls, intensity of inputs, duration of inputs, and/or changes thereof, instead of and/or in addition to other input devices and/or sensors. In some embodiments, the one or more display generation components include one or more touch screen displays, head-mounted displays, heads-up displays, integrated displays, and/or standalone displays, that are used to display content and information generated by the computer system.

The devices, methods, and/or computer-readable storage mediums described below with respect to method 7000 enhance the operability of the device (e.g., the computer system) and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Performing an operation when a set of conditions has been met without requiring further user input (such as by automatically changing a spatial arrangement and/or an aspect ratio of content or other user interface elements in a system user interface or other user interface, such as a wake screen, to improve legibility) enhances the operability of the device by reducing unnecessary inputs and/or steps to navigate through different user interfaces or sets of controls, reducing energy usage by the device. Reducing the number of inputs needed to perform an operation (such as by enabling a user interface to be dismissed using a movement input such as a swipe gesture) enhances the operability of the device by reducing the number of inputs and time required to perform a particular operation and improving ergonomics, reducing energy usage by the device. Displaying user interface elements with different appearances at different times (such as when scrolling a user interface, dismissing a user interface, or displaying a simulated camera transition of content or other user interface elements in a user interface) helps to avoid image persistence or burn in effects that can occur with some display technologies when the same object is displayed with the same appearance at the same location repeatedly or for a long period of time. Restricting access to potentially sensitive information and/or compartmentalizing the information to specific devices and processes (such as when the device enters a low power state) improves privacy and security by limiting the manner in which that potentially sensitive information can be accessed. Providing improved feedback (such as by rearranging user interface elements in a user interface in response to a change in an orientation of the device) enhances the operability of the device by reducing accidental and mistaken inputs, reducing energy usage by the device. Providing additional control options (such as by enabling user interface element sizes to be increased or decreased by moving inputs in different, optionally opposite, directions) without cluttering the UI with additional displayed controls enhances the operability of the device by reducing unnecessary inputs and/or steps to navigate through different user interfaces or sets of controls, reducing energy usage by the device.

The computer system displays (7002), via the one or more display generation components, a first user interface (e.g., wake screen user interface 502, FIG. 5A). Displaying the first user interface includes (7004) concurrently displaying: first content (e.g., wallpaper, indication of current date, user interface objects such as widgets, application icons, controls, notifications, live activities that are updated based on updates from followed events); and an indication of a current time of day (e.g., an indication of a system time, local time, civil time, universal time, and/or another type of time associated with the computer system) that is updated as the current time of day changes (e.g., where the indication of the current time is a clock face with moving hands, or a digital representation of the current time that changes every minute or every second). In some embodiments, the first user interface includes a wake screen user interface, a lock screen user interface, a low power always-on user interface, and/or another system user interface that restrict access to a home screen user interface and application user interface, and need to be dismissed in order to access the home screen user interface and the application user interfaces in a normal fashion. For example, as described with reference to FIG. 5A, the wake screen user interface 502 includes a wallpaper, such as the face and tree illustrated in FIG. 5A, and time indication 506-1.

While displaying the first user interface, the computer system detects (7006) a first event (e.g., a start of a followed event causing display of a live activity object, arrival of a notification, generation of a system alert for an incoming call, a tap gesture on a touch-screen, activation of a power button, movement of the computer system from a resting position, a voice command to wake up, activation of a control displayed in the first user interface, and/or other event that causes visual changes in the first user interface). In some embodiments, the first event is detected via the one or more input devices (e.g., one or more orientation sensors, motion sensors, cameras, vibration sensors, touch-sensitive surfaces, ambient light sensors, buttons, joysticks, and/or other types of input devices). In some embodiments, the first event is detected by the operating system of the computer system through communications between one or more program processes (e.g., background program processes and/or foreground program processes, and/or software program process and/or hardware program processes) and/or via one or more communication interfaces of the computer system (e.g., I/O ports, network communication interfaces, and/or other communication interfaces). For example, as described with reference to FIG. 5A, the device 100 detects a user input 508-1 or another event, such as arrival of a notification, system alert, or live activity while displaying the wake screen user interface 502.

In response to detecting the first event (7008): the computer system displays (7010), via the one or more display generation components, a change in a spatial arrangement (e.g., a size, orientation, layout, and/or position) of the first content in the first user interface (e.g., adding, removing, and/or moving content and/or portions thereof). For example, in some embodiments, the change in the spatial arrangement of the first content in the first user interface includes adding a new notification, a live activity, an alert for an incoming call, a new navigation instruction, and/or other user interface object or content that is displayed as a result of the first event. In another example, in some embodiments, the change in the spatial arrangement of the first content in the first user interface includes moving shifting, and/or scaling a photo in the wallpaper, expanding and/or scrolling notifications and/or live activities already displayed in the first user interface, moving the first content as a whole relative to the display area provided via the one or more display generation components. In some embodiments, the addition of additional content and/or the movement of an input that is directed to the first user interface causes existing content in the first user interface to move and/or rearrange to make way for the new content and/or to respond to the movement of the input. For example, as described with reference to FIGS. 5A-5C, the foreground of the wallpaper is moved upward to prevent occlusion of the foreground of the wallpaper as the stack of notifications moves upward (e.g., and additional notifications are displayed in the wake screen user interface 502).

The computer system displays (7012), via the one or more display generation components, a change to the indication of the current time of day, including changing an aspect ratio of the indication of the current time of day (e.g., a height-to-width ratio, a thickness to width ratio, and/or another aspect ratio that specifies a two-dimensional and/or three-dimensional shape, of the indication of the current time and/or a bounding box thereof) while maintaining display of the indication of the current time of day in the first user interface, based on the change in the spatial arrangement of the first content (e.g., the movement of portions of the first content causes the indication of the current time of day to be stretched in a direction different from (e.g., perpendicular to or transverse from) the direction of the content movement, and/or squeezed in the direction of the content movement). For example, in some embodiments, while the indication of current time remains displayed and while displaying a first time value corresponding to the current time, the height of the indication is gradually shortened while its width remains unchanged or slightly increased, resulting in a change in aspect ratio for the indication, while the spatial arrangement of the first content in the first user interface is changed. In some embodiments, when the indication of current time changes its aspect ratio in the vertical direction, at least a portion of the first content moves toward the indication of current time in the vertical direction as well, e.g., in response to the detection of the first event. In some embodiments, the indication of time shows a simulated deformation analogous to a gel, a liquid, a plastic material, and/or liquid glass material deforming under the influence of some outside force. The indication of time is optionally stretching but maintaining a stroke width of the numerals (e.g., using a dynamic font that has a variable font height but a consistent stroke width). In some embodiments, the appearance and/or behavior of the indication of the current time is generated based on a user interface material that is described with respect to other portions of the present disclosure. For example, as described with reference to FIGS. 5B-5D, the time indication 506-1 decreases in height, as illustrated by time indication 506-2 and time indication 506-3, without changing a width of the time indication, thus changing an aspect ratio of the time indication 506-1.

In some embodiments, changing the aspect ratio of the indication of the current time of day while maintaining display of the indication of the current time of day in the first user interface, based on the change in the spatial arrangement of the first content, includes: in accordance with a determination that the first content has a first spatial arrangement as a result of the change in the spatial arrangement of the first content, the computer system displays, via the one or more display generation components, the indication of the current time of day with a first change in aspect ratio (e.g., a first amount of change, a first direction of change, and/or a first type of change); and in accordance with a determination that the first content has a second spatial arrangement that is different from the first spatial arrangement, as a result of the change in the spatial arrangement of the first content, the computer system displays, via the one or more display generation components, the indication of the current time of day with a second change in aspect ratio that is different from the first change in aspect ratio (e.g., a second amount of change that is different from the first amount of change, a second direction of change that is different from the first direction of change, and/or a second type of change that is different from the first type of change). For example, in some embodiments, if the spatial arrangement of the first content is changed by a first amount, the aspect ratio of the indication of the current time is updated based on the first amount of change of the spatial arrangement of the first content (e.g., as the spatial arrangement of the first content changes by a greater amount, the aspect ratio of the indication of the current time is changed by a greater amount). In some embodiments, the aspect ratio of the indication of the current time is displayed to maintain a position relative to at least a portion of the first content (e.g., the indication of the current time increases and/or decreases in size to maintain a relative relationship between the indication and a face of a subject in the first content, and/or to avoid overlapping with the face of the subject in the first content). In some embodiments, the aspect ratio of the indication of the current time continues to change through a plurality of intermediate aspect ratios while the spatial arrangement of the first content continues to change through a plurality of intermediate spatial arrangements in the first user interface. For example, as described with reference to FIGS. 5B-5D, the time indication 506-1 changes by a first amount to have the aspect ratio illustrated by time indication 506-2 based on the display of notifications 510, 512 and 514, and the time indication 506-1 changes by a second amount to have a second aspect ratio illustrated by time indication 506-3 based on the display of an additional notification 516. For example, as additional notifications are displayed (e.g., in response to a user input scrolling through the notifications), the aspect ratio of the time indication 506-1 is updated to make space in the display area for displaying additional notifications.

In some embodiments, detecting the first event includes detecting, via the one or more input devices, a movement input (e.g., a swipe input that includes movement in a first direction, such as an air swipe gesture detected by a camera, a swipe gesture by a contact moving across a touch-sensitive surface, and/or a movement of a contact along a solid state button or bezel). In some embodiments, the movement input is an upward swipe input, and in response to detecting the upward swipe input, existing content in the first user interface moves (e.g., scrolls upward, is dismissed, reflows, and/or is otherwise rearranged) and makes way for new content (e.g., additional notifications, a different portion of background content, or other content) and/or responds to the movement of the swipe input. In some embodiments, the movement input is directed toward the first user interface as a whole, a portion of the first user interface, and/or a control included in the first user interface, based on a start location of the movement input and/or another means of selecting a target of the movement input (e.g., a location of user's attention, and/or a location of input focus). In some embodiments, the movement input is associated with a respective operation based on one or more characteristics of the movement input meeting a set of criteria corresponding to the respective operation. For example, in some embodiments, a swipe input meeting first criteria causes performance of a first operation that corresponds to a first change in the spatial arrangement of the first content (e.g., a swipe input directed to a currently displayed notification scrolls the recently received notifications, and/or a swipe input directed to a currently displayed notification and includes more than a threshold amount of movements causes scroll of the recently received notifications and display of a listing of stored notifications); and a swipe input meeting second criteria, different from the first criteria, causes performance of a second operation that corresponds to a second change in the spatial arrangement of the first content that is different from the first change in the spatial arrangement of the first content (e.g., a swipe that starts from the bottom edge of the first user interface initiate a process to dismiss the first user interface. For example, as described with reference to FIGS. 5A-5B, the user input 508-1 and/or the user input 508-2 comprises a swipe gesture.

In some embodiments, the movement input corresponds to a request to dismiss the first user interface (e.g., the movement input is an upward edge swipe gesture that corresponds to a request to dismiss the wake screen user interface that includes the first content, and display a home screen user interface or another system user interface); and displaying the change in the spatial arrangement of the first content in the first user interface includes displaying, via the one or more display generation components, an animated transition to dismiss the first user interface. In some embodiments, in response to detecting the swipe input, the computer system replaces display of the first user interface with display of a second user interface (e.g., a system user interface, such as a home screen user interface, a widget screen user interface, a notification user interface, and/or a control user interface, and/or an application user interface of an application, such as a last displayed application, and/or a recommended application). In some embodiments, in response to detecting the swipe input, the computer system ceases display of the first user interface (e.g., a wake screen user interface or other system user interface), and displays another user interface different from the first user interface. In some embodiments, during at least a portion of the animated transition between displaying the first user interface and displaying the second user interface, the computer system maintains display of the indication of the current time of day while changing the spatial arrangement of the content that is included in the first user interface, and also changes the aspect ratio of the indication of the current time of day based on the change in the spatial arrangement of the content in the first user interface. For example, as described with reference to FIGS. 5M-50, the user input 530-1 (e.g., continued as user input 530-2 and user input 530-3) comprises a request to dismiss the wake screen user interface 502 and the device 100 displays an animated transition that slides the wallpaper upwards.

In some embodiments, while displaying the first user interface that includes the first content and the indication of the current time of day, the computer system detects occurrence of an event that causes (e.g., a sequence of one or more inputs that corresponds to a request for and/or a timeout that causes) the computer system to enter a low power state (e.g., a sleep state, a dimmed always-on state, and/or another power saving state in which the computer system displays a dimmed, reduced, and/or simplified wake screen user interface or a standby user interface). In some embodiments, the event that causes the computer system to enter a low power state includes prolong inactivity by a user, activation of a power button while the computer system is not in the low power state, a voice command to transition into the low power state from a normal state. In response to detecting occurrence of the event that causes the computer system to enter the low power state, the computer system modifies an appearance (e.g., gradually, through a plurality of intermediate states over a period of time) of the first content and the indication of the current time of day in accordance with a simulated camera transition relative to the first content and the indication of the current time of day (e.g., simulating a pan, zoom, whip pan and/or whip zoom, invisible whip, sky transition, shake and/or swing, and other camera transitions when switching between displaying the first user interface and the user interface of the low power mode). In some embodiments, a camera transition that is used to transition between different shots is simulated when transitioning between displaying the first content and the indication of current time of day in the first user interface to displaying a user interface corresponding to the low power state, where the angle, depth, and/or orientation of the first content and/or indication of the current time of day are changed with certain directions and/or speeds of change to create a sense of motion and dynamism and/or to reduce abruptness and confusion. In some embodiments, modifying the appearance includes a simulated camera transition effect that changes a depth of the content and/or a depth of the indication of the current time of day. For example, the animated transition comprises making the content appear to flatten. In some embodiments, modifying the appearance of the first content includes fading, dimming, or otherwise visually obscuring the first content, whereby the first content is optionally not displayed in the low power state while the indication of the current time of day continues to be displayed in the low power state. In some embodiments, the first content continues to be displayed with a modified appearance (e.g., dimmed with a decreased depth effect) in the low power state. In some embodiments, the indication of the current time of day is modified to be displayed with a decreased simulated thickness (e.g., the indication of the current time of day is displayed with a first simulated thickness while displaying the first user interface and is displayed with a second simulated thickness less than the first simulated thickness in the low power state). For example, as described with reference to FIGS. 5Q-5S, the device 100 enters a low power state (e.g., in response to detecting user input 536 or without detecting activity of the device 100 for at least a threshold amount of time), including displaying a gradual animation that includes a simulated camera transition.

In some embodiments, the movement input corresponds to a request to scroll one or more notifications in the first user interface; and displaying the change in the spatial arrangement of the first content in the first user interface includes moving one or more notifications in the first user interface and/or displaying one or more notifications that were not displayed in the first user interface at a start of the movement input (e.g., scroll one or more currently displayed notifications, expand and scroll a coalesced notification stack, moving some notifications off of a visible display area and moving one or more notifications into the visible display area, and/or displaying a plurality of stored notifications, in response to the movement input). In some embodiments, the swipe input causes the computer system to scroll a listing of currently displayed notifications and/or causes display of a plurality of previously received notifications (e.g., stored notifications and/or notification history). In some embodiments, in response to detecting the swipe input, the computer system moves one or more notifications in a direction corresponding to the direction of the movement input (e.g., toward or away from the indication of the current time of day), and during at least a portion of movement of the notifications, the computer system maintains display of the indication of the current time of day and changes the aspect ratio of the indication of the current time of day based on the movement and/or addition of the notifications in the first user interface. For example, as described with reference to FIG. 5B, the user input 508-2 corresponds to a scrolling input to scroll through the notification 510 and notification 512, including displaying an additional notification 514 in response to the scrolling input, as illustrated in FIG. 5C.

In some embodiments, the movement input includes a first portion of the movement input, and a second portion of the movement input other than the first portion of the movement input. For example, in some embodiments, the second portion of the movement input follows the first portion of the movement input. In some embodiments, the second portion of the movement input is a continuation of the first portion of the movement input in the same movement direction. In some embodiments, the movement input includes a swipe input in a first direction, where the first portion of the movement input includes an initial portion of the swipe input in the first direction and the second portion of the movement input includes a continuation of the swipe input in the first direction (e.g., upward, downward, rightward, leftward, and/or in another direction that is in the direction that aligns with the orientation of the indication of the current time of day). In some embodiments, the movement input includes a swipe gesture that includes touch down of a contact at a location that corresponds to a portion of the first content (e.g., a notification, a live activity, a background image, an alert, a control, and/or another portion of the first user interface), followed by movement of the contact in a first direction relative to the first user interface (e.g., upward, downward, rightward, leftward, and/or another direction that is in the direction that aligns with the orientation of the indication of the current time of day). In some embodiments, the first portion of the movement input corresponds to a portion of the movement input before the movement input has met movement criteria (e.g., a threshold movement distance, a threshold movement speed, and/or another threshold value of a movement characteristic of the movement input), and the second portion of the movement input corresponds to a portion of the movement input after the movement input has met the movement criteria. In some embodiments, the first portion of the movement input corresponds to a portion of the movement input before overlap criteria (e.g., a threshold amount of overlap between the indication of time and a face of a subject in the first content, and/or other criteria based on the spatial arrangement of the first content relative to the indication of current time) are met, and the second portion of the movement input corresponds to a portion of the movement input after the overlap criteria are met. In some embodiments, displaying the change in the spatial arrangement of the first content in the first user interface in response to detecting the first event includes: displaying, via the one or more display generation components, the change in the spatial arrangement of the first content (e.g., shifting an image or photo in the first user interface, relative to other content, such as user interface objects and/or a background material of the first user interface) in response to detecting the first portion of the movement input (e.g., optionally, without concurrently displaying the change to the indication of the current time, and optionally, while maintaining the aspect ratio of the indication of the current time of day). For example, in some embodiments, a position of the first user interface as a whole changes relative to the display area (e.g., appears to shift upward, shift backward and/or otherwise update) in response to the first portion of the swipe input, but a photo or image (e.g., an image of a person's face, a pet, and/or other main subjects of the photo or image) in the wallpaper of the first user interface is shifted relative to the background material and/or other user interface objects (e.g., application icons, live activities, notifications, and/or other controls) of the first user interface, in response to the first portion of the swipe input. In some embodiments, the position, orientation, and/or size of the indication of the current time is maintained relative to the display area provided via the one or more display generation components, while the first user interface and/or portions of the first content within the first user interface are shifted in response to the first portion of the movement input, resulting in a change in the spatial arrangement between the first content and the indication of the current time of day (e.g., the background material and/or other user interface object in the first user interface are shifted relative to the indication of the current time of day). In some embodiments, displaying the change in the spatial arrangement of the first content in the first user interface in response to detecting the first event includes displaying, via the one or more display generation components, the change to the indication of the current time in response to detecting the second portion of the movement input (e.g., optionally, without concurrently displaying a change in the spatial arrangement of the first content; or optionally, while continuing the change the spatial arrangement of the first content). For example, after the first portion of the swipe input that shifted background material and/or other user interface objects of the first user interface relative to the photo or image in the first user interface (e.g., resulting in a change in the spatial arrangement of the first content in the first user interface), the computer system changes an aspect ratio of the indication of the current time in response to detecting the second portion of the swipe input (e.g., in accordance with a determination that the swipe input has continued for more than a threshold amount of movement and/or at more than a threshold speed of movement, and/or in accordance with a determination that a face of a subject in the first content has at least a threshold amount of overlap with the indication of the current time). In some embodiments, the indication of the current time is also changed in position and size in addition to the change in aspect ratio, in response to the second portion of the movement input, optionally, while the computer system continues to display additional changes in the spatial arrangement of the first content. For example, in some embodiments, while the time indication changes in aspect ratio in response to detecting the second portion of the swipe input, the first content of the first user interface continues to shift in the direction of the movement input, optionally appearing to be swiped off the display area of the one or more display generation components. In some embodiments, in response to the initial portion of the movement input directed to the first user interface, the first content as a whole is scrolled and/or moved relative to the display area provided via the one or more display generation components, in accordance with the direction of the first portion of the movement input; however, the photo and/or image in the first user interface (e.g., the main subject of the wallpaper of the first user interface) temporarily stops scrolling along with the rest of the content of the first user interface when it overlaps with the indication of the current time by a threshold amount of overlap. In some embodiments, the photo and/or image is repositioned, scaled, and/or shifted relative to the other content of the first user interface, such that a key portion of the photo or image remains substantially in place relative to the display (e.g., centered and below the indication of the current time, optionally with no overlap and/or less than a threshold amount of overlap with the indication of the current time) as the rest of the first content is shifted in response to the movement input. For example, in some embodiments, the photo and/or image is shifted in position relative to the background of the wallpaper, and/or other user interface objects, such as widgets corresponding to application functions of one or more applications, one or more application icons, one or more live activities, one or more notifications, one or more shortcuts to application functions, and/or other user interface objects of the first user interface, to allow the key portion of the photo and/or image to remain substantially unobscured (e.g., centered and overlaying the indication of the current time) while the rest of the first content slide under the indication of the current time. As a result, the spatial arrangement of the first content of the first user interface is changed in response to the first portion of the movement input, in accordance with some embodiments. In addition, while the spatial arrangement of the first content is changed in the first user interface in response to the first portion of the movement input, the spatial arrangement of the indication of the current time of day remains substantially unchanged relative to the display area provided via the one or more display generation component, such that the spatial arrangement between the photo or image in the first user interface and the indication of the current time of day remains substantially unchanged during the first portion of the movement input (e.g., the main subject of the photo or image does not slide under the indication of the current time of day along with other content of the first user interface during the first portion of the movement input, the indication of current time remains above the main subject of the photo or image, while the main subject of the photo or time overlays less than a threshold amount of the indication of the current time). As the movement input continues in the same direction (e.g., while the second portion of the movement input is detected), the photo or image in the first user interface optionally shifts relative to the indication of the current time of day in the direction of the movement input, and/or catches up to the rest of the content that had already shifted in the direction of the movement input, and the indication of the current time of day is changed in aspect ratio (e.g., squeezed or stretched in the direction of the movement input), optionally before the indication of the current time of day is shifted relative to the display area along with the rest of the first user interface. In some embodiments, the image or photo optionally fades out in place (and optionally faded back in if the photo or image is also used as the wallpaper for the next user interface that is displayed after the first user interface), as the rest of the content and the indication of the current time of day are shifted out of the display area of the one or more display generation components, in response to the movement input. For example, as described with reference to FIGS. 5A-5C, initially, the subject in the photo of the wallpaper shift upward in response to detecting the user input 508-2 (e.g., a first portion of the input) without adjusting the time indication 506-1 (FIG. 5B), and as the user input 508-2 continues as user input 508-3 (e.g., a second portion of the input), the time indication 506-2 is updated (FIG. 5C).

In some embodiments, the first content includes a first subset of content (e.g., a photo or image in the first user interface, and/or a portion of the wallpaper that corresponds to a main subject, such as a person, a face, and/or a pet, of a photo or image that is used as the wallpaper) and a second subset of content (e.g., one or more widgets corresponding to subsets of application functions of one or more applications, application icons, live activities, notifications, shortcuts to application functions) different from the first subset of content; and displaying the change in the spatial arrangement of the first content includes changing a position of the first subset of content relative to the second subset of content in the first user interface, while the second subset of content is moved (e.g., moved relative to the indication of the current time of day) in response to the first portion of the movement input, wherein changing the position of the first subset of content relative to the second subset of content in the first user interface reduces visual occlusion of the first subset of content by the second subset of content during the first portion of the movement input. In some embodiments, the first subset of content includes a portion of a photo or image that corresponds to a key portion of the photo or image (e.g., a face of a person or a pet in an image used as the wallpaper of the first user interface), and the second subset of content includes one or more notifications, live activities, widgets, or other content displayed in the first user interface (e.g., overlaying portions of the wallpaper other than the key portion of the photo or image). For example, in some embodiments, in response to the first portion of the movement input, the second subset of content changes position relative to the display area based at least in part on the first portion of the movement input (e.g., the second subset of content moves in the direction of the swipe input), and the position and/or size of the first subset of content is updated (e.g., kept stationary, shifted, and/or rescaled relative to the display area) such that the second subset of content does not occlude or overlap the first subset of content by more than a threshold amount of occlusion and/or overlap (e.g., so that the face of the subject remains visible even as the second subset of content moves in accordance with the swipe input). In some embodiments, when a photo or image is used in a wallpaper of the first user interface, a first portion of the whole photo or image is visible in the wallpaper before detecting the movement input; and during the movement input and while changing the spatial arrangement of the first content in the first user interface, a second portion of the photo or image that was previously not displayed in the wallpaper (e.g., a peripheral portion of the photo or image outside of the first portion of the photo or image) is optionally displayed along with the key portion of the photo or image (e.g., a face of a subject) as the photo or image is repositioned, shifted, and/or scaled to keep the key portion of the image from being obscured by other content due to the rearrangement of the first content of the first user interface. For example, as described with reference to FIGS. 5B-5D, in some embodiments, the foreground of the wallpaper (e.g., the face) is moved upward to prevent occlusion of the foreground of the wallpaper as additional notifications are displayed in the wake screen user interface 502.

In some embodiments, detecting the movement input includes detecting, via the one or more input devices, an end portion of the movement input (e.g., after detecting the first portion and/or the second portion of the movement input, and including detecting movement beyond a threshold amount of movement and/or after a threshold amount of time since the state of the movement input, and/or, including a termination of the movement input). In some embodiments, detecting the end portion of the movement input includes detecting liftoff of a contact in a swipe gesture, detecting a cease in movement of the movement input, and/or detecting that the movement input has been maintained for at least a threshold amount of movement and/or time. In some embodiments, in response to detecting the end portion of the movement input: the computer system continues to display, via the one or more display generation components, an additional change in the spatial arrangement of the first content in the first user interface (e.g., continuing to display at least a portion of the additional change in the spatial arrangement of the first content prior to detecting a termination of the movement input; and/or continuing to display at least a portion of the additional change in the spatial arrangement of the first content after detecting a termination of the movement input); and after continuing to display the additional change in the spatial arrangement of the first content in the first user interface, reversing at least a portion of the additional change (e.g., at least a portion of the additional change displayed before the termination of the movement input, and/or at least a portion of the additional change displayed after the termination of the movement input) in the spatial arrangement of the first content in the first user interface (e.g., reversing at least a portion of the additional change in response to detecting the termination of the movement input). In some embodiments, upon detecting the end of the movement input, the first content is displayed with a rubberbanding effect. For example, the first user interface as a whole is shifted upward in accordance with the swipe input being in the upward direction, with the photo in the first user interface being kept in place or shifted to avoid overlapping with the indication of the current time and other content in the first user interface, and/or with the indication of the time being squeezed in the direction of the movement input; and at the end of the swipe input (e.g., upon liftoff of a contact of the swipe gesture, and/or upon more than a threshold amount of movement or speed having been detected), the first user interface continues to shift in the upward direction by an additional amount before the first content is shifted in an opposite direction, thereby reversing the additional change in spatial arrangement of the first content (e.g., with the spatial arrangement of the photo relative to the other content in the first user interface being restored, and with the aspect ratio of the indication of current time being restored). For example, as described with reference to FIG. 5E, a rubberbanding visual effect is displayed in response to detecting an end of the scroll user input 508-4.

In some embodiments, while displaying the first user interface, the computer system detects a second event (e.g., the same event as the first event, and/or an event other than the first event). In some embodiments, the second event is detected via the one or more input devices (e.g., one or more orientation sensors, motion sensors, cameras, vibration sensors, touch-sensitive surfaces, ambient light sensors, buttons, joysticks, and/or other types of input devices). In some embodiments, the second event is detected by the operating system of the computer system through communications between one or more program processes (e.g., background program processes and/or foreground program processes, and/or software program process and/or hardware program processes) and/or via one or more communication interfaces of the computer system (e.g., I/O ports, network communication interfaces, and/or other communication interfaces). In some embodiments, in response to detecting the second event: the computer system displays, via the one or more display generation components, a second change in the spatial arrangement (e.g., a size, orientation, layout, and/or position) of the first content in the first user interface (e.g., adding, removing, and/or moving content and/or portions thereof); and displays, via the one or more display generation components, a second change to the indication of the current time of day, including changing the aspect ratio of the indication of the current time of day (e.g., a height-to-width ratio, a thickness to width ratio, and/or another aspect ratio that specifies a two-dimensional and/or three-dimensional shape, of the indication of the current time and/or a bounding box thereof) while maintaining display of the indication of the current time of day in the first user interface, based on the second change in the spatial arrangement of the first content (e.g., the movement of portions of the first content causes the indication of the current time of day to be stretched in a direction transverse to the direction of the content movement, and/or squeezed in the direction of the content movement). In some embodiments, the second change in the spatial arrangement and the second change to the indication of the current time of day, that are displayed in response to the detection of the second event include characteristics described with respect to the change in the spatial arrangement and the change to the indication of the current time of day that are displayed in response to the detection of the first event. In some embodiments, detecting the second event includes detecting a change in an orientation of the computer system from a first orientation to a second orientation (e.g., resulting in a change in orientation of a display area provided via the one or more display generation component, from a landscape orientation to a portrait orientation, or vice versa). In some embodiments, detecting the change in orientation of the computer system includes detecting a rotation of the computer system (e.g., relative to a direction gravity, relative to a user, and/or relative to the orientation of a supporting surface), for example from a portrait orientation to a landscape orientation and vice-versa. For example, as described with reference to FIGS. 5U-5V, in some embodiments, in response to detecting a change in orientation of the device 100, the aspect ratio of the time indication 506-14 is updated to a different aspect ratio, illustrated by time indication 506-15.

In some embodiments, displaying the second change in the spatial arrangement of the first content in the first user interface includes, changing an orientation of the first content and an orientation of the indication of the current time of day (e.g., through respective separate rotations of the first content and the indication of current time) in accordance with the change in orientation of the computer system, while maintaining a spatial relationship (e.g., relative positions of the anchor points of the respective rotations) between the indication of the current time of day and a first portion of the first content (e.g., the first portion of the first content includes a key portion of an image or photo used in the wallpaper of the first user interface, such as a face of a subject, a horizon in a landscape, a landmark feature in a landscape; the first portion of the first content includes an indication of a current date in the first user interface; and/or the first portion of the first content includes another type of content that is substantially centered above and/or below the indication of the current time of day). For example, in some embodiments, when the computer system is rotated from a first device orientation to a second device orientation, the first user interface is rotated from a first user interface orientation to a second user interface orientation according to the rotation of the computer system, where the first content (e.g., background, widgets, indication of date, controls, application icons, notifications, and/or other content in the first user interface that is not the indication of the current time of day) is rotated around a first anchor point located in a key portion of the photo in the first user interface (e.g., the face of a subject of the photo, a center of a horizon line in the photo, or another key portion of the photo selected by the computer system). In some embodiments, when rotating the first content, the indication of the current time of day is also rotated separately from the first content, around a second anchor point (e.g., a center, bottom center, and/or other portion of the indication of the current time) that is kept substantially stationary and/or fixed in spatial relationship relative to the first anchor point. As a result, when the computer system is rotated triggering rotation of the first user interface, the relative spatial relationship between the indication of the current time and the key portion of the photo in the background of the first user interface remain substantially unchanged, and the key portion of the photo remains unobscured during the rotation of the device and rotation of the first user interface. For example, as described with reference to FIGS. 5U-5V, the time indication 506-15 continues to be displayed at a same relative position to the horizon line displayed in the wallpaper of the wake screen user interface.

In some embodiments, changing the aspect ratio of the indication of the current time of day while maintaining display of the indication of the current time of day in the first user interface includes changing a height of the indication of the current time of day while maintaining a width of the indication of the current time of day (e.g., elongating and/or squeezing the height of the indication of the current time, without changing the width of the indication of the current time of day). For example, the aspect ratio of the indication of the current time is changed by changing the height of the text corresponding to the indication of the current time without changing a font width of the text corresponding to indication of the current time (e.g., each character in the text is maintained with a same width even as the height of the character changes). In some embodiments, the separator(s) between the different segments of the current time of day (e.g., the “:” symbols between the hours segment and the minutes segment, and/or between the minutes segment and seconds segment) in the indication of the current time is not stretched with the different segments of the current time, and/or is stretched differently from the different segments of the current time (e.g., separation between the dots are increased or decreased while the aspect ratio of two or more dots remains unchanged). For example, as described with reference to FIG. 5C, the time indication 506-2 is updated to change in height without changing in width or font weight relative to the time indication 506-1.

In some embodiments, after displaying the change to the indication of current time of day in response to detecting the first event, the computer system detects a third event. In some embodiments, the third event is different from (e.g., an independent and separate event) the first event and/or the second event. In some embodiments, the third event is a different type of event than the first event and/or the second event (e.g., the third event corresponds to a user input and the first event and/or the second event correspond to a start of a followed event causing display of a live activity object, arrival of a notification, and/or generation of a system alert for an incoming call, or vice-versa). In some embodiments, the third event is a continuation of the first event and/or the second event (e.g., the third event corresponds to a later portion of an input and the first event and/or the second event correspond to an earlier portion of the same input). In some embodiments, in response to detecting the third event, the computer system displays, via the one or more display generation components, a third change to the indication of the current time of day that is different (e.g., different in terms of how the indication of the current time of day is changed) from the change to the indication of the current time of day displayed in response to detecting the first event (and/or that is different from the second change to the indication of the current time of day that was displayed in response to detecting the second event). For example, in some embodiments, the changes that can be applied to the indication of the current time of day in response to different portions of the same event, to different types of events, and/or to the same type of event with different amounts and/or types of first content in the first user interface, can vary. In some embodiments, the aspect ratio of the indication of the current time of day is changed while its position (and/or another characteristic of the indication of the current time of day) is maintained, in response to one event, and the position of the indication of the current time of day is changed while its aspect ratio (e.g., an original ratio, or a changed ratio due to an earlier event) is maintained in response to a subsequent event, and/or vice versa. For example, as described with reference to FIGS. 5C-5D, a size and/or aspect ratio of the time indication 506-2 is updated relative to time indication 506-2 in response to detecting the user input 508-3, and in response to detecting the user input 508-4 (e.g., a continuation of the user input 508-3, or another event), the time indication 506-3 is shifted in position within the wake screen user interface 502.

In some embodiments, displaying the first change to the indication of the current time of day includes changing a height of the indication of the current time of day (e.g., optionally without changing the width of the indication of the current time of day), resulting in a first amount of change in the aspect ratio of the indication of the current time of day; and displaying the third change to the indication of current time of day includes changing a width of the indication of the current time of day (e.g., optionally without changing a height of the indication of the current time of day), resulting in a second amount of change in the aspect ratio of the indication of the current time of day. In some embodiments, the third change to the indication of the current time of day includes changing an aspect ratio of the indication of the current time by a different amount than changing the aspect ratio of the indication of the current time of day in response to detecting the first event (e.g., the second amount of change in the aspect ratio of the indication of the current time of day is different from the first amount of change in the aspect ratio of the indication of the current time of day). For example, as described with reference to FIG. 5D, in some embodiments, the time indication 506-3 changes in width without changing in height relative to the time indication 506-2 in response to detecting the user input 508-3.

In some embodiments, displaying the first change to the indication of the current time of day includes changing the aspect ratio of the indication of the current time of day while maintaining a position of the indication of the current time of day (e.g., with an anchor position of the indication of the current time kept substantially stationary, and/or maintaining a spatial relationship between the indication of the current time of day and a key portion of a photo in the first content of the first user interface); and displaying the third change to the indication of the current time of day includes changing the position of the indication of the current time of day in the first user interface (e.g., shifting the indication of the current time in the vertical direction and/or the horizontal direction). For example, in response to detecting the third event, the indication of the current time is shifted (e.g., optionally in accordance with a detected movement of an input corresponding to the third event) within the first user interface. In some embodiments, the indication of the current time is shifted to the left and/or to the right within the first user interface. In some embodiments, the indication of the current time changes position and changes a width of the font in response to detecting the third event. In some embodiments, the indication of the current time of day changes its position to maintain a spatial relationship between the indication of the current time of day and a key portion of a photo in the background of the first user interface (e.g., to avoid more than a threshold amount of overlap between the indication of the current time of day and the key portion of the photo, to make way for the key portion of the photo as the first content including the photo is moving in the first user interface, and/or to allow the key portion of the photo to occupy a central position on the display without being obscured by the other content in the first user interface). For example, as described with reference to FIG. 5D, the position of the time indication 506-3 in the wake screen user interface 502 is updated relative to the time indication 506-2. In some embodiments, as described with reference to FIG. 5I, in response to detecting an incoming phone call, the time indication is shifted to a different position, as illustrated by time indication 506-7, that does not obscure the contact photo associated with the incoming phone call.

In some embodiments, while displaying the first user interface, the computer system detects an event that corresponds to display of additional content in the first user interface (e.g., the same event as the first event, the second event, third event, and/or an event other than the first, second, or third event); and in response to detecting the event that corresponds to display of additional content in the first user interface, the computer system displays (e.g., in conjunction with displaying the additional content in the first user interface and changing the spatial arrangement of the first content in the first user interface), via the one or more display generation components, a change to the indication of the current time of day (e.g., a change to an aspect ratio of the indication of the current time of day, such as a height-to-width ratio, a thickness to width ratio, and/or another aspect ratio that specifies a two-dimensional and/or three-dimensional shape, of the indication of the current time and/or a bounding box thereof) while maintaining display of the indication of the current time of day in the first user interface, based on display of the additional content in the first user interface (e.g., the display of the additional content causes the indication of the current time of day to be stretched in one direction, and/or squeezed in another direction). For example, in some embodiments, the additional content includes content that was not displayed prior to detecting the first event. In some embodiments, the additional content includes a new notification, a live activity that is displayed in response to a followed event becoming active, an alert for an incoming call, a new navigation instruction from a background navigation session, and/or other user interface object or content that is displayed as a result of the first event. In some embodiments, the additional content is displayed automatically without detecting additional user inputs (e.g., in response to occurrence of the first event). In some embodiments, the additional content is displayed in response to detecting a user input (e.g., the first event corresponds to a swipe input, a scroll input, or other user input), such as an expansion of a coalesced notification stack, and/or display of a notification history in response to a user input directed to the first user interface. It is to be noted that, displaying the additional content is different from navigating away from the first user interface to a second user interface different from the first user interface, as the first user interface remains displayed when the additional content is added to the existing first content of the first user interface. For example, as described with reference to FIGS. 5C, additional content, such as notifications 510, 512 and 514 are displayed while maintaining display of the time indication 506-2.

In some embodiments, detecting the event that corresponds to display of additional content in the first user interface includes detecting occurrence of an event for a new notification (e.g., generation and/or receipt of a new notification from an application, another device, a remote server, and/or an operating system process); and the computer system displays, via the one or more display generation components, the new notification in the first user interface. In some embodiments, display of the new notification in the first user interface causes the spatial arrangement of the first content in the first user interface to change, and also causes the indication of the current time to change in aspect ratio and/or position (e.g., to allow the key portion of the photo in the first user interface to remain unobscured, and/to provide additional visual feedback to the user regarding the change in the system state). For example, as described with reference to FIG. 5Q, in some embodiments, in response to detecting the arrival of notification 538, the device 100 changes the aspect ratio of the time indication 506-9′.

In some embodiments, detecting the event that corresponds to display of additional content in the first user interface includes detecting availability of an update for an ongoing activity that is followed by the computer system (e.g., generation and/or receipt of a new status update for a followed activity, from an application, another device, a remote server, and/or an operating system process); and the computer system displays, via the one or more display generation components, the update in a user interface object corresponding to the ongoing activity in the first user interface (e.g., displaying a delivery status update in a delivery live activity object, displaying a score update in a sports live activity object, and/or displaying another status update in a live activity object included in the first content). In some embodiments, display of the update in the user interface object corresponding to the live activity in the first user interface causes the spatial arrangement of the first content in the first user interface to change (e.g., due to expansion of the live activity object), and also causes the indication of the current time to change in aspect ratio and/or position (e.g., to allow the key portion of the photo in the first user interface to remain unobscured, and/to provide additional visual feedback to the user regarding the change in the system state). In some embodiments, a live activity object includes current status information for an ongoing activity that is followed by the computer system, that is updated over time (e.g., while the event is active). In some embodiments, the live activity object is displayed and/or expanded in the first user interface in response to detecting that the live activity is started, and/or is receiving updated status information. For example, as described with reference to FIG. 5F, the live activity 518 is automatically displayed in the wake screen user interface 502, and the device 100 continues to display time indication 506-4 (e.g., with a different size relative to time indication 506-1).

In some embodiments, while displaying the first user interface, the computer system detects an event that corresponds to changing a background of the first user interface (e.g., the same event as the first event, the second event, third event, and/or an event other than the first, second, or third event); and in response to detecting the event that corresponds to changing the background of the first user interface, displaying (e.g., in conjunction with changing the background of the first user interface and/or changing the spatial arrangement of the first content in the first user interface), via the one or more display generation components, a change to the indication of the current time of day (e.g., a change to an aspect ratio of the indication of the current time of day, such as a height-to-width ratio, a thickness to width ratio, and/or another aspect ratio that specifies a two-dimensional and/or three-dimensional shape, of the indication of the current time and/or a bounding box thereof) while maintaining display of the indication of the current time of day in the first user interface, based on changing the background of the first user interface (e.g., the changing the background causes the indication of the current time of day to be stretched in one direction, and/or squeezed in another direction). In some embodiments, the background of the first user interface automatically, without user input, changes based at least in part on occurrence of a time lapse event (e.g., the background changes every 1 minute, 5 minutes, 30 minutes, every day, or another amount of time). In some embodiments, the background of the first user interface changes in response to detecting a wake event (e.g., detecting a tap user input that wakes the computer system and/or detecting occurrence of an event, such as a notification or other alert, that wakes the computer system) that transitions the computer system from a low power mode (e.g., a sleep state and/or dimmed always-on state) to an active state, optionally resulting in an animated transformation of the background in the first user interface. In some embodiments, the indication of the current time displayed in the first user interface is associated with a respective background (e.g., different backgrounds are displayed with different time indications of different sizes). In some embodiments, different photos are used in different backgrounds of the first user interface, and when the background is changed, a different photo is used in the background, leading to a new key portion of the photo being used as a basis for the change to the spatial arrangement of the first content and/or the indication of the current time of day. For example, as described with reference to FIGS. 5J-5L, the background of the wake screen user interface 502 is updated while continuing to display the time indication 506-8 in FIG. 5K during an animated transition to update the background.

In some embodiments, the computer system detects, via the one or more input devices, a user input that corresponds to a request to edit the first user interface. In some embodiments, the computer system displays the first user interface in an editing mode in response to a sequence of one or more user inputs directed to the first user interface (e.g., a touch and hold input directed to a widget or a background portion of the first user interface to trigger display of an “edit” affordance, and a tap input directed to the “edit” affordance to trigger display of the first user interface in the edit mode). In some embodiments, the first user interface displayed in the edit mode allows the user to resize and/or reposition (e.g., by dragging and/or by selecting preconfigured sizes and positions for) the indication of the current time of day relative to the background of the first user interface, and/or choosing a different photo or image as the background for the first user interface. In some embodiments, the first user interface displayed in the edit mode allows the user to select the font, font size, font styles, and/or font color for the indication of the current time of day, optionally, to be associated with the background and/or the set of widgets selected for the first user interface. In some embodiments, the first user interface in the edit mode, with its current configuration for the indication of the current time of day, current background, and current set of user interface objects, is saved as a preconfigured version of the first user interface available for automatic and/or user selection as the currently displayed first user interface. In some embodiments, the first user interface in the edit mode allows the user to shift and reposition a photo to be used as a background of the first user interface relative to the indication of the current time, to establish the preferred spatial relationship between the indication of the current time of day and the key portion of the photo (e.g., a face of the subject, the horizon line, and/or a landmark or point of interest in a scene). In some embodiments, in response to detecting the user input that corresponds to the request to edit the first user interface, the computer system displays, via the one or more display generation components, an editing user interface for the first user interface (e.g., a replica of the first user interface with editing options for various portions of the first user interface) that includes the indication of the current time of day displayed in an editable state in the first user interface. For example, the editing user interface optionally includes a region for the indication of the current time that can be resized and repositioned in response to drag inputs, and optionally includes selectable options for changing a font style, a font size, a font color, and/or other visual properties of the indication of the current time of day. In some embodiments, while displaying the editing user interface for the first user interface, the computer system detects, via the one or more input devices, a user input that includes movement in a first direction (e.g., a swipe user input, a drag user input, or other selection user input that includes movement) directed to the indication of the current time of day (e.g., directed to a grabber and/or resize handle of the indication of the current time of day, and/or directed to a selectable option for altering a visual property of the indication of the current time of day); and in response to detecting the user input that includes movement in the first direction directed to the indication of the current time of day, the computer system changes a size of the indication of the current time of day in accordance with the movement in the first direction (e.g., in accordance with an amount of the movement and/or a direction of the movement). In some embodiments, the size of the indication of the current time increases in accordance with a determination that the first direction is moving away from the indication of the current time and the size of the indication of the current time decreases in accordance with a determination that the first direction is moving towards the indication of the current time. For example, as described with reference to FIGS. 5Y-5Z, in response to detecting a user input 568, such as a drag user input, the size of the time indication in reticle 566 is updated in accordance with a magnitude and/or direction of the user input 568.

In some embodiments, in response to detecting the user input that includes movement in the first direction directed to the indication of the current time of day, the computer system moves at least a first portion of the first content (e.g., by moving the photo, and/or moving the key portion of the photo, that is used as the background of the first user interface) in the first user interface relative to the indication of the current time (e.g., as the indication of the time is resized and/or repositioned relative to the first user interface), while the first portion of the first content overlays at least a portion of the indication of the current time (e.g., the key portion of the photo is not obscured by the indication of the current time when they overlap during the adjustment of the indication of the current time by the user input) and while the indication of the current time overlays a second portion of the first content that is different from the first portion of the first content (e.g., other portions of the photo outside of the key portion of the photo is obscured by the indication of the current time when they overlap during the adjustment of the indication of the current time by the user input). For example, in some embodiments, a photo is used as the background of the first user interface, with the main subject of the photo displayed at a position that overlaps with the indication of the current time, and the main subject overlaying a portion of the indication of the current time. In some embodiments, other portions of the photo overlap with the indication of the current time and underlies at least a portion of the indication of the current time. As the indication of the current time changes in size and/or position relative to the first user interface, the position and/or size of the photo are automatically updated such that the subject of the photo has substantially the same relationship with the indication of the current time (e.g., overlap by less than a threshold amount and/or aligned along a vertical central axis). In some embodiments, the main subject of the photo is separated from the background of the photo into two or more different layers, with the main subject of the photo moving in a layer overlaying the indication of the current time, and with the background of the photo moving in a layer underlying the indication of the current time (e.g., optionally along with other content of the first user interface). For example, as described with reference to FIG. 5Z2-5Z3, the star in the background is displayed as partially in front of the time indication after the time indication is resized to overlap with the star.

In some embodiments, changing the size of the indication of the current time of day in accordance with the movement in the first direction includes changing the size of the indication of the current time by an amount that is based on a value of a first characteristic of the movement (e.g., a distance, displacement, magnitude, and/or speed of the movement) in the first direction. For example, a user input that includes a greater amount of movement in the first direction causes a larger change in the size of the indication of the current time; and a user input that includes a lesser amount of movement in the first direction causes a smaller change in the size of the indication of the current time. For example, as described with reference to FIGS. 5Y-5Z3, the change in size of the time indication is based on a magnitude and/or direction of the movement of the user input 568, user input 572, user input 5002, and/or user input 5004 for resizing the time indication.

In some embodiments, the indication of the current time is displayed with an appearance that is based on a simulated visual interaction between a user interface material and the first content (e.g., simulated refraction of the first content by the user interface material; and/or other simulated visual interplay between the user interface material and the first content at and/or near the location of the user interface material). In some embodiments, the user interface material is a simulated material (e.g., a glassy material, a gelatinous material, and/or a translucent material) that simulates optical interactions (e.g., reflection, refraction, and/or transmission) with its surrounding content and/or external lighting conditions. In some embodiments, the user interface material is displayed with a non-zero thickness that is partially translucent, refracts and/or blurs the appearance of underlying user interface objects and/or the background, and/or content immediately adjacent and/or near the user interface material. In some embodiments, the indication of the current time is displayed as being made of a simulated material that has simulated interactions with virtual light and/or real light, such as a simulated glass material and/or a simulated gel material that transmits, reflects, refracts, and/or otherwise changes the behavior of simulated light that propagates in the space occupied by the simulated material. For example, as described with reference to FIG. 5A, the time indication 506-1 is displayed with a simulated glassy appearance.

In some embodiments, the computer system detects, via the one or more input devices, a user input that corresponds to a request to edit the first user interface. In some embodiments, the computer system displays the first user interface in an editing mode in response to a sequence of one or more user inputs directed to the first user interface (e.g., a long selection input such as a touch and hold input or air pinch and hold gesture directed to a widget or a background portion of the first user interface to trigger display of an “edit” affordance, and a tap input or other selection input directed to the “edit” affordance to trigger display of the first user interface in the edit mode). In some embodiments, in response to detecting the user input that corresponds to the request to edit the first user interface, the computer system displays, via the one or more display generation components, an editing user interface for the first user interface (e.g., a replica of the first user interface with editing options for various portions of the first user interface) that includes the indication of the current time of day displayed in an editable state in the first user interface, including displaying, in the editing user interface for the first user interface, a first control for selecting between a plurality of values for a degree of the simulated visual interaction between the user interface material and the first content (e.g., on which the appearance of the indication of the current time of day is based). In some embodiments, selecting different values for the degree of the simulated visual interaction between the user interface material and the first content adjusts reflection, refraction, translucency, and/or transparency of the user interface material. In some embodiments, while displaying the editing user interface for the first user interface and while displaying the indication of the current time of day with an appearance that is based on a first degree of the simulated visual interaction between the user interface material and the first content, the computer system detects, via the one or more input devices, a user input directed toward the first control (e.g., a touch input, air gesture, or other selection input, optionally including movement such as a drag gesture, to adjust the control, and/or a hardware input such as a button press or rotation of a rotatable input element). In some embodiments, the first control is an adjustable control such as a slider or wheel, with a first adjustable element, such as a slider thumb, indicating a currently selected value for a parameter (e.g., the degree of simulated visual interaction) controlled by the control. In some embodiments, a current position of the first adjustable element indicates a current value of the degree of simulated visual interaction (e.g., a slider thumb positioned along a slider at a current degree of simulated visual interaction between the user interface material and the first content). In some embodiments, in response to detecting the user input directed toward the first control, the computer system displays the indication of the current time of day with an appearance that is based on a second degree of the simulated visual interaction between the user interface material and the first content (e.g., and ceases to display the indication of the current time of day with the appearance that is based on the first degree of the simulated visual interaction between the user interface material and the first content), wherein the second degree of the simulated visual interaction is different from the first degree of the simulated visual interaction. For example, in response to detecting an input dragging a slider thumb from a first slider position corresponding to the first degree of the simulated visual interaction to a second slider position corresponding to the second degree of the simulated visual interaction (or rotation of a crown from a first crown position to a second crown position, or other input), the computer system changes the appearance of the indication of the current time of day at least in part by changing the current degree of simulated visual interaction between the user interface material and the first content from the first degree to the second degree (e.g., as described herein with reference to slider 5510 for changing the level of the optical effect in FIGS. 5AD3-5AD4).

In some embodiments, adjusting the degree of simulated visual interaction includes changing a value of a parameter that affects how a respective portion of background content (e.g., behind, adjacent to, and/or near the indication of time) is used to influence an appearance of the indication of time, where the indication of time is optionally a simulated translucent material that takes on an appearance based on the respective portion of the background content. Changing the value of the parameter includes one or more of: changing a degree to which the material changes in appearance based on a luminance of the respective portion of the background content, changing a degree of blur of the respective portion of the background content that is shown in the indication of time, changing a degree of simulated refraction of the respective portion of the background content that is shown in the indication of time, and/or changing a degree of reflection of the respective portion of the background content onto the indication of time. In some embodiments, adjusting the degree of simulated visual interaction includes changing a magnitude (e.g., size and/or visual intensity) of a simulated specular highlight along an edge of the indication of time. In some embodiments, adjusting the degree of simulated visual interaction includes changing a magnitude (e.g., size and/or visual intensity) of a simulated shadow cast by the indication of time onto the respective portion of the background content. In some embodiments, the values of one or more of these parameters are gradually adjusted (e.g., based on a magnitude of input such as movement of a touch, mouse, air gesture, and/or rotation of a rotatable input element) through a plurality of intermediate states as the control for controlling the values is adjusted (e.g., linearly or otherwise interpolating between values for the one or more different parameters. In some embodiments, the direction of adjustment of the one or more parameters is based on a direction of movement of input (e.g., movement of the touch, mouse, air gesture, or rotation of the rotatable input element in a first input direction causes a respective parameter or set of parameters to move (or change) in a first adjustment direction, and movement of the touch, mouse, air gesture, or rotation of the rotatable input element in a second input direction, different from the first input direction, causes a (or the) respective parameter or set of parameters to move (or change) in a second adjustment direction, different from the first adjustment direction).

In some embodiments, the computer system detects, via the one or more input devices, a user input that corresponds to a request to edit the first user interface. In some embodiments, in response to detecting the user input that corresponds to the request to edit the first user interface, the computer system displays, via the one or more display generation components, an editing user interface for the first user interface that includes the indication of the current time of day displayed in an editable state in the first user interface, including displaying, in the editing user interface for the first user interface, one or more controls for selecting between a plurality of values for a first tint property of the indication of the current time of day (e.g., a plurality of displayed options corresponding to respective values for the first tint property, such as color, hue, saturation, contrast, and/or other visual property, an adjustable control with an adjustable element, such as a wheel, or a slider with a slider thumb, or other control(s)). In some embodiments, while displaying the editing user interface for the first user interface and while displaying the indication of the current time of day with an appearance having a first value of the first tint property and that is based on a respective degree of the simulated visual interaction between the user interface material and the first content, the computer system detects, via the one or more input devices, a user input directed toward the one or more controls (e.g., a selection input directed to a respective option of a plurality of displayed options, a drag input directed to a slider thumb to move the slider thumb along the slider, or other input). In some embodiments, in response to detecting the user input directed toward the one or more controls, the computer system displays, via the one or more display generation components, the indication of the current time of day with an appearance having a second value of the first tint property and that is based on the respective degree (e.g., the same degree) of the simulated visual interaction between the user interface material and the first content (e.g., as described in greater detail above), wherein the second value of the first tint property is different from the first value of the first tint property. For example, as described herein with reference to FIGS. 5AD4-5AD5, a user is enabled to select a respective color option 5506 to change the time indication in reticle 566 to a tint that is based on the selected respective color option 5506. In some embodiments, the appearance of the indication of the current time of day changes from having the first value of the first tint property to having the second value of the first tint property (e.g., from a first tint color to a second tint color, or other change in tint property) without changing the degree of the simulated visual interaction between the user interface material and the first content (e.g., in FIGS. 5AD4-5AD5, changing the tint of the time indication in reticle 566 does not change the level of the optical effect nor the position of the slider thumb of slider 5510).

In some embodiments, displaying the first user interface includes concurrently displaying, via the one or more display generation components, an indication of a current date and the indication of the current time of day (e.g., optionally displayed at a position above (e.g., in the y-direction) the indication of the current time). In some embodiments, while changing a size of the indication of the current time of day by a first amount in response to detecting a respective event (e.g., the first event, the second event, the third event, and/or other events that cause a change in the size, position, and/or aspect ratio of the indication of the current time of day), the computer system changes a size of the indication of the current date by a second amount that is different from the first amount (e.g., optionally not changing the size of the indication of the current date at all, or changing the size of the indication of the current date by an amount that is smaller than the amount of change in size of the indication of the current time). For example, as described with reference to FIG. 5Z, the size of the date indication in reticle 564 is independently controlled such that resizing the time indication does not cause resizing of the date indication.

In some embodiments, detecting the first event includes detecting that a respective amount of time has elapsed (e.g., automatically increasing or decreasing a size and/or height of the indication of time over time as time elapses). In some embodiments, detecting that the respective amount of time has elapsed includes detecting that a respective time corresponding to the computer system meets a first time threshold, for example, by detecting that the current time of day reaches a respective threshold time of day, a timer for displaying the indication of the current time of day with a respective appearance elapses, or other manner of tracking the passage of time. In some embodiments, before the respective time meets the first time threshold, the indication of the current time of day is displayed with a first size and/or height, and upon the respective time meeting the first time threshold, the indication of the current time changes to being displayed with a second size and/or height that is different from (e.g., greater than or less than) the first size and/or height. Similarly, before the respective time meets the first time threshold, the first content is displayed with a first spatial arrangement (e.g., with respect to the first user interface and/or the display area provided via the one or more display generation components), and upon the respective time meeting the first time threshold, the first content is displayed with a different, second spatial arrangement (e.g., with a different size, orientation, layout, and/or position), optionally to accommodate the change in the indication of the current time of day and/or to maintain one or more aspects of a spatial relationship (e.g., positioning, ordering, overlap (and/or degree thereof) or non-overlap, and/or other spatial parameter) between the indication of the current time and the first content. In some embodiments, the spatial arrangement of the first content in the first user interface and/or the indication of the current time of day (e.g., optionally in conjunction with each other) change one or more times, and optionally repeatedly, over a period of time (e.g., every minute, every hour, each day, and/or at particular times such as sunrise, sunset, midnight, and/or user-defined times such as for work, sleep, commuting, and/or other time thresholds). In some embodiments, the indication of time gradually increases in size and/or height over a first period of time and then gradually decreases in size and/or height over a second period of time (e.g., optionally gradually oscillating back and forth over time between a larger size and/or taller height and a smaller size and/or shorter height). In some embodiments this gradual increase and then decrease in height repeats over a respective time period (e.g., one hour, one day, and/or one week). In some embodiments, in response to detecting a subsequent event involving a respective time corresponding to the computer system meeting a different, second time threshold, the computer system displays a subsequent change to the indication of the current time of day (e.g., further changing in size and/or height, or at least partially reversing the change in size and/or height performed in response to detecting the first event) and/or displays a subsequent change to the spatial arrangement of the first content in the first user interface (e.g., further changing in size, orientation, layout, and/or position, or at least partially reversing the change(s) in size, orientation, layout, and/or position performed in response to detecting the first event). In some embodiments, the indication of the current date is changed (e.g., in size, position, and/or aspect ratio) in conjunction with changing the indication of the current time of day and/or changing the spatial arrangement of the first content in the first user interface, or optionally the indication of the current date is not changed as the indication of the current time of day and/or the spatial arrangement of the first content in the first user interface are changed. In some embodiments, the change in size and/or height of the indication of time occurs when the indication of time is associated with a dynamic time setting that enables the indication of time to change automatically as time elapses. In some embodiments, the change in size and/or height of the indication of time does not occur when the indication of time is not associated with a dynamic time setting that prevents the indication of time from changing automatically as time elapses. In some embodiments, the dynamic time setting is available for some backgrounds but not for other backgrounds (e.g., for some system provided wallpapers but not for other wallpapers). Automatic changing of the size and/or height of the time indication 506 over time, optionally with corresponding automatic changes to the position, size, and/or other aspects of the wallpaper of wake screen user interface 502, and optionally in accordance with a dynamic time setting of device 100 being enabled, are described in more detail herein with respect to FIGS. 5AM-5AP.

It should be understood that the particular order in which the operations relating to FIG. 7 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 8000, 9000, and 1000) are also applicable in an analogous manner to method 7000 described above with respect to FIG. 7. For example, the user interfaces, applications, user interface objects, spatial arrangements, content, and user inputs described above with reference to method 7000 optionally have one or more of the characteristics of the user interfaces, applications, user interface objects, spatial arrangements, content, and user inputs described herein with reference to other methods described herein (e.g., methods 8000, 9000, and 10000). For brevity, these details are not repeated here.

FIG. 8 is a flow diagram illustrating method 8000 of modifying object placement regions in a wake screen in accordance with some embodiments. Method 8000 is performed at a computer system (e.g., device 300 of FIG. 3A or portable multifunction device 100 of FIG. 1A) that is in communication with one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, mice, joysticks, user-held and/or user-worn controllers, and/or other sensors and input devices) (e.g., touch-sensitive display system 112 of FIG. 1A, optical sensor(s) 164 of FIG. 1A, other input or control devices 116 of FIG. 1A, touchpad 355 of FIG. 3A, keyboard/mouse 350 of FIG. 3A, or sensor(s) 359 of FIG. 3A) and one or more display generation components (e.g., touch screen 112 of FIG. 1A or display 340 of FIG. 3). In some embodiments, the one or more display generation components include a display that is a touch-screen display and the one or more input devices include a touch-sensitive surface on or integrated with the display. In some embodiments, the display is separate from the touch-sensitive surface. Some operations in the described method are, optionally, combined and/or the order of some operations is, optionally, changed.

In some embodiments, the one or more input devices include one or more touch-sensitive surfaces such as touch-sensitive buttons, touch pads, touch screens, and/or other touch-sensitive input regions located on the computer system and/or are coupled to the computer system via one or more wired or wireless connections that detect user inputs based on contacts. In some embodiments, the one or more input devices includes one or more cameras that capture movement and/or gestures inputs of the user. In some embodiments, the one or more input devices include one or more microphones that detect voice inputs from the user. In some embodiments, the one or more input devices include sensors for detecting changes in position, lighting, noise, temperature, proximity of objects, activation of hardware controls, intensity of inputs, duration of inputs, and/or changes thereof, instead of and/or in addition to other input devices and/or sensors. In some embodiments, the one or more display generation components include one or more touch screen displays, head-mounted displays, heads-up displays, integrated displays, and/or standalone displays, that are used to display content and information generated by the computer system.

The devices, methods, and/or computer-readable storage mediums described below with respect to method 8000 enhance the operability of the device (e.g., the computer system) and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Performing an operation when a set of conditions has been met without requiring further user input (such as by automatically adding another object placement region to and/or rearranging objects already in an object placement region of a user interface to make space for moving objects in the user interface) enhances the operability of the device by reducing unnecessary inputs and/or steps to navigate through different user interfaces or sets of controls, reducing energy usage by the device. Providing additional control options (such as by enabling an object placement region to be conditionally expanded with another object placement region or not based on conditions present during movement of an additional object to the object placement region) without cluttering the UI with additional displayed controls enhances the operability of the device by reducing unnecessary inputs and/or steps to navigate through different user interfaces or sets of controls, reducing energy usage by the device. Reducing the number of inputs needed to perform an operation (such as by enabling objects to be moved in response to drag inputs) enhances the operability of the device by reducing the number of inputs and time required to perform a particular operation and improving ergonomics, reducing energy usage by the device. Displaying user interface elements with different appearances at different times (such as by enabling user interface elements to be resized) helps to avoid image persistence or burn in effects that can occur with some display technologies when the same object is displayed with the same appearance at the same location repeatedly or for a long period of time. Providing additional control options (such as by enabling user interface element sizes to be increased or decreased by moving inputs in different, optionally opposite, directions) without cluttering the UI with additional displayed controls enhances the operability of the device by reducing unnecessary inputs and/or steps to navigate through different user interfaces or sets of controls, reducing energy usage by the device. Providing improved feedback (such as by basing the appearance of controls in a user interface on the appearance of other aspects such as a background of the user interface and/or providing recommendations for the appearance of the controls) enhances the operability of the device by reducing accidental and mistaken inputs, reducing energy usage by the device.

The computer system displays (8002), via the one or more display generation components, a first user interface (e.g., a system user interface displayed in an editing mode, and/or an editing user interface for a system user interface, where the system user interface includes a lock screen user interface, a wake screen user interface, a system user interface that corresponds to a restricted state of the computer system, and/or another type of system user interface that includes an indication of current time and is displayed when the computer system exits a low power state and returns to a normal operating state). For example, as described with reference to FIG. 5Y, an editing user interface 560 for the wake screen user interface is displayed.

The first user interface includes (8004) a first object placement region that includes a first set of two or more object placement locations arranged in a first spatial arrangement (e.g., a group of two, three, four, or more object placement locations arranged in a single row, located below the indication of current time, or another arrangement of multiple object placement locations located in a region that has a first location relative to other content in the first user interface), and a second object placement region that includes a second set of two or more object placement locations arranged in a second spatial arrangement (e.g., a group of two, three, four, or more object placement locations arranged in a single row, located along the bottom portion of the first user interface, or another arrangement of multiple object placement locations located in a region that has a second location relative to other content in the first user interface).

In some embodiments, the object placement regions and object placement locations are placement regions and placement locations for a first type of objects (e.g., a type of object called “widgets” and/or a type of object that includes application icons, application shortcuts, and/or controls for adjusting a system function). In some embodiments, the first type of objects includes an application object that provides a subset, less than all, of application content and/or functionality of a corresponding application, a status indicator that corresponds to a system function, and/or a control for a system function. In some embodiments, the features described with respect to “widget placement region” and “widget placement locations” for widgets may be used to implement “object placement region” and “object placement locations” for another type of objects, such as application icons, controls, shortcuts for application functions, status indicators for system functions, controls for system functions, and/or other objects of the same type that are spatially arranged in groups in a user interface. In some embodiments, the first object placement region is located adjacent to an indication of current time that is maintained in the first user interface, and the second object placement region is located away from the indication of current time and the first object placement region, and closer to an edge of the display region provided via the one or more display generation components. In some embodiments, object placement locations included the same object placement region subject to the same object reflow process, when a new object is placed into the object placement region, an existing object is moved within the object placement region, an existing object is removed from the object placement region, and/or an existing object is resized to occupy more or fewer consecutive and adjacent object placement locations; while two sets of object placement locations included in two different object placement are not subject to the same object reflow process when a new object is placed into one of the object placement regions, an existing object is moved within one of the object placement regions, an existing object is removed from one of the object placement regions, and/or an existing object is resized to occupy more or fewer consecutive and adjacent object placement locations in one of the object placement regions. In some embodiments, the reflow of objects within a respective object placement region does not overflow into and/or impact another object placement region.

The first and second object placement regions include (8006) multiple object placement locations for placing a respective type of user interface object in the first user interface, and the respective type of user interface object is restricted from being placed outside of an object placement region for placing the respective type of user interface object (e.g., an object of the respective type of user interface object can only be displayed within an object placement location in an object placement region for its type, and cannot be placed elsewhere in the first user interface in a steady state of the first user interface). It is to be understood that these object placement regions and/or object placement locations can be unoccupied and not visually indicated in the first user interface when unoccupied, in some embodiments. In some embodiments, these object placement regions and/or object placement locations are visually indicated in an editing user interface of the first user interface, and/or in the editing mode of the first user interface, both in the occupied state and the in unoccupied state. In some embodiments, the first user interface is displayed, e.g., as an editing user interface for a system user interface and/or as a system user interface in the editing mode, in response to one or more user inputs, such as a touch and hold input directed to a portion of the system user interface (e.g., the indication of the current time, a background portion, an application icon, and/or other portions of the system user interface), a click input selecting an option that was displayed in response to a right click input directed to a portion of the system user interface, and/or another sequence of one or more inputs. In some embodiments, the computer system detects an input (e.g., a tap and hold input, a tap input, a swipe input, or another input) directed to a system user interface (e.g., a wake screen user interface and/or a settings user interface for the wake screen), and in response to detecting the input, the editing user interface for the wake screen (e.g., the first user interface) is displayed. In some embodiments, in response to detecting the input (e.g., a long press), a “customize” control is displayed and the editing user interface for the wake screen is displayed in response to detecting an input directed to the “customize” control. In some embodiments, the computer system displays an editing user interface for the home screen editing in response to detecting an input directed to the home screen (e.g., an “edit” control is displayed in response to a long press, optionally along with widget, pages, and/or icon editing options). For example, as described with reference to FIG. 5Y, reticle 562-1 (e.g., a first object placement region) includes placeholders to which widgets may be added and reticle 562-2 (e.g., a second object placement region) includes placeholders to which widgets may be added.

While displaying the first user interface, the computer system detects (8008), via the one or more input devices, a user input that corresponds to a request to move a first user interface object of the respective type of user interface object to an object placement location in the second object placement region, or a user input that corresponds to a request to move a first user interface object of the respective type of user interface object to the second object placement region more generally (e.g., the first user interface object is dragged from an object placement location in the first object placement region toward the second object placement region, and maintained over the second object placement region). In some embodiments, the request to move the first user interface object corresponds to a detected user input (e.g., a touch user input or a selection via a mouse and cursor) that selects the first user interface object and drags the first user interface object toward the second object placement region. In some embodiments, the second object placement region does not have an unoccupied object placement location at the time of the user input. In some embodiments, the second object placement region has at least one unoccupied object placement location at the time of the user input. In some embodiments, the second object placement region is completely unoccupied at the time of the user input. In some embodiments, the first user interface object was moved from an object placement location in the first object placement region by the user input. In some embodiments, the first user interface object is selected from an object selection user interface by the user input for insertion into the second object placement region. For example, as described with reference to FIG. 5AA, the device detects a user input 578 corresponding to a request to move the widget 544-3′ and in FIG. 5AC, the device 100 detects a user input 582 corresponding to a request to move the widget 544-2′.

In response to detecting the user input (8010) that corresponds to the request to move the first user interface object to an object placement location in the second object placement region: in accordance with a determination that the second set of two or more object placement locations in the second object placement region meets first criteria (e.g., the second set of two or more placement locations includes an unoccupied placement location to accommodate the first user interface object), the computer system moves (8012) the first user interface object into an object placement location in the second set of two or more object placement locations in the second object placement region (e.g., maintaining the first user interface object in the object placement location in the second set of two or more object placement locations, after the termination of the user input (e.g., liftoff of a touch user input, a release of a click and hold input via a mouse, and/or the end of a drag movement, optionally without detecting liftoff or release). In some embodiments, after the first user interface object is moved into the second object placement region, the first user interface object leaves behind at least one vacated object placement location in the first object placement region without changing the overall location of the first object placement region in the first user interface. In some embodiments, after the first user interface object is moved from the first object placement region and inserted into the second object placement region, the first object placement region may become completely unoccupied (e.g., if the first user interface object was the only object in the first object placement region prior to the movement of the first user interface object), and/or is ready to receive additional user interface objects of the respective type at the current location of the first object placement region in response to subsequent user inputs. For example, as described with reference to FIG. 5AA, widget 544-3′ is moved to an available placeholder within the reticle 562-2.

In response to detecting the user input (8010) that corresponds to the request to move the first user interface object to an object placement location in the second object placement region: in accordance with a determination that the second set of two or more object placement locations does not meet the first criteria (e.g., the second set of two or more object placement locations does not include an unoccupied placement location to accommodate the first user interface object): the computer system moves (8014) the first object placement region to a location adjacent the second object placement region (e.g., to form a new row above the second object placement region, and/or to merge the first and second object placement regions into a single object placement region with a new arrangement of placement locations); and the computer system moves the first user interface object to a placement location within a user interface object placement location in a combined object placement region including the first set of two or more object placement locations and the second set of two or more object placement locations (e.g., into a destination placement location in the original second object placement region, or in a placement location in the first object placement region after the first object placement region has been relocated as a whole, along with any objects currently placed within the first object placement region, to be adjacent the original second object placement region). For example, as described with reference to FIG. 5AC-5AD, reticle 562-1 is moved adjacent to reticle 562-2 to create a combined region, and widget 544-2′ is moved into the combined region. In some embodiments, after the combined user interface object placement region is formed and includes the user interface objects of the first object placement region, the first object placement region and/or the portion of the first user interface previously occupied by the first object placement region is no longer available for object placement (e.g., user interface objects of the respective type cannot be placed in the area corresponding to where the first object placement region was displayed prior to moving the first object placement region to a location adjacent the second object placement region, but can be placed in the area now occupied by the combined object placement region). In some embodiments, once the first object placement region is moved to a new location adjacent to the second object placement region, the first set of two or more object placement locations and the second set of two or more object placement locations are subject to the same reflow process, when a new object is placed into the combined object placement region, when an existing object is moved within the combined object placement region, when an existing object is removed from the combined object placement region, and/or when an existing object is resized to occupy more or fewer consecutive and adjacent object placement locations in the combined object placement region. In some embodiments, the first object placement region and the second object placement region still are subject to separate reflow processes, even after the first object placement region is moved to a location adjacent the second object placement region. In some embodiments, a “reflow process” describes how the computer system, in response to adding, removing, resizing, and/or moving an object within a respective object placement region, automatically, without requiring additional user input, moves and/or removes one or more other objects within the respective object placement region to, for example, create space for the added or moved object, and/or to fill up occupied placement locations within a cluster of placement locations.

In some embodiments, in response to detecting the user input that corresponds to the request to move the first user interface object to an object placement location in the second object placement region (e.g., to release the first user interface object into the second object placement region, and/or to held over the second object placement region with less than a threshold amount of movement for more than a threshold amount of time): in accordance with a determination that the second set of two or more object placement locations does not meet the first criteria, the computer system moves one or more second user interface objects present in respective object placement locations in the first object placement region, into respective placement locations in the combined object placement region. In some embodiments, all of the user interface objects that were included in the first object placement region are moved into object placement locations in the combined object placement region. For example, in some embodiments, one or more user interface objects remain in their respective object placement locations in the first object placement region as the first object placement region is moved as a whole to the location adjacent to the second object placement region, following the movement of the first user interface object into the second object placement region. For example, as described with reference to FIG. 5AD, widget 544-1′ is moved with the reticle 562-1.

In some embodiments, detecting the user input that corresponds to the request to move the first user interface object to an object placement location in the second object placement region includes, detecting, via the one or more input devices, a drag input while the first user interface object is selected (e.g., a contact that touches down at a location that corresponds to the first user interface object in the first object placement region, that is, optionally, held substantially stationary for at least a threshold amount of time to select the first user interface object, and that moves to drag the first user interface object from the first object placement region onto a portion of the second object placement region). For example, as described with reference to FIG. 5AC, user input 582 corresponds to a drag input corresponding to a request to move the widget 544-2′.

In some embodiments, detecting the drag user input includes: detecting, via the one or more input devices, a selection input that selects the first user interface object in the first object placement region; and detecting, via the one or more input devices, a movement input with a movement toward the second object placement region, while the first user interface object remains selected by the selection input. For example, the drag input includes selecting the first user interface object while the first user interface object is located within an object placement location in the first object placement region (e.g., by a touch gesture, a touch and hold gesture, an air pinch gesture while a gaze is directed to the first user interface object, and/or another type of selection input), followed by a movement of the selection input (e.g., dragging the first user interface object by moving the contact of the touch or touch and hold gesture, moving the hand while holding the air pinch gesture, and/or moving while maintaining the type of selection input) toward the second object placement region. In some embodiments, the user input that corresponds to the request to move the first user interface object to the second object placement region includes a termination of the selection input while the first user interface object is held over the second object placement region. In some embodiments, the user input does not require a termination of the selection input, as long as the first user interface object is held over the second object placement region for at least a threshold amount of time. In some embodiments, if the second object placement region is displayed near a bottom of the display area of the one or more display generation components while the first object placement region is displayed under the time indication, the drag input drags the first user interface object downward from the first object placement region toward the bottom of the display area where the second object placement region is located. For example, as described with reference to FIG. 5AC, user input 582 corresponds to a drag input corresponding to a request to move the widget 544-2′ towards the reticle 562-2.

In some embodiments, the first criteria includes a criterion that is met in accordance with a determination that the second set of one or more object placement locations includes an unoccupied object placement location that is able to accommodate (e.g., large enough for) the first user interface object. For example, if an object placement location is available within the second object placement region, the first user interface object is moved from the first object placement region into an available placement location of the second object placement region and/or into a targeted object placement location that is vacated by moving its occupant into an available placement location of the second object placement region or reflowing the existing user interface objects in the second object placement region. However, if no vacant object placement locations are available within the second object placement region, the entire first object placement region is moved to merge with the second object placement region in response to detecting the user input to move the first user interface object to the second object placement region. For example, as described with reference to FIGS. 5AA and 5AC, in response to a request to move widget 544-3′, the widget 544-3′ is moved to reticle 562-2 without moving reticle 562-1 as there is an available placeholder in reticle 562-2, whereas the request to move widget 544-2′ causes the reticle 562-1 to move as there are no available placeholders in reticle 562-2.

In some embodiments, moving the first object placement region to the location adjacent the second object placement region includes: initiating movement toward the location adjacent the second object placement region with a first magnitude (e.g., rate or amount) of movement, in accordance with a determination that the first user interface object has been moved by less than a threshold magnitude of movement (e.g., threshold speed, movement distance, distance away from the second object placement region, movement time, time held over the second placement region, and/or other threshold values) toward the second object placement region. In some embodiments, the first user interface object placement is not moving at all or is displayed as moving with a small distance and/or a slow speed, such that the first user interface object appears to resist moving in response to movement input, while the first user interface object is moved toward the second object placement region by less than a threshold distance, less than a threshold speed, and/or for less than a threshold amount of time, and/or while the first user interface object is outside of the threshold distance away from the second object placement region and/or the first user interface object is held over the second object placement region for less than a threshold amount of time. In some embodiments, moving the first object placement region to the location adjacent the second object placement region includes: continuing movement toward the location adjacent the second object placement region with a second magnitude (e.g., rate or amount) of movement that is greater than the first magnitude (e.g., rate or amount) of movement, in accordance with a determination that the first user interface object has been movement by at least the threshold magnitude of movement toward the second object placement region. In some embodiments, the first user interface object placement starts moving or is displayed as moving with a greater distance and/or a faster speed, such that the first user interface object appears to catch up with or snap to a current position of the user input that causes the movement (e.g., after the first user interface object initially appears to resist moving in response to movement input), while the first user interface object is moved toward the second object placement region by at least the threshold distance, with at least the threshold speed, and/or for at least the threshold amount of time, and/or while the first user interface object is within the threshold distance away from the second object placement region and/or the first user interface object is held over the second object placement region for at least the threshold amount of time. In some embodiments, in accordance with a determination that the first user interface object is not moved by more than the threshold amount before the end of the user input, the computer system forgoes moving the first object placement region toward the second object placement region at the second magnitude of movement (e.g., the first object placement region is maintained at its original location). For example, as described with reference to FIGS. 5AC1-5AC2, reticle 562-1 appears to drag behind or otherwise resist movement as widget 544-2′ moves toward reticle 562-2 until the widget 544-2′ travels beyond a threshold position in the user interface, and reticle 562-1 is displayed as moving faster to catch up with the widget 544-2′ before snapping into its position above reticle 562-2 illustrated in FIG. 5AD.

In some embodiments, continuing movement toward the location adjacent the second object placement region with the second magnitude of movement includes reducing a gap between the first object placement region and the first user interface object (e.g., while both the first object placement region and the first user interface object are moving, or while the first user interface object is held substantially over the second object placement region). For example, the first object placement region is moved at a faster rate to catch up to the first user interface object that has been moving toward the second object placement region, such that the first user interface object is, optionally, redisplayed at its original placement location within the first object placement region when the first object placement region completes its move to the location adjacent to the second object placement region. For example, as described with reference to FIGS. 5AC1-5AC2, reticle 562-1 is displayed as moving faster to catch up with the widget 544-2′ before snapping into its position above reticle 562-2 illustrated in FIG. 5AD.

In some embodiments, moving the first object placement region to the location adjacent the second object placement region includes snapping the first object placement region to the location adjacent the second object placement region, without requiring the user input that corresponds to the request to move the first user interface object to specify (and/or reach) the location adjacent the second object placement region. In some embodiments, the user input that corresponds to the request to move the first user interface object is a drag input that drags the first user interface object towards the second object placement region, and in response to detecting that the drag input has satisfied movement criteria (e.g., that are satisfied before the drag input is detected at the location adjacent the second user interface object placement location), the first object placement region is automatically snapped into its new position at the location adjacent the second object placement region (e.g., such that the user does not need to continue the drag input all the way to reach the location adjacent the second object placement region). In some embodiments, initiating the movement of the entire first object placement region and snapping it to its final location adjacent the second object placement region, in response to a drag input that drags the first user interface object toward the second object placement region but not necessarily near and/or over the second object placement region, allows the reposition of the second object placement region to be performed more quickly and efficient. For example, as described with reference to FIG. 5AD, in some embodiments, reticle 562-1 snaps to its position before user input 582″ reaches the position.

In some embodiments, the first user interface includes an indication of a current time of day (e.g., the indication of the current time of day is editable in the first user interface, when the first user interface is an editing user interface of a system user interface, the system user interface displayed in the editing mode, and/or when the indication of the current time of day is selected to be edited by a sequence of one or more user inputs). In some embodiments, the indication of the current time of day is displayed with one or more options for changing a font style, a size, a color, and/or other visual properties of the indication of the current time, when the indication of the current time of day is displayed in the first user interface, e.g., a system user interface in the editing mode and/or in the editing user interface of the system user interface. In some embodiments, the computer system detects, via the one or more input devices, a drag input that is directed to least a portion of the indication of the current time of day. In some embodiments, the drag input includes a touch gesture that includes touch-down of a contact at a location that corresponds to a corner, edge, and/or a resize handle of the indication of the current time and movement of the contact in a first direction across a touch-sensitive surface, an air pinch gesture that is detected while a gaze is directed to a corner, edge, and/or resize handle of the indication of the current time and movement of the hand in the pinched posture, a click input directed to a corner, edge, and/or resize handle of the indication of the current time and movement while the click input is maintained, and/or other selection input that includes movement. In some embodiments, in response to detecting the drag input that is directed to the indication of the current time of day, the computer system changes a size (e.g., overall size, height, width, spacing between time segments, and/or size of bounding box of the indication) of the indication of the current time in accordance with the drag input (e.g., in accordance with an amount of the movement and/or a direction of the movement of the drag input). In some embodiments, the size of the indication of the current time increases in accordance with a determination that the drag input includes movement in a first direction that is moving away from the indication of the current time, and the size of the indication of the current time decreases in accordance with a determination that the drag input includes movement in a second direction that is moving towards the indication of the current time. For example, as described with reference to FIGS. 5Y-5Z3, a drag input directed to the time indication in reticle 566 causes the device 100 to change a size of the time indication in accordance with the drag input.

In some embodiments, in response to detecting the drag input that is directed to the indication of the current time of day, in accordance with a determination that the indication of the current time of day is expanded (e.g., as a result of the drag input) within a threshold distance of (e.g., less than a threshold distance away from, and/or overlaps with) the first object placement region (e.g., the first object placement region that is located adjacent to the indication of the current time of day, and spaced apart from the second object placement region at the time of the drag input), the computer system moves the first object placement region (e.g., to the location adjacent the second object placement region and/or another location in the first user interface). For example, in some embodiments, in response to detecting that the indication of the current time has increased in size as a result of the drag input such that it overlaps with the first object placement region (e.g., displayed adjacent to the indication of the current time), the first object placement region is moved (e.g., pushed and/or bumped by the indication of the current time) so as to not overlap with the indication of the current time (e.g., shifted downward while remaining adjacent to the indication of the current time or moved to the location adjacent to the second user interface object placement location). In some embodiments, in response to detecting the drag input that is directed to the indication of the current time of day, in accordance with a determination that the indication of the current time of day is not expanded (e.g., as a result of the drag input) within the threshold distance of the first object placement region (e.g., the indication of the current time is shrunken, and/or expanded by not overlapping with the first object placement region), the computer system forgoes moving the first object placement region (e.g., the computer system maintains the first object placement region at its current location in the first user interface). In some embodiments, the computer system moves the first object placement region gradually in accordance with the movement of a boundary of the indication of the current time, as the boundary of the indication of the current time is shifted due to a drag input and/or other editing input (e.g., input that changes the font size and font style of the indication of the current time) that change the size of the indication of the current time, to maintain a consistent gap between the first object placement region and the indication of the current time. In some embodiments, when the size of the indication of the current time is increased by more than a threshold amount, the computer system, instead of continuing to move the first object placement region to maintain a consistent gap between the first object placement region and the indication of the current time, snaps the first object placement region to the location adjacent the second object placement region, such that the gap between the indication of the current time and the first object placement region is no longer maintained, and the first object placement region is spaced apart from the indication of the current time and, optionally, merged with the second object placement region. For example, as described with reference to FIGS. 5Z1-5Z2, in accordance with a determination that a size of the time indication has increased such that the time indication overlaps the reticle 562-1, the reticle 562-1 is automatically moved to a position proximate to the reticle 562-2.

In some embodiments, changing the size of the indication of the current time in accordance with the drag input includes: in accordance with a determination that the drag input includes movement in a first direction, changing a height of the indication of the current time in accordance with the movement in the first direction (e.g., the first direction is a vertical direction, and/or up and down direction); and in accordance with a determination that the drag input includes movement in a second direction different from the first direction (e.g., the second direction is a horizontal direction, and/or a sideways direction), changing a width and a font weight of the indication of the current time in accordance with the movement in the second direction. In some embodiments, in accordance with a determination that the drag input includes movement in a third direction different from the first direction and the second direction (e.g., the third direction is a diagonal direction that includes both horizontal and vertical components, such as in a drag input directed to a corner of the indication of the current time), the computer system changes the width, the height, and the font weight of the indication of the current time in accordance with the movement in the third direction. For example, in some embodiments, a vertical drag input directed to a corner or edge of the indication of the current time changes the height of the indication of the current time without changing the width and the font weight of the indication, a horizontal drag input directed to a corner or edge of the indication of the current time changes the width of the indication and the font weight of the indication (e.g., greater width corresponds to greater font weight, and vice versa), and/or a slanted drag input directed to a corner of the indication of the current time changes the height, width, and the font weight of the indication of the current time. For example, as described with reference to FIGS. 5Z-5Z2, the time indication changes in height and/or width based on a direction of movement of the user input (e.g., user input 572, user input 5002, or user input 5004).

In some embodiments, the first user interface includes a background (e.g., a wallpaper comprising a photo or image) that includes a subject (e.g., the background includes all or a portion of a photo with a person or pet as the subject, and/or the background includes an image that includes a key portion that is the foreground subject and other portions that are not the foreground subject). In some embodiments, when configuring the first user interface, the computer system allows a user to choose a photo or image to use as the wallpaper of the first user interface. In some embodiments, the computer system automatically scales, shifts, and crops the photo or image relative to the dimensions of the first user interface, such that a main subject of the photo or image is located in a region of the first user interface that is not obscured by other content in the first user interface. In some embodiments, the computer system automatically separates the main subject of the photo or image from other portions of the photo or image, and overlays the main subject on other content (e.g., including a portion of the indication of the current time, and/or the first object placement region) while letting other content overlay the portions of the photo or image that are not the main subject of the photo or image. In some embodiments, the computer system allows a user to manually adjust the photo or image in the wallpaper, to scale, shift, and crop the photo or image, relative to the wallpaper and the other content in the first user interface. In some embodiments, the computer system detects, via the one or more input devices, a user input (e.g., a pinch and zoom gesture, a drag input, and/or other user input) that corresponds to a request to modify the background (e.g., a request to move, zoom, resize, crop and/or otherwise modify an image used as the background, which optionally changes the spatial arrangement between a subject of the photo or image used as the background and other content in the first user interface); and in response to detecting the user input that corresponds to the request to modify the background, in accordance with a determination that the subject of the background overlaps with the first object placement region (e.g., the object placement region itself, and/or the objects currently occupying the object placement region) by more than a threshold amount of overlap (e.g., the subject of the background overlays the first object placement region and/or overlays the objects existing in the first object placement region by more than the threshold amount of overlap), the computer system moves the first object placement region (e.g., by updating the first user interface based on the change to the background, and moving the first object placement region such that the subject of the photo or image of the background overlaps with the first object placement region by less than the threshold amount of overlap). In some embodiments, the computer system snaps the first object placement region to the location adjacent the second object placement region (e.g., optionally, when the overlap cannot be reduced to less than the threshold amount of overlap by less than the threshold amount of movement) and/or shifting the object placement region to a location that does not overlap with the subject or only overlaps with the subject by less than the threshold amount of overlap (e.g., optionally, when the overlap can be reduced to less than the threshold amount of overlap by less than a threshold amount of movement). For example, as described with reference to FIG. 5AB4, in accordance with a determination that the subject of the photo 5018a overlaps with the time indication, the reticle 562-1 is automatically moved to a position immediately above reticle 562-2.

In some embodiments, in response to detecting the user input that corresponds to the request to modify the background, in accordance with a determination that the subject of the background does not overlap with the first object placement region (e.g., the object placement region itself, and/or the objects currently occupying the object placement region) by more than the threshold amount of overlap (e.g., the subject of the background does not overlay the first object placement region and/or the objects existing in the first object placement region by more than the threshold amount of overlap), the computer system forgoes moving the first object placement region (e.g., updating the first user interface based on the change to the background, and maintain the first object placement region at its current location). For example, as described with reference to FIG. 5AB3, the reticle 562-1 is not moved (e.g., to a position immediately above reticle 562-2) while the face of the photo 5018a does not overlap with the reticle 562-1.

In some embodiments, the first user interface (e.g., an editing user interface for a system user interface, such as an editing user interface for the wake screen user interface, and/or the system user interface displayed in the editing mode) includes one or more editing controls (e.g., a cancel button, a done button, and/or other buttons for changing one or more aspects of the first user interface, that are concurrently displayed with the indication of the current time, background image, object placement regions, user interface objects such as application icons, controls for system functions, shortcut for application and/or system functions, widgets, and/or other types of objects). In some embodiments, while concurrently displaying a first background of the first user interface (e.g., a wallpaper comprising an image, a photo, an album art, an animation, a color, a gradient, a pattern, a user interface material, and/or other types of backgrounds) and the one or more editing controls in the first user interface (e.g., the one or more editing controls overlay the background at different locations relative to the background), the computer system displays the one or more editing controls with a first set of control appearances (e.g., a first set of values for a first set of one or more visual properties, such as color, texture, luminance, blur, simulated refraction, simulated reflectivity, simulated glow, simulated transmissivity, translucency, and/or another visual properties), wherein the first set of control appearances are based at least in part on a first background appearance of the first background. For example, in some embodiments, the color(s) of the editing controls are colors that are similar (or alternatively, contrasting) to the colors used in the first background with the first background appearance. In another example, in some embodiments, the editing controls are translucent and/or comprise a user interface material that has appearances that simulate refraction of the first background underlying the editing controls. In some embodiments, the computer system detects one or more user inputs that correspond to a request to change a background of the first user interface from the first background to a second background with a second background appearance different from the first background appearance (e.g., by changing the color, brightness, texture, image, photo, pattern, positions and sizes of subject of the photo used in the background, and/or other visual properties of the background); and in response to detecting the user input that corresponds to the request to change to change the background of the first user interface from the first background to the second background, the computer system: concurrently displays the second background of the first user interface (e.g., a wallpaper comprising an image, a photo, an album art, an animation, a color, a gradient, a pattern, a user interface material, and/or other types of backgrounds) and the one or more editing controls in the first user interface (e.g., the one or more editing controls overlay the background at different locations relative to the background); and displays the one or more editing controls with a second set of control appearances (e.g., a second set of values for the first set of one or more visual properties), wherein the second set of control appearances are based at least in part on the second background appearance of the first background, and are different from the first set of control appearances. For example, in some embodiments, the color(s) of the editing controls are colors that are similar (or alternatively, contrasting) to the colors used in the second background with the second background appearance. In another example, in some embodiments, the editing controls are translucent and/or comprise a user interface material that has appearances that simulate refraction of the second background underlying the editing controls. For example, as described with reference to FIG. 5AB3, one or more visual properties, such as color, of the one or more controls, such as the cancel button and/or the done button, are automatically updated based on the wallpaper for the wake screen user interface.

In some embodiments, the first set of control appearances includes a first set of colors that are selected from a set of one or more prominent colors in the first background, and the second set of control appearances includes a second set of colors that are selected from a set of one or more prominent colors in the second background. In some embodiments, the prominent colors of a background are automatically identified by the computer system in accordance with a determination that the color values (e.g., RGB values or other color values) of the colors are represented in more than a threshold area of the background and/or are represented more than other colors in the background. In some embodiments, the prominent colors are identified in accordance with a determination that the colors are contrasting to the dominant colors of the background, and are accent colors in the background. For example, as described with reference to FIG. 5AB3, the color selected for the one or more controls, such as the cancel button and/or the done button is sampled from, or otherwise based at least in part on, colors in the photo 5018a that is used as the wallpaper background.

In some embodiments, the first user interface includes an indication of a current time of day and a background, and the indication of the current time of day is displayed with one or more recommended colors (e.g., with one or more font colors, and/or accent colors in the indication of the current time, and/or as recommended font colors in one or more editing controls corresponding to the indication of the current time of day) that are based at least in part on an appearance (e.g., colors, patterns, textures, and/or other visual properties) of the background. For example, in some embodiments, the indication of the current time of day is displayed with an accent color, in addition to or instead of being displayed with a user interface material (e.g., simulated glassy, translucent, and/or gelatinous material) for the different time segments of the indication of the current time. In some embodiments, the accent color of the indication of the current time is selected from a set of prominent colors of the background (e.g., main colors, colors that are in contrast to the main colors of the background, and/or colors that are similar to the main colors, that are, optionally, automatically identified by the computer system). For example, as described with reference to FIG. 5AB3, the color selected for the time indication is sampled from, or otherwise based at least in part on, colors in the photo 5018a that is used as the wallpaper background.

In some embodiments, the computer system detects, via the one or more input device, a user input directed to a respective object placement region (e.g., the first object placement region, the second object placement region, and/or the combined object placement region). In some embodiments, the user input includes a tap gesture directed to the respective object placement region (e.g., with a contact at a location of the respective object placement region, an air pinch gesture with a gaze directed to the respective object placement region, a click input while a focus selector is at the location of the respective object placement region, and/or another selection input directed to the location of the respective object placement region). In response to detecting the user input directed to the respective object placement region, the computer system displays, via the one or more display generation components, a plurality of selectable user interface objects (e.g., within a platter, menu, list, and/or other container object) that can be added as an object in an object placement location of the respective object placement region, wherein the plurality of selectable user interface objects includes a set of application content objects for one or more applications (e.g., one or more widgets that respectively include a subset, less than all, of the content and/or controls, of a corresponding application) and a set of controls corresponding to one or more functions (e.g., shortcuts to trigger respective system functions and/or application functions without launching corresponding system and/or user applications, and/or application icons corresponding to applications). In some embodiments, the set of controls corresponding to one or more functions include quick access controls, such as a control for turning on a flashlight, a control for invoking a camera of the computer system, and/or other controls for triggering various system and/or application functions. In some embodiments, the set of controls can also be added to a third object placement region that is different from the first object placement region and the second object placement region, wherein the third object placement region does not accommodate the set of application content objects for the one or more applications. In some embodiments, the computer system detects, via the one or more input devices, a user input (e.g., a tap input, a drag input, a click and drag input, and/or another type of selection input) corresponding to a request to select a respective user interface object of the plurality of selectable user interface objects; and in response to detecting the user input corresponding to the request to select the respective user interface object, the computer system adds the respective user interface object to a respective placement location in the respective object placement region. For example, in response to a user input selecting a widget of an application and/or a control for a system or application function, the selected widget and/or control is added to an unoccupied placement location included in the respective object placement region. In some embodiments, the user input is a drag input that drags the selected widget and/or control to a respective placement location to add the selected widget and/or control to that placement location. In some embodiments, if the user input drags the selected widget and/or control to a placement location that is occupied, the user interface object that occupies the placement location is automatically moved (e.g., according to a reflow process for the respective placement region) to make space for the selected widget and/or control. For example, as described with reference to FIG. 5AB, the platter that includes a plurality of selectable widgets includes one or more quick access controls.

In some embodiments, the first user interface includes an indication of a current time of day displayed with a first size (e.g., a user-selected size or a system-selected size that is based on a background). In some embodiments, the computer system displays, in the first user interface, an option for displaying the indication of the current time of day with a fixed size. In some embodiments, the computer system detects, via the one or more input devices, a user input (e.g., a tap input directed to the option, a drag input directed to the indication of the current time of day, or another user input) directed to the option for displaying the indication of the current time of day with a fixed size; and in response to detecting a user input directed to the option for displaying the indication of the current time of day with a fixed size, the computer system updates a size of the indication of the current time of day from the first size to the fixed size. For example, in some embodiments, the computer system detects selection of the selectable option while the indication of the current time is displayed with a user-selected size; and in response to detecting the selection of the selectable option, the computer system displays the indication of the current time of day with a system-selected size that is different from the user-selected size (e.g., whether the user-selected size is a first size or a second size different from the first size), and, optionally, displaying the indication of the current time at a system-selected location different from the current location of the indication of the current time (e.g., moving the indication of the current time at the system-selected size, to a location adjacent to the indication of the current date). In some embodiments, in response to detecting a user input directed to the option for displaying the indication of the current time with a fixed size, the indication of the current time is displayed in line with (e.g., adjacent to) an indication of the current date. In some embodiments, if the indication of the current time is displayed adjacent to the indication of the current date at the fixed system-selected size, the user is not enabled to drag the indication of the current time to change a size of the indication of the current time, and the size of the indication of the current time does not change in response to changes in the spatial arrangement of the other content in the first user interface (e.g., in the manners such as those described with respect to method 7000 of FIG. 7 and/or method 9000 of FIG. 9). For example, as described with reference to FIGS. 5Z3-5Z4, in some embodiments, a selectable option is displayed in the user interface 560 for displaying the time indication with a fixed size (e.g., the fixed size illustrated in FIG. 5Z4).

In some embodiments, in accordance with a determination that the first user interface is configured so that a portion of background content (e.g., a subject or foreground element in a wallpaper) is permitted to overlap with a portion (e.g., an indication of time that changes over time to indicate a current date and/or time) of the first user interface (e.g., and optionally, in accordance with a determination that first content of the first user interface overlaps with (e.g., is displayed in front of) second content of the first user interface), the computer system displays, via the one or more display generation components, the first object placement region at a first location in the first user interface (e.g., in or near a bottom portion of the first user interface, and/or away from the indication of the current time of day). In some embodiments, the computer system displays the second object placement region at a second location in the first user interface (e.g., in or near the bottom portion of the first user interface). In some embodiments, in accordance with a determination that the first user interface is configured so that a portion of background content (e.g., a subject or foreground element in a wallpaper) is not permitted to overlap with a portion (e.g., an indication of time that changes over time to indicate a current date and/or time) of the first user interface (e.g., and optionally, in accordance with a determination that the first content of the first user interface does not overlap with (e.g., is not displayed in front of) the second content of the first user interface), the computer system displays, via the one or more display generation components, the first object placement region at a location in the first user interface that is different from the first location in the first user interface (e.g., a third location, in or near a top portion of the first user interface and/or near the indication of the current time of day). In some embodiments, the computer system displays the second object placement region at a location (e.g., a fourth location) in the first user interface that is the same as or different from the second location in the first user interface (e.g., in or near the bottom portion of the first user interface). For example, as described herein with reference to FIGS. 5AB3-5AB4, because the photo 5018a used as the wallpaper has increased in size such that a subject of the photo 5018a (e.g., face 5022) overlaps with the time indication in reticle 566 (e.g., in accordance with device 100 being configured to allow overlap), reticle 562-1 is displayed at (e.g., automatically moved to) a position immediately above the reticle 562-2, instead of being displayed at a position below the time indication in accordance with face 5022 not overlapping with the time indication as in FIG. 5AB3 (e.g., in accordance with device 100 being configured to not allow overlap).

It should be understood that the particular order in which the operations relating to FIG. 8 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 9000, and 1000) are also applicable in an analogous manner to method 8000 described above with respect to FIG. 8. For example, the user interfaces, applications, user interface objects, spatial arrangements, content, and user inputs described above with reference to method 8000 optionally have one or more of the characteristics of the user interfaces, applications, user interface objects, spatial arrangements, content, and user inputs described herein with reference to other methods described herein (e.g., methods 7000, 9000, and 10000). For brevity, these details are not repeated here.

FIG. 9 is a flow diagram illustrating method 9000 of interacting with a wake screen that includes a media player and a current time in accordance with some embodiments. Method 9000 is performed at a computer system (e.g., device 300 of FIG. 3A or portable multifunction device 100 of FIG. 1A) that is in communication with one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, mice, joysticks, user-held and/or user-worn controllers, and/or other sensors and input devices) (e.g., touch-sensitive display system 112 of FIG. 1A, optical sensor(s) 164 of FIG. 1A, other input or control devices 116 of FIG. 1A, touchpad 355 of FIG. 3A, keyboard/mouse 350 of FIG. 3A, or sensor(s) 359 of FIG. 3A) and one or more display generation components (e.g., touch screen 112 of FIG. 1A or display 340 of FIG. 3). In some embodiments, the one or more display generation components include a display that is a touch-screen display and the one or more input devices include a touch-sensitive surface on or integrated with the display. In some embodiments, the display is separate from the touch-sensitive surface. Some operations in the described method are, optionally, combined and/or the order of some operations is, optionally, changed.

In some embodiments, the one or more input devices include one or more touch-sensitive surfaces such as touch-sensitive buttons, touch pads, touch screens, and/or other touch-sensitive input regions located on the computer system and/or are coupled to the computer system via one or more wired or wireless connections that detect user inputs based on contacts. In some embodiments, the one or more input devices includes one or more cameras that capture movement and/or gestures inputs of the user. In some embodiments, the one or more input devices include one or more microphones that detect voice inputs from the user. In some embodiments, the one or more input devices include sensors for detecting changes in position, lighting, noise, temperature, proximity of objects, activation of hardware controls, intensity of inputs, duration of inputs, and/or changes thereof, instead of and/or in addition to other input devices and/or sensors. In some embodiments, the one or more display generation components include one or more touch screen displays, head-mounted displays, heads-up displays, integrated displays, and/or standalone displays, that are used to display content and information generated by the computer system.

The devices, methods, and/or computer readable storage mediums described below with respect to method 9000 enhance the operability of the device (e.g., the computer system) and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Restricting access to potentially sensitive information and/or compartmentalizing the information to specific devices and processes (such as by remaining in a restricted state of the device during interaction with a media player displayed in a user interface corresponding to the restricted state such as a wake screen) improves privacy and security by limiting the manner in which that potentially sensitive information can be accessed. Reducing the number of inputs needed to perform an operation (such as by expanding the media player in response to a selection input directed toward the media player) enhances the operability of the device by reducing the number of inputs and time required to perform a particular operation, reducing energy usage by the device. Providing improved feedback (such as by expanding the media player and extending visual media for the media player to edges of the display region of the device, replacing the background of the user interface of the restricted state, in response to interaction with the media player) enhances the operability of the device by reducing accidental and mistaken inputs, reducing energy usage by the device. Displaying user interface elements with different appearances at different times (such as by displaying animated visual media for the media player) helps to avoid image persistence or burn in effects that can occur with some display technologies when the same object is displayed with the same appearance at the same location repeatedly or for a long period of time. Performing an operation when a set of conditions has been met without requiring further user input (such as by displaying elements in a user interface with the appearance of a material that includes a simulated optical effect and/or with appearances based on a background of the user interface, to automatically improve user interface legibility) enhances the operability of the device by reducing unnecessary inputs and/or steps to navigate through different user interfaces or sets of controls, reducing energy usage by the device. Providing additional control options (such as by conditionally changing position and/or size of one or more user interface elements such as the current time based on whether the media player is being repositioned while expanded or not) without cluttering the UI with additional displayed controls enhances the operability of the device by reducing unnecessary inputs and/or steps to navigate through different user interfaces or sets of controls, reducing energy usage by the device.

The computer system displays (9002), via the one or more display generation components, a first user interface that corresponds to a restricted state of the computer system (e.g., a wake screen user interface, a lock screen user interface, a coversheet user interface, a standby user interface, a widget user interface, a dimmed always-on user interface, and/or another system user interface that restricts interaction with a home screen user interface of the computer system and needs to be dismissed in order to access the home screen user interface and the application user interfaces in a normal fashion). Displaying the first user interface includes (9004) concurrently displaying: a background (e.g., a wallpaper, a photo, an image, a color gradient, and/or other types of background that is associated with the first user interface through a system setting, optionally based on prior user configuration inputs); a media player user interface object (for example, as described with reference to FIG. 5AE, a media player user interface element 610 is displayed), overlaying the background; and an indication of a current time of day (e.g., indication of a system time, local time, civil time, universal time, and/or another type of time associated with the computer system) that is updated as the current time changes (e.g., the indication of the current time is a clock face with moving hands, or a digital representation of the current time that changes every minute or every second), wherein the indication of the current time is displayed at a first size, overlaying the background, for example, as described with reference to FIG. 5AE, time indication 602-1 is displayed in the user interface 502.

In some embodiments, the background is static and does not change unless editing inputs are detected to change the background. In some embodiments, the background is automatically changed from time to time (e.g., from a first preselected background to another preselected background) based on certain conditions being met (e.g., activation and/or termination of a notification mode and/or DND mode), a change in contextual conditions, such as the location, time of day, and/or other contextual conditions. For example, as described with reference to FIG. 5AE, the background includes a star image.

In some embodiments, the media player user interface object includes one or more playback controls for controlling playback of a media item, an album art for the currently playing album, a progress bar indicating progress of the currently playing media, and/or other content corresponding to the now-playing media. In some embodiments, the media player user interface object is displayed in the first user interface when media playback is ongoing and/or was ongoing within a threshold amount of time before the current time. In some embodiments, the media player user interface object automatically ceases to be displayed after the media playback is stopped for at least the threshold amount of time. In some embodiments, the media player user interface object is displayed in the first user interface according to a system or user setting, whether or not media playback is ongoing.

While displaying the first user interface, the computer system detects (9006), via the one or more input devices, a first user input (e.g., user input 608, FIG. 5AE, or another user input) directed to the media player user interface object (e.g., a tap user input or other selection user input directed to the album art for the currently playing album displayed in the media player user interface object and/or directed to a portion of the media player user interface outside of the one or more playback controls such as an input directed to a background area of the media player user interface object).

In response to detecting the first user input directed to the media player user interface object (9008): in accordance with a determination that the first user input directed to the media player user interface object meets first criteria, wherein the first criteria require that the first user input is directed to a first portion of the media player user interface object (e.g., an unoccupied region, a region occupied by the album art, and/or a region that is not occupied by a media playback control or progress bar) in order for the first criteria to be met, while remaining in the restricted state of the computer system, the computer system concurrently displays (9010), via the one or more display generation components: visual media (e.g., a still image, animated three-dimensional images, animated sequences, and/or video images) associated with audio content that is being controlled using the media player user interface object, wherein the visual media associated with the audio content replaces display of a respective portion of (e.g., a previously visible portion of, and/or all of) the background of the first user interface (e.g., a respective portion of the background that is outside of the media player user interface object); and an indication of the current time of day at a second size that is different from the first size. For example, as described with reference to FIG. 5AF, visual media including an animated image of snowflakes falling is displayed. In addition, as described with reference to FIG. 5AF, time indication 602-2 is displayed with a different size than time indication 602-1, for example.

In response to detecting the first user input directed to the media player user interface object (9008): in accordance with a determination that the first user input directed to the media player user interface object does not meet the first criteria, while remaining in the restricted state of the computer system, the computer system forgoes (9012) replacing display of the respective portion of the background of the first user interface with the visual media associated with the audio content and forgoes changing the size of the indication of the current time of day to the second size (e.g., maintaining display of the first user interface without replacing display of the respective portion of the background of the first user interface with the visual media associated with the audio content and without changing the size of the indication of the current time of day to the second size). In some embodiments, the background of the first user interface is fully replaced by the visual media associated with the audio content, without the user explicitly reconfiguring the background of the first user interface in an editing user interface or editing mode of the first user interface, and without the computer system automatically changing the background based on satisfaction of criteria based on changes in contextual conditions. For example, as described with reference to FIGS. 5AE and 5AG, in response to detecting user input 6002, user input 6008 and/or user input 6010, the device 100 performs one or more operations without updating the wake screen user interface 502 to wake screen user interface 502′.

In some embodiments, the visual media associated with the audio content that is being controlled using the media player user interface object includes animated visual media that changes appearance over time (e.g., in a repeated animated pattern). In some embodiments, the visual media includes video content and/or an animated sequence, such as an animated version of the album art associated with the audio content. In some embodiments, the visual media includes animated and non-animated portions, for example, an enlarged version of the album art is displayed, optionally without animation, concurrently with one or more animated objects that appear to move or otherwise update around and/or behind the enlarged version of the album art, where the one or more animated objects are displayed with a background that extends to the edges of the display. In some embodiments, the animated visual media changes with a rhythm that corresponds to changes in one or more characteristics of the audio content over time. In some embodiments, when the audio content changes (e.g., changes style, genre, artist, mood, topic, and/or moves to the next audio track in the album) due to the natural progression of the audio playback in the media player user interface object, the visual media is automatically updated to correspond to the audio content (e.g., use the album art of the currently playing audio content, and/or have animated changes based on the characteristics of the currently playing audio content). For example, as described with reference to FIG. 5AF, in some embodiments, the snowflakes illustrated in wake screen user interface 502′ are animated to appear as falling or otherwise moving in the wake screen user interface 502′.

In some embodiments, the visual media associated with the audio content replaces the background and is displayed as extending to one or more edges of a display region provided via the one or more display generation components. For example, the visual media is displayed as a full screen (e.g., or mostly full screen) background in which the indication of the current time of day is displayed. In some embodiments, the visual media is displayed at a larger size than album art that was displayed within the media player user interface object, in the first user interface. For example, as described with reference to FIG. 5AF, the grey background of wake screen user interface 502′ extends to the edges of the display area of device 100.

In some embodiments, the indication of the current time is displayed with a user interface material that includes a simulated optical effect (e.g., blur, refraction, and/or reflection) along a boundary of the indication of the current time from the background and/or the visual media (e.g., based on a portion of the visual media that is outside of the boundary and/or a portion of the visual media that is inside of the boundary). For example, the user interface material is a simulated material, such as a simulated glassy, translucent and/or gelatinous material, that visually separates the indication of the current time from its surrounding content, optionally, with simulated surfaces, simulated refraction, simulated reflection, simulated shadow, and/or other simulated properties that visually separate the indication of the current time from the background and/or the visual media surrounding the indication of the current time. In some embodiments, the indication of the current time is an object comprising a translucent or transparent virtual material with a finite, non-zero thickness (e.g., a virtual gel, liquid, and/or glass material), overlaying a portion of the background and/or the visual media. In some embodiments, the indication of the current time is displayed as being made of a simulated material that has simulated interactions with virtual light, such as a simulated glass material and/or a simulated gel material that transmits, reflects, refracts, and/or otherwise changes the behavior of simulated light that propagates in the space occupied by the material. For example, as described with reference to FIG. 5A, the time indication 506-1 (e.g., as well as other time indications, including time indication 602-1 (FIG. 5AG) and time indication 602-2 (FIG. 5AF)) is displayed with a simulated material, such as a simulated glassy material.

In some embodiments, displaying the indication of the current time of day at the first size includes displaying the indication of the current time with user interface material with first simulated optical properties (e.g., simulated refraction, simulated reflection, simulated thickness, and/or simulated blurring); and displaying the indication of the current time of day at the second size includes displaying the indication of the current time with user interface material with second simulated optical properties that are different from the first simulated optical properties (e.g., different simulated refraction, simulated reflection, simulated thickness, and/or simulated blurring relative to the corresponding properties of the user interface material with the first simulated optical properties). For example, as described with reference to FIGS. 5AF, the time indication 602-2 is displayed with a different set of simulated optical properties than the time indication 602-1 (FIG. 5AE).

In some embodiments, the computer system displays, in the media player user interface object, one or more media playback controls with a user interface material (e.g., a simulated material, such as simulated glassy, translucent and/or gelatinous material). In some embodiments, the computer system detects, via the one or more input devices, a user input selecting a first playback control of the one or more media playback controls; and in response to detecting the user input selecting the first playback control, the computer system performs an operation associated with the first playback control. In some embodiments, the one or more media playback controls are displayed with a user interface material that sets off respective boundaries of the playback controls from a background material of the media player user interface object. For example, the media player user interface object includes controls such as a skip backwards control, a skip forwards control, a pause and/or play control, a volume control, and/or an output device control (e.g., headphones, speakers, and/or other connected devices); and in response to detecting the user input selecting the first playback control, an associated operation is performed (e.g., in response to selection of the skip forwards control, the device initiates playback of a next media item; in response to selection of the pause and/or play control, the device pauses and/or plays a currently played media item; in response to selection of the volume control, the device increases and/or decreases a volume of the played media item, optionally in accordance with a magnitude and/or direction of movement of the user input; and in response to selection of the output device control, the device displays a plurality of available playback devices that are selectable to change the device at which the media item is output). In some embodiments, the media player user interface object is displayed with a simulated material to appear glass-like with a non-zero thickness, such that content displayed in a background layer beneath (e.g., in the z-plane) the media player user interface object appears distorted (e.g., blurred, refracted, reflected, or otherwise modified) where the media player user interface object overlaps with the content. In some embodiments, the controls within the media player user interface object (e.g., including one or more buttons, affordances and/or toggles) are displayed with a user interface material that is a simulated glassy, translucent and/or gelatinous material with a non-zero thickness, such that each control is displayed with a respective simulated three-dimensional volume defined by a respective boundary that embodies the respective control. For example, as described with reference to FIG. 5AE, in some embodiments, the one or more controls in the media player user interface element 610 are displayed with a simulated glass material.

In some embodiments, while displaying the media player user interface object in the first user interface with the background, the one or more media playback controls are displayed with a first set of control appearances, wherein the first set of control appearances are based on an appearance of the background (e.g., based on simulated interactions such as blurring, reflection, and/or refraction between the user interface materials of the controls and the appearance of the underlying portions of the background); and while displaying the media player user interface object in the first user interface with the visual media associated with the audio content that is being controlled using the media player user interface object, the one or more media playback controls are displayed with a second set of control appearances, wherein the second set of control appearances are based on an appearance of the visual media, and are different from the first set of control appearances (e.g., changes with the changes in the appearance of the visual media). For example, in some embodiments, content displayed in a background layer beneath (e.g., in the z-plane) the media playback controls within the media player user interface object appears distorted (e.g., blurred, refracted, reflected, or otherwise modified). In some embodiments, as the background content changes (e.g., from displaying the first user interface with the background to displaying the visual media underneath the media player user interface object), the content that appears beneath the respective media playback controls changes, such that the appearance of the media playback controls is updated to show distorted versions of the content that is currently beneath the media playback controls. For example, in some embodiments, a first playback control is displayed with a first visual appearance that includes a distorted version of the first content that is beneath the first playback control in the first user interface; after the first user interface is updated to display the visual media, the first playback control overlaps with second content different from the first content such that the first playback control is displayed with a second visual appearance that includes a distorted version of the second content that is beneath the first playback control. In some embodiments, the media playback controls overlay a user interface material of the media player user interface object which is also translucent and distorts the appearance of the content underneath, so the appearance of the media playback controls is based on a further distortion of the distorted version of the content underneath the media player user interface object. For example, as described with reference to FIGS. 5AF-5AF1, the one or more controls (e.g., and/or the media player user interface element 610) are updated as the animation of the background content causes different portions of the background content to be positioned as overlapping with or near the one or more controls.

In some embodiments, while displaying the one or more media playback controls with the user interface material, the computer system detects occurrence of an event corresponding to a change in appearance of the background (e.g., a change in media item being played, a user input moving the media playback controls, a user input interacting with one or more of the media playback controls, and/or animation of an animated background); and in response to detecting occurrence of the event corresponding to the change in appearance of the background, the computer system updates an appearance of the user interface material to show a simulated lighting effect (e.g., a reflection and/or refraction of content from the background that changes over time based in changes in the background) based on the change in appearance of the background. For example, as an animation of album art for the media item progresses, a specular highlight and/or refraction changes to track progression of the animation (e.g., movement of one or more visual elements) in the animation. Similar effects are, optionally, displayed when album art changes between different media items. Additionally when a user interacts with the media player controls, the computer system optionally changes a simulated position, size, and/or thickness of the media player controls and adjusts a specular highlight and or refraction in the UI material that makes up the media player controls to illustrate the change. For example, as described with reference to FIGS. 5AF-5AF2, specular highlights 6012 are updated to specular highlights 6012′ in accordance with a determination that the song has changed from Song A to Song B, and the representation of the currently playing song is updated. As described with reference to FIG. 5AF2, in some embodiments, the specular highlights 6012′ are updated to specular highlights 6012″ in accordance with the animation that causes different portions of the content (e.g., the animated musical notes that change position) to interact with the media player user interface element 610.

In some embodiments, the visual media associated with the audio content includes automatically generated (e.g., without user input) content that is generated (e.g., with simulated reflection, blurring, refraction, mirroring, and/or other techniques) based at least in part on one or more properties of visual content (e.g., colors, text, images and/or other properties of the album art) displayed in the media player user interface object. In some embodiments, the content that is generated includes reflected, blurred and/or otherwise modified version of the visual content displayed in the media player user interface object. For example, the album art is displayed with a first size that optionally does not extend to the edge(s) of the one or more display generation components, and the computer system automatically generates additional content, such as reflected and/or blurred version of the album art, that is expanded to extend to the edge(s) of the one or more display generation components. In some embodiments, the automatically generated content is extended to one or more edges of the one or more display generation components. For example, as described with reference to FIG. 5AF, in some embodiments, the device 100 automatically generates the representation of the currently playing media item displayed in the wake screen user interface 502′ by reflecting, blurring, or otherwise modifying the representation 606 of the cover art.

In some embodiments, the media player user interface object includes a representation of a currently playing media content item (e.g., an album art, a visual representation of the currently playing media item, and/or another visual representation of the currently playing media content); and the first user input directed to the media player user interface object includes an input (e.g., a tap input, an air pinch gesture, a click input, and/or other selection input) directed toward (e.g., selecting) the representation of the currently playing media content item. For example, in some embodiments, the first user input selects the album art that is displayed in the media player user interface object, and in response to the first user input, the album art is expanded and/or modified into the visual media that replaces all or a substantial portion of the background of the first user interface outside of the media player user interface object. In some embodiments, the media player user interface object ceases to be displayed, and only one or more playback controls remain displayed overlaying the visual media. In some embodiments, other content of the first user interface, such as notifications, widgets, controls for system functions, are also removed from the first user interface, when the visual media is displayed with the indication of the current time of day. For example, as described with reference to FIG. 5AE, in response to detecting the user input 608 selecting the representation 606 of the cover art of Song A, the device 100 displays the wake screen user interface 502′.

In some embodiments, while displaying the first user interface including the indication of the current time of day (e.g., with the background or with the visual media associated with the audio content controlled by the media player user interface object), the computer system detects, via the one or more input devices, a user input (e.g., a drag input, a swipe input, a click and drag input, an air pinch and drag input, and/or other user input directed to the media player user interface object or detected while attention is directed to the media player user interface object) corresponding to a request to change a position of the media player user interface object from a first position to a second position in the first user interface; and in response to detecting the user input that corresponds to the request to change the position of the media player user interface object from the first position to the second position in the first user interface: in accordance with a determination that the background is displayed in the first user interface (e.g., before detecting the first user input), the computer system updates a position and/or size of the indication of the current time of day. For example, in response to detecting a request to move the media player user interface object within the first user interface, in accordance with a determination that the media player user interface object is to be moved to a position that overlaps with the indication of the current time of day, the indication of the current time of day is updated (e.g., as described with reference to method 7000 of FIG. 7) to decrease in size and/or change position such that the indication of the current time of day does not overlap with the media player user interface object by more than a threshold amount at the new position of the media player user interface object. For example, as described with reference to FIGS. 5AG-5AI, in response to detecting the user inputs 6002, 6002′ and 6002″, the time indication 602-1 decreases in size and optionally scrolls upward as the media player user interface element 610 moves upward in the wake screen user interface 502. In response to detecting the user input that corresponds to the request to change the position of the media player user interface object from the first position to the second position in the first user interface: in accordance with a determination that the visual media is displayed in the first user interface (e.g., after the background is replaced by the visual media corresponding to the audio content that is controlled by the media player user interface object), the computer system maintains display of the indication of the current time of day at a current size and a current position of the indication of the current time of day. For example, in some embodiments, if the time indication is already displayed in a minimized state (e.g., in response to detecting the first user input), the media player user interface object displayed at its new position does not overlap with the time indication by more than the threshold amount of overlap, and the position and/or size of the time indication is not updated when the media player user interface object is moved in the first user interface. In some embodiments, even if the indication of the current time does overlap with the media player user interface object by more than the threshold amount of overlap when the visual media is displayed, the computer system still does not change the size and/or position of the indication of the current time. For example, as described with reference to FIGS. 5AJ-5AL, the time indication 602-2 does not change in size and/or position as the media player user interface element 610 moves upward in the wake screen user interface 502′.

It should be understood that the particular order in which the operations relating to FIG. 9 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, and 1000) are also applicable in an analogous manner to method 9000 described above with respect to FIG. 9. For example, the user interfaces, applications, user interface objects, content, and user inputs described above with reference to method 9000 optionally have one or more of the characteristics of the user interfaces, applications, user interface objects, content, and user inputs described herein with reference to other methods described herein (e.g., methods 7000, 8000, and 10000). For brevity, these details are not repeated here.

FIG. 10 is a flow diagram illustrating method 10000 of displaying live activity status information in a wake screen in accordance with some embodiments. Method 10000 is performed at a computer system (e.g., device 300 of FIG. 3A or portable multifunction device 100 of FIG. 1A) that is in communication with one or more display generation components (e.g., touch screen 112 of FIG. 1A or display 340 of FIG. 3) and optionally one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, mice, joysticks, user-held and/or user-worn controllers, and/or other sensors and input devices) (e.g., touch-sensitive display system 112 of FIG. 1A, optical sensor(s) 164 of FIG. 1A, other input or control devices 116 of FIG. 1A, touchpad 355 of FIG. 3A, keyboard/mouse 350 of FIG. 3A, or sensor(s) 359 of FIG. 3A). In some embodiments, the one or more display generation components include a display that is a touch-screen display and the one or more input devices include a touch-sensitive surface on or integrated with the display. In some embodiments, the display is separate from the touch-sensitive surface. Some operations in the described method are, optionally, combined and/or the order of some operations is, optionally, changed.

The devices, methods, and/or computer-readable storage mediums described below with respect to method 10000 enhance the operability of the device (e.g., the computer system) and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing additional control options (such as by determining whether to display, in a system user interface, multiple active session status elements, optionally for related background activities, or an expanded user interface for a single active session, in response to the detection of occurrence of a respective event) without cluttering the user interface with additional displayed controls enhances the operability of the device by reducing unnecessary inputs and/or steps to navigate through different user interfaces or sets of controls, reducing energy usage by the device. Performing an operation when a set of conditions has been met without requiring further user input (such as by displaying status information about an active session of a respective application in a system user interface or a status region while the active session is ongoing, if a user interface of the respective application is not otherwise displayed and one or more other system user interfaces and/or application user interfaces are displayed instead; by automatically expanding a set of status elements of related active sessions in response to an event occurring in at least one of the active sessions such as a change in state or an input directed to a status element; or by automatically ending an active session that has been paused for too long and/or automatically ceasing to display the status element for an active session that has ended) enhances the operability of the device by reducing unnecessary inputs and/or steps to navigate through different user interfaces or sets of controls, reducing energy usage by the device. Displaying user interface elements with different appearances at different times (such as by switching between displaying a representation of an application and displaying an indication of progress of an associated active session, or displaying a thumbnail or other representation of content involved in an active session and optionally updating the representation over time) helps to avoid image persistence or burn in effects that can occur with some display technologies when the same object is displayed with the same appearance at the same location repeatedly or for a long period of time. Providing improved feedback (such as by concurrently displaying distinct status elements for active sessions that are not related) enhances the operability of the device by reducing accidental and mistaken inputs, reducing energy usage by the device. Reducing the number of inputs needed to perform an operation (such as by displaying an option to collapse a set of status elements of related active sessions, displaying in a status element of an active session respective affordances for controlling the active session, or automatically navigating to a user interface in a portion of an application that is related to an active session in response to an input directed toward a status element for the active session) enhances the operability of the device by reducing the number of inputs and time required to perform a particular operation, reducing energy usage by the device.

The computer system displays (10002), displays, via the one or more display generation components, a system user interface (e.g., that corresponds to a restricted state of the computer system). Displaying the system user interface includes (10004) concurrently displaying: first content (e.g., wallpaper, an indication of a current date, an indication of a current time of day, widgets, application icons, controls, notifications, and/or other content); and a first status element that includes first status information about a first active session of a first application (e.g., executing on the computer system as a background process). The first status information in the first status element is updated over time while the first active session is ongoing (e.g., dynamically updated with current status information provided by the first software application as the first active session continues to execute). For example, wake screen user interface 6142 of FIG. 6J includes a background (e.g., wallpaper, such as a photo, image, pattern, or other media content, such as the face, animal, and tree in FIG. 6J) and live activity user interface elements 6144, 6146, and 6148.

The computer system detects (10006) occurrence of an event corresponding to the first active session (e.g., by detecting, via one or more input devices of the computer system, an input directed toward the first status element representing the first active session, or detecting a start or end of the first active session or similar change in state, such as a content transition such as between playback of different songs, or other event). In some embodiments, the event is detected while displaying the system user interface with the first status element.

In response to detecting the occurrence of the event corresponding to the first active session (10008): in accordance with a determination that respective criteria are met, wherein the respective criteria include a requirement that a second active session of a second application is executing on the computer system (e.g., as a background process), wherein the second application is different from the first application, and that the second active session is related to the first active session in order for the respective criteria to be met, the computer system concurrently displays (10010) in the system user interface, via the one or more display generation components: the first status element (e.g., that includes the first status information about the first active session); and a second status element that includes second status information about the second active session, wherein the second status information in the second status element is updated over time while the second active session is ongoing (e.g., dynamically updated with current status information provided by the second software application as the second active session continues to execute). For example, in response to detecting user input 6140 directed toward live activity user interface element 6146 in FIG. 6J, device 100 displays both live activity user interface element 6146 and a second live activity user interface element 6152, among others, in FIG. 6K. In another example, in response to detecting a change in state of a live activity that is associated with stack 6150 and related to the live activity of live activity user interface element 6152 in FIG. 6N, device 100 displays both live activity user interface element 6152 and live activity user interface element 6154 in FIG. 6O. In yet another example, in response to detecting a change in state of a live activity that is associated with stack 6150 and related to the live activity of live activity user interface element 6156 in FIG. 6W, device 100 displays both live activity user interface element 6156 and live activity user interface element 6197 in FIG. 6X.

In response to detecting the occurrence of the event corresponding to the first active session (10008): in accordance with a determination that the respective criteria are not met (e.g., a second active session of a second application that is different from the first application is not executing on the computer system or is not related to the first active session), the computer system displays (10012) in the system user interface, via the one or more display generation components, an expanded user interface corresponding to the first active session without displaying the second status element (e.g., continuing to display the user interface that corresponds to the restricted state of the computer system and changing the first status element to an expanded status element that includes additional status information about the first active session, the additional status information being different from and optionally a superset of the first status information, or replacing the user interface that corresponds to the restricted state of the computer system with a user interface of an application corresponding to the first active session). For example, in response to detecting user input 6122 directed toward live activity user interface element 6104, which is not related to other ongoing live activities on device 100, device 100 expands live activity user interface element 6104 to display expanded live activity user interface element 6124. In some embodiments, device 100 would similarly expand live activity user interface element 6144 in wake screen user interface 6142 in FIG. 6J in response to a user input directed toward live activity user interface element 6144 or a change in state of the corresponding live activity (e.g., an end of the timer). Similarly, device 100 would in some embodiments expand live activity user interface element 6156 in wake screen user interface 6142 in FIG. 6AB in response to a user input directed toward live activity user interface element 6156 or a change in state of the corresponding live activity (e.g., failure or an end of the movie rendering), because live activity user interface element 6156 in FIG. 6AB has no related ongoing live activities (e.g., and is displayed without the stack 6150 appearance).

In some embodiments, the first active session and the second active session are related based on being the same type of operation or activity (e.g., background activities, file downloads, file transfers, media playback, timers, navigation, live sporting event updates, or other type of activity) from different applications. In some embodiments, active sessions are related based on being the same type of operation from different applications and/or being operations (e.g., the same type or different types) of the same software application.

In some embodiments, the first active session is a first background process executing on the computer system (e.g., photo sharing, video processing, file transfer, and/or content downloading); and the second active session includes a second background process executing on the computer system, wherein the second background process is different from the first background process (e.g., photo sharing, video processing, file transfer, and/or content downloading). In some embodiments, the first active session is a first instance of a respective type of background process, and the second active session is a second instance of the respective type of background process (e.g., the different active sessions correspond to different photos being shared, different videos being processed, different files being transferred, and/or different content being downloaded, concurrently or at least partially overlapping in time). For example, FIGS. 6A-6AC illustrate various examples of background processing activities including television series downloading, music album downloading, photo album downloading, movie rendering, and game schedule downloading.

In some embodiments, while displaying a respective user interface that is different from the system user interface (e.g., an application user interface or a different system user interface), the computer system detects occurrence of an event corresponding to a request to display the system user interface (e.g., by detecting, via the one or more input devices, an input corresponding to a request to display a home menu user interface, an input corresponding to a request to display a user interface that corresponds to a restricted state of the computer system, or detecting the elapsing of a threshold amount of time following which the computer system automatically transitions to the restricted state, or other event). In some embodiments, displaying the first status element in the system user interface is performed in response to detecting the occurrence of the event corresponding to a request to display the system user interface. For example, live activity user interface element 6146 is displayed in wake screen user interface 6142 in response to device 100 detecting user input 6140 corresponding to a request to display wake screen user interface 6142, in response to device 100 detecting a user input (e.g., user input 536 of FIG. 5Q) directed to a button for putting device 100 into the standby mode, or in accordance with the device 100 automatically, without user input, entering the standby mode in accordance with a determination that a threshold amount of time has passed without activity of the device 100 (e.g., without detecting user interaction, providing notifications, or performing other activities).

In some embodiments, while displaying the system user interface (e.g., including the first status element or the expanded user interface corresponding to the first active session), the computer system detects, via the one or more input devices, an input corresponding to a request to display a respective user interface of respective software (e.g., a touch input and/or air gesture directed toward a representation of the respective software such as an application icon or notification for the respective software, a gesture for dismissing the system user interface where dismissing the system user interface results in the respective user interface of the respective software being displayed instead, and/or other input), wherein the respective user interface is different from the system user interface and the respective software is different from the first application (e.g., the respective user interface is a different system user interface, such as a home menu user interface, control user interface, dashboard or widget user interface; or the respective user interface is an application user interface of an application that is different from the first application). In some embodiments, in response to detecting the input corresponding to the request to display the respective user interface of the respective software, the computer system ceases to display the system user interface (e.g., including ceasing to display the first status element) and concurrently displays, via the one or more display generation components: in a first display region of a display area of the one or more display generation components, first session information corresponding to the first active session of the first application; and in a second display region of the display area, wherein the second display region is adjacent to (e.g., at least partially surrounds) the first display region, the respective user interface of the respective software (e.g., without displaying the first status information about the first active session of the first application in the second display region of the display area). In some embodiments, the first session information is different from, and optionally is a subset of, the first status information about the first active session of the first application that is displayed in the first status element. In some embodiments, the first session information includes status information about an active session that is related to the first active session. For example, device 100 displays live activity user interface element 6176 for the photo album downloading operation in the status region in FIG. 6S (e.g., instead of live activity user interface element 6154 in wake screen user interface 6142 as in FIG. 6R) while displaying, in FIG. 6S, application user interface 6172 for an application other than the photos application (e.g., rather than wake screen user interface 6142), or in some embodiments while displaying a system user interface other than wake screen user interface 6142, such as home screen user interface 532 of FIG. 5P.

In some embodiments, while concurrently displaying the first session information in the first display region and the respective user interface of the respective software in the second display region, the computer system detects occurrence of an event corresponding to the first session information (e.g., by detecting occurrence of an input, such as a touch input or air gesture, directed toward the first session information, or detecting occurrence of an event such as a change in state of the first active session or of an active session that is related to the first active session, even if status information about the related active session is not itself displayed in the first display region). In some embodiments, in response to detecting the occurrence of the event corresponding to the first session information: in accordance with a determination that the respective criteria are met (e.g., the second active session of the second application is executing on the computer system and the second active session is related to the first active session), the computer system displays, via the one or more display generation components, the first status element and the second status element (e.g., over at least a portion of the respective user interface of the respective software). For example, FIG. 6B shows the expanded list of multiple live activity user interface elements 6108, 6110, and 6112 displayed in response to detection of user input 6102 directed toward live activity user interface element 6106 in FIG. 6A. In some embodiments, in response to detecting the occurrence of the event corresponding to the first session information, in accordance with a determination that the respective criteria are not met (e.g., the second active session of the second application is not executing on the computer system or the second active session, though executing on the computer system, is not related to the first active session), the computer system displays, via the one or more display generation components, an expanded status element (e.g., the first status element or the expanded user interface) corresponding to the first active session (e.g., over at least a portion of the respective user interface of the respective software) without displaying the second status element. For example, FIG. 6E shows the single expanded live activity user interface element 6124 displayed in response to detection of user input 6122 directed toward live activity user interface element 6104 in FIG. 6D.

In some embodiments, the first active session is a respective process executing (e.g., in the background) on the computer system. In some embodiments, displaying the first session information in the first display region includes switching between displaying a representation of the first application (e.g., an application icon or thumbnail) at a first time and displaying an indication of progress of the respective process at a second time that is different from the first time (e.g., progress toward completion of photo sharing, video processing, file transfer, content downloading, and/or other process). For example, the computer system displays in the first display region (e.g., or more specifically in a portion of the first display region corresponding to the first session information) an application icon of the first application, and then ceases to display the application icon and instead displays a progress bar or other progress indicator, and then ceases to display the progress indicator and instead redisplays the application icon, and so on (e.g., as illustrated by the different appearances of live activity user interface element 6106 in FIGS. 6A and 6C, of live activity user interface element 6130 in FIGS. 6F and 6H-6I, and of live activity user interface element 6181 in FIGS. 6U-6V and 6Z-6AA). In some embodiments, one or more additional visual elements are included in the alternating, or cycling, sequence (e.g., interleaved with the representation of the first application and the indication of progress).

In some embodiments, prior to detecting the occurrence of the event corresponding to the first active session, displaying the system user interface includes concurrently displaying the first content and the first status element without concurrently displaying a status element that is different from the first status element and that includes status information that is updated over time about an active session that is different from the first active session (e.g., in accordance with a determination that no active session that is different from the first active session is executing on the computer system, for example because no other active session of the first application is executing on the computer system, and/or because no active session of an application that is different from the first application is executing on the computer system). For example, the first status element is displayed without concurrently displaying the second status element that includes the second status information about the second active session (e.g., as illustrated by live activity user interface element 6156 in FIG. 6AB being displayed without the stack 6150 appearance of FIG. 6W).

In some embodiments, prior to detecting the occurrence of the event corresponding to the first active session, displaying the system user interface includes: in accordance with a determination that the second active session of the second application is executing on the computer system and that the second active session is not related to the first active session (e.g., a determination that the respective criteria are not met because, even though the second active session is executing on the computer system, the first active session and the second active session are not related), concurrently displaying, via the one or more display generation components, the first status element and the second status element (e.g., as distinct status elements); and, in accordance with a determination that the respective criteria are met (e.g., the second active session of the second application is executing on the computer system and the second active session is related to the first active session), displaying, via the one or more display generation components, the first status element with an indication of multiple active sessions (e.g., without concurrently displaying the second status element). In some embodiments, displaying the first status element with an indication of multiple active sessions includes displaying the first status element with the appearance of a stack of status elements, with an affordance for expanding the first and related active sessions, and/or other indication. In some embodiments, even if the first status element and the second status element are displayed as separate representations (e.g., not in a stack), the first status element is nonetheless displayed with an indication of multiple active sessions if, in addition to the second active session that is not related to the first active session, one or more active sessions that are related to the first active session and associated with one or more applications other than the first application are also executing on the computer system. For example, the running timer is not related to the television series downloading operation, so live activity user interface element 6144 for the timer is displayed separately from live activity user interface element 6146 for the television series downloading operation.

In some embodiments, in response to detecting the occurrence of the event corresponding to the first active session: in accordance with a determination that the second active session of the second application is executing on the computer system and that the second active session is not related to the first active session (e.g., a determination that the respective criteria are not met because, even though the second active session is executing, the first active session and the second active session are not related), the computer system continues to concurrently display, via the one or more display generation components, (e.g., maintaining the concurrent display of) the first status element and the second status element (e.g., as distinct status elements). For example, live activity user interface element 6144 for the timer continues to be displayed in FIG. 6K while live activity user interface element 6146 for the television series download is displayed with live activity user interface elements for other live activities related to the television series download. In some circumstances, however, the second status element ceases to be displayed if, in response to detecting the occurrence of the event corresponding to the first active session, the computer system expands a stack of multiple status elements or expands the first status element to the expanded user interface corresponding to the first active session such that there is insufficient display area for the second status element (e.g., live activity user interface element 6148 for ongoing sports game updates, which is not related to the television series download and which was displayed separately from live activity user interface element 6146 for the television series download in FIG. 6J, ceases to be displayed in wake screen user interface 6142 in FIG. 6K).

In some embodiments, detecting the occurrence of the event corresponding to the first active session includes detecting a change in state (e.g., a start or end of the first active session, a content transition such as between playback of different songs, or other change in state) of the first active session (e.g., an error in the photo album download as illustrated in FIG. 6O, or the completion of the game schedule download as illustrated in FIG. 6X).

In some embodiments, prior to detecting the occurrence of the event corresponding to the first active session, displaying the system user interface includes: in accordance with a determination that the respective criteria are met, displaying, via the one or more display generation components, the first status element with an indication of multiple active sessions (e.g., with the appearance of a stack of status elements, with an affordance for expanding the first and related active sessions, and/or other indication); and, in accordance with a determination that the respective criteria are not met, displaying, via the one or more display generation components, the first status element without the indication of multiple active sessions. In some embodiments, detecting the occurrence of the event corresponding to the first active session includes detecting, via one or more input devices of the computer system, an input (e.g., a selection input such as a tap, air pinch, button press, or other input) directed toward the first status element (e.g., user input 6140 directed toward live activity user interface element 6146 in FIG. 6J).

In some embodiments, in response to detecting the occurrence of the event corresponding to the first active session, in accordance with the determination that the respective criteria are met, the computer system displays a first affordance concurrently with displaying the first status element and the second status element (e.g., affordance 6161 in FIG. 6K). In some embodiments, while displaying the first affordance concurrently with displaying the first status element and the second status element, the computer system detects, via the one or more input devices, an input (e.g., a selection input such as a tap, air pinch, button press, or other input) directed toward the first affordance (e.g., user input 6163 in FIG. 6M). In some embodiments, in response to detecting the input directed toward the first affordance, the computer system: ceases to display the second status element; and displays, via the one or more display generation components, the first status element with the indication of multiple related active sessions (e.g., as illustrated in FIG. 6N). In some embodiments, in response to detecting the occurrence of the event corresponding to the first active session, in accordance with the determination that the respective criteria are not met (e.g., a second active session of a second application that is different from the first application is not executing on the computer system or is not related to the first active session), the computer system displays the expanded user interface corresponding to the first active session without displaying the indication of multiple related sessions.

In some embodiments, displaying the first status element includes displaying, in the first status element, one or more affordances, wherein a respective affordance of the one or more affordances is activatable to perform a first operation associated with the first active session (e.g., to control the active session, such as to stop, pause, retry, and/or resume the active session). In some embodiments, the one or more affordances include a second affordance, different from the respective affordance, that is activatable to perform a second operation, different from the first operation, associated with the first active session (e.g., or any number of affordances each activatable to perform a different operation associated with the respective active session). For example, live activity user interface element 6146 in FIG. 6J includes cancel affordance 6159 and pause affordance 6158.

In some embodiments, while displaying, via the one or more display generation components, the first status element, the computer system detects, via one or more input devices of the computer system, an input directed toward the respective affordance (e.g., detecting an input that corresponds to a request to activate the respective affordance). In some embodiments, in response to detecting the input directed toward the respective affordance, the computer system pauses the first active session (e.g., including updating the first status element to display an indication that the first active session has been paused, such as by displaying a graphical and/or textual indication in the first status element that the first active session is paused and/or by ceasing to update the first status information in the first status element while continuing to display the first status element, by ceasing to display the first status element altogether, or other indication). For example, in response to detecting user input 6160 directed toward pause affordance 6158 in FIG. 6K, device 100 pauses the television series downloading operation. In some embodiments, after detecting the input directed toward the respective affordance, in accordance with a determination that the first active session has been paused for at least a threshold amount of time (e.g., 10 seconds, 30 seconds, 1 min, 5 min, 10 min, 30 min, or other length of time) (e.g., based on time since the input that corresponds to the request to activate the respective affordance was detected, time since the first active session was paused, time since an indication of the first active session being paused was displayed, or other associated time), the computer system displays, via the one or more display generation components, an indication that the first active session has ended (e.g., including displaying an indication that the first active session has been terminated, such as by displaying a graphical and/or textual indication in the first status element that the first active session has been canceled, and/or by ceasing to display the first status element altogether, or other indication). For example, FIG. 6M illustrates that device 100 ends the television series downloading operation corresponding to live activity user interface element 6146, and displays a corresponding indication in live activity user interface element 6146, after ten minutes have passed since the television series downloading operation was paused.

In some embodiments, detecting the occurrence of the event corresponding to the first active session includes detecting an end of the first active session. In some embodiments, displaying the first status element (e.g., concurrently with displaying the second status element) in response to detecting the occurrence of the event corresponding to the first active session (and in accordance with the determination that the respective criteria are met) includes displaying an indication of a completion state of the first status element (e.g., including an indication that the first active session has ended). In some embodiments, after displaying the indication of the completion state of the first status element in the system user interface, the computer system ceases to display the first status element in the system user interface (e.g., after the television series downloading operation has ended as shown in FIG. 6M, the corresponding live activity user interface element 6146 ceases to be displayed in wake screen user interface 6142 as shown in FIG. 6N; similarly, after the game schedule downloading operation has completed as shown in FIG. 6X, the corresponding live activity user interface element 6197 continues to be displayed in wake screen user interface 6142 and indicates the completion of the live activity until wake screen user interface 6142 is dismissed, after which live activity user interface element 6197 is no longer displayed in the redisplayed wake screen user interface 6142 in FIG. 6AB). In some embodiments, the computer system continues to display the system user interface and, after displaying the indication of the completion state of the first status element for a threshold amount of time, automatically ceases to display the first status element after the threshold amount of time has elapsed (e.g., while continuing to display the rest of the system user interface). In some embodiments, while displaying in the system user interface the indication of the completion state of the first status element, the computer system detects a first input corresponding to a request to dismiss the system user interface, and in response ceases to display the system user interface and the first status element. In some embodiments, the computer system subsequently detects a second input corresponding to a request to display (e.g., redisplay) the system user interface, and in response displays the system user interface without displaying the first status element in the (e.g., redisplayed) system user interface (e.g., because the first active session had already ended prior to detection of the second input).

In some embodiments, while displaying the system user interface, the computer system detects, via the one or more input devices, an input (e.g., a touch input such as a tap gesture or swipe gesture, an air gesture such as an air pinch gesture or air pinch and drag gesture, or other input) directed toward a respective status element that includes respective status information about a respective active session of a respective application (e.g., an input directed toward the first status element that includes the first status information about the first active session of the first application, toward the second status element that includes the second status information about the second active session of the second application, or toward a different, third status element that includes third status information about a third active session of a different, third application). In some embodiments, in response to detecting the input directed toward the respective status element, in accordance with a determination that the input directed toward the respective status element is a first type of gesture (e.g., as opposed to a different, second type of gesture), the computer system initiates a process for ending the respective active session from the system user interface (e.g., by displaying in the system user interface one or more affordances for ending the respective active session, without navigating to a user interface of the respective application in place of the system user interface). For example, in response to detecting user input 6164 in FIG. 6P, device 100 initiates a process for ending the music album downloading, at least in part by displaying end affordance 6166 as in FIG. 6Q, which is activatable (e.g., by user input 6169 in FIG. 6Q) to end the music album downloading operation as illustrated in FIG. 6R. In some embodiments, in accordance with a determination that the input directed toward the respective status element is a second type of gesture that is different from the first type of gesture, the computer system forgoes initiating the process for ending the respective active session from the system user interface, and optionally performs a different operation instead. For example, if the input directed toward the respective status element is or includes a swipe gesture, the computer system initiates the process for ending the respective active session, whereas if the input directed toward the respective status element is or includes a tap gesture, the computer system ceases to display the system user interface and instead displays a user interface for the respective application.

In some embodiments, the computer system detects, via the one or more input devices, an input (e.g., a selection input such as a tap, air pinch, button press, or other input) directed toward the first status element corresponding to the first active session; and, in response to detecting the input directed toward the first status element corresponding to the first active session, the computer system displays, via the one or more display generation components, a first user interface of the first application. For example, in response to detecting user input 6170 in FIG. 6R directed toward live activity user interface element 6148 for ongoing sports game updates, device 100 displays user interface 6172 of the sports application as in FIG. 6S. In another example, in response to detecting user input 6179 in FIG. 6T directed toward live activity user interface element 6112 for the photo album downloading operation, device 100 displays user interface 6182 of the photos application as in FIG. 6U. In some embodiments, the computer system likewise displays a first user interface of the first application in response to detecting an input directed toward the expanded user interface corresponding to the first active session.

In some embodiments, the first user interface of the first application includes information about the first active session (e.g., by including content associated with the first active session). In some embodiments, the first user interface of the first application that is displayed in response to the input directed toward the first status element (e.g., or the expanded user interface) corresponding to the first active session is different from a second user interface of the first application that is displayed in response to activation of an application icon for the first application that is displayed on a home menu user interface, interaction with a notification, or other mechanism for navigating to the first application that does not involve the first active session (e.g., where content associated with the first active session is not displayed in the second user interface). For example, the user interface 6172 displayed in FIG. 6S in response to detection of user input 6170 in FIG. 6R directed toward live activity user interface element 6148 includes information about the particular sports game for which status information was displayed in live activity user interface element 6148 when user input 6170 was detected. Similarly, the user interface 6182 displayed in FIG. 6U in response to detection of user input 6179 in FIG. 6T directed toward live activity user interface element 6112 for the photo album downloading operation displays the photos of the downloaded photo album.

In some embodiments, executing a respective active session includes performing an operation involving content associated with the respective active session (e.g., downloading, uploading, sending, receiving, transferring, saving, deleting, rendering, or other operation performed on the content). In some embodiments, displaying a respective status element that includes respective status information about the respective active session includes displaying a representation (e.g., a thumbnail, an icon, a summary, a count or tally, or other representation) of the content associated with the respective active session (e.g., without displaying the content itself), such as the thumbnail graphics described with reference to live activity user interface element 6104 of FIG. 6A, live activity user interface elements 6108, 6110, and 6112 of FIG. 6B, live activity user interface element 6124 of FIG. 6E, live activity user interface element 6130 of FIGS. 6F and 6H, and other live activity user interface elements described herein. In some embodiments, the representation of the content is updated over time while the respective status element is displayed (e.g., continues to be displayed). For example, a thumbnail of album art of a music album currently being downloaded changes to a different thumbnail of album art as the device 100 switches to downloading a different music album (e.g., while performing a music album downloading operation for multiple music albums). In some embodiments, the representation of the content is updated as the respective status element is displayed (e.g., redisplayed) after ceasing to be displayed. For example, if a respective status element that includes a representation of first content ceases to be displayed at a first time, the respective status element is displayed (e.g., redisplayed) at a second time that is different from (e.g., after) the first time and includes a representation of second content that is different from the first content.

It should be understood that the particular order in which the operations relating to FIG. 10 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, and 9000) are also applicable in an analogous manner to method 10000 described above with respect to FIG. 10. For example, the user interfaces, applications, active sessions, status elements, and status information described above with reference to method 10000 optionally have one or more of the characteristics of the user interfaces, applications, live activities, and status information described herein with reference to other methods described herein (e.g., methods 7000, 8000, and 9000). For brevity, these details are not repeated here.

FIG. 12 is a flow diagram illustrating method 12000 of transitioning from a wake screen user interface in accordance with some embodiments. Method 12000 is performed at a computer system (e.g., device 300 of FIG. 3A or portable multifunction device 100 of FIG. 1A) that is in communication with one or more input devices (e.g., one or more optical sensors such as cameras (e.g., color sensors, infrared sensors, structured light scanners, and/or other depth-sensing cameras), eye-tracking devices, touch sensors, touch-sensitive surfaces, proximity sensors, motion sensors, buttons, crowns, mice, joysticks, user-held and/or user-worn controllers, and/or other sensors and input devices) (e.g., touch-sensitive display system 112 of FIG. 1A, optical sensor(s) 164 of FIG. 1A, other input or control devices 116 of FIG. 1A, touchpad 355 of FIG. 3A, keyboard/mouse 350 of FIG. 3A, or sensor(s) 359 of FIG. 3A) and one or more display generation components (e.g., touch screen 112 of FIG. 1A or display 340 of FIG. 3). In some embodiments, the one or more display generation components include a display that is a touch-screen display and the one or more input devices include a touch-sensitive surface on or integrated with the display. In some embodiments, the display is separate from the touch-sensitive surface. Some operations in the described method are, optionally, combined and/or the order of some operations is, optionally, changed.

In some embodiments, the one or more input devices include one or more touch-sensitive surfaces such as touch-sensitive buttons, touch pads, touch screens, and/or other touch-sensitive input regions located on the computer system and/or are coupled to the computer system via one or more wired or wireless connections that detect user inputs based on contacts. In some embodiments, the one or more input devices includes one or more cameras that capture movement and/or gestures inputs of the user. In some embodiments, the one or more input devices include one or more microphones that detect voice inputs from the user. In some embodiments, the one or more input devices include sensors for detecting changes in position, lighting, noise, temperature, proximity of objects, activation of hardware controls, intensity of inputs, duration of inputs, and/or changes thereof, instead of and/or in addition to other input devices and/or sensors. In some embodiments, the one or more display generation components include one or more touch screen displays, head-mounted displays, heads-up displays, integrated displays, and/or standalone displays, that are used to display content and information generated by the computer system.

The devices, methods, and/or computer-readable storage mediums described below with respect to method 12000 enhance the operability of the device (e.g., the computer system) and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Restricting access to potentially sensitive information and/or compartmentalizing the information to specific devices and processes (such as by, in response to detecting a user input to dismiss a user interface corresponding to a restricted state of the device, such as a wake screen, moving a user interface overlay displayed as a simulated glass material while remaining in the restricted state, until the end of the user input and/or authentication is successful) improves privacy and security by limiting the manner in which that potentially sensitive information can be accessed. Providing improved feedback (such as by increasing the degree of simulated optical distortion by the simulated glass material of the user interface overlay as the user interface overlay is moved further) enhances the operability of the device by reducing accidental and mistaken inputs, reducing energy usage by the device. Performing an operation when a set of conditions has been met without requiring further user input (such as by automatically increasing the degree of simulated optical distortion by the simulated glass material of edge portions of the user interface overlay more than the degree of simulated optical distortion by the simulated glass material of an interior portion of the user interface overlay and/or of other user interface elements, to improve legibility of the interior portion and/or other user interface elements) enhances the operability of the device by reducing unnecessary inputs and/or steps to navigate through different user interfaces or sets of controls, reducing energy usage by the device. Reducing the number of inputs needed to perform an operation (such as by displaying a variety of controls in an editing user interface for a system user interface such as a wake screen or home screen) enhances the operability of the device by reducing the number of inputs and time required to perform a particular operation and improving ergonomics, reducing energy usage by the device. Displaying user interface elements with different appearances at different times (such as when dismissing a user interface corresponding to a restricted state of the device, such as a wake screen, and transitioning to another user interface such as a home screen or application user interface) helps to avoid image persistence or burn in effects that can occur with some display technologies when the same object is displayed with the same appearance at the same location repeatedly or for a long period of time.

The computer system displays (12002), via the one or more display generation components, a first user interface (e.g., a wake screen user interface, lockscreen user interface, a standby user interface, an application switcher user interface, an application library user interface, a widget user interface, a control user interface, and/or another type of system user interface, an application user interface, a window, and/or another type of user interface that is displayed overlying another user interface or underlying content and that can be moved to reveal the underlying user interface and/or content), such as wake screen user interface 11000 of FIG. 11A. In some embodiments, displaying the first user interface includes displaying foreground content (e.g., an indication of current time of day, one or more widgets, complications, notifications, live activities, controls, and/or other types of user interface elements and/or content) overlaying one or more portions of a background (e.g., wallpaper, image, gradient, color, and/or other types of background) of the first user interface. In some embodiments, the first user interface is displayed overlaying a second user interface that previously occupied (e.g., last occupied) the same or substantially the same display area as the first user interface; and movement of the first user interface reveals at least a portion of the second user interface underlying the first user interface, and/or removal of the first user interface causes the second user interface to be displayed (e.g., redisplayed) in the space previously occupied by the first user interface.

While displaying the first user interface, the computer system detects (12004), via the one or more input devices, a first user input (e.g., user input 11004 of FIGS. 11A-110) that corresponds to a request to move a user interface overlay (e.g., simulated glass material overlay 11006 of FIGS. 11A-110) relative to a reference location (e.g., in the first user interface, on the device, or in a user interface region for displaying user interfaces via the one or more display generation components). In some embodiments, the first user input includes a swipe gesture by a contact directed to a portion of the first user interface, an edge swipe gesture by a contact directed to an edge portion of the first user interface. In some embodiments, the first user input includes an air pinch and drag gesture detected when the user's attention (e.g., detected based on gaze and/or other indications of user's attention) is directed toward the first user interface and/or an edge portion of the first user interface. In some embodiments, the first user input includes an input that activates a hardware or solid state button and/or other types of physical affordances. In some embodiments, the first user input includes a click input or other types of selection input that is detected when the focus selector or input focus is at the location of a control for dismissing the first user interface and displaying (e.g., redisplaying) a second user interface at the location previously occupied by the first user interface.

In response to detecting the first user input that corresponds to the request to move the user interface overlay relative to the reference location (12006): the computer system moves (12008) the user interface overlay, including moving an edge portion of the user interface overlay (e.g., a bottom edge, or another edge of the first user interface) across a first region of a display area, previously occupied by a portion of the first user interface, that includes respective content (e.g., a portion of the first user interface and/or a portion of a second user interface), including: displaying, via the one or more display generation components, the edge portion of the user interface overlay with an appearance based on a first degree of simulated optical distortion (e.g., blurring, reflection and/or refraction) of a portion (e.g., a first portion) of the respective content at a location that corresponds to (e.g., under, near, and/or adjacent to) the edge portion of the user interface overlay; and displaying, via the one or more display generation components, an interior portion of the user interface overlay with an appearance based on the respective content with less than the first degree of simulated optical distortion (e.g., with no simulated optical distortion and/or with a lesser degree of simulated optical distortion) of the respective content under the interior portion of the user interface overlay. In some embodiments, the interior portion of the user interface overlay is adjacent to and/or at least partially surrounded by the edge portion of the user interface overlay. In some embodiments, the edge portion of the user interface overlay corresponds to a respective edge of the display area, and the interior portion of the user interface overlay is further from the respective edge of the display area than the edge portion of the user interface overlay is from the respective edge of the display area. For example, as described herein with reference to FIGS. 11A-110, in response to detecting user input 11004, device 100 moves simulated glass material overlay 11006, including moving bottom edge 11008a and side edge(s) 11010a upward from the bottom edge of the display area of device 100 across a region of the display area, previously occupied by the bottom portion of wake screen user interface 11000, that includes underlying background 11002′, including displaying simulated glass material overlay 11006 as a simulated glass material where the bottom edge 11008a and side edge(s) 11010a distort the underlying background 11002′ more than a middle portion of simulated glass material overlay 11006 distorts the underlying background 11002′.

In some embodiments, the first user input includes detecting a first portion of the first user input, and, after detecting the first portion of the first user input, the computer system detects, via the one or more input devices, a second portion of the first user input (e.g., that follows the first portion of the first user input, such as continued movement of a swipe touch gesture, of an air pinch and drag gesture, or of a click and drag input of a mouse, or other continuation of the first user input) that corresponds to a request to continue to move the user interface overlay relative to the reference location (e.g., a request to move the user interface overlay further relative to the reference location). For example, after detecting user input 11004a of FIG. 11A, device 100 continues to detect subsequent portions of user input 11004 including user input 11004b of FIG. 11B, user input 11004c of FIG. 11C, and user input 11004d of FIG. 11D. In some embodiments, in response to detecting the second portion of the first user input that corresponds to the request to continue to move the user interface overlay relative to the reference location, the computer system moves the user interface overlay (e.g., further than in response to detecting the first portion of the first user input prior to detecting the second portion of the first user input), including moving the edge portion of the user interface overlay across a second region of the display area (e.g., different from and in some circumstances adjacent to the first region of the display area), previously occupied by a portion of the first user interface, including: displaying, via the one or more display generation components, the edge portion of the user interface overlay with an appearance based on a second degree of simulated optical distortion (e.g., blurring, reflection and/or refraction) of a portion (e.g., a second portion different from the first portion) of the respective content at a location that corresponds to (e.g., under, near, and/or adjacent to) the edge portion of the user interface overlay, wherein the second degree of simulated optical distortion is greater than the first degree of simulated optical distortion. For example, in response to detecting the subsequent portions of user input 11004 including user input 11004b of FIG. 11B, user input 11004c of FIG. 11C, and user input 11004d of FIG. 11D, device 100 displays simulated glass material overlay 11006 with progressively increasing area of the bottom edge 11008 and side edges 11010 and progressively increasing amount of distortion to the portion(s) of the underlying background 11002′ that are under and/or near the bottom edge 11008 and side edges 11010. In some embodiments, the computer system displays the interior portion of the user interface overlay (e.g., the middle portion of simulated glass material overlay 11006, at least partially surrounded by and/or adjacent to the bottom edge 11008 and side edges 11010 of simulated glass material overlay 11006) with an appearance based on the portion of the respective content at the location that corresponds to the edge portion of the user interface overlay with less than the second degree of simulated optical distortion and/or with less than the first degree of simulated optical distortion of the portion of the respective content at the location that corresponds to the edge portion of the user interface overlay under the interior portion of the user interface overlay (e.g., with no simulated optical distortion and/or with a lesser degree of simulated optical distortion than for the edge portion of the user interface overlay).

In some embodiments, displaying the first user interface prior to detecting the first user input includes concurrently displaying: a first user interface feature (e.g., a background of the first user interface); and one or more user interface elements (e.g., a current time of day, widgets, controls, notifications, live activities that are updated based on updates from followed events, and/or other content). In some embodiments, in response to detecting the first portion of the first user input that corresponds to the request to move the user interface overlay relative to the reference location, the computer system displays, via the one or more display generation components, the one or more user interface elements (e.g., moving relative to the reference location, in conjunction with the movement of the user interface overlay) with an appearance based on a third degree of simulated optical distortion of one or more portions (e.g., one or more first portions) of the respective content at a location that corresponds to (e.g., under, near, and/or adjacent to) the one or more user interface elements (e.g., greater than the degree of simulated optical distortion of the interior portion of the user interface overlay and in some embodiments greater than the first degree of simulated optical distortion of the edge portion of the user interface overlay). In some embodiments, in response to detecting the second portion of the first user input that corresponds to the request to continue to move the user interface overlay relative to the reference location, the computer system displays, via the one or more display generation components, the one or more user interface elements (e.g., further moving relative to the reference location, in conjunction with the further movement of the user interface overlay) with an appearance based on a fourth degree of simulated optical distortion of one or more portions (e.g., one or more second portions different from the one or more first portions) of the respective content at a location that corresponds to (e.g., under, near, and/or adjacent to) the one or more user interface elements; wherein a difference between the fourth degree of simulated optical distortion and the third degree of simulated optical distortion is different from (e.g., less than or greater than) a difference between the second degree of simulated optical distortion and the first degree of simulated optical distortion. In some embodiments, the third degree of simulated optical distortion is the same as the fourth degree of simulated optical distortion (e.g., the degree of simulated optical distortion of the one or more user interface elements does not change, so the difference is zero), whereas the second degree of simulated optical distortion is greater than the first degree of simulated optical distortion (e.g., the degree of simulated optical distortion of the edge portion of the user interface overlay increases). In some embodiments, the increase in degree of simulated optical distortion of the edge portion of the user interface overlay is greater than a change (e.g., increase, decrease, or zero change) in degree of simulated optical distortion of the one or more user interface elements. For example, as described herein with reference to FIGS. 11A-11D, the simulated glass material of notification 1130, time indication 11036, and/or live activity 11028 on simulated glass material overlay 11006 is simulated to have different simulated visual properties (e.g., less distortion, and/or less progressive increase in distortion, of corresponding portions of the underlying background 11002′) than the simulated glass material of simulated glass material overlay 11006.

In some embodiments, the edge portion of the user interface overlay includes respective portions of two or more edges of the user interface overlay (e.g., a portion of a first edge and a portion of a second edge, at least, and optionally a portion of a third edge, and so on, such as a portion of a bottom edge, and a portion of a right edge and/or a portion of a left edge) (e.g., bottom edge 11008 and side edge(s) 11010 of simulated glass material overlay 11006 in FIGS. 11A-110). In some embodiments, the edge portion of the user interface overlay includes more portions of a respective edge and/or portions of more edges of the user interface overlay as the first user input progresses (e.g., as subsequent portions of the first user input are detected). In some embodiments, the two edges extend in different directions (e.g., a bottom edge that extends in a right to left direction and a side edge that extends in a bottom to top direction or a top to bottom direction).

In some embodiments, the first user interface includes a background; detecting the first user input includes detecting a first portion of the first user input; the first region of the display area that includes respective content includes the background of the first user interface (e.g., a portion of the background of the first user interface). In some embodiments, after detecting the first portion of the first user input, the computer system detects, via the one or more input devices, a third portion of the first user input (e.g., continued movement of a swipe touch gesture, of an air pinch and drag gesture, or of a click and drag input of a mouse, or other continuation of the first user input, optionally including an end of the first user input, such as liftoff of a touch user input, a release of a click and hold input via a mouse, release of an air gesture, and/or other end of a user input). In some embodiments, the third portion of the first user input follows (e.g., is detected after detecting) the second portion of the first user input. In some embodiments, in response to detecting the third portion of the first user input, the computer system moves the user interface overlay (e.g., further than in response to detecting the first user input prior to the continuation of the first user input), including moving the edge portion of the user interface overlay across a third region of the display area (e.g., different from the first region of the display area, and the same as or different from the second region of the display area), previously occupied by a portion of the first user interface, that includes second respective content (e.g., the same as or different from the respective content), including: displaying, via the one or more display generation components, the edge portion of the user interface overlay with an appearance based on a third degree of simulated optical distortion (e.g., blurring, reflection and/or refraction) of a portion of the second respective content at a location that corresponds to (e.g., under, near, and/or adjacent to) the edge portion of the user interface overlay; and displaying, via the one or more display generation components, the interior portion of the user interface overlay with an appearance based on the second respective content with less than the first degree of simulated optical distortion (e.g., with no simulated optical distortion and/or with a lesser degree of simulated optical distortion) of the second respective content under the interior portion of the user interface overlay; wherein the second respective content includes a portion of a second user interface that is different from the first user interface. In some embodiments, the third degree of simulated optical distortion is the same as or different from (e.g., greater than or less than) the second degree of simulated optical distortion, and/or the same as or different from (e.g., greater than or less than) the first degree of simulated optical distortion. In some embodiments, the second user interface is a home screen user interface or an application user interface that requires the computer system to be in an unlocked state in order for the second user interface to be displayed. In some embodiments, the second respective content includes an animated transition between the first user interface and the second user interface (e.g., one or more user interface elements of the second user interface moving in one or more directions across the display area into place, such as flying in from the edges of the display area). For example, device 100 displays simulated glass material overlay 11006 as a simulated glass material where the bottom edge 11008a and side edge(s) 11010a distort corresponding content more than a middle portion of simulated glass material overlay 11006 distorts the corresponding content, where the content initially includes the underlying background 11002′, as described herein with reference to FIGS. 11A-11D, and later includes an animated transition to authentication user interface 11012, as described herein with reference to FIGS. 11G-11H, and/or an animated transition to home screen user interface 11014, as described herein with reference to FIGS. 11E-11F.

In some embodiments, detecting the third portion of the first user input includes detecting an end of the first user input (e.g., liftoff of a touch user input, a release of a click and hold input via a mouse, release of an air gesture, and/or other end of a user input), for example by detecting liftoff of the user input 11004d and/or detecting that movement of the user input 11004d has ceased, as described herein with reference to FIG. 11D.

In some embodiments, displaying the first user interface includes displaying first content (e.g., a current time of day, widgets, controls, notifications, live activities that are updated based on updates from followed events, and/or other content) in the first user interface. In some embodiments, in response to detecting the first user input that corresponds to the request to move the user interface overlay relative to the reference location, the computer system moves the first content relative to the reference location (e.g., in conjunction with, and/or based on a magnitude and/or direction of, moving the user interface overlay, such as if the first content were part of or overlaid on the user interface overlay). In some embodiments, the first user interface includes one or more user interface features that are different from the first content, such as a background (e.g., on which the first content is overlaid), and in response to detecting the first user input, the computer system moves the first content relative to the reference location without moving the one or more user interface features that are different from the first content (e.g., relative to the reference location or at all). For example, as described herein with reference to FIGS. 11A-11D, as the simulated glass material overlay 11006 shifts upward, content of the wake screen user interface, including the date indication, time indication 11036, notification 11030, live activity 11028, and/or camera option 11032 are displayed as moving and/or sliding upward along with the simulated glass material overlay 11006 (e.g., whereas the background 11002′ does not appear to move with the simulated glass material overlay 11006).

In some embodiments, as described herein with reference to FIG. 11O, the edge portion of the user interface overlay corresponds to an edge of the display area (e.g., from which the first user input is initiated). Accordingly, in some embodiments, in response to detecting the first user input that corresponds to the request to move the user interface overlay relative to the reference location: in accordance with a determination that the edge of the display area has a first shape, the computer system displays the edge portion of the user interface overlay with a first edge shape (e.g., that is based on the first shape of the edge of the display area); and in accordance with a determination that the edge of the display area has a second shape that is different from the first shape, the computer system displays the edge portion of the user interface overlay with a second edge shape that is different from the first edge shape (e.g., and that is based on the second shape of the edge of the display area). For example, the more rounded the edge of the display area, the more rounded the edge portion of the user interface overlay (e.g., to match the shape of the edge of the display area), and/or the longer the edge of the display area, the wider the edge portion of the user interface overlay (e.g., to match the width of the display area). For example, the large the corner radius of a respective corner of the display area, the larger the corner radius of a corresponding corner portion of the user interface overlay (e.g., to match the shape of the corner of the display area). In some embodiments, different devices (e.g., different display generation components and/or computer systems) have different edge shapes and/or different corner radiuses. In some embodiments, different portions of a respective device have different edge shapes such that the user interface overlay has a first set of edge shapes while displayed on the respective device in a first orientation (e.g., portrait) versus a second set of edge shapes while displayed on the respective device in a second orientation (e.g., landscape) that is different from the first orientation.

In some embodiments, the first user interface is a system user interface (e.g., that corresponds to a restricted state of the computer system), such as wake screen user interface 11000 of FIGS. 11A-110. In some embodiments, the first user interface includes a wake screen user interface, a lock screen user interface, a low power always-on user interface, a notifications user interface, and/or another system user interface that restricts access to a home screen user interface and application user interfaces, and needs to be dismissed in order to access the home screen user interface and the application user interfaces in a normal fashion.

In some embodiments, the computer system detects, via the one or more input devices, an end of the first user input (e.g., liftoff of a touch user input, a release of a click and hold input via a mouse, release of an air gesture, and/or other end of a user input). In some embodiments, in response to detecting the end of the first user input: in accordance with a determination that the first user input does not meet first criteria (e.g., input progress criteria that require that the first user input meet a threshold magnitude of movement and/or threshold velocity of movement, optionally in a respective direction or within a range of directions, in order for the input progress criteria or more generally the first criteria to be met), the computer system: displays (e.g., redisplays), via the one or more display generation components, the first user interface; and ceases to display the user interface overlay with an appearance based on simulated optical distortion; and in accordance with a determination that the first user input meets the first criteria, the computer system displays, via the one or more display generation components, a user interface that is different from the first user interface (and optionally ceases to display the user interface overlay). In some embodiments, the user interface that is different from the first user interface is a home screen user interface, an application user interface, a system user interface, or other user interface that is different from the first user interface (e.g., the second user interface or the third user interface). For example, as described herein with reference to FIGS. 11E-11J, in response to detecting the end of the user input 11004d, device 100 displays authentication user interface 11012 (e.g., as in FIGS. 11G-11I) or home screen user interface 11014 (e.g., as in FIGS. 11E-11F and 11J). In some embodiments, device 100 determines which user interface to display based on whether user input 11004 has moved by a threshold distance (e.g., greater than or less than the threshold distance), is moving at a threshold speed (e.g., greater than or less than the threshold speed), is maintained for a threshold amount of time (e.g., greater than or less than the threshold amount of time), and/or other input progress criteria.

In some embodiments, displaying the user interface that is different from the first user interface includes: in accordance with a determination that authentication criteria are met (e.g., that require that a user of the computer system is authenticated and/or the computer system is in an unlocked state), displaying a third user interface that is different from the first user interface (e.g., a home screen user interface or an application user interface that requires the computer system to be in an unlocked state in order for the third user interface to be displayed, such as the second user interface described herein); and in accordance with a determination that the authentication criteria are not met, displaying a system user interface (e.g., a system authentication user interface) for providing authentication information (e.g., a prompt to enter a passcode or password, software keyboard or number pad for entering a passcode or password and/or biometric information), wherein the system user interface is different from the third user interface. In some embodiments, the computer system displays an animation of user interface elements of the system authentication user interface moving in one or more directions across the display area into place (e.g., flying in sideways and/or other direction(s) from the edges of the display area). In some embodiments, in response to receiving and verifying authentication information via the system authentication user interface, the computer system transitions from the restricted state to the unlocked state and displays the third user interface (e.g., the same home screen user interface or the application user interface that would have been displayed if authentication had not first been required). In some embodiments, the computer system determines that the authentication criteria are met by performing biometric authentication of a user (e.g., using detected biometric information such as fingerprint, face, and/or eye information). In some embodiments, if the biometric authentication is successful, the computer system is transitioned to the unlocked state (e.g., from a locked state), and the third user interface is displayed; and if the biometric authentication is not successful, the computer system is maintained in the locked state (e.g., and the system user interface is displayed). For example, as described herein with reference to FIGS. 11E-11H, in response to detecting the end of the user input 11004d, device 100 displays authentication user interface 11012 (e.g., in FIG. 11I), optionally via an animated transition (e.g., gradually displaying number options for entering a passcode as flying onto the display area from one or more sides of the display area), without displaying the home screen user interface 11014 if device 100 is in a locked state and authentication criteria are not met (e.g., facial, fingerprint, and/or other biometric authentication are unsuccessful); whereas device 100 displays home screen user interface 11014 (e.g., in FIG. 11J), optionally via an animated transition (e.g., gradually displaying application icons as flying onto the display area from one or more sides of the display area), if device 100 is in an unlocked state and/or the authentication criteria are met (e.g., facial, fingerprint, and/or other biometric authentication are successful).

In some embodiments, the computer system detects, via the one or more input devices, an end of the first user input (e.g., liftoff of a touch user input, a release of a click and hold input via a mouse, release of an air gesture, and/or other end of a user input); and in response to detecting the end of the first user input, displays, via the one or more display generation components, a home screen user interface that includes one or more selectable user interface elements corresponding to one or more functions of the computer system (e.g., one or more application icons, wherein a respective application icon is selectable to launch a corresponding application, and/or one or more widgets corresponding to subsets of application functions of one or more applications). For example, in response to detecting an end of the user input 11004d (e.g., as described herein with reference to FIG. 11D), device 100 displays home screen user interface 11014 (e.g., as described herein with reference to FIGS. 11E-11F and 11J).

In some embodiments, displaying the home screen user interface includes displaying first home screen content (e.g., a background of the home screen user interface, such as a wallpaper, image, gradient, color, and/or other types of background) concurrently with displaying the one or more selectable user interface elements; and a respective selectable user interface element of the one or more selectable user interface elements is displayed with an appearance based on a simulated optical distortion of a respective portion of the first home screen content under the respective selectable user interface element. In some embodiments, more generally, respective selectable user interface elements of a plurality of selectable user interface elements are displayed with respective appearances based on simulated optical distortion of respective portions of the first home screen content under the respective selectable user interface elements. For example, as described herein with reference to FIGS. 11E-11F and 11J, home screen user interface 11014 includes application icons that are optionally displayed as a simulated glass material overlaying background 11002′.

In some embodiments, the computer system detects, via the one or more input devices, one or more user inputs (e.g., any combination of one or more tap inputs, drag inputs, click and drag inputs, air gestures, button presses, and/or other inputs including one or more inputs directed to a control for editing the home screen user interface), such as a long selection input such as a touch and hold input or air pinch and hold input directed to an application icon or widget and subsequent selection input directed to an affordance for editing the home screen user interface, or a long selection input such as a touch and hold input or an air pinch and hold input directed to a background portion of the home screen user interface, to trigger display of an “edit” affordance, and a tap input or other selection input directed to the “edit” affordance). In some embodiments, in response to detecting the one or more user inputs, the computer system displays, via the one or more display generation components, an editing user interface for modifying one or more aspects of an appearance of the home screen user interface (e.g., while continuing to display at least a portion of the home screen user interface or a preview of the home screen user interface as modified using the home screen editing user interface), including concurrently displaying: a first affordance for displaying the home screen user interface with a first appearance (e.g., a light mode appearance, dark mode appearance, clear appearance, tinted appearance, or other appearance mode or treatment); and a second affordance for displaying the home screen user interface with a second appearance (e.g., a light mode appearance, dark mode appearance, clear appearance, tinted appearance, or other appearance mode or treatment) that is different from the first appearance. In some embodiments, the editing user interface includes one or more (e.g., any number of) affordances for displaying the home screen user interface with respective corresponding appearances. An example editing user interface is illustrated in and described herein with reference to editing platter 11020 of FIGS. 11L-11N.

In some embodiments, displaying the editing user interface includes displaying: an affordance for displaying the home screen user interface (e.g., including the first home screen content and/or the one or more selectable user interface elements) with a light mode appearance; an affordance for displaying the home screen user interface with a dark mode appearance; an affordance for displaying the home screen user interface with a clear appearance; and an affordance for displaying the home screen user interface with a tinted appearance (e.g., as described herein with reference to selectable options 11026 in FIGS. 11L-11N). In some embodiments, the computer system detects a second user input directed toward the editing user interface (e.g., a tap input, an air gesture, a click input, a button press, and/or other selection input that is directed to a location of a control in the editing user interface and/or is detected while attention of the user is directed to the location of a control in the editing user interface). In some embodiments, in response to detecting the second user input directed toward the editing user interface, the computer system: in accordance with a determination that the second user input is directed toward the affordance for displaying the home screen user interface with a light mode appearance, displays the home screen user interface (e.g., including the first home screen content and/or the one or more selectable user interface elements) with the light mode appearance; in accordance with a determination that the second user input is directed toward the affordance for displaying the home screen user interface with a dark mode appearance, displays the home screen user interface (e.g., including the first home screen content and/or the one or more selectable user interface elements) with the dark mode appearance; in accordance with a determination that the second user input is directed toward the affordance for displaying the home screen user interface with a clear appearance, displays the home screen user interface (e.g., including the first home screen content and/or the one or more selectable user interface elements) with the clear appearance; and in accordance with a determination that the second user input is directed toward the affordance for displaying the home screen user interface with a tinted appearance, displays the home screen user interface (e.g., including the first home screen content and/or the one or more selectable user interface elements) with the tinted appearance. In some embodiments displaying the home screen user interface with the clear appearance and/or the tinted appearance includes displaying one or more elements of the home screen user interface with a user interface material (e.g., simulated glassy, translucent, and/or gelatinous material) based on simulated optical distortion of respective corresponding portions of the home screen user interface (e.g., of a background and/or adjacent portions). For example, as described herein with reference to FIGS. 11L-11N, selecting different selectable options 11026 modifies visual properties of the application icons in home screen user interface 11014 and/or of a background of home screen user interface 11014.

In some embodiments, while the editing user interface is configured for displaying the home screen user interface with a tinted appearance (e.g., in response to detecting a user input selecting the affordance for displaying the home screen user interface with a tinted appearance), the computer system displays, via the one or more display generation components, (e.g., in the editing user interface) one or more selectable color options for the home screen user interface (e.g., including the first home screen content and/or the one or more selectable user interface elements) based on a current context of the computer system (e.g., a selectable option for tinting the home screen user interface with a color based on or selected from the first home screen content, a selectable option for tinting the home screen user interface with a color based on a color of the computer system or of a component of the computer system such as a housing, a selectable option for tinting the home screen user interface based on a color of an accessory of the computer system such as a case, and/or other recommended color option). In some embodiments, in accordance with a determination that the computer system is in a first context, a respective selectable color option of the one or more selectable color options corresponds to a first color (e.g., if the computer system is configured to display the home screen user interface with a first background or wallpaper that includes, is associated with, or coordinates with the first color and/or is configured with a first accessory such as a case having or coordinating with the first color). In some embodiments, in accordance with a determination that the computer system is in a second context different from the first context, the respective selectable color option of the one or more selectable color options corresponds to a second color different from the first color (e.g., if the computer system is configured to display the home screen user interface with a second background or wallpaper that includes, is associated with, or coordinates with the second color and/or is configured with a second accessory such as a case having or coordinating with the second color). In some embodiments, the computer system detects, via the one or more input devices, a third user input (e.g., a tap input, an air gesture, a click input, a button press, and/or other selection input that is directed to a location of a control in the editing user interface and/or is detected while attention of the user is directed to the location of a control in the editing user interface) corresponding to selection of a first selectable color option of the one or more selectable color options for the home screen user interface, wherein the first selectable color option corresponds to a respective color; and in response to detecting the third user input corresponding to selection of the first selectable color option, the computer system displays, via the one or more display generation components, one or more elements on the home screen user interface with an appearance tinted with the respective color. For example, as described herein with reference to FIGS. 11L-11M, in response to selection of tinted option 11026d (e.g., by user input 11018 of FIG. 11L), editing platter 11020-1 includes one or more suggested color options 11048 that are optionally sampled and/or automatically selected without user input based at least in part on one or more colors of the background of home screen user interface 11014 and that are selectable (e.g., by user input 11044 of FIG. 11M) directed to a respective color option of the color options 11048 to update the color of the tint applied to the application icons in home screen user interface 11014 to the selected respective color option.

In some embodiments, while the editing user interface is configured for displaying the home screen user interface with a tinted appearance (e.g., in response to detecting a user input selecting the affordance for displaying the home screen user interface with a tinted appearance): the computer system displays, via the one or more display generation components, (e.g., in the editing user interface) a first control for selecting between a plurality of values for a first tint parameter (e.g., color, hue, saturation, contrast, and/or other visual property) of one or more elements (e.g., app icons and/or widgets) on the home screen user interface (e.g., one or more sliders for controlling one or more tint parameters); and in response to detecting the third user input corresponding to selection of the first selectable color option of the one or more selectable color options, wherein the first selectable color option corresponds to a first value of the first tint parameter, the computer system displays, via the one or more display generation components, the first control for selecting between the plurality of values for the first tint parameter with an indication of the first value of the first tint parameter. For example, as described herein with reference to FIG. 11M, in response to user input 11044 directed to a respective color option of the color options 11048, in conjunction with the color of the tint applied to the application icons being updated to the selected respective color option, slider 11054 and/or slider 11050 in editing platter 11020-1 for the tinted option 11026d are updated to reflect the color value and/or level of darkness, respectively, of the color of the tint corresponding to the selected respective color option. In some embodiments, in response to detecting a user input corresponding to selection of a second selectable color option of the one or more selectable color options, where the second selectable color option is different from the first selectable color option and corresponds to a second value of the first tint parameter, the computer system displays the first user interface element with an indication of the second value of the first tint parameter (e.g., and ceases to display the indication of the first value of the first tint parameter). In some embodiments, the first control is an adjustable control such as a slider or wheel, with a first adjustable element indicating a currently selected value for the parameter controlled by the control such as a slider thumb. In some embodiments, a current position of the first adjustable element indicates a current value of the first tint parameter (e.g., a slider thumb positioned along a color slider at a current tint color of elements on the home screen user interface). In some embodiments, in response to selection of a different tint color option, the computer system changes the current position of the adjustable element (e.g., moves the slider thumb along the color slider) to correspond to a value of the color parameter associated with the newly selected tint color option. In some embodiments, the editing user interface includes a second control for selecting between a plurality of values for a second tint parameter that is different from the first tint parameter. In some embodiments, in response to detecting a user input (e.g., the third user input) corresponding to selection of the first selectable color option, the second control includes an indication of a first value of the second tint parameter. In some embodiments, in response to detecting a user input corresponding to selection of the second selectable color option, wherein the second selectable color option corresponds to a second value of the second tint parameter that is different from the first value of the second tint parameter, the computer system displays the second control with an indication of the second value of the second tint parameter instead of with the indication of the first value of the second tint parameter (e.g., by moving a slider thumb along a second slider for the second tint parameter from a position corresponding to the first value of the second tint parameter to a position corresponding to the second value of the second tint parameter).

In some embodiments, the computer system detects, via the one or more input devices, a user input directed toward the editing user interface (e.g., a tap input, an air gesture, a click input, a button press, and/or other input that is directed to a location of a control in the editing user interface and/or is detected while attention of the user is directed to the location of a control in the editing user interface). In some embodiments, in response to detecting the user input directed toward the editing user interface: in accordance with a determination that the user input directed toward the editing user interface corresponds to selection of the first affordance for displaying the home screen user interface with the first appearance, the computer system: displays, via the one or more display generation components, the home screen user interface (e.g., including the first home screen content and/or the one or more selectable user interface elements) with the first appearance; and displays, via the one or more display generation components, in the editing user interface, a first set of controls corresponding to the first appearance; and, in accordance with a determination that the user input directed toward the editing user interface corresponds to selection of the second affordance for displaying the home screen user interface with the second appearance, the computer system: displays via the one or more display generation components, the home screen user interface (e.g., including the first home screen content and/or the one or more selectable user interface elements) with the second appearance; and displays, via the one or more display generation components, in the editing user interface, a second set of controls corresponding to the second appearance, wherein the second set of controls is different from (e.g., includes one or more different controls than) the first set of controls. For example, the set of controls provided for a dark mode appearance include an option to display home screen user interface elements with a dark mode appearance (e.g., whether the device is in dark mode or not or at all times) and/or an option to display home screen user interface elements with a dark mode appearance automatically if certain conditions are met (e.g., at certain times of day, based on whether a wallpaper of the home screen user interface includes dark colors, and/or other criteria) and otherwise with a different appearance (e.g., a default or unmodified appearance) if the conditions are not met. For example, the set of controls provided for a clear appearance and/or tinted appearance include an option to display home screen user interface elements with a light mode appearance, an option to display home screen user interface elements with a dark mode appearance, and/or an option to display home screen user interface elements with different appearances (e.g., light mode, dark mode, clear, or tinted) automatically based on whether certain conditions are met (e.g., at certain times of day, based on colors of a wallpaper of the home screen user interface, and/or other criteria). For example, as described herein with reference to FIGS. 11M-11N, editing platter 11020-1 for the tinted option 11026d includes a set of options 11046 for adjusting a light and/or dark mode to be applied to the application icons, which is different from option 11058 in editing platter 11020-2 for when the dark option 11026b is to be applied to the application icons.

The operations described above with reference to FIGS. 7-10 and 12 are, optionally, implemented by components depicted in FIGS. 1A-1B. For example, the operations are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at a computer system that is in communication with one or more input devices and one or more display generation components:
displaying, via the one or more display generation components, a first user interface, wherein displaying the first user interface includes concurrently displaying:
first content; and
an indication of a current time of day that is updated as the current time of day changes;
while displaying the first user interface, detecting a first event; and
in response to detecting the first event:
displaying, via the one or more display generation components, a change in a spatial arrangement of the first content in the first user interface; and,
displaying, via the one or more display generation components, a change to the indication of the current time of day, including changing an aspect ratio of the indication of the current time of day while maintaining display of the indication of the current time of day in the first user interface, based on the change in the spatial arrangement of the first content.

2. The method of claim 1, wherein changing the aspect ratio of the indication of the current time of day while maintaining display of the indication of the current time of day in the first user interface, based on the change in the spatial arrangement of the first content, includes:
in accordance with a determination that the first content has a first spatial arrangement as a result of the change in the spatial arrangement of the first content, displaying, via the one or more display generation components, the indication of the current time of day with a first change in aspect ratio; and
in accordance with a determination that the first content has a second spatial arrangement that is different from the first spatial arrangement, as a result of the change in the spatial arrangement of the first content, displaying, via the one or more display generation components, the indication of the current time of day with a second change in aspect ratio that is different from the first change in aspect ratio.

3. The method of claim 1, wherein detecting the first event includes detecting, via the one or more input devices, a movement input.

4. The method of claim 3, wherein:
the movement input corresponds to a request to dismiss the first user interface; and
displaying the change in the spatial arrangement of the first content in the first user interface includes displaying, via the one or more display generation components, an animated transition to dismiss the first user interface.

5. The method of claim 4, including:
while displaying the first user interface that includes the first content and the indication of the current time of day, detecting occurrence of an event that causes the computer system to enter a low power state; and
in response to detecting occurrence of the event that causes the computer system to enter the low power state, modifying an appearance of the first content and the indication of the current time of day in accordance with a simulated camera transition relative to the first content and the indication of the current time of day.

6. The method of claim 3, wherein:
the movement input corresponds to a request to scroll one or more notifications in the first user interface; and
displaying the change in the spatial arrangement of the first content in the first user interface includes moving one or more notifications in the first user interface and/or displaying one or more notifications that were not displayed in the first user interface at a start of the movement input.

7. The method of claim 3, wherein:
the movement input includes a first portion of the movement input, and a second portion of the movement input other than the first portion of the movement input; and
displaying the change in the spatial arrangement of the first content in the first user interface in response to detecting the first event includes:
displaying, via the one or more display generation components, the change in the spatial arrangement of the first content in response to detecting the first portion of the movement input; and
displaying, via the one or more display generation components, the change to the indication of the current time in response to detecting the second portion of the movement input.

8. The method of claim 7, wherein:
the first content includes a first subset of content and a second subset of content different from the first subset of content; and
displaying the change in the spatial arrangement of the first content includes changing a position of the first subset of content relative to the second subset of content in the first user interface, while the second subset of content is moved in response to the first portion of the movement input, wherein changing the position of the first subset of content relative to the second subset of content in the first user interface reduces visual occlusion of the first subset of content by the second subset of content during the first portion of the movement input.

9. The method of claim 3, wherein:
detecting the movement input includes detecting, via the one or more input devices, an end portion of the movement input; and
the method includes:
in response to detecting the end portion of the movement input:
continuing to display, via the one or more display generation components, an additional change in the spatial arrangement of the first content in the first user interface; and
after continuing to display the additional change in the spatial arrangement of the first content in the first user interface, reversing at least a portion of the additional change in the spatial arrangement of the first content in the first user interface.

10. The method of claim 1, including:
while displaying the first user interface, detecting a second event;
in response to detecting the second event:
displaying, via the one or more display generation components, a second change in the spatial arrangement of the first content in the first user interface; and
displaying, via the one or more display generation components, a second change to the indication of the current time of day, including changing the aspect ratio of the indication of the current time of day while maintaining display of the indication of the current time of day in the first user interface, based on the second change in the spatial arrangement of the first content;
wherein detecting the second event includes detecting a change in an orientation of the computer system from a first orientation to a second orientation.

11. The method of claim 10, wherein displaying the second change in the spatial arrangement of the first content in the first user interface includes, changing an orientation of the first content and an orientation of the indication of the current time of day in accordance with the change in orientation of the computer system, while maintaining a spatial relationship between the indication of the current time of day and a first portion of the first content.

12. The method of claim 1, wherein changing the aspect ratio of the indication of the current time of day while maintaining display of the indication of the current time of day in the first user interface includes changing a height of the indication of the current time of day while maintaining a width of the indication of the current time of day.

13. The method of claim 1, further including:
after displaying the change to the indication of current time of day in response to detecting the first event, detecting a third event; and
in response to detecting the third event, displaying, via the one or more display generation components, a third change to the indication of the current time of day that is different from the change to the indication of the current time of day displayed in response to detecting the first event.

14. The method of claim 13, wherein:
displaying the change to the indication of the current time of day includes changing a height of the indication of the current time of day, resulting in a first amount of change in the aspect ratio of the indication of the current time of day; and
displaying the third change to the indication of current time of day includes changing a width of the indication of the current time of day, resulting in a second amount of change in the aspect ratio of the indication of the current time of day.

15. The method of claim 13, wherein:
displaying the change to the indication of the current time of day includes changing the aspect ratio of the indication of the current time of day while maintaining a position of the indication of the current time of day; and
displaying the third change to the indication of the current time of day includes changing the position of the indication of the current time of day in the first user interface.

16. The method of claim 1, including:
while displaying the first user interface, detecting an event that corresponds to display of additional content in the first user interface; and
in response to detecting the event that corresponds to display of additional content in the first user interface, displaying, via the one or more display generation components, a change to the indication of the current time of day while maintaining display of the indication of the current time of day in the first user interface, based on display of the additional content in the first user interface.

17. The method of claim 16, wherein:
detecting the event that corresponds to display of additional content in the first user interface includes detecting occurrence of an event for a new notification; and
the method includes displaying, via the one or more display generation components, the new notification in the first user interface.

18. The method of claim 16, wherein:
detecting the event that corresponds to display of additional content in the first user interface includes detecting availability of an update for an ongoing activity that is followed by the computer system; and
the method includes displaying, via the one or more display generation components, the update in a user interface object corresponding to the ongoing activity in the first user interface.

19. The method of claim 1, including:
while displaying the first user interface, detecting an event that corresponds to changing a background of the first user interface; and
in response to detecting the event that corresponds to changing the background of the first user interface, displaying, via the one or more display generation components, a change to the indication of the current time of day while maintaining display of the indication of the current time of day in the first user interface, based on changing the background of the first user interface.

20. The method of claim 1, including:
detecting, via the one or more input devices, a user input that corresponds to a request to edit the first user interface;
in response to detecting the user input that corresponds to the request to edit the first user interface, displaying, via the one or more display generation components, an editing user interface for the first user interface that includes the indication of the current time of day displayed in an editable state in the first user interface;
while displaying the editing user interface for the first user interface, detecting, via the one or more input devices, a user input that includes movement in a first direction directed to the indication of the current time of day; and
in response to detecting the user input that includes movement in the first direction directed to the indication of the current time of day, changing a size of the indication of the current time of day in accordance with the movement in the first direction.

21. The method of claim 20, including:
in response to detecting the user input that includes movement in the first direction directed to the indication of the current time of day, moving at least a first portion of the first content in the first user interface relative to the indication of the current time, while the first portion of the first content overlays at least a portion of the indication of the current time and while the indication of the current time overlays a second portion of the first content that is different from the first portion of the first content.

22. The method of claim 20, wherein changing the size of the indication of the current time of day in accordance with the movement in the first direction includes changing the size of the indication of the current time by an amount that is based on a value of a first characteristic of the movement in the first direction.

23. The method of claim 1, wherein the indication of the current time is displayed with an appearance that is based on a simulated visual interaction between a user interface material and the first content.

24. The method of claim 23, including:
detecting, via the one or more input devices, a user input that corresponds to a request to edit the first user interface;
in response to detecting the user input that corresponds to the request to edit the first user interface, displaying, via the one or more display generation components, an editing user interface for the first user interface that includes the indication of the current time of day displayed in an editable state in the first user interface, including displaying, in the editing user interface for the first user interface, a first control for selecting between a plurality of values for a degree of the simulated visual interaction between the user interface material and the first content;
while displaying the editing user interface for the first user interface and while displaying the indication of the current time of day with an appearance that is based on a first degree of the simulated visual interaction between the user interface material and the first content, detecting, via the one or more input devices, a user input directed toward the first control; and
in response to detecting the user input directed toward the first control, displaying the indication of the current time of day with an appearance that is based on a second degree of the simulated visual interaction between the user interface material and the first content, wherein the second degree of the simulated visual interaction is different from the first degree of the simulated visual interaction.

25. The method of claim 23, including:
detecting, via the one or more input devices, a user input that corresponds to a request to edit the first user interface;
in response to detecting the user input that corresponds to the request to edit the first user interface, displaying, via the one or more display generation components, an editing user interface for the first user interface that includes the indication of the current time of day displayed in an editable state in the first user interface, including displaying, in the editing user interface for the first user interface, one or more controls for selecting between a plurality of values for a first tint property of the indication of the current time of day;
while displaying the editing user interface for the first user interface and while displaying the indication of the current time of day with an appearance having a first value of the first tint property and that is based on a respective degree of the simulated visual interaction between the user interface material and the first content, detecting, via the one or more input devices, a user input directed toward the one or more controls; and
in response to detecting the user input directed toward the one or more controls, displaying, via the one or more display generation components, the indication of the current time of day with an appearance having a second value of the first tint property and that is based on the respective degree of the simulated visual interaction between the user interface material and the first content, wherein the second value of the first tint property is different from the first value of the first tint property.

26. The method of claim 1, wherein:
displaying the first user interface includes concurrently displaying, via the one or more display generation components, an indication of a current date and the indication of the current time of day, and
the method includes:
while changing a size of the indication of the current time of day by a first amount in response to detecting a respective event, changing a size of the indication of the current date by a second amount that is different from the first amount.

27. The method of claim 1, wherein detecting the first event includes detecting that a respective amount of time has elapsed.

28. A computer system that is in communication with one or more input devices and one or more display generation components, the computer system comprising:
one or more processors; and
memory storing one or more programs, wherein the one or more programs are configured to be executed by the one or more processors, the one or more programs including instructions for:
displaying, via the one or more display generation components, a first user interface, wherein displaying the first user interface includes concurrently displaying:
first content; and
an indication of a current time of day that is updated as the current time of day changes;
while displaying the first user interface, detecting a first event; and
in response to detecting the first event:
displaying, via the one or more display generation components, a change in a spatial arrangement of the first content in the first user interface; and,
displaying, via the one or more display generation components, a change to the indication of the current time of day, including changing an aspect ratio of the indication of the current time of day while maintaining display of the indication of the current time of day in the first user interface, based on the change in the spatial arrangement of the first content.

29. A computer readable storage medium storing one or more programs, the one or more programs comprising instructions that, when executed by a computer system that is in communication with one or more input devices and one or more display generation components, cause the computer system to:
display, via the one or more display generation components, a first user interface, wherein displaying the first user interface includes concurrently displaying:
first content; and
an indication of a current time of day that is updated as the current time of day changes;
while displaying the first user interface, detect a first event; and
in response to detecting the first event:
display, via the one or more display generation components, a change in a spatial arrangement of the first content in the first user interface; and,
display, via the one or more display generation components, a change to the indication of the current time of day, including changing an aspect ratio of the indication of the current time of day while maintaining display of the indication of the current time of day in the first user interface, based on the change in the spatial arrangement of the first content.

30-49. (canceled)
